(19) United States
(12) Patent Application Publication
(10) Pub. No.: US 2026/0296408 A1
(43) Pub. Date: Oct. 1, 2026

(54) SYSTEMS AND METHODS FOR PARKING A VEHICLE

(71) Applicant: MOBILEYE VISION TECHNOLOGIES LTD., Jerusalem (IL)

(72) Inventors: Tomer COHEN, Tel-Aviv (IL); Tomer BABA, Jerusalem (IL); Shai SHALEV-SHWARTZ, Jerusalem (IL); Jonathan Philippe Y. BOINET, Netanya (IL); Ori PETEL, Tel Aviv (IL); Sheina GENDELMAN, Haifa (IL); Mark MATUSEVICH, Akko (IL); Victoria PODOLEANU, Haifa (IL)

(21) Appl. No.: 19/544,505

(22) Filed: Feb. 19, 2026

Related U.S. Application Data
(60) Provisional application No. 63/760,757, filed on Feb. 20, 2025.
(60) Provisional application No. 63/822,585, filed on Jun. 12, 2025.
(60) Provisional application No. 63/853,805, filed on Jul. 30, 2025.

(51) Int. Cl. B60W 30/06; G06T 7/13; G06T 7/73; G06V 10/82; G06V 20/58

(52) U.S. Cl. CPC B60W 30/06; G06T 7/13; G06T 7/74; G06V 20/586; B60W 2420/403; B60W 2420/408; B60W 2520/06; B60W 2530/201; B60W 2556/10; B60W 2556/45; B60W 2720/24; G06T 2207/20081; G06T 2207/20084; G06T 2207/30261; G06T 2207/30264; G06V 10/82; G06V 2201/08

(57) ABSTRACT

Systems and methods for navigating a host vehicle relative to a parking space may include receiving sensed image data acquired by an image sensing system; determining, based at least in part on analysis of the sensed image data, a first indicator of a left boundary and a second indicator of a right boundary associated with a parking space; and determining a parking space approach maneuver initial position. The parking space approach maneuver initial position may be determined based on the determined first and second indicators of the left and right boundaries and also based on a determined indicator of an entrance to the parking space. One or more actuator systems associated with the host vehicle may be caused to active to cause the host vehicle to navigate into the parking space from the parking space approach maneuver initial position.

### CROSS-REFERENCES TO RELATED APPLICATIONS

This application claims the benefit of priority of U.S. Provisional Application No. 63/760,757, filed on Feb. 20, 2025; U.S. Provisional Application No. 63/822,585, filed on Jun. 12, 2025; and U.S. Provisional Application No. 63/853,805, filed on Jul. 30, 2025. The foregoing applications are incorporated herein by reference in their entireties.

### BACKGROUND

### Technical Field

This disclosure relates generally to vehicle navigation.

### Background Information

As technology continues to advance, the goal of a fully autonomous vehicle that is capable of navigating on roadways is on the horizon. Autonomous vehicles may need to take into account a variety of factors and make appropriate decisions based on those factors to safely and accurately reach an intended destination. For example, an autonomous vehicle may need to process and interpret visual information (e.g., information captured from a camera) and may also use information obtained from other sources (e.g., from a GPS device, a speed sensor, an accelerometer, a suspension sensor, etc.). At the same time, in order to navigate to a destination, an autonomous vehicle may also need to identify its location within a particular roadway (e.g., a specific lane within a multi-lane road), navigate alongside other vehicles, avoid obstacles and pedestrians, observe traffic signals and signs, and travel from one road to another road at appropriate intersections or interchanges. Harnessing and interpreting vast volumes of information collected by an autonomous vehicle as the vehicle travels to its destination poses a multitude of design challenges. The sheer quantity of data (e.g., captured image data, map data, GPS data, sensor data, etc.) that an autonomous vehicle may need to analyze, access, and/or store poses challenges that can in fact limit or even adversely affect autonomous navigation. Furthermore, if an autonomous vehicle relies on traditional mapping technology to navigate, the sheer volume of data needed to store and update the map poses daunting challenges.

### SUMMARY

In an embodiment, there is a system for navigating a host vehicle relative to a parking space. The system comprises at least one processor comprising circuitry and a memory. The memory includes instructions that when executed by the circuitry cause the at least one processor to: receive sensed image data acquired by an image sensing system, wherein the sensed image data includes a representation of a parking space; determine, based at least in part on analysis of the sensed image data, a first indicator of a left boundary and a second indicator of a right boundary associated with the parking space; determine a parking space approach maneuver initial position, wherein the parking space approach maneuver initial position is determined based on the determined first and second indicators of the left and right boundaries and also based on a determined indicator of an entrance to the parking space; wherein the parking space approach maneuver initial position is one from which the host vehicle is able to navigate toward the entrance to the parking space and enter the parking space with an envelope of the host vehicle between the left boundary and the right boundary, and wherein further entry of the host vehicle into the parking space can be performed without requiring the vehicle envelope to intersect with or cross over the left boundary or the right boundary inside the parking space; and cause activation of one or more actuator systems associated with the host vehicle to cause the host vehicle to navigate into the parking space from the parking space approach maneuver initial position.

In another embodiment, there is a method for navigating a host vehicle relative to a parking space. The method comprises: receiving sensed image data acquired by an image sensing system, wherein the sensed image data includes a representation of a parking space; determining, based at least in part on analysis of the sensed image data, a first indicator of a left boundary and a second indicator of a right boundary associated with the parking space; determining, based at least in part on analysis of the sensed image data, an indicator of an entrance to the parking space; determining a parking space approach maneuver initial position, wherein the parking space approach maneuver initial position is determined based on the determined first and second indicators of the left and right boundaries and also based on the determined indicator of the entrance to the parking space; wherein the parking space approach maneuver initial position is one from which the host vehicle is able to navigate toward the entrance to the parking space and enter the parking space with an envelope of the host vehicle between the left boundary and the right boundary, and wherein further entry of the host vehicle into the parking space can be performed without requiring the vehicle envelope to intersect with or cross over the left boundary or the right boundary; and causing activation of one or more actuator systems associated with the host vehicle to cause the host vehicle to navigate into the parking space from the parking space approach maneuver initial position.

In another embodiment, there is a non-transitory computer-readable medium storing instructions for navigating a host vehicle relative to a parking space according to a method. The method comprises: receiving sensed image data acquired by an image sensing system, wherein the sensed image data includes a representation of a parking space; determining, based at least in part on analysis of the sensed image data, a first indicator of a left boundary and a second indicator of a right boundary associated with the parking space; determining, based at least in part on analysis of the sensed image data, an indicator of an entrance to the parking space; determining a parking space approach maneuver initial position, wherein the parking space approach maneuver initial position is determined based on the determined first and second indicators of the left and right boundaries and also based on the determined indicator of the entrance to the parking space; wherein the parking space approach maneuver initial position is one from which the host vehicle is able to navigate toward the entrance to the parking space and enter the parking space with an envelope of the host vehicle between the left boundary and the right boundary, and wherein further entry of the host vehicle into the parking space can be performed without requiring the vehicle envelope to intersect with or cross over the left boundary or the right boundary; and causing activation of one or more actuator systems associated with the host vehicle to cause the host vehicle to navigate into the parking space from the parking space approach maneuver initial position.

In an embodiment there is a system for navigating a host vehicle relative to a parking space, the system comprising: at least one processor comprising circuitry and a memory, wherein the memory includes instructions that when executed by the circuitry cause the at least one processor to: receive sensed image data acquired by an image sensing system, wherein the sensed image data includes a representation of a parking space; determine, based at least in part on analysis of the sensed image data, a first indicator of a left boundary and a second indicator of a right boundary associated with the parking space; determine, based at least in part on analysis of the sensed image data, an indicator of a parking space threshold associated with the parking space; determine a parking space approach maneuver initial position, wherein the parking space approach maneuver initial position is determined based on the determined first and second indicators of the left and right boundaries and also based on the determined parking space threshold; wherein the parking space approach maneuver initial position is one from which the host vehicle is able to navigate toward the parking space threshold and cross the threshold with an envelope of the host vehicle passing between the left boundary and the right boundary, and wherein further entry of the host vehicle into the parking space can be performed without requiring the vehicle envelope to intersect with or cross over the left boundary or the right boundary; and wherein the parking space approach maneuver initial position is also one from which the host vehicle has sufficient space to complete an S maneuver prior to crossing the parking space threshold; and cause activation of one or more actuator systems associated with the host vehicle to cause the host vehicle to navigate into the parking space from the parking space approach maneuver initial position and to complete the S maneuver prior to crossing the parking space threshold.

In an embodiment there is a method for navigating a host vehicle relative to a parking space, the method comprising: receiving sensed image data acquired by an image sensing system, wherein the sensed image data includes a representation of a parking space; determining, based at least in part on analysis of the sensed image data, a first indicator of a left boundary and a second indicator of a right boundary associated with the parking space; determining, based at least in part on analysis of the sensed image data, a parking space threshold associated with the parking space; determining a parking space approach maneuver initial position, wherein the parking space approach maneuver initial position is determined based on the determined first and second indicators of the left and right boundaries and also based on the determined parking space threshold; wherein the parking space approach maneuver initial position is one from which the host vehicle is able to navigate toward the parking space threshold and cross the threshold with an envelope of the host vehicle passing between the left boundary and the right boundary, and wherein further entry of the host vehicle into the parking space can be performed without requiring the vehicle envelope to intersect with or cross over the left boundary or the right boundary; and wherein the parking space approach maneuver initial position is also one from which the host vehicle has sufficient space to complete an S maneuver prior to crossing the parking space threshold; and causing activation of one or more actuator systems associated with the host vehicle to cause the host vehicle to navigate into the parking space from the parking space approach maneuver initial position and to complete the S maneuver prior to crossing the parking space threshold.

In an embodiment there is a non-transitory computer-readable medium storing instructions for navigating a host vehicle relative to a parking space according to a method, the method comprising: receiving sensed image data acquired by an image sensing system, wherein the sensed image data includes a representation of a parking space; determining, based at least in part on analysis of the sensed image data, a first indicator of a left boundary and a second indicator of a right boundary associated with the parking space; determining, based at least in part on analysis of the sensed image data, a parking space threshold associated with the parking space; determining a parking space approach maneuver initial position, wherein the parking space approach maneuver initial position is determined based on the determined first and second indicators of the left and right boundaries and also based on the determined parking space threshold; wherein the parking space approach maneuver initial position is one from which the host vehicle is able to navigate toward the parking space threshold and cross the threshold with an envelope of the host vehicle passing between the left boundary and the right boundary, and wherein further entry of the host vehicle into the parking space can be performed without requiring the vehicle envelope to intersect with or cross over the left boundary or the right boundary; and wherein the parking space approach maneuver initial position is also one from which the host vehicle has sufficient space to complete an S maneuver prior to crossing the parking space threshold; and causing activation of one or more actuator systems associated with the host vehicle to cause the host vehicle to navigate into the parking space from the parking space approach maneuver initial position and to complete the S maneuver prior to crossing the parking space threshold.

In an embodiment, there is a system for navigating a host vehicle relative to a parking space, the system comprising: at least one processor comprising circuitry and a memory, wherein the memory includes instructions that when executed by the circuitry cause the at least one processor to: receive sensed image data acquired by an image sensing system, wherein the sensed image data includes a partial representation of a parking space, such that less than a full area of the parking space is represented in the sensed image data, and a distal region of the parking space and an associated parking space depth limiter are not represented in the captured image; determine, based at least in part on analysis of the sensed image data, a first indicator of a left boundary and a second indicator of a right boundary associated with the parking space; determine, based at least in part on analysis of the sensed image data, a parking space threshold associated with the parking space; cause activation of one or more actuator systems associated with the host vehicle to cause the host vehicle to navigate toward the parking space threshold along a curved trajectory to enter the parking space; receive new sensed image data, as the host vehicle approaches the parking space, wherein the new sensed image data includes a representation of a distal region of the parking space and an associated parking space depth limiter; based on a determination of whether the parking space depth limiter allows for sufficient depth for the host vehicle to reach a position where the host vehicle is substantially parallel to the left boundary or the right boundary, cause the host vehicle to continue onward along the curved trajectory to complete entry into the parking space if there is sufficient depth, or cause activation of the one or more actuator systems associated with the host vehicle to cause the host vehicle to initiate a correction maneuver during entry into the parking space.

In an embodiment, there is a method for navigating a host vehicle relative to a parking space, the method comprising: receiving sensed image data acquired by an image sensing system, wherein the sensed image data includes a partial representation of a parking space, such that less than a full area of the parking space is represented in the sensed image data, and a distal region of the parking space and an associated parking space depth limiter are not represented in the captured image; determining, based at least in part on analysis of the sensed image data, a first indicator of a left boundary and a second indicator of a right boundary associated with the parking space; determining, based at least in part on analysis of the sensed image data, a parking space threshold associated with the parking space; causing activation of one or more actuator systems associated with the host vehicle to cause the host vehicle to navigate toward the parking space threshold along a curved trajectory to enter the parking space; receiving new sensed image data, as the host vehicle approaches the parking space, wherein the new sensed image data includes a representation of a distal region of the parking space and an associated parking space depth limiter; based on a determination of whether the parking space depth limiter allows for sufficient depth for the host vehicle to reach a position where the host vehicle is substantially parallel to the left boundary or the right boundary, causing the host vehicle to continue onward along the curved trajectory to complete entry into the parking space if there is sufficient depth, or causing activation of the one or more actuator systems associated with the host vehicle to cause the host vehicle to initiate a correction maneuver during entry into the parking space.

In an embodiment there is a non-transitory computer-readable medium storing instructions for navigating a host vehicle relative to a parking space according to a method, the method comprising: receiving sensed image data acquired by an image sensing system, wherein the sensed image data includes a partial representation of a parking space, such that less than a full area of the parking space is represented in the sensed image data, and a distal region of the parking space and an associated parking space depth limiter are not represented in the captured image; determining, based at least in part on analysis of the sensed image data, a first indicator of a left boundary and a second indicator of a right boundary associated with the parking space; determining, based at least in part on analysis of the sensed image data, a parking space threshold associated with the parking space; causing activation of one or more actuator systems associated with the host vehicle to cause the host vehicle to navigate toward the parking space threshold along a curved trajectory to enter the parking space; receiving new sensed image data, as the host vehicle approaches the parking space, wherein the new sensed image data includes a representation of a distal region of the parking space and an associated parking space depth limiter; based on a determination of whether the parking space depth limiter allows for sufficient depth for the host vehicle to reach a position where the host vehicle is substantially parallel to the left boundary or the right boundary, causing the host vehicle to continue onward along the curved trajectory to complete entry into the parking space if there is sufficient depth, or causing activation of the one or more actuator systems associated with the host vehicle to cause the host vehicle to initiate a correction maneuver during entry into the parking space.

In an embodiment, there is a system for navigating a host vehicle relative to a parking space, the system comprising: at least one processor comprising circuitry and a memory, wherein the memory includes instructions that when executed by the circuitry cause the at least one processor to: receive sensed image data acquired by an image sensing system, wherein the sensed image data includes a representation of a parking space; determine, based at least in part on analysis of the sensed image data, a first indicator of a left boundary and a second indicator of a right boundary associated with the parking space; determine, based at least in part on analysis of the sensed image data, a parking space threshold associated with the parking space; where, based on an initial position of the host vehicle, a predetermined minimum vehicle turn radius for the host vehicle, and a predetermined envelope associated with the host vehicle, sufficient space is determined to exist from the initial position of the host vehicle to allow the host vehicle to enter the parking space via a single turn in maneuver, cause activation of one or more actuator systems associated with the host vehicle to cause the host vehicle to navigate into the parking space via the single turn in maneuver; and where, based on the initial position of the host vehicle, the predetermined minimum vehicle turn radius for the host vehicle, and the predetermined envelope associated with the host vehicle, sufficient space is determined to not exist from the initial position of the host vehicle to allow the host vehicle to enter the parking space via the single turn in maneuver, cause activation of one or more actuator systems associated with the host vehicle to cause the host vehicle to navigate into the parking space via a three-point turn in maneuver.

In an embodiment, there is a method for navigating a host vehicle relative to a parking space, the method comprising: receiving sensed image data acquired by an image sensing system, wherein the sensed image data includes a representation of a parking space; determining, based at least in part on analysis of the sensed image data, a first indicator of a left boundary and a second indicator of a right boundary associated with the parking space; determining, based at least in part on analysis of the sensed image data, a parking space threshold associated with the parking space; where, based on an initial position of the host vehicle, a predetermined minimum vehicle turn radius for the host vehicle, and a predetermined envelope associated with the host vehicle, sufficient space is determined to exist from the initial position of the host vehicle to allow the host vehicle to enter the parking space via a single turn in maneuver, causing activation of one or more actuator systems associated with the host vehicle to cause the host vehicle to navigate into the parking space via the single turn in maneuver; and where, based on the initial position of the host vehicle, the predetermined minimum vehicle turn radius for the host vehicle, and the predetermined envelope associated with the host vehicle, sufficient space is determined to not exist from the initial position of the host vehicle to allow the host vehicle to enter the parking space via the single turn in maneuver, causing activation of one or more actuator systems associated with the host vehicle to cause the host vehicle to navigate into the parking space via a three-point turn in maneuver.

In an embodiment, there is a non-transitory computer-readable medium storing instructions for navigating a host vehicle relative to a parking space according to a method, the method comprising: receiving sensed image data acquired by an image sensing system, wherein the sensed image data includes a representation of a parking space; determining, based at least in part on analysis of the sensed image data, a first indicator of a left boundary and a second indicator of a right boundary associated with the parking space; determining, based at least in part on analysis of the sensed image data, a parking space threshold associated with the parking space; where, based on an initial position of the host vehicle, a predetermined minimum vehicle turn radius for the host vehicle, and a predetermined envelope associated with the host vehicle, sufficient space is determined to exist from the initial position of the host vehicle to allow the host vehicle to enter the parking space via a single turn in maneuver, causing activation of one or more actuator systems associated with the host vehicle to cause the host vehicle to navigate into the parking space via the single turn in maneuver; and where, based on the initial position of the host vehicle, the predetermined minimum vehicle turn radius for the host vehicle, and the predetermined envelope associated with the host vehicle, sufficient space is determined to not exist from the initial position of the host vehicle to allow the host vehicle to enter the parking space via the single turn in maneuver, causing activation of one or more actuator systems associated with the host vehicle to cause the host vehicle to navigate into the parking space via a three-point turn in maneuver.

In an embodiment, there is a system for navigating a host vehicle relative to a parking space, the system comprising: at least one processor comprising circuitry and a memory, wherein the memory includes instructions that when executed by the circuitry cause the at least one processor to: receive sensed image data acquired by an image sensing system, wherein the sensed image data includes a representation of a fishbone parking space; determine, based at least in part on analysis of the sensed image data, a first indicator of a left boundary and a second indicator of a right boundary associated with the fishbone parking space; determine, based at least in part on analysis of the sensed image data, an indicator of a parking space threshold associated with the fishbone parking space; cause activation of one or more actuator systems associated with the host vehicle to cause the host vehicle to navigate toward the fishbone parking space and cross the parking space threshold at a non-orthogonal angle; receive a new sensed image data, as the host vehicle approaches the fishbone parking space, wherein the new sensed image data includes a representation of a fishbone parking space depth limiter non-orthogonally oriented relative to a direction of travel of the host vehicle into the fishbone parking space; determine a host vehicle stopping location based on the fishbone parking space depth limiter; and cause activation of the one or more actuator systems associated with the host vehicle to cause the host vehicle to proceed into the fishbone parking space and come to a stop in response to the determined host vehicle stopping location.

In an embodiment, there is a method for navigating a host vehicle relative to a parking space, the method comprising: receiving sensed image data acquired by an image sensing system, wherein the sensed image data includes a representation of a fishbone parking space; determining, based at least in part on analysis of the sensed image data, a first indicator of a left boundary and a second indicator of a right boundary associated with the fishbone parking space; determining, based at least in part on analysis of the sensed image data, an indicator of a parking space threshold associated with the fishbone parking space; causing activation of one or more actuator systems associated with the host vehicle to cause the host vehicle to navigate toward the fishbone parking space and cross the parking space threshold at a non-orthogonal angle; receiving a new sensed image data, as the host vehicle approaches the fishbone parking space, wherein the new sensed image data includes a representation of a fishbone parking space depth limiter non-orthogonally oriented relative to a direction of travel of the host vehicle into the fishbone parking space; determining a host vehicle stopping location based on the fishbone parking space depth limiter; and causing activation of the one or more actuator systems associated with the host vehicle to cause the host vehicle to proceed into the fishbone parking space and come to a stop in response to the determined host vehicle stopping location.

In an embodiment, there is a non-transitory computer-readable medium storing instructions for navigating a host vehicle relative to a parking space according to a method, the method comprising: receiving sensed image data acquired by an image sensing system, wherein the sensed image data includes a representation of a fishbone parking space; determining, based at least in part on analysis of the sensed image data, a first indicator of a left boundary and a second indicator of a right boundary associated with the fishbone parking space; determining, based at least in part on analysis of the sensed image data, an indicator of a parking space threshold associated with the fishbone parking space; causing activation of one or more actuator systems associated with the host vehicle to cause the host vehicle to navigate toward the fishbone parking space and cross the parking space threshold at a non-orthogonal angle; receiving a new sensed image data, as the host vehicle approaches the fishbone parking space, wherein the new sensed image data includes a representation of a fishbone parking space depth limiter non-orthogonally oriented relative to a direction of travel of the host vehicle into the fishbone parking space; determining a host vehicle stopping location based on the fishbone parking space depth limiter; and causing activation of the one or more actuator systems associated with the host vehicle to cause the host vehicle to proceed into the fishbone parking space and come to a stop in response to the determined host vehicle stopping location.

### BRIEF DESCRIPTION OF THE DRAWINGS

The accompanying drawings, which are incorporated in and constitute a part of this disclosure, illustrate various disclosed embodiments. In the drawings:

FIG. 1 is a diagrammatic representation of an exemplary system consistent with the disclosed embodiments.

FIG. 2A is a diagrammatic side view representation of an exemplary vehicle including a system consistent with the disclosed embodiments.

FIG. 2B is a diagrammatic top view representation of the vehicle and system shown in FIG. 2A consistent with the disclosed embodiments.

FIG. 2C is a diagrammatic top view representation of another embodiment of a vehicle including a system consistent with the disclosed embodiments.

FIG. 2D is a diagrammatic top view representation of yet another embodiment of a vehicle including a system consistent with the disclosed embodiments.

FIG. 2E is a diagrammatic top view representation of yet another embodiment of a vehicle including a system consistent with the disclosed embodiments.

FIG. 2F is a diagrammatic representation of exemplary vehicle control systems consistent with the disclosed embodiments.

FIG. 3A is a diagrammatic representation of an interior of a vehicle including a rearview mirror and a user interface for a vehicle imaging system consistent with the disclosed embodiments.

FIG. 3B is an illustration of an example of a camera mount that is configured to be positioned behind a rearview mirror and against a vehicle windshield consistent with the disclosed embodiments.

FIG. 3C is an illustration of the camera mount shown in FIG. 3B from a different perspective consistent with the disclosed embodiments.

FIG. 3D is an illustration of an example of a camera mount that is configured to be positioned behind a rearview mirror and against a vehicle windshield consistent with the disclosed embodiments.

FIG. 4 is an exemplary block diagram of a memory configured to store instructions for performing one or more operations consistent with the disclosed embodiments.

FIG. 5A is a flowchart showing an exemplary process for causing one or more navigational responses based on monocular image analysis consistent with disclosed embodiments.

FIG. 5B is a flowchart showing an exemplary process for detecting one or more vehicles and/or pedestrians in a set of images consistent with the disclosed embodiments.

FIG. 5C is a flowchart showing an exemplary process for detecting road marks and/or lane geometry information in a set of images consistent with the disclosed embodiments.

FIG. 5D is a flowchart showing an exemplary process for detecting traffic lights in a set of images consistent with the disclosed embodiments.

FIG. 5E is a flowchart showing an exemplary process for causing one or more navigational responses based on a vehicle path consistent with the disclosed embodiments.

FIG. 5F is a flowchart showing an exemplary process for determining whether a leading vehicle is changing lanes consistent with the disclosed embodiments.

FIG. 6 is a flowchart showing an exemplary process for causing one or more navigational responses based on stereo image analysis consistent with the disclosed embodiments.

FIG. 7 is a flowchart showing an exemplary process for causing one or more navigational responses based on an analysis of three sets of images consistent with the disclosed embodiments.

FIG. 8 shows a sparse map for providing autonomous vehicle navigation, consistent with the disclosed embodiments.

FIG. 9A illustrates a polynomial representation of a portions of a road segment consistent with the disclosed embodiments.

FIG. 9B illustrates a curve in three-dimensional space representing a target trajectory of a vehicle, for a particular road segment, included in a sparse map consistent with the disclosed embodiments.

FIG. 10 illustrates example landmarks that may be included in sparse map consistent with the disclosed embodiments.

FIG. 11A shows polynomial representations of trajectories consistent with the disclosed embodiments.

FIGS. 11B and 11C show target trajectories along a multi-lane road consistent with disclosed embodiments.

FIG. 11D shows an example road signature profile consistent with disclosed embodiments.

FIG. 12 is a schematic illustration of a system that uses crowd sourcing data received from a plurality of vehicles for autonomous vehicle navigation, consistent with the disclosed embodiments.

FIG. 13 illustrates an example autonomous vehicle road navigation model represented by a plurality of three-dimensional splines, consistent with the disclosed embodiments.

FIG. 14 shows a map skeleton generated from combining location information from many drives, consistent with the disclosed embodiments.

FIG. 15 shows an example of a longitudinal alignment of two drives with example signs as landmarks, consistent with the disclosed embodiments.

FIG. 16 shows an example of a longitudinal alignment of many drives with an example sign as a landmark, consistent with the disclosed embodiments.

FIG. 17 is a schematic illustration of a system for generating drive data using a camera, a vehicle, and a server, consistent with the disclosed embodiments.

FIG. 18 is a schematic illustration of a system for crowdsourcing a sparse map, consistent with the disclosed embodiments.

FIG. 19 is a flowchart showing an exemplary process for generating a sparse map for autonomous vehicle navigation along a road segment, consistent with the disclosed embodiments.

FIG. 20 illustrates a block diagram of a server consistent with the disclosed embodiments.

FIG. 21 illustrates a block diagram of a memory consistent with the disclosed embodiments.

FIG. 22 illustrates a process of clustering vehicle trajectories associated with vehicles, consistent with the disclosed embodiments.

FIG. 23 illustrates a navigation system for a vehicle, which may be used for autonomous navigation, consistent with the disclosed embodiments.

FIGS. 24A, 24B, 24C, and 24D illustrate exemplary lane marks that may be detected consistent with the disclosed embodiments.

FIG. 24E shows exemplary mapped lane marks consistent with the disclosed embodiments.

FIG. 24F shows an exemplary anomaly associated with detecting a lane mark consistent with the disclosed embodiments.

FIG. 25A shows an exemplary image of a vehicle's surrounding environment for navigation based on the mapped lane marks consistent with the disclosed embodiments.

FIG. 25B illustrates a lateral localization correction of a vehicle based on mapped lane marks in a road navigation model consistent with the disclosed embodiments.

FIGS. 25C and 25D provide conceptual representations of a localization technique for locating a host vehicle along a target trajectory using mapped features included in a sparse map.

FIG. 26A is a flowchart showing an exemplary process for mapping a lane mark for use in autonomous vehicle navigation, consistent with disclosed embodiments.

FIG. 26B is a flowchart showing an exemplary process for autonomously navigating a host vehicle along a road segment using mapped lane marks, consistent with disclosed embodiments.

FIG. 27 provides a diagrammatic representation of a host vehicle navigation system for a vehicle, which may be used for autonomous navigation, consistent with the disclosed embodiments.

FIGS. 28A, 28B, and 28C provide diagrammatic representations of various arrangements of parking spaces, consistent with the disclosed embodiments.

FIGS. 29A and 29B are examples of captured images, including representations of a parking environments, acquired by a camera onboard a host vehicle, consistent with the disclosed embodiments.

FIGS. 30A, 30B, 30C, and 30D provide diagrammatic representation of example navigation maneuvers that may be controlled by a host vehicle navigation system to navigate a host vehicle relative to a parking space, consistent with the disclosed embodiments.

FIG. 31 is a flowchart of a process for navigating a host vehicle relative to a parking space, consistent with the disclosed embodiments.

FIG. 32 provides a diagrammatic representation of an example navigation maneuver that may be controlled by a host vehicle navigation system to navigate a host vehicle relative to a parking space, consistent with the disclosed embodiments.

FIG. 33 provides a diagrammatic representation of an example navigation maneuver that may be controlled by a host vehicle navigation system to navigate a host vehicle relative to a parking space, consistent with the disclosed embodiments.

FIG. 34 is a flowchart of a process for navigating a host vehicle relative to a parking space, consistent with the disclosed embodiments.

FIG. 35 is an example of a captured image including a representation of an arrangement of parking spaces, consistent with the disclosed embodiments.

FIG. 36 illustrates the navigation of a host vehicle into a parking space consistent with the disclosed embodiments.

FIG. 37 is a flowchart representing an example method for navigating a host vehicle into a parking space, consistent with the disclosed embodiments.

FIG. 38 is a flowchart of a process for navigating a host vehicle relative to a parking space, consistent with the disclosed embodiments.

FIG. 39 is an example of a captured image including a representation of an arrangement of parking spaces, consistent with the disclosed embodiments.

FIG. 40 represents an example of navigating a host vehicle into a parking space consistent with the disclosed embodiments.

FIG. 41 is a flowchart of a process for navigating a host vehicle relative to a parking space, consistent with the disclosed embodiments.

FIGS. 42A and 42B provide diagrammatic representations of parking space corridors and techniques for determining and characterizing parking space corridors, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

### Autonomous Vehicle (AV) Overview

As used throughout this disclosure, the term “autonomous vehicle” refers to a vehicle capable of implementing at least one navigational change without driver input. A “navigational change” refers to a change in one or more of steering, braking, or acceleration of the vehicle. To be autonomous, a vehicle need not be fully automatic (e.g., fully operational without a driver or without driver input). Rather, an autonomous vehicle includes those that can operate under driver control during certain time periods and without driver control during other time periods. Autonomous vehicles may also include vehicles that control only some aspects of vehicle navigation, such as steering (e.g., to maintain a vehicle course between vehicle lane constraints), but may leave other aspects to the driver (e.g., braking). In some cases, autonomous vehicles may handle some or all aspects of braking, speed control, and/or steering of the vehicle.

As human drivers typically rely on visual cues and observations to control a vehicle, transportation infrastructures are built accordingly, with lane markings, traffic signs, and traffic lights, all designed to provide visual information to drivers. In view of these design characteristics of transportation infrastructures, an autonomous vehicle may include a camera and a processing unit that analyzes visual information captured from the environment of the vehicle. The visual information may include, for example, components of the transportation infrastructure (e.g., lane markings, traffic signs, traffic lights, etc.) that are observable by drivers and other obstacles (e.g., other vehicles, pedestrians, debris, etc.). Additionally, an autonomous vehicle may also use stored information, such as information that provides a model of the vehicle's environment when navigating. For example, the vehicle may use GPS data, sensor data (e.g., from an accelerometer, a speed sensor, a suspension sensor, etc.), and/or other map data to provide information related to its environment while the vehicle is traveling, and the vehicle (as well as other vehicles) may use the information to localize itself on the model.

In some embodiments in this disclosure, an autonomous vehicle may use information obtained while navigating (e.g., from a camera, GPS device, an accelerometer, a speed sensor, a suspension sensor, etc.). In other embodiments, an autonomous vehicle may use information obtained from past navigations by the vehicle (or by other vehicles) while navigating. In yet other embodiments, an autonomous vehicle may use a combination of information obtained while navigating and information obtained from past navigations. The following sections provide an overview of a system consistent with the disclosed embodiments, followed by an overview of a forward-facing imaging system and methods consistent with the system. The sections that follow disclose systems and methods for constructing, using, and updating a sparse map for autonomous vehicle navigation.

### System Overview

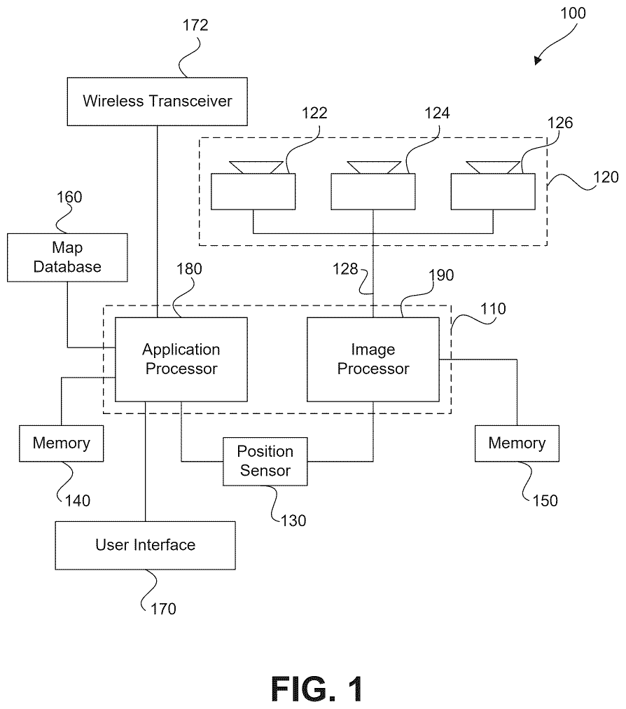

FIG. 1 is a block diagram representation of a system 100 consistent with the exemplary disclosed embodiments. System 100 may include various components depending on the requirements of a particular implementation. In some embodiments, system 100 may include a processing unit 110, an image acquisition unit 120, a position sensor 130, one or more memory units 140, 150, a map database 160, a user interface 170, and a wireless transceiver 172. Processing unit 110 may include one or more processing devices. In some embodiments, processing unit 110 may include an applications processor 180, an image processor 190, or any other suitable processing device. Similarly, image acquisition unit 120 may include any number of image acquisition devices and components depending on the requirements of a particular application. In some embodiments, image acquisition unit 120 may include one or more image capture devices (e.g., cameras), such as image capture device 122, image capture device 124, and image capture device 126. System 100 may also include a data interface 128 communicatively connecting processing unit 110 to image acquisition unit 120. For example, data interface 128 may include any wired and/or wireless link or links for transmitting image data acquired by image accusation unit 120 to processing unit 110.

Wireless transceiver 172 may include one or more devices configured to exchange transmissions over an air interface to one or more networks (e.g., cellular, the Internet, etc.) by use of a radio frequency, infrared frequency, magnetic field, or an electric field. Wireless transceiver 172 may use any known standard to transmit and/or receive data (e.g., Wi-Fi, Bluetooth®, Bluetooth Smart, 802.15.4, ZigBee, etc.). Such transmissions can include communications from the host vehicle to one or more remotely located servers. Such transmissions may also include communications (one-way or two-way) between the host vehicle and one or more target vehicles in an environment of the host vehicle (e.g., to facilitate coordination of navigation of the host vehicle in view of or together with target vehicles in the environment of the host vehicle), or even a broadcast transmission to unspecified recipients in a vicinity of the transmitting vehicle.

Both applications processor 180 and image processor 190 may include various types of processing devices. For example, either or both of applications processor 180 and image processor 190 may include a microprocessor, preprocessors (such as an image preprocessor), a graphics processing unit (GPU), a central processing unit (CPU), support circuits, digital signal processors, integrated circuits, memory, or any other types of devices suitable for running applications and for image processing and analysis. In some embodiments, applications processor 180 and/or image processor 190 may include any type of single or multi-core processor, mobile device microcontroller, central processing unit, etc. Various processing devices may be used, including, for example, processors available from manufacturers such as Intel®, AMD®, etc., or GPUs available from manufacturers such as NVIDIA®, ATI®, etc. and may include various architectures (e.g., x86 processor, ARM®, etc.).

In some embodiments, applications processor 180 and/or image processor 190 may include any of the EyeQ series of processor chips available from Mobileye®. These processor designs each include multiple processing units with local memory and instruction sets. Such processors may include video inputs for receiving image data from multiple image sensors and may also include video out capabilities. In one example, the EyeQ2® uses 90 nm-micron technology operating at 332 Mhz. The EyeQ2® architecture consists of two floating point, hyper-thread 32-bit RISC CPUs (MIPS 32® 34K® cores), five Vision Computing Engines (VCE), three Vector Microcode Processors (VMP®) , Denali 64-bit Mobile DDR Controller, 128-bit internal Sonics Interconnect, dual 16-bit Video input and 18-bit Video output controllers, 16 channels DMA and several peripherals. The MIPS34K CPU manages the five VCEs, three VMP™ and the DMA, the second MIPS34K CPU and the multi-channel DMA as well as the other peripherals. The five VCEs, three VMP® and the MIPS34K CPU can perform intensive vision computations required by multi-function bundle applications. In another example, the EyeQ3®, which is a third generation processor and is six times more powerful that the EyeQ2®, may be used in the disclosed embodiments. In other examples, the EyeQ4® and/or the EyeQ5® may be used in the disclosed embodiments. Of course, any newer or future EyeQ processing devices may also be used together with the disclosed embodiments.

Any of the processing devices disclosed herein may be configured to perform certain functions. Configuring a processing device, such as any of the described EyeQ processors or other controller or microprocessor, to perform certain functions may include programming of computer executable instructions and making those instructions available to the processing device for execution during operation of the processing device. In some embodiments, configuring a processing device may include programming the processing device directly with architectural instructions. For example, processing devices such as field-programmable gate arrays (FPGAs), application-specific integrated circuits (ASICs), and the like may be configured using, for example, one or more hardware description languages (HDLs).

In other embodiments, configuring a processing device may include storing executable instructions on a memory that is accessible to the processing device during operation. For example, the processing device may access the memory to obtain and execute the stored instructions during operation. In either case, the processing device configured to perform the sensing, image analysis, and/or navigational functions disclosed herein represents a specialized hardware-based system in control of multiple hardware based components of a host vehicle.

While FIG. 1 depicts two separate processing devices included in processing unit 110, more or fewer processing devices may be used. For example, in some embodiments, a single processing device may be used to accomplish the tasks of applications processor 180 and image processor 190. In other embodiments, these tasks may be performed by more than two processing devices. Further, in some embodiments, system 100 may include one or more of processing unit 110 without including other components, such as image acquisition unit 120.

Processing unit 110 may comprise various types of devices. For example, processing unit 110 may include various devices, such as a controller, an image preprocessor, a central processing unit (CPU), a graphics processing unit (GPU), support circuits, digital signal processors, integrated circuits, memory, or any other types of devices for image processing and analysis. The image preprocessor may include a video processor for capturing, digitizing and processing the imagery from the image sensors. The CPU may comprise any number of microcontrollers or microprocessors. The GPU may also comprise any number of microcontrollers or microprocessors. The support circuits may be any number of circuits generally well known in the art, including cache, power supply, clock and input-output circuits. The memory may store software that, when executed by the processor, controls the operation of the system. The memory may include databases and image processing software. The memory may comprise any number of random access memories, read only memories, flash memories, disk drives, optical storage, tape storage, removable storage and other types of storage. In one instance, the memory may be separate from the processing unit 110. In another instance, the memory may be integrated into the processing unit 110.

Each memory 140, 150 may include software instructions that when executed by a processor (e.g., applications processor 180 and/or image processor 190), may control operation of various aspects of system 100. These memory units may include various databases and image processing software, as well as a trained system, such as a neural network, or a deep neural network, for example. The memory units may include random access memory (RAM), read only memory (ROM), flash memory, disk drives, optical storage, tape storage, removable storage and/or any other types of storage. In some embodiments, memory units 140, 150 may be separate from the applications processor 180 and/or image processor 190. In other embodiments, these memory units may be integrated into applications processor 180 and/or image processor 190.

Position sensor 130 may include any type of device suitable for determining a location associated with at least one component of system 100. In some embodiments, position sensor 130 may include a GPS receiver. Such receivers can determine a user position and velocity by processing signals broadcasted by global positioning system satellites. Position information from position sensor 130 may be made available to applications processor 180 and/or image processor 190.

In some embodiments, system 100 may include components such as a speed sensor (e.g., a tachometer, a speedometer) for measuring a speed of vehicle 200 and/or an accelerometer (either single axis or multi-axis) for measuring acceleration of vehicle 200.

User interface 170 may include any device suitable for providing information to or for receiving inputs from one or more users of system 100. In some embodiments, user interface 170 may include user input devices, including, for example, a touchscreen, microphone, keyboard, pointer devices, track wheels, cameras, knobs, buttons, etc. With such input devices, a user may be able to provide information inputs or commands to system 100 by typing instructions or information, providing voice commands, selecting menu options on a screen using buttons, pointers, or eye-tracking capabilities, or through any other suitable techniques for communicating information to system 100.

User interface 170 may be equipped with one or more processing devices configured to provide and receive information to or from a user and process that information for use by, for example, applications processor 180. In some embodiments, such processing devices may execute instructions for recognizing and tracking eye movements, receiving and interpreting voice commands, recognizing and interpreting touches and/or gestures made on a touchscreen, responding to keyboard entries or menu selections, etc. In some embodiments, user interface 170 may include a display, speaker, tactile device, and/or any other devices for providing output information to a user.

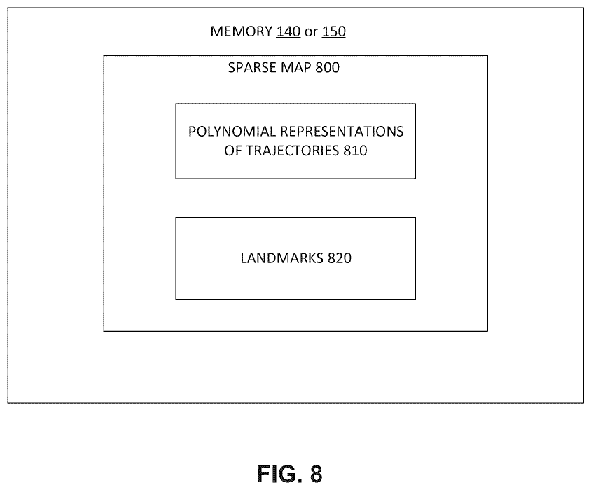

Map database 160 may include any type of database for storing map data useful to system 100. In some embodiments, map database 160 may include data relating to the position, in a reference coordinate system, of various items, including roads, water features, geographic features, businesses, points of interest, restaurants, gas stations, etc. Map database 160 may store not only the locations of such items, but also descriptors relating to those items, including, for example, names associated with any of the stored features. In some embodiments, map database 160 may be physically located with other components of system 100. Alternatively or additionally, map database 160 or a portion thereof may be located remotely with respect to other components of system 100 (e.g., processing unit 110). In such embodiments, information from map database 160 may be downloaded over a wired or wireless data connection to a network (e.g., over a cellular network and/or the Internet, etc.). In some cases, map database 160 may store a sparse data model including polynomial representations of certain road features (e.g., lane markings) or target trajectories for the host vehicle. Systems and methods of generating such a map are discussed below with references to FIGS. 8-19.

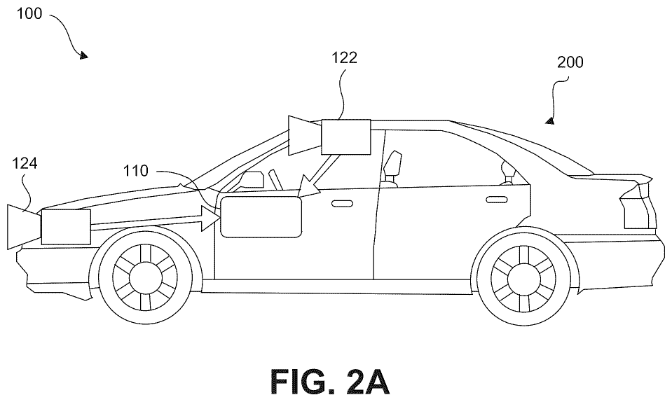

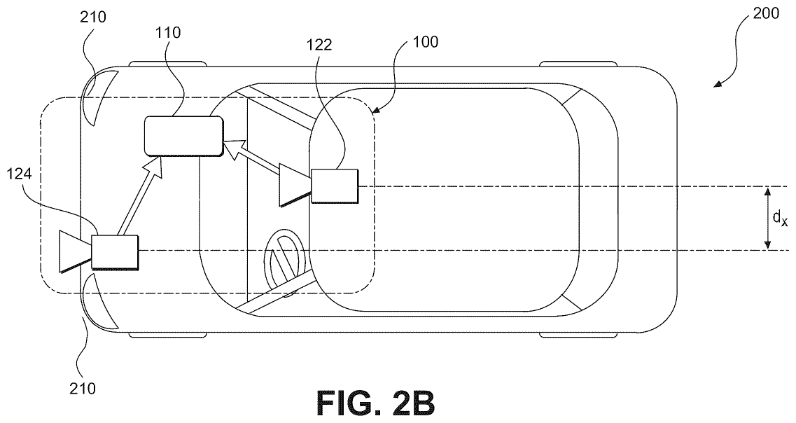

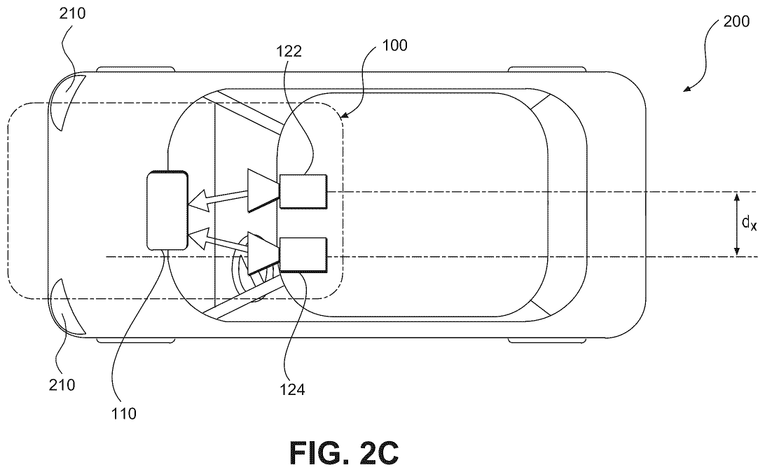

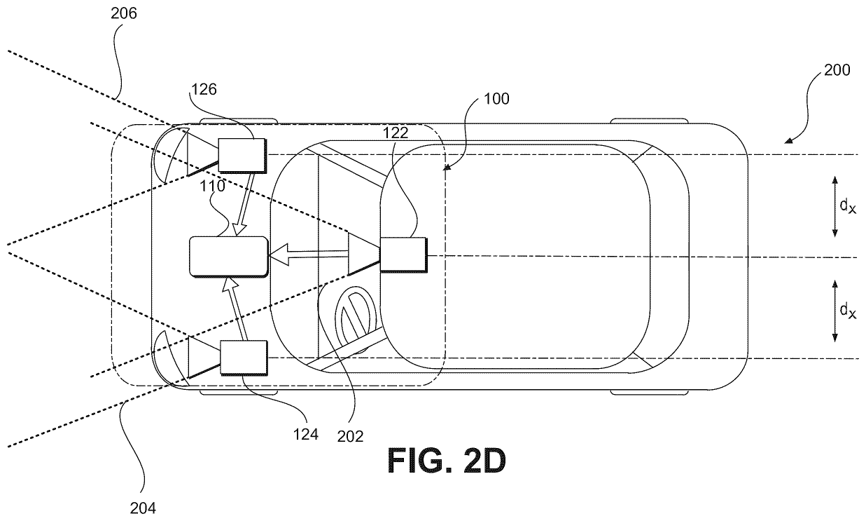

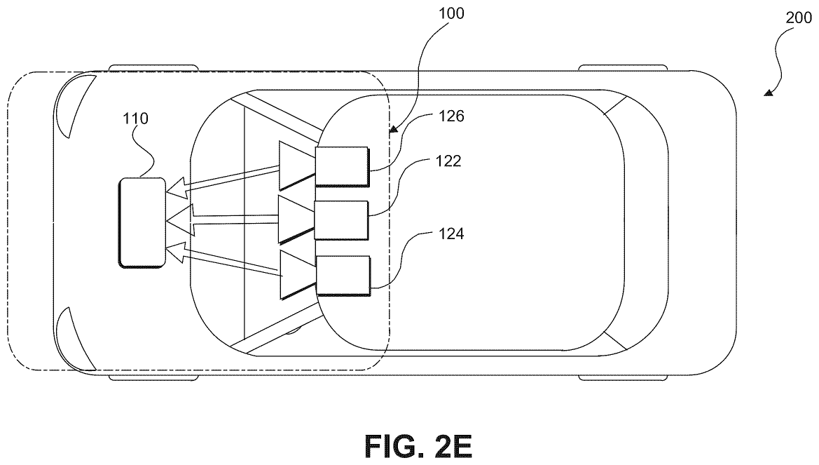

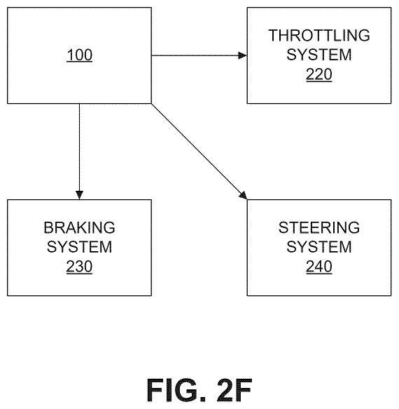

Image capture devices 122, 124, and 126 may each include any type of device suitable for capturing at least one image from an environment. Moreover, any number of image capture devices may be used to acquire images for input to the image processor. Some embodiments may include only a single image capture device, while other embodiments may include two, three, or even four or more image capture devices. Image capture devices 122, 124, and 126 will be further described with reference to FIGS. 2B-2E, below.

System 100, or various components thereof, may be incorporated into various different platforms. In some embodiments, system 100 may be included on a vehicle 200, as shown in FIG. 2A. For example, vehicle 200 may be equipped with a processing unit 110 and any of the other components of system 100, as described above relative to FIG. 1. While in some embodiments vehicle 200 may be equipped with only a single image capture device (e.g., camera), in other embodiments, such as those discussed in connection with FIGS. 2B-2E, multiple image capture devices may be used. For example, either of image capture devices 122 and 124 of vehicle 200, as shown in FIG. 2A, may be part of an ADAS (Advanced Driver Assistance Systems) imaging set.

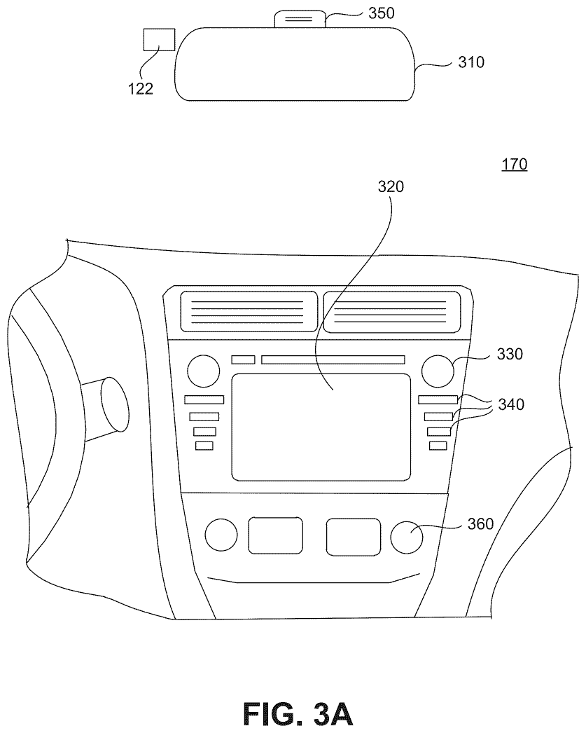

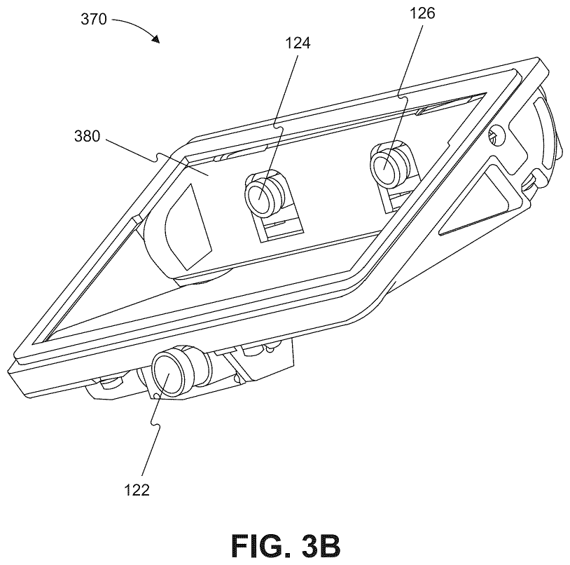

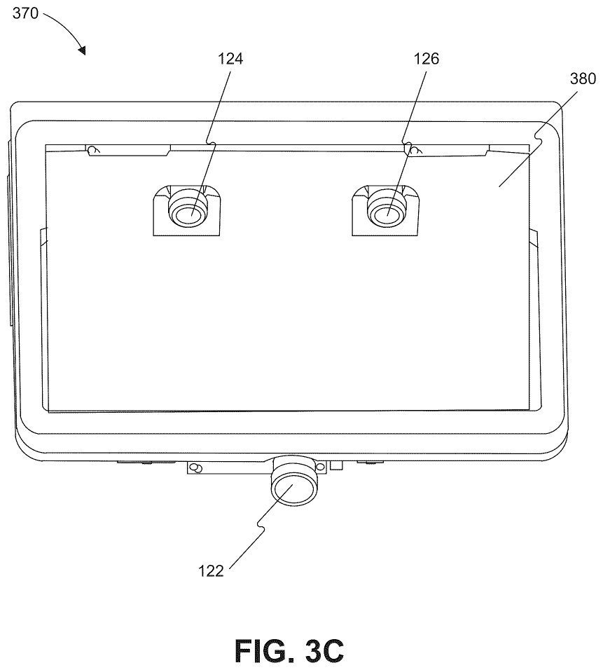

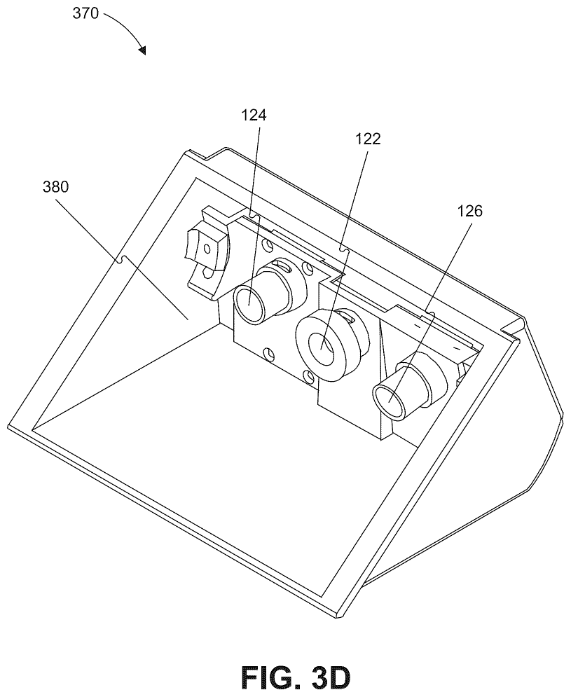

The image capture devices included on vehicle 200 as part of the image acquisition unit 120 may be positioned at any suitable location. In some embodiments, as shown in FIGS. 2A-2E and 3A-3C, image capture device 122 may be located in the vicinity of the rearview mirror. This position may provide a line of sight similar to that of the driver of vehicle 200, which may aid in determining what is and is not visible to the driver. Image capture device 122 may be positioned at any location near the rearview mirror, but placing image capture device 122 on the driver side of the mirror may further aid in obtaining images representative of the driver's field of view and/or line of sight.

Other locations for the image capture devices of image acquisition unit 120 may also be used. For example, image capture device 124 may be located on or in a bumper of vehicle 200. Such a location may be especially suitable for image capture devices having a wide field of view. The line of sight of bumper-located image capture devices can be different from that of the driver and, therefore, the bumper image capture device and driver may not always see the same objects. The image capture devices (e.g., image capture devices 122, 124, and 126) may also be located in other locations. For example, the image capture devices may be located on or in one or both of the side mirrors of vehicle 200, on the roof of vehicle 200, on the hood of vehicle 200, on the trunk of vehicle 200, on the sides of vehicle 200, mounted on, positioned behind, or positioned in front of any of the windows of vehicle 200, and mounted in or near light figures on the front and/or back of vehicle 200, etc.

In addition to image capture devices, vehicle 200 may include various other components of system 100. For example, processing unit 110 may be included on vehicle 200 either integrated with or separate from an engine control unit (ECU) of the vehicle. Vehicle 200 may also be equipped with a position sensor 130, such as a GPS receiver and may also include a map database 160 and memory units 140 and 150.

As discussed earlier, wireless transceiver 172 may and/or receive data over one or more networks (e.g., cellular networks, the Internet, etc.). For example, wireless transceiver 172 may upload data collected by system 100 to one or more servers, and download data from the one or more servers. Via wireless transceiver 172, system 100 may receive, for example, periodic or on demand updates to data stored in map database 160, memory 140, and/or memory 150. Similarly, wireless transceiver 172 may upload any data (e.g., images captured by image acquisition unit 120, data received by position sensor 130 or other sensors, vehicle control systems, etc.) from by system 100 and/or any data processed by processing unit 110 to the one or more servers.

System 100 may upload data to a server (e.g., to the cloud) based on a privacy level setting. For example, system 100 may implement privacy level settings to regulate or limit the types of data (including metadata) sent to the server that may uniquely identify a vehicle and or driver/owner of a vehicle. Such settings may be set by user via, for example, wireless transceiver 172, be initialized by factory default settings, or by data received by wireless transceiver 172.

In some embodiments, system 100 may upload data according to a “high” privacy level, and under setting a setting, system 100 may transmit data (e.g., location information related to a route, captured images, etc.) without any details about the specific vehicle and/or driver/owner. For example, when uploading data according to a “high” privacy setting, system 100 may not include a vehicle identification number (VIN) or a name of a driver or owner of the vehicle, and may instead of transmit data, such as captured images and/or limited location information related to a route.

Other privacy levels are contemplated. For example, system 100 may transmit data to a server according to an “intermediate” privacy level and include additional information not included under a “high” privacy level, such as a make and/or model of a vehicle and/or a vehicle type (e.g., a passenger vehicle, sport utility vehicle, truck, etc.). In some embodiments, system 100 may upload data according to a “low” privacy level. Under a “low” privacy level setting, system 100 may upload data and include information sufficient to uniquely identify a specific vehicle, owner/driver, and/or a portion or entirely of a route traveled by the vehicle. Such “low” privacy level data may include one or more of, for example, a VIN, a driver/owner name, an origination point of a vehicle prior to departure, an intended destination of the vehicle, a make and/or model of the vehicle, a type of the vehicle, etc.

FIG. 2A is a diagrammatic side view representation of an exemplary vehicle imaging system consistent with the disclosed embodiments. FIG. 2B is a diagrammatic top view illustration of the embodiment shown in FIG. 2A. As illustrated in FIG. 2B, the disclosed embodiments may include a vehicle 200 including in its body a system 100 with a first image capture device 122 positioned in the vicinity of the rearview mirror and/or near the driver of vehicle 200, a second image capture device 124 positioned on or in a bumper region (e.g., one of bumper regions 210) of vehicle 200, and a processing unit 110.

As illustrated in FIG. 2C, image capture devices 122 and 124 may both be positioned in the vicinity of the rearview mirror and/or near the driver of vehicle 200. Additionally, while two image capture devices 122 and 124 are shown in FIGS. 2B and 2C, it should be understood that other embodiments may include more than two image capture devices. For example, in the embodiments shown in FIGS. 2D and 2E, first, second, and third image capture devices 122, 124, and 126, are included in the system 100 of vehicle 200.

As illustrated in FIG. 2D, image capture device 122 may be positioned in the vicinity of the rearview mirror and/or near the driver of vehicle 200, and image capture devices 124 and 126 may be positioned on or in a bumper region (e.g., one of bumper regions 210) of vehicle 200. And as shown in FIG. 2E, image capture devices 122, 124, and 126 may be positioned in the vicinity of the rearview mirror and/or near the driver seat of vehicle 200. The disclosed embodiments are not limited to any particular number and configuration of the image capture devices, and the image capture devices may be positioned in any appropriate location within and/or on vehicle 200.

It is to be understood that the disclosed embodiments are not limited to vehicles and could be applied in other contexts. It is also to be understood that disclosed embodiments are not limited to a particular type of vehicle 200 and may be applicable to all types of vehicles including automobiles, trucks, trailers, and other types of vehicles.

The first image capture device 122 may include any suitable type of image capture device. Image capture device 122 may include an optical axis. In one instance, the image capture device 122 may include an Aptina M9V024 WVGA sensor with a global shutter. In other embodiments, image capture device 122 may provide a resolution of 1280×960 pixels and may include a rolling shutter. Image capture device 122 may include various optical elements. In some embodiments one or more lenses may be included, for example, to provide a desired focal length and field of view for the image capture device. In some embodiments, image capture device 122 may be associated with a 6 mm lens or a 12 mm lens. In some embodiments, image capture device 122 may be configured to capture images having a desired field-of-view (FOV) 202, as illustrated in FIG. 2D. For example, image capture device 122 may be configured to have a regular FOV, such as within a range of 40 degrees to 56 degrees, including a 46 degree FOV, 50 degree FOV, 52 degree FOV, or greater. Alternatively, image capture device 122 may be configured to have a narrow FOV in the range of 23 to 40 degrees, such as a 28 degree FOV or 36 degree FOV. In addition, image capture device 122 may be configured to have a wide FOV in the range of 100 to 180 degrees. In some embodiments, image capture device 122 may include a wide angle bumper camera or one with up to a 180 degree FOV. In some embodiments, image capture device 122 may be a 7.2M pixel image capture device with an aspect ratio of about 2:1 (e.g., H×V=3800×1900 pixels) with about 100 degree horizontal FOV. Such an image capture device may be used in place of a three image capture device configuration. Due to significant lens distortion, the vertical FOV of such an image capture device may be significantly less than 50 degrees in implementations in which the image capture device uses a radially symmetric lens. For example, such a lens may not be radially symmetric which would allow for a vertical FOV greater than 50 degrees with 100 degree horizontal FOV.

The first image capture device 122 may acquire a plurality of first images relative to a scene associated with the vehicle 200. Each of the plurality of first images may be acquired as a series of image scan lines, which may be captured using a rolling shutter. Each scan line may include a plurality of pixels.

The first image capture device 122 may have a scan rate associated with acquisition of each of the first series of image scan lines. The scan rate may refer to a rate at which an image sensor can acquire image data associated with each pixel included in a particular scan line.

Image capture devices 122, 124, and 126 may contain any suitable type and number of image sensors, including CCD sensors or CMOS sensors, for example. In one embodiment, a CMOS image sensor may be employed along with a rolling shutter, such that each pixel in a row is read one at a time, and scanning of the rows proceeds on a row-by-row basis until an entire image frame has been captured. In some embodiments, the rows may be captured sequentially from top to bottom relative to the frame.

In some embodiments, one or more of the image capture devices (e.g., image capture devices 122, 124, and 126) disclosed herein may constitute a high resolution imager and may have a resolution greater than 5M pixel, 7M pixel, 10M pixel, or greater.

The use of a rolling shutter may result in pixels in different rows being exposed and captured at different times, which may cause skew and other image artifacts in the captured image frame. On the other hand, when the image capture device 122 is configured to operate with a global or synchronous shutter, all of the pixels may be exposed for the same amount of time and during a common exposure period. As a result, the image data in a frame collected from a system employing a global shutter represents a snapshot of the entire FOV (such as FOV 202) at a particular time. In contrast, in a rolling shutter application, each row in a frame is exposed and data is capture at different times. Thus, moving objects may appear distorted in an image capture device having a rolling shutter. This phenomenon will be described in greater detail below.

The second image capture device 124 and the third image capturing device 126 may be any type of image capture device. Like the first image capture device 122, each of image capture devices 124 and 126 may include an optical axis. In one embodiment, each of image capture devices 124 and 126 may include an Aptina M9V024 WVGA sensor with a global shutter. Alternatively, each of image capture devices 124 and 126 may include a rolling shutter. Like image capture device 122, image capture devices 124 and 126 may be configured to include various lenses and optical elements. In some embodiments, lenses associated with image capture devices 124 and 126 may provide FOVs (such as FOVs 204 and 206) that are the same as, or narrower than, a FOV (such as FOV 202) associated with image capture device 122. For example, image capture devices 124 and 126 may have FOVs of 40 degrees, 30 degrees, 26 degrees, 23 degrees, 20 degrees, or less.

Image capture devices 124 and 126 may acquire a plurality of second and third images relative to a scene associated with the vehicle 200. Each of the plurality of second and third images may be acquired as a second and third series of image scan lines, which may be captured using a rolling shutter. Each scan line or row may have a plurality of pixels. Image capture devices 124 and 126 may have second and third scan rates associated with acquisition of each of image scan lines included in the second and third series.

Each image capture device 122, 124, and 126 may be positioned at any suitable position and orientation relative to vehicle 200. The relative positioning of the image capture devices 122, 124, and 126 may be selected to aid in fusing together the information acquired from the image capture devices. For example, in some embodiments, a FOV (such as FOV 204) associated with image capture device 124 may overlap partially or fully with a FOV (such as FOV 202) associated with image capture device 122 and a FOV (such as FOV 206) associated with image capture device 126.

Image capture devices 122, 124, and 126 may be located on vehicle 200 at any suitable relative heights. In one instance, there may be a height difference between the image capture devices 122, 124, and 126, which may provide sufficient parallax information to enable stereo analysis. For example, as shown in FIG. 2A, the two image capture devices 122 and 124 are at different heights. There may also be a lateral displacement difference between image capture devices 122, 124, and 126, giving additional parallax information for stereo analysis by processing unit 110, for example. The difference in the lateral displacement may be denoted by dₓ, as shown in FIGS. 2C and 2D. In some embodiments, fore or aft displacement (e.g., range displacement) may exist between image capture devices 122, 124, and 126. For example, image capture device 122 may be located 0.5 to 2 meters or more behind image capture device 124 and/or image capture device 126. This type of displacement may enable one of the image capture devices to cover potential blind spots of the other image capture device(s).

Image capture devices 122 may have any suitable resolution capability (e.g., number of pixels associated with the image sensor), and the resolution of the image sensor(s) associated with the image capture device 122 may be higher, lower, or the same as the resolution of the image sensor(s) associated with image capture devices 124 and 126. In some embodiments, the image sensor(s) associated with image capture device 122 and/or image capture devices 124 and 126 may have a resolution of 640×480, 1024×768, 1280×960, or any other suitable resolution.

The frame rate (e.g., the rate at which an image capture device acquires a set of pixel data of one image frame before moving on to capture pixel data associated with the next image frame) may be controllable. The frame rate associated with image capture device 122 may be higher, lower, or the same as the frame rate associated with image capture devices 124 and 126. The frame rate associated with image capture devices 122, 124, and 126 may depend on a variety of factors that may affect the timing of the frame rate. For example, one or more of image capture devices 122, 124, and 126 may include a selectable pixel delay period imposed before or after acquisition of image data associated with one or more pixels of an image sensor in image capture device 122, 124, and/or 126. Generally, image data corresponding to each pixel may be acquired according to a clock rate for the device (e.g., one pixel per clock cycle). Additionally, in embodiments including a rolling shutter, one or more of image capture devices 122, 124, and 126 may include a selectable horizontal blanking period imposed before or after acquisition of image data associated with a row of pixels of an image sensor in image capture device 122, 124, and/or 126. Further, one or more of image capture devices 122, 124, and/or 126 may include a selectable vertical blanking period imposed before or after acquisition of image data associated with an image frame of image capture device 122, 124, and 126.

These timing controls may enable synchronization of frame rates associated with image capture devices 122, 124, and 126, even where the line scan rates of each are different. Additionally, as will be discussed in greater detail below, these selectable timing controls, among other factors (e.g., image sensor resolution, maximum line scan rates, etc.) may enable synchronization of image capture from an area where the FOV of image capture device 122 overlaps with one or more FOVs of image capture devices 124 and 126, even where the field of view of image capture device 122 is different from the FOVs of image capture devices 124 and 126.

Frame rate timing in image capture device 122, 124, and 126 may depend on the resolution of the associated image sensors. For example, assuming similar line scan rates for both devices, if one device includes an image sensor having a resolution of 640×480 and another device includes an image sensor with a resolution of 1280×960, then more time will be required to acquire a frame of image data from the sensor having the higher resolution.

Another factor that may affect the timing of image data acquisition in image capture devices 122, 124, and 126 is the maximum line scan rate. For example, acquisition of a row of image data from an image sensor included in image capture device 122, 124, and 126 will require some minimum amount of time. Assuming no pixel delay periods are added, this minimum amount of time for acquisition of a row of image data will be related to the maximum line scan rate for a particular device. Devices that offer higher maximum line scan rates have the potential to provide higher frame rates than devices with lower maximum line scan rates. In some embodiments, one or more of image capture devices 124 and 126 may have a maximum line scan rate that is higher than a maximum line scan rate associated with image capture device 122. In some embodiments, the maximum line scan rate of image capture device 124 and/or 126 may be 1.25, 1.5, 1.75, or 2 times or more than a maximum line scan rate of image capture device 122.

In another embodiment, image capture devices 122, 124, and 126 may have the same maximum line scan rate, but image capture device 122 may be operated at a scan rate less than or equal to its maximum scan rate. The system may be configured such that one or more of image capture devices 124 and 126 operate at a line scan rate that is equal to the line scan rate of image capture device 122. In other instances, the system may be configured such that the line scan rate of image capture device 124 and/or image capture device 126 may be 1.25, 1.5, 1.75, or 2 times or more than the line scan rate of image capture device 122.

In some embodiments, image capture devices 122, 124, and 126 may be asymmetric. That is, they may include cameras having different fields of view (FOV) and focal lengths. The fields of view of image capture devices 122, 124, and 126 may include any desired area relative to an environment of vehicle 200, for example. In some embodiments, one or more of image capture devices 122, 124, and 126 may be configured to acquire image data from an environment in front of vehicle 200, behind vehicle 200, to the sides of vehicle 200, or combinations thereof.

Further, the focal length associated with each image capture device 122, 124, and/or 126 may be selectable (e.g., by inclusion of appropriate lenses etc.) such that each device acquires images of objects at a desired distance range relative to vehicle 200. For example, in some embodiments image capture devices 122, 124, and 126 may acquire images of close-up objects within a few meters from the vehicle. Image capture devices 122, 124, and 126 may also be configured to acquire images of objects at ranges more distant from the vehicle (e.g., 25 m, 50 m, 100 m, 150 m, or more). Further, the focal lengths of image capture devices 122, 124, and 126 may be selected such that one image capture device (e.g., image capture device 122) can acquire images of objects relatively close to the vehicle (e.g., within 10 m or within 20 m) while the other image capture devices (e.g., image capture devices 124 and 126) can acquire images of more distant objects (e.g., greater than 20 m, 50 m, 100 m, 150 m, etc.) from vehicle 200.

According to some embodiments, the FOV of one or more image capture devices 122, 124, and 126 may have a wide angle. For example, it may be advantageous to have a FOV of 140 degrees, especially for image capture devices 122, 124, and 126 that may be used to capture images of the area in the vicinity of vehicle 200. For example, image capture device 122 may be used to capture images of the area to the right or left of vehicle 200 and, in such embodiments, it may be desirable for image capture device 122 to have a wide FOV (e.g., at least 140 degrees).

The field of view associated with each of image capture devices 122, 124, and 126 may depend on the respective focal lengths. For example, as the focal length increases, the corresponding field of view decreases.

Image capture devices 122, 124, and 126 may be configured to have any suitable fields of view. In one particular example, image capture device 122 may have a horizontal FOV of 46 degrees, image capture device 124 may have a horizontal FOV of 23 degrees, and image capture device 126 may have a horizontal FOV in between 23 and 46 degrees. In another instance, image capture device 122 may have a horizontal FOV of 52 degrees, image capture device 124 may have a horizontal FOV of 26 degrees, and image capture device 126 may have a horizontal FOV in between 26 and 52 degrees. In some embodiments, a ratio of the FOV of image capture device 122 to the FOVs of image capture device 124 and/or image capture device 126 may vary from 1.5 to 2.0. In other embodiments, this ratio may vary between 1.25 and 2.25.

System 100 may be configured so that a field of view of image capture device 122 overlaps, at least partially or fully, with a field of view of image capture device 124 and/or image capture device 126. In some embodiments, system 100 may be configured such that the fields of view of image capture devices 124 and 126, for example, fall within (e.g., are narrower than) and share a common center with the field of view of image capture device 122. In other embodiments, the image capture devices 122, 124, and 126 may capture adjacent FOVs or may have partial overlap in their FOVs. In some embodiments, the fields of view of image capture devices 122, 124, and 126 may be aligned such that a center of the narrower FOV image capture devices 124 and/or 126 may be located in a lower half of the field of view of the wider FOV image capture device 122.

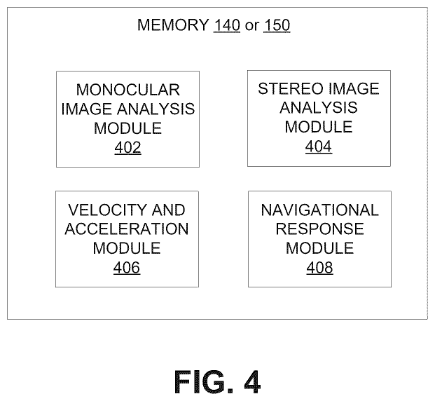

FIG. 2F is a diagrammatic representation of exemplary vehicle control systems, consistent with the disclosed embodiments. As indicated in FIG. 2F, vehicle 200 may include throttling system 220, braking system 230, and steering system 240. System 100 may provide inputs (e.g., control signals) to one or more of throttling system 220, braking system 230, and steering system 240 over one or more data links (e.g., any wired and/or wireless link or links for transmitting data). For example, based on analysis of images acquired by image capture devices 122, 124, and/or 126, system 100 may provide control signals to one or more of throttling system 220, braking system 230, and steering system 240 to navigate vehicle 200 (e.g., by causing an acceleration, a turn, a lane shift, etc.). Further, system 100 may receive inputs from one or more of throttling system 220, braking system 230, and steering system 24 indicating operating conditions of vehicle 200 (e.g., speed, whether vehicle 200 is braking and/or turning, etc.). Further details are provided in connection with FIGS. 4-7, below.

As shown in FIG. 3A, vehicle 200 may also include a user interface 170 for interacting with a driver or a passenger of vehicle 200. For example, user interface 170 in a vehicle application may include a touch screen 320, knobs 330, buttons 340, and a microphone 350. A driver or passenger of vehicle 200 may also use handles (e.g., located on or near the steering column of vehicle 200 including, for example, turn signal handles), buttons (e.g., located on the steering wheel of vehicle 200), and the like, to interact with system 100. In some embodiments, microphone 350 may be positioned adjacent to a rearview mirror 310. Similarly, in some embodiments, image capture device 122 may be located near rearview mirror 310. In some embodiments, user interface 170 may also include one or more speakers 360 (e.g., speakers of a vehicle audio system). For example, system 100 may provide various notifications (e.g., alerts) via speakers 360.

FIGS. 3B-3D are illustrations of an exemplary camera mount 370 configured to be positioned behind a rearview mirror (e.g., rearview mirror 310) and against a vehicle windshield, consistent with disclosed embodiments. As shown in FIG. 3B, camera mount 370 may include image capture devices 122, 124, and 126. Image capture devices 124 and 126 may be positioned behind a glare shield 380, which may be flush against the vehicle windshield and include a composition of film and/or anti-reflective materials. For example, glare shield 380 may be positioned such that the shield aligns against a vehicle windshield having a matching slope. In some embodiments, each of image capture devices 122, 124, and 126 may be positioned behind glare shield 380, as depicted, for example, in FIG. 3D. The disclosed embodiments are not limited to any particular configuration of image capture devices 122, 124, and 126, camera mount 370, and glare shield 380. FIG. 3C is an illustration of camera mount 370 shown in FIG. 3B from a front perspective.

As will be appreciated by a person skilled in the art having the benefit of this disclosure, numerous variations and/or modifications may be made to the foregoing disclosed embodiments. For example, not all components are essential for the operation of system 100. Further, any component may be located in any appropriate part of system 100 and the components may be rearranged into a variety of configurations while providing the functionality of the disclosed embodiments. Therefore, the foregoing configurations are examples and, regardless of the configurations discussed above, system 100 can provide a wide range of functionality to analyze the surroundings of vehicle 200 and navigate vehicle 200 in response to the analysis.

As discussed below in further detail and consistent with various disclosed embodiments, system 100 may provide a variety of features related to autonomous driving and/or driver assist technology. For example, system 100 may analyze image data, position data (e.g., GPS location information), map data, speed data, and/or data from sensors included in vehicle 200. System 100 may collect the data for analysis from, for example, image acquisition unit 120, position sensor 130, and other sensors. Further, system 100 may analyze the collected data to determine whether or not vehicle 200 should take a certain action, and then automatically take the determined action without human intervention. For example, when vehicle 200 navigates without human intervention, system 100 may automatically control the braking, acceleration, and/or steering of vehicle 200 (e.g., by sending control signals to one or more of throttling system 220, braking system 230, and steering system 240). Further, system 100 may analyze the collected data and issue warnings and/or alerts to vehicle occupants based on the analysis of the collected data. Additional details regarding the various embodiments that are provided by system 100 are provided below.

### Forward-Facing Multi-Imaging System

As discussed above, system 100 may provide drive assist functionality that uses a multi-camera system. The multi-camera system may use one or more cameras facing in the forward direction of a vehicle. In other embodiments, the multi-camera system may include one or more cameras facing to the side of a vehicle or to the rear of the vehicle. In one embodiment, for example, system 100 may use a two-camera imaging system, where a first camera and a second camera (e.g., image capture devices 122 and 124) may be positioned at the front and/or the sides of a vehicle (e.g., vehicle 200). The first camera may have a field of view that is greater than, less than, or partially overlapping with, the field of view of the second camera. In addition, the first camera may be connected to a first image processor to perform monocular image analysis of images provided by the first camera, and the second camera may be connected to a second image processor to perform monocular image analysis of images provided by the second camera. The outputs (e.g., processed information) of the first and second image processors may be combined. In some embodiments, the second image processor may receive images from both the first camera and second camera to perform stereo analysis. In another embodiment, system 100 may use a three-camera imaging system where each of the cameras has a different field of view. Such a system may, therefore, make decisions based on information derived from objects located at varying distances both forward and to the sides of the vehicle. References to monocular image analysis may refer to instances where image analysis is performed based on images captured from a single point of view (e.g., from a single camera). Stereo image analysis may refer to instances where image analysis is performed based on two or more images captured with one or more variations of an image capture parameter. For example, captured images suitable for performing stereo image analysis may include images captured: from two or more different positions, from different fields of view, using different focal lengths, along with parallax information, etc.

For example, in one embodiment, system 100 may implement a three camera configuration using image capture devices 122, 124, and 126. In such a configuration, image capture device 122 may provide a narrow field of view (e.g., 34 degrees, or other values selected from a range of about 20 to 45 degrees, etc.), image capture device 124 may provide a wide field of view (e.g., 150 degrees or other values selected from a range of about 100 to about 180 degrees), and image capture device 126 may provide an intermediate field of view (e.g., 46 degrees or other values selected from a range of about 35 to about 60 degrees). In some embodiments, image capture device 126 may act as a main or primary camera. Image capture devices 122, 124, and 126 may be positioned behind rearview mirror 310 and positioned substantially side-by-side (e.g., 6 cm apart). Further, in some embodiments, as discussed above, one or more of image capture devices 122, 124, and 126 may be mounted behind glare shield 380 that is flush with the windshield of vehicle 200. Such shielding may act to minimize the impact of any reflections from inside the car on image capture devices 122, 124, and 126.

In another embodiment, as discussed above in connection with FIGS. 3B and 3C, the wide field of view camera (e.g., image capture device 124 in the above example) may be mounted lower than the narrow and main field of view cameras (e.g., image capture devices 122 and 126 in the above example). This configuration may provide a free line of sight from the wide field of view camera. To reduce reflections, the cameras may be mounted close to the windshield of vehicle 200, and may include polarizers on the cameras to damp reflected light.

A three camera system may provide certain performance characteristics. For example, some embodiments may include an ability to validate the detection of objects by one camera based on detection results from another camera. In the three camera configuration discussed above, processing unit 110 may include, for example, three processing devices (e.g., three EyeQ series of processor chips, as discussed above), with each processing device dedicated to processing images captured by one or more of image capture devices 122, 124, and 126.

In a three camera system, a first processing device may receive images from both the main camera and the narrow field of view camera, and perform vision processing of the narrow FOV camera to, for example, detect other vehicles, pedestrians, lane marks, traffic signs, traffic lights, and other road objects. Further, the first processing device may calculate a disparity of pixels between the images from the main camera and the narrow camera and create a 3D reconstruction of the environment of vehicle 200. The first processing device may then combine the 3D reconstruction with 3D map data or with 3D information calculated based on information from another camera.

The second processing device may receive images from main camera and perform vision processing to detect other vehicles, pedestrians, lane marks, traffic signs, traffic lights, and other road objects. Additionally, the second processing device may calculate a camera displacement and, based on the displacement, calculate a disparity of pixels between successive images and create a 3D reconstruction of the scene (e.g., a structure from motion). The second processing device may send the structure from motion based 3D reconstruction to the first processing device to be combined with the stereo 3D images.

The third processing device may receive images from the wide FOV camera and process the images to detect vehicles, pedestrians, lane marks, traffic signs, traffic lights, and other road objects. The third processing device may further execute additional processing instructions to analyze images to identify objects moving in the image, such as vehicles changing lanes, pedestrians, etc.

In some embodiments, having streams of image-based information captured and processed independently may provide an opportunity for providing redundancy in the system. Such redundancy may include, for example, using a first image capture device and the images processed from that device to validate and/or supplement information obtained by capturing and processing image information from at least a second image capture device.

In some embodiments, system 100 may use two image capture devices (e.g., image capture devices 122 and 124) in providing navigation assistance for vehicle 200 and use a third image capture device (e.g., image capture device 126) to provide redundancy and validate the analysis of data received from the other two image capture devices. For example, in such a configuration, image capture devices 122 and 124 may provide images for stereo analysis by system 100 for navigating vehicle 200, while image capture device 126 may provide images for monocular analysis by system 100 to provide redundancy and validation of information obtained based on images captured from image capture device 122 and/or image capture device 124. That is, image capture device 126 (and a corresponding processing device) may be considered to provide a redundant sub-system for providing a check on the analysis derived from image capture devices 122 and 124 (e.g., to provide an automatic emergency braking (AEB) system). Furthermore, in some embodiments, redundancy and validation of received data may be supplemented based on information received from one more sensors (e.g., radar, lidar, acoustic sensors, information received from one or more transceivers outside of a vehicle, etc.).

One of skill in the art will recognize that the above camera configurations, camera placements, number of cameras, camera locations, etc., are examples only. These components and others described relative to the overall system may be assembled and used in a variety of different configurations without departing from the scope of the disclosed embodiments. Further details regarding usage of a multi-camera system to provide driver assist and/or autonomous vehicle functionality follow below.

FIG. 4 is an exemplary functional block diagram of memory 140 and/or 150, which may be stored/programmed with instructions for performing one or more operations consistent with the disclosed embodiments. Although the following refers to memory 140, one of skill in the art will recognize that instructions may be stored in memory 140 and/or 150.

As shown in FIG. 4, memory 140 may store a monocular image analysis module 402, a stereo image analysis module 404, a velocity and acceleration module 406, and a navigational response module 408. The disclosed embodiments are not limited to any particular configuration of memory 140. Further, application processor 180 and/or image processor 190 may execute the instructions stored in any of modules 402, 404, 406, and 408 included in memory 140. One of skill in the art will understand that references in the following discussions to processing unit 110 may refer to application processor 180 and image processor 190 individually or collectively. Accordingly, steps of any of the following processes may be performed by one or more processing devices.

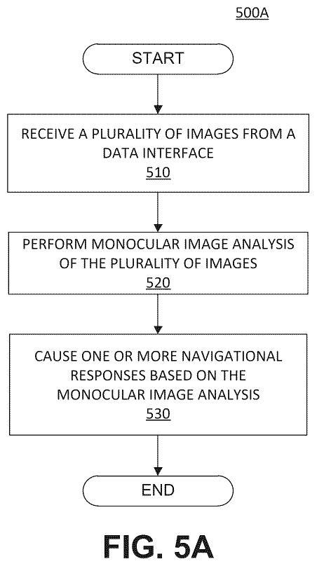

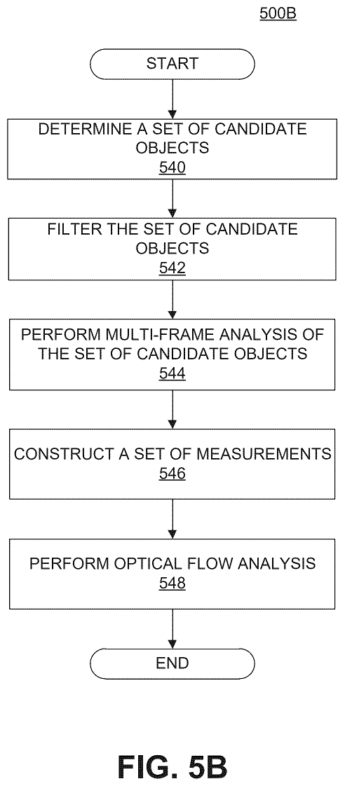

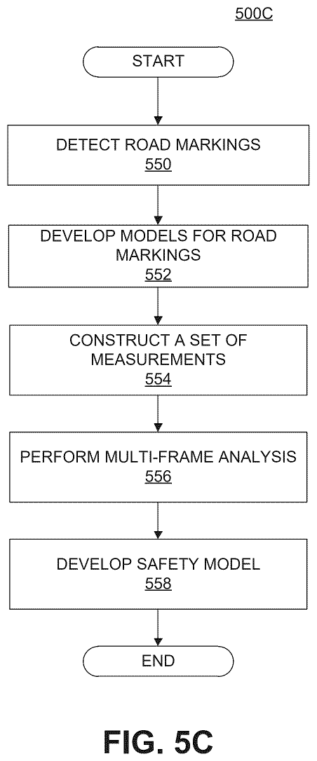

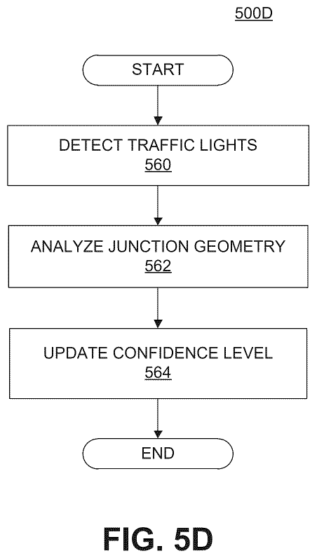

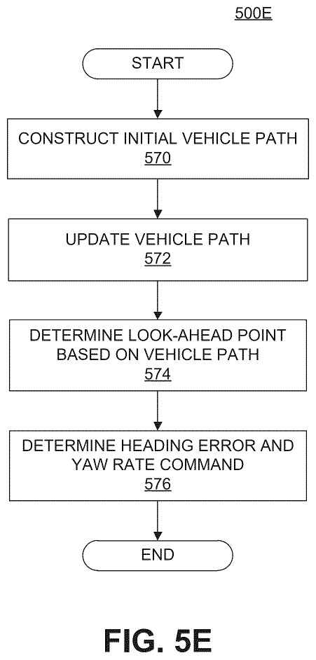

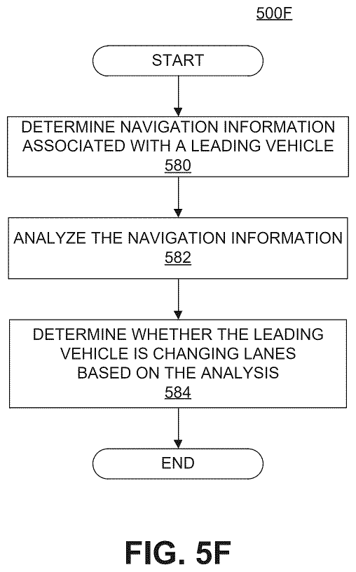

In one embodiment, monocular image analysis module 402 may store instructions (such as computer vision software) which, when executed by processing unit 110, performs monocular image analysis of a set of images acquired by one of image capture devices 122, 124, and 126. In some embodiments, processing unit 110 may combine information from a set of images with additional sensory information (e.g., information from radar, lidar, etc.) to perform the monocular image analysis. As described in connection with FIGS. 5A-5D below, monocular image analysis module 402 may include instructions for detecting a set of features within the set of images, such as lane markings, vehicles, pedestrians, road signs, highway exit ramps, traffic lights, hazardous objects, and any other feature associated with an environment of a vehicle. Based on the analysis, system 100 (e.g., via processing unit 110) may cause one or more navigational responses in vehicle 200, such as a turn, a lane shift, a change in acceleration, and the like, as discussed below in connection with navigational response module 408.

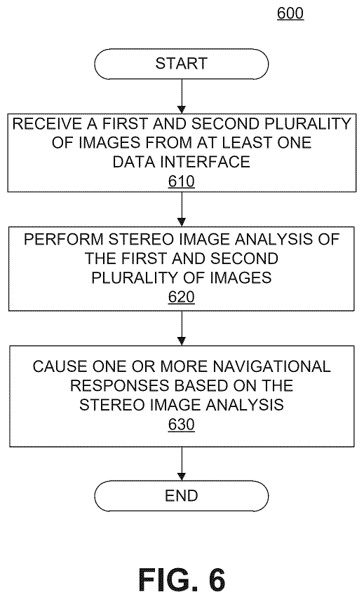

In one embodiment, stereo image analysis module 404 may store instructions (such as computer vision software) which, when executed by processing unit 110, performs stereo image analysis of first and second sets of images acquired by a combination of image capture devices selected from any of image capture devices 122, 124, and 126. In some embodiments, processing unit 110 may combine information from the first and second sets of images with additional sensory information (e.g., information from radar) to perform the stereo image analysis. For example, stereo image analysis module 404 may include instructions for performing stereo image analysis based on a first set of images acquired by image capture device 124 and a second set of images acquired by image capture device 126. As described in connection with FIG. 6 below, stereo image analysis module 404 may include instructions for detecting a set of features within the first and second sets of images, such as lane markings, vehicles, pedestrians, road signs, highway exit ramps, traffic lights, hazardous objects, and the like. Based on the analysis, processing unit 110 may cause one or more navigational responses in vehicle 200, such as a turn, a lane shift, a change in acceleration, and the like, as discussed below in connection with navigational response module 408. Furthermore, in some embodiments, stereo image analysis module 404 may implement techniques associated with a trained system (such as a neural network or a deep neural network) or an untrained system, such as a system that may be configured to use computer vision algorithms to detect and/or label objects in an environment from which sensory information was captured and processed. In one embodiment, stereo image analysis module 404 and/or other image processing modules may be configured to use a combination of a trained and untrained system.

In one embodiment, velocity and acceleration module 406 may store software configured to analyze data received from one or more computing and electromechanical devices in vehicle 200 that are configured to cause a change in velocity and/or acceleration of vehicle 200. For example, processing unit 110 may execute instructions associated with velocity and acceleration module 406 to calculate a target speed for vehicle 200 based on data derived from execution of monocular image analysis module 402 and/or stereo image analysis module 404. Such data may include, for example, a target position, velocity, and/or acceleration, the position and/or speed of vehicle 200 relative to a nearby vehicle, pedestrian, or road object, position information for vehicle 200 relative to lane markings of the road, and the like. In addition, processing unit 110 may calculate a target speed for vehicle 200 based on sensory input (e.g., information from radar) and input from other systems of vehicle 200, such as throttling system 220, braking system 230, and/or steering system 240 of vehicle 200. Based on the calculated target speed, processing unit 110 may transmit electronic signals to throttling system 220, braking system 230, and/or steering system 240 of vehicle 200 to trigger a change in velocity and/or acceleration by, for example, physically depressing the brake or easing up off the accelerator of vehicle 200.

In one embodiment, navigational response module 408 may store software executable by processing unit 110 to determine a desired navigational response based on data derived from execution of monocular image analysis module 402 and/or stereo image analysis module 404. Such data may include position and speed information associated with nearby vehicles, pedestrians, and road objects, target position information for vehicle 200, and the like. Additionally, in some embodiments, the navigational response may be based (partially or fully) on map data, a predetermined position of vehicle 200, and/or a relative velocity or a relative acceleration between vehicle 200 and one or more objects detected from execution of monocular image analysis module 402 and/or stereo image analysis module 404. Navigational response module 408 may also determine a desired navigational response based on sensory input (e.g., information from radar) and inputs from other systems of vehicle 200, such as throttling system 220, braking system 230, and steering system 240 of vehicle 200. Based on the desired navigational response, processing unit 110 may transmit electronic signals to throttling system 220, braking system 230, and steering system 240 of vehicle 200 to trigger a desired navigational response by, for example, turning the steering wheel of vehicle 200 to achieve a rotation of a predetermined angle. In some embodiments, processing unit 110 may use the output of navigational response module 408 (e.g., the desired navigational response) as an input to execution of velocity and acceleration module 406 for calculating a change in speed of vehicle 200.

Furthermore, any of the modules (e.g., modules 402, 404, and 406) disclosed herein may implement techniques associated with a trained system (such as a neural network or a deep neural network) or an untrained system.

FIG. 5A is a flowchart showing an exemplary process 500A for causing one or more navigational responses based on monocular image analysis, consistent with disclosed embodiments. At step 510, processing unit 110 may receive a plurality of images via data interface 128 between processing unit 110 and image acquisition unit 120. For instance, a camera included in image acquisition unit 120 (such as image capture device 122 having field of view 202) may capture a plurality of images of an area forward of vehicle 200 (or to the sides or rear of a vehicle, for example) and transmit them over a data connection (e.g., digital, wired, USB, wireless, Bluetooth, etc.) to processing unit 110. Processing unit 110 may execute monocular image analysis module 402 to analyze the plurality of images at step 520, as described in further detail in connection with FIGS. 5B-5D below. By performing the analysis, processing unit 110 may detect a set of features within the set of images, such as lane markings, vehicles, pedestrians, road signs, highway exit ramps, traffic lights, and the like.

Processing unit 110 may also execute monocular image analysis module 402 to detect various road hazards at step 520, such as, for example, parts of a truck tire, fallen road signs, loose cargo, small animals, and the like. Road hazards may vary in structure, shape, size, and color, which may make detection of such hazards more challenging. In some embodiments, processing unit 110 may execute monocular image analysis module 402 to perform multi-frame analysis on the plurality of images to detect road hazards. For example, processing unit 110 may estimate camera motion between consecutive image frames and calculate the disparities in pixels between the frames to construct a 3D-map of the road. Processing unit 110 may then use the 3D-map to detect the road surface, as well as hazards existing above the road surface.

At step 530, processing unit 110 may execute navigational response module 408 to cause one or more navigational responses in vehicle 200 based on the analysis performed at step 520 and the techniques as described above in connection with FIG. 4. Navigational responses may include, for example, a turn, a lane shift, a change in acceleration, and the like. In some embodiments, processing unit 110 may use data derived from execution of velocity and acceleration module 406 to cause the one or more navigational responses. Additionally, multiple navigational responses may occur simultaneously, in sequence, or any combination thereof. For instance, processing unit 110 may cause vehicle 200 to shift one lane over and then accelerate by, for example, sequentially transmitting control signals to steering system 240 and throttling system 220 of vehicle 200. Alternatively, processing unit 110 may cause vehicle 200 to brake while at the same time shifting lanes by, for example, simultaneously transmitting control signals to braking system 230 and steering system 240 of vehicle 200.

FIG. 5B is a flowchart showing an exemplary process 500B for detecting one or more vehicles and/or pedestrians in a set of images, consistent with disclosed embodiments. Processing unit 110 may execute monocular image analysis module 402 to implement process 500B. At step 540, processing unit 110 may determine a set of candidate objects representing possible vehicles and/or pedestrians. For example, processing unit 110 may scan one or more images, compare the images to one or more predetermined patterns, and identify within each image possible locations that may contain objects of interest (e.g., vehicles, pedestrians, or portions thereof). The predetermined patterns may be designed in such a way to achieve a high rate of “false hits” and a low rate of “misses.” For example, processing unit 110 may use a low threshold of similarity to predetermined patterns for identifying candidate objects as possible vehicles or pedestrians. Doing so may allow processing unit 110 to reduce the probability of missing (e.g., not identifying) a candidate object representing a vehicle or pedestrian.

At step 542, processing unit 110 may filter the set of candidate objects to exclude certain candidates (e.g., irrelevant or less relevant objects) based on classification criteria. Such criteria may be derived from various properties associated with object types stored in a database (e.g., a database stored in memory 140). Properties may include object shape, dimensions, texture, position (e.g., relative to vehicle 200), and the like. Thus, processing unit 110 may use one or more sets of criteria to reject false candidates from the set of candidate objects.

At step 544, processing unit 110 may analyze multiple frames of images to determine whether objects in the set of candidate objects represent vehicles and/or pedestrians. For example, processing unit 110 may track a detected candidate object across consecutive frames and accumulate frame-by-frame data associated with the detected object (e.g., size, position relative to vehicle 200, etc.). Additionally, processing unit 110 may estimate parameters for the detected object and compare the object's frame-by-frame position data to a predicted position.

At step 546, processing unit 110 may construct a set of measurements for the detected objects. Such measurements may include, for example, position, velocity, and acceleration values (relative to vehicle 200) associated with the detected objects. In some embodiments, processing unit 110 may construct the measurements based on estimation techniques using a series of time-based observations such as Kalman filters or linear quadratic estimation (LQE), and/or based on available modeling data for different object types (e.g., cars, trucks, pedestrians, bicycles, road signs, etc.). The Kalman filters may be based on a measurement of an object's scale, where the scale measurement is proportional to a time to collision (e.g., the amount of time for vehicle 200 to reach the object). Thus, by performing steps 540-546, processing unit 110 may identify vehicles and pedestrians appearing within the set of captured images and derive information (e.g., position, speed, size) associated with the vehicles and pedestrians. Based on the identification and the derived information, processing unit 110 may cause one or more navigational responses in vehicle 200, as described in connection with FIG. 5A, above.

At step 548, processing unit 110 may perform an optical flow analysis of one or more images to reduce the probabilities of detecting a “false hit” and missing a candidate object that represents a vehicle or pedestrian. The optical flow analysis may refer to, for example, analyzing motion patterns relative to vehicle 200 in the one or more images associated with other vehicles and pedestrians, and that are distinct from road surface motion. Processing unit 110 may calculate the motion of candidate objects by observing the different positions of the objects across multiple image frames, which are captured at different times. Processing unit 110 may use the position and time values as inputs into mathematical models for calculating the motion of the candidate objects. Thus, optical flow analysis may provide another method of detecting vehicles and pedestrians that are nearby vehicle 200. Processing unit 110 may perform optical flow analysis in combination with steps 540-546 to provide redundancy for detecting vehicles and pedestrians and increase the reliability of system 100.

FIG. 5C is a flowchart showing an exemplary process 500C for detecting road marks and/or lane geometry information in a set of images, consistent with disclosed embodiments. Processing unit 110 may execute monocular image analysis module 402 to implement process 500C. At step 550, processing unit 110 may detect a set of objects by scanning one or more images. To detect segments of lane markings, lane geometry information, and other pertinent road marks, processing unit 110 may filter the set of objects to exclude those determined to be irrelevant (e.g., minor potholes, small rocks, etc.). At step 552, processing unit 110 may group together the segments detected in step 550 belonging to the same road mark or lane mark. Based on the grouping, processing unit 110 may develop a model to represent the detected segments, such as a mathematical model.

At step 554, processing unit 110 may construct a set of measurements associated with the detected segments. In some embodiments, processing unit 110 may create a projection of the detected segments from the image plane onto the real-world plane. The projection may be characterized using a 3rd-degree polynomial having coefficients corresponding to physical properties such as the position, slope, curvature, and curvature derivative of the detected road. In generating the projection, processing unit 110 may take into account changes in the road surface, as well as pitch and roll rates associated with vehicle 200. In addition, processing unit 110 may model the road elevation by analyzing position and motion cues present on the road surface. Further, processing unit 110 may estimate the pitch and roll rates associated with vehicle 200 by tracking a set of feature points in the one or more images.

At step 556, processing unit 110 may perform multi-frame analysis by, for example, tracking the detected segments across consecutive image frames and accumulating frame-by-frame data associated with detected segments. As processing unit 110 performs multi-frame analysis, the set of measurements constructed at step 554 may become more reliable and associated with an increasingly higher confidence level. Thus, by performing steps 550, 552, 554, and 556, processing unit 110 may identify road marks appearing within the set of captured images and derive lane geometry information. Based on the identification and the derived information, processing unit 110 may cause one or more navigational responses in vehicle 200, as described in connection with FIG. 5A, above.

At step 558, processing unit 110 may consider additional sources of information to further develop a safety model for vehicle 200 in the context of its surroundings. Processing unit 110 may use the safety model to define a context in which system 100 may execute autonomous control of vehicle 200 in a safe manner. To develop the safety model, in some embodiments, processing unit 110 may consider the position and motion of other vehicles, the detected road edges and barriers, and/or general road shape descriptions extracted from map data (such as data from map database 160). By considering additional sources of information, processing unit 110 may provide redundancy for detecting road marks and lane geometry and increase the reliability of system 100.

FIG. 5D is a flowchart showing an exemplary process 500D for detecting traffic lights in a set of images, consistent with disclosed embodiments. Processing unit 110 may execute monocular image analysis module 402 to implement process 500D. At step 560, processing unit 110 may scan the set of images and identify objects appearing at locations in the images likely to contain traffic lights. For example, processing unit 110 may filter the identified objects to construct a set of candidate objects, excluding those objects unlikely to correspond to traffic lights. The filtering may be done based on various properties associated with traffic lights, such as shape, dimensions, texture, position (e.g., relative to vehicle 200), and the like. Such properties may be based on multiple examples of traffic lights and traffic control signals and stored in a database. In some embodiments, processing unit 110 may perform multi-frame analysis on the set of candidate objects reflecting possible traffic lights. For example, processing unit 110 may track the candidate objects across consecutive image frames, estimate the real-world position of the candidate objects, and filter out those objects that are moving (which are unlikely to be traffic lights). In some embodiments, processing unit 110 may perform color analysis on the candidate objects and identify the relative position of the detected colors appearing inside possible traffic lights.

At step 562, processing unit 110 may analyze the geometry of a junction. The analysis may be based on any combination of: (i) the number of lanes detected on either side of vehicle 200, (ii) markings (such as arrow marks) detected on the road, and (iii) descriptions of the junction extracted from map data (such as data from map database 160). Processing unit 110 may conduct the analysis using information derived from execution of monocular analysis module 402. In addition, Processing unit 110 may determine a correspondence between the traffic lights detected at step 560 and the lanes appearing near vehicle 200.

As vehicle 200 approaches the junction, at step 564, processing unit 110 may update the confidence level associated with the analyzed junction geometry and the detected traffic lights. For instance, the number of traffic lights estimated to appear at the junction as compared with the number actually appearing at the junction may impact the confidence level. Thus, based on the confidence level, processing unit 110 may delegate control to the driver of vehicle 200 in order to improve safety conditions. By performing steps 560, 562, and 564, processing unit 110 may identify traffic lights appearing within the set of captured images and analyze junction geometry information. Based on the identification and the analysis, processing unit 110 may cause one or more navigational responses in vehicle 200, as described in connection with FIG. 5A, above.

FIG. 5E is a flowchart showing an exemplary process 500E for causing one or more navigational responses in vehicle 200 based on a vehicle path, consistent with the disclosed embodiments. At step 570, processing unit 110 may construct an initial vehicle path associated with vehicle 200. The vehicle path may be represented using a set of points expressed in coordinates (x, z), and the distance dᵢ between two points in the set of points may fall in the range of 1 to 5 meters. In one embodiment, processing unit 110 may construct the initial vehicle path using two polynomials, such as left and right road polynomials. Processing unit 110 may calculate the geometric midpoint between the two polynomials and offset each point included in the resultant vehicle path by a predetermined offset (e.g., a smart lane offset), if any (an offset of zero may correspond to travel in the middle of a lane). The offset may be in a direction perpendicular to a segment between any two points in the vehicle path. In another embodiment, processing unit 110 may use one polynomial and an estimated lane width to offset each point of the vehicle path by half the estimated lane width plus a predetermined offset (e.g., a smart lane offset).

At step 572, processing unit 110 may update the vehicle path constructed at step 570. Processing unit 110 may reconstruct the vehicle path constructed at step 570 using a higher resolution, such that the distance dₖ between two points in the set of points representing the vehicle path is less than the distance dᵢ described above. For example, the distance dₖ may fall in the range of 0.1 to 0.3 meters. Processing unit 110 may reconstruct the vehicle path using a parabolic spline algorithm, which may yield a cumulative distance vector S corresponding to the total length of the vehicle path (i.e., based on the set of points representing the vehicle path).

At step 574, processing unit 110 may determine a look-ahead point (expressed in coordinates as (xₗ, zₗ)) based on the updated vehicle path constructed at step 572. Processing unit 110 may extract the look-ahead point from the cumulative distance vector S, and the look-ahead point may be associated with a look-ahead distance and look-ahead time. The look-ahead distance, which may have a lower bound ranging from 10 to 20 meters, may be calculated as the product of the speed of vehicle 200 and the look-ahead time. For example, as the speed of vehicle 200 decreases, the look-ahead distance may also decrease (e.g., until it reaches the lower bound). The look-ahead time, which may range from 0.5 to 1.5 seconds, may be inversely proportional to the gain of one or more control loops associated with causing a navigational response in vehicle 200, such as the heading error tracking control loop. For example, the gain of the heading error tracking control loop may depend on the bandwidth of a yaw rate loop, a steering actuator loop, car lateral dynamics, and the like. Thus, the higher the gain of the heading error tracking control loop, the lower the look-ahead time.

At step 576, processing unit 110 may determine a heading error and yaw rate command based on the look-ahead point determined at step 574. Processing unit 110 may determine the heading error by calculating the arctangent of the look-ahead point, e.g., arctan (xₗ/zₗ). Processing unit 110 may determine the yaw rate command as the product of the heading error and a high-level control gain. The high-level control gain may be equal to: (2/look-ahead time), if the look-ahead distance is not at the lower bound. Otherwise, the high-level control gain may be equal to: (2*speed of vehicle 200/look-ahead distance).

FIG. 5F is a flowchart showing an exemplary process 500F for determining whether a leading vehicle is changing lanes, consistent with the disclosed embodiments. At step 580, processing unit 110 may determine navigation information associated with a leading vehicle (e.g., a vehicle traveling ahead of vehicle 200). For example, processing unit 110 may determine the position, velocity (e.g., direction and speed), and/or acceleration of the leading vehicle, using the techniques described in connection with FIGS. 5A and 5B, above. Processing unit 110 may also determine one or more road polynomials, a look-ahead point (associated with vehicle 200), and/or a snail trail (e.g., a set of points describing a path taken by the leading vehicle), using the techniques described in connection with FIG. 5E, above.

At step 582, processing unit 110 may analyze the navigation information determined at step 580. In one embodiment, processing unit 110 may calculate the distance between a snail trail and a road polynomial (e.g., along the trail). If the variance of this distance along the trail exceeds a predetermined threshold (for example, 0.1 to 0.2 meters on a straight road, 0.3 to 0.4 meters on a moderately curvy road, and 0.5 to 0.6 meters on a road with sharp curves), processing unit 110 may determine that the leading vehicle is likely changing lanes. In the case where multiple vehicles are detected traveling ahead of vehicle 200, processing unit 110 may compare the snail trails associated with each vehicle. Based on the comparison, processing unit 110 may determine that a vehicle whose snail trail does not match with the snail trails of the other vehicles is likely changing lanes. Processing unit 110 may additionally compare the curvature of the snail trail (associated with the leading vehicle) with the expected curvature of the road segment in which the leading vehicle is traveling. The expected curvature may be extracted from map data (e.g., data from map database 160), from road polynomials, from other vehicles'snail trails, from prior knowledge about the road, and the like. If the difference in curvature of the snail trail and the expected curvature of the road segment exceeds a predetermined threshold, processing unit 110 may determine that the leading vehicle is likely changing lanes.

In another embodiment, processing unit 110 may compare the leading vehicle's instantaneous position with the look-ahead point (associated with vehicle 200) over a specific period of time (e.g., 0.5 to 1.5 seconds). If the distance between the leading vehicle's instantaneous position and the look-ahead point varies during the specific period of time, and the cumulative sum of variation exceeds a predetermined threshold (for example, 0.3 to 0.4 meters on a straight road, 0.7 to 0.8 meters on a moderately curvy road, and 1.3 to 1.7 meters on a road with sharp curves), processing unit 110 may determine that the leading vehicle is likely changing lanes. In another embodiment, processing unit 110 may analyze the geometry of the snail trail by comparing the lateral distance traveled along the trail with the expected curvature of the snail trail. The expected radius of curvature may be determined according to the calculation: (δ_{z}²+δₓ²)/2/(δₓ), where δₓ represents the lateral distance traveled and δ_{z} represents the longitudinal distance traveled. If the difference between the lateral distance traveled and the expected curvature exceeds a predetermined threshold (e.g., 500 to 700 meters), processing unit 110 may determine that the leading vehicle is likely changing lanes. In another embodiment, processing unit 110 may analyze the position of the leading vehicle. If the position of the leading vehicle obscures a road polynomial (e.g., the leading vehicle is overlaid on top of the road polynomial), then processing unit 110 may determine that the leading vehicle is likely changing lanes. In the case where the position of the leading vehicle is such that, another vehicle is detected ahead of the leading vehicle and the snail trails of the two vehicles are not parallel, processing unit 110 may determine that the (closer) leading vehicle is likely changing lanes.

At step 584, processing unit 110 may determine whether or not leading vehicle 200 is changing lanes based on the analysis performed at step 582. For example, processing unit 110 may make the determination based on a weighted average of the individual analyses performed at step 582. Under such a scheme, for example, a decision by processing unit 110 that the leading vehicle is likely changing lanes based on a particular type of analysis may be assigned a value of “1” (and “0” to represent a determination that the leading vehicle is not likely changing lanes). Different analyses performed at step 582 may be assigned different weights, and the disclosed embodiments are not limited to any particular combination of analyses and weights.

FIG. 6 is a flowchart showing an exemplary process 600 for causing one or more navigational responses based on stereo image analysis, consistent with disclosed embodiments. At step 610, processing unit 110 may receive a first and second plurality of images via data interface 128. For example, cameras included in image acquisition unit 120 (such as image capture devices 122 and 124 having fields of view 202 and 204) may capture a first and second plurality of images of an area forward of vehicle 200 and transmit them over a digital connection (e.g., USB, wireless, Bluetooth, etc.) to processing unit 110. In some embodiments, processing unit 110 may receive the first and second plurality of images via two or more data interfaces. The disclosed embodiments are not limited to any particular data interface configurations or protocols.

At step 620, processing unit 110 may execute stereo image analysis module 404 to perform stereo image analysis of the first and second plurality of images to create a 3D map of the road in front of the vehicle and detect features within the images, such as lane markings, vehicles, pedestrians, road signs, highway exit ramps, traffic lights, road hazards, and the like. Stereo image analysis may be performed in a manner similar to the steps described in connection with FIGS. 5A-5D, above. For example, processing unit 110 may execute stereo image analysis module 404 to detect candidate objects (e.g., vehicles, pedestrians, road marks, traffic lights, road hazards, etc.) within the first and second plurality of images, filter out a subset of the candidate objects based on various criteria, and perform multi-frame analysis, construct measurements, and determine a confidence level for the remaining candidate objects. In performing the steps above, processing unit 110 may consider information from both the first and second plurality of images, rather than information from one set of images alone. For example, processing unit 110 may analyze the differences in pixel-level data (or other data subsets from among the two streams of captured images) for a candidate object appearing in both the first and second plurality of images. As another example, processing unit 110 may estimate a position and/or velocity of a candidate object (e.g., relative to vehicle 200) by observing that the object appears in one of the plurality of images but not the other or relative to other differences that may exist relative to objects appearing if the two image streams. For example, position, velocity, and/or acceleration relative to vehicle 200 may be determined based on trajectories, positions, movement characteristics, etc. of features associated with an object appearing in one or both of the image streams.

At step 630, processing unit 110 may execute navigational response module 408 to cause one or more navigational responses in vehicle 200 based on the analysis performed at step 620 and the techniques as described above in connection with FIG. 4. Navigational responses may include, for example, a turn, a lane shift, a change in acceleration, a change in velocity, braking, and the like. In some embodiments, processing unit 110 may use data derived from execution of velocity and acceleration module 406 to cause the one or more navigational responses. Additionally, multiple navigational responses may occur simultaneously, in sequence, or any combination thereof.

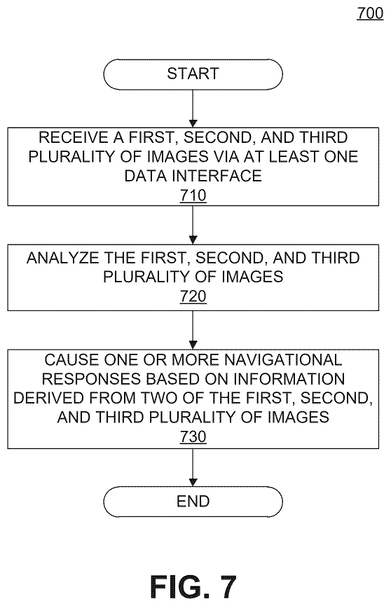

FIG. 7 is a flowchart showing an exemplary process 700 for causing one or more navigational responses based on an analysis of three sets of images, consistent with disclosed embodiments. At step 710, processing unit 110 may receive a first, second, and third plurality of images via data interface 128. For instance, cameras included in image acquisition unit 120 (such as image capture devices 122, 124, and 126 having fields of view 202, 204, and 206) may capture a first, second, and third plurality of images of an area forward and/or to the side of vehicle 200 and transmit them over a digital connection (e.g., USB, wireless, Bluetooth, etc.) to processing unit 110. In some embodiments, processing unit 110 may receive the first, second, and third plurality of images via three or more data interfaces. For example, each of image capture devices 122, 124, 126 may have an associated data interface for communicating data to processing unit 110. The disclosed embodiments are not limited to any particular data interface configurations or protocols.

At step 720, processing unit 110 may analyze the first, second, and third plurality of images to detect features within the images, such as lane markings, vehicles, pedestrians, road signs, highway exit ramps, traffic lights, road hazards, and the like. The analysis may be performed in a manner similar to the steps described in connection with FIGS. 5A-5D and 6, above. For instance, processing unit 110 may perform monocular image analysis (e.g., via execution of monocular image analysis module 402 and based on the steps described in connection with FIGS. 5A-5D, above) on each of the first, second, and third plurality of images. Alternatively, processing unit 110 may perform stereo image analysis (e.g., via execution of stereo image analysis module 404 and based on the steps described in connection with FIG. 6, above) on the first and second plurality of images, the second and third plurality of images, and/or the first and third plurality of images. The processed information corresponding to the analysis of the first, second, and/or third plurality of images may be combined. In some embodiments, processing unit 110 may perform a combination of monocular and stereo image analyses. For example, processing unit 110 may perform monocular image analysis (e.g., via execution of monocular image analysis module 402) on the first plurality of images and stereo image analysis (e.g., via execution of stereo image analysis module 404) on the second and third plurality of images. The configuration of image capture devices 122, 124, and 126—including their respective locations and fields of view 202, 204, and 206—may influence the types of analyses conducted on the first, second, and third plurality of images. The disclosed embodiments are not limited to a particular configuration of image capture devices 122, 124, and 126, or the types of analyses conducted on the first, second, and third plurality of images.

In some embodiments, processing unit 110 may perform testing on system 100 based on the images acquired and analyzed at steps 710 and 720. Such testing may provide an indicator of the overall performance of system 100 for certain configurations of image capture devices 122, 124, and 126. For example, processing unit 110 may determine the proportion of “false hits” (e.g., cases where system 100 incorrectly determined the presence of a vehicle or pedestrian) and “misses.”

At step 730, processing unit 110 may cause one or more navigational responses in vehicle 200 based on information derived from two of the first, second, and third plurality of images. Selection of two of the first, second, and third plurality of images may depend on various factors, such as, for example, the number, types, and sizes of objects detected in each of the plurality of images. Processing unit 110 may also make the selection based on image quality and resolution, the effective field of view reflected in the images, the number of captured frames, the extent to which one or more objects of interest actually appear in the frames (e.g., the percentage of frames in which an object appears, the proportion of the object that appears in each such frame, etc.), and the like.

In some embodiments, processing unit 110 may select information derived from two of the first, second, and third plurality of images by determining the extent to which information derived from one image source is consistent with information derived from other image sources. For example, processing unit 110 may combine the processed information derived from each of image capture devices 122, 124, and 126 (whether by monocular analysis, stereo analysis, or any combination of the two) and determine visual indicators (e.g., lane markings, a detected vehicle and its location and/or path, a detected traffic light, etc.) that are consistent across the images captured from each of image capture devices 122, 124, and 126. Processing unit 110 may also exclude information that is inconsistent across the captured images (e.g., a vehicle changing lanes, a lane model indicating a vehicle that is too close to vehicle 200, etc.). Thus, processing unit 110 may select information derived from two of the first, second, and third plurality of images based on the determinations of consistent and inconsistent information.

Navigational responses may include, for example, a turn, a lane shift, a change in acceleration, and the like. Processing unit 110 may cause the one or more navigational responses based on the analysis performed at step 720 and the techniques as described above in connection with FIG. 4. Processing unit 110 may also use data derived from execution of velocity and acceleration module 406 to cause the one or more navigational responses. In some embodiments, processing unit 110 may cause the one or more navigational responses based on a relative position, relative velocity, and/or relative acceleration between vehicle 200 and an object detected within any of the first, second, and third plurality of images. Multiple navigational responses may occur simultaneously, in sequence, or any combination thereof.

### Sparse Road Model for Autonomous Vehicle Navigation

In some embodiments, the disclosed systems and methods may use a sparse map for autonomous vehicle navigation. In particular, the sparse map may be for autonomous vehicle navigation along a road segment. For example, the sparse map may provide sufficient information for navigating an autonomous vehicle without storing and/or updating a large quantity of data. As discussed below in further detail, an autonomous vehicle may use the sparse map to navigate one or more roads based on one or more stored trajectories.

### Sparse Map for Autonomous Vehicle Navigation

In some embodiments, the disclosed systems and methods may generate a sparse map for autonomous vehicle navigation. For example, the sparse map may provide sufficient information for navigation without requiring excessive data storage or data transfer rates. As discussed below in further detail, a vehicle (which may be an autonomous vehicle) may use the sparse map to navigate one or more roads. For example, in some embodiments, the sparse map may include data related to a road and potentially landmarks along the road that may be sufficient for vehicle navigation, but which also exhibit small data footprints. For example, the sparse data maps described in detail below may require significantly less storage space and data transfer bandwidth as compared with digital maps including detailed map information, such as image data collected along a road.

For example, rather than storing detailed representations of a road segment, the sparse data map may store three-dimensional polynomial representations of preferred vehicle paths along a road. These paths may require very little data storage space. Further, in the described sparse data maps, landmarks may be identified and included in the sparse map road model to aid in navigation. These landmarks may be located at any spacing suitable for enabling vehicle navigation, but in some cases, such landmarks need not be identified and included in the model at high densities and short spacings. Rather, in some cases, navigation may be possible based on landmarks that are spaced apart by at least 50 meters, at least 100 meters, at least 500 meters, at least 1 kilometer, or at least 2 kilometers. As will be discussed in more detail in other sections, the sparse map may be generated based on data collected or measured by vehicles equipped with various sensors and devices, such as image capture devices, Global Positioning System sensors, motion sensors, etc., as the vehicles travel along roadways. In some cases, the sparse map may be generated based on data collected during multiple drives of one or more vehicles along a particular roadway. Generating a sparse map using multiple drives of one or more vehicles may be referred to as “crowdsourcing” a sparse map.

Consistent with disclosed embodiments, an autonomous vehicle system may use a sparse map for navigation. For example, the disclosed systems and methods may distribute a sparse map for generating a road navigation model for an autonomous vehicle and may navigate an autonomous vehicle along a road segment using a sparse map and/or a generated road navigation model. Sparse maps consistent with the present disclosure may include one or more three-dimensional contours that may represent predetermined trajectories that autonomous vehicles may traverse as they move along associated road segments.

Sparse maps consistent with the present disclosure may also include data representing one or more road features. Such road features may include recognized landmarks, road signature profiles, and any other road-related features useful in navigating a vehicle. Sparse maps consistent with the present disclosure may enable autonomous navigation of a vehicle based on relatively small amounts of data included in the sparse map. For example, rather than including detailed representations of a road, such as road edges, road curvature, images associated with road segments, or data detailing other physical features associated with a road segment, the disclosed embodiments of the sparse map may require relatively little storage space (and relatively little bandwidth when portions of the sparse map are transferred to a vehicle) but may still adequately provide for autonomous vehicle navigation. The small data footprint of the disclosed sparse maps, discussed in further detail below, may be achieved in some embodiments by storing representations of road-related elements that require small amounts of data but still enable autonomous navigation.

For example, rather than storing detailed representations of various aspects of a road, the disclosed sparse maps may store polynomial representations of one or more trajectories that a vehicle may follow along the road. Thus, rather than storing (or having to transfer) details regarding the physical nature of the road to enable navigation along the road, using the disclosed sparse maps, a vehicle may be navigated along a particular road segment without, in some cases, having to interpret physical aspects of the road, but rather, by aligning its path of travel with a trajectory (e.g., a polynomial spline) along the particular road segment. In this way, the vehicle may be navigated based mainly upon the stored trajectory (e.g., a polynomial spline) that may require much less storage space than an approach involving storage of roadway images, road parameters, road layout, etc.

In addition to the stored polynomial representations of trajectories along a road segment, the disclosed sparse maps may also include small data objects that may represent a road feature. In some embodiments, the small data objects may include digital signatures, which are derived from a digital image (or a digital signal) that was obtained by a sensor (e.g., a camera or other sensor, such as a suspension sensor) onboard a vehicle traveling along the road segment. The digital signature may have a reduced size relative to the signal that was acquired by the sensor. In some embodiments, the digital signature may be created to be compatible with a classifier function that is configured to detect and to identify the road feature from the signal that is acquired by the sensor, for example, during a subsequent drive. In some embodiments, a digital signature may be created such that the digital signature has a footprint that is as small as possible, while retaining the ability to correlate or match the road feature with the stored signature based on an image (or a digital signal generated by a sensor, if the stored signature is not based on an image and/or includes other data) of the road feature that is captured by a camera onboard a vehicle traveling along the same road segment at a subsequent time.

In some embodiments, a size of the data objects may be further associated with a uniqueness of the road feature. For example, for a road feature that is detectable by a camera onboard a vehicle, and where the camera system onboard the vehicle is coupled to a classifier that is capable of distinguishing the image data corresponding to that road feature as being associated with a particular type of road feature, for example, a road sign, and where such a road sign is locally unique in that area (e.g., there is no identical road sign or road sign of the same type nearby), it may be sufficient to store data indicating the type of the road feature and its location.

As will be discussed in further detail below, road features (e.g., landmarks along a road segment) may be stored as small data objects that may represent a road feature in relatively few bytes, while at the same time providing sufficient information for recognizing and using such a feature for navigation. In one example, a road sign may be identified as a recognized landmark on which navigation of a vehicle may be based. A representation of the road sign may be stored in the sparse map to include, e.g., a few bytes of data indicating a type of landmark (e.g., a stop sign) and a few bytes of data indicating a location of the landmark (e.g., coordinates). Navigating based on such data-light representations of the landmarks (e.g., using representations sufficient for locating, recognizing, and navigating based upon the landmarks) may provide a desired level of navigational functionality associated with sparse maps without significantly increasing the data overhead associated with the sparse maps. This lean representation of landmarks (and other road features) may take advantage of the sensors and processors included onboard such vehicles that are configured to detect, identify, and/or classify certain road features.

When, for example, a sign or even a particular type of a sign is locally unique (e.g., when there is no other sign or no other sign of the same type) in a given area, the sparse map may use data indicating a type of a landmark (a sign or a specific type of sign), and during navigation (e.g., autonomous navigation) when a camera onboard an autonomous vehicle captures an image of the area including a sign (or of a specific type of sign), the processor may process the image, detect the sign (if indeed present in the image), classify the image as a sign (or as a specific type of sign), and correlate the location of the image with the location of the sign as stored in the sparse map.

The sparse map may include any suitable representation of objects identified along a road segment. In some cases, the objects may be referred to as semantic objects or non-semantic objects. Semantic objects may include, for example, objects associated with a predetermined type classification. This type classification may be useful in reducing the amount of data required to describe the semantic object recognized in an environment, which can be beneficial both in the harvesting phase (e.g., to reduce costs associated with bandwidth use for transferring drive information from a plurality of harvesting vehicles to a server) and during the navigation phase (e.g., reduction of map data can speed transfer of map tiles from a server to a navigating vehicle and can also reduce costs associated with bandwidth use for such transfers). Semantic object classification types may be assigned to any type of objects or features that are expected to be encountered along a roadway.

Semantic objects may further be divided into two or more logical groups. For example, in some cases, one group of semantic object types may be associated with predetermined dimensions. Such semantic objects may include certain speed limit signs, yield signs, merge signs, stop signs, traffic lights, directional arrows on a roadway, manhole covers, or any other type of object that may be associated with a standardized size. One benefit offered by such semantic objects is that very little data may be needed to represent/fully define the objects. For example, if a standardized size of a speed limit size is known, then a harvesting vehicle may need only identify (through analysis of a captured image) the presence of a speed limit sign (a recognized type) along with an indication of a position of the detected speed limit sign (e.g., a 2D position in the captured image (or, alternatively, a 3D position in real world coordinates) of a center of the sign or a certain corner of the sign) to provide sufficient information for map generation on the server side. Where 2D image positions are transmitted to the server, a position associated with the captured image where the sign was detected may also be transmitted so the server can determine a real-world position of the sign (e.g., through structure in motion techniques using multiple captured images from one or more harvesting vehicles). Even with this limited information (requiring just a few bytes to define each detected object), the server may construct the map including a fully represented speed limit sign based on the type classification (representative of a speed limit sign) received from one or more harvesting vehicles along with the position information for the detected sign.

Semantic objects may also include other recognized object or feature types that are not associated with certain standardized characteristics. Such objects or features may include potholes, tar seams, light poles, non-standardized signs, curbs, trees, tree branches, or any other type of recognized object type with one or more variable characteristics (e.g., variable dimensions). In such cases, in addition to transmitting to a server an indication of the detected object or feature type (e.g., pothole, pole, etc.) and position information for the detected object or feature, a harvesting vehicle may also transmit an indication of a size of the object or feature. The size may be expressed in 2D image dimensions (e.g., with a bounding box or one or more dimension values) or real-world dimensions (determined through structure in motion calculations, based on LIDAR or RADAR system outputs, based on trained neural network outputs, etc.).

Non-semantic objects or features may include any detectable objects or features that fall outside of a recognized category or type, but that still may provide valuable information in map generation. In some cases, such non-semantic features may include a detected corner of a building or a corner of a detected window of a building, a unique stone or object near a roadway, a concrete splatter in a roadway shoulder, or any other detectable object or feature. Upon detecting such an object or feature one or more harvesting vehicles may transmit to a map generation server a location of one or more points (2D image points or 3D real world points) associated with the detected object/feature. Additionally, a compressed or simplified image segment (e.g., an image hash) may be generated for a region of the captured image including the detected object or feature. This image hash may be calculated based on a predetermined image processing algorithm and may form an effective signature for the detected non-semantic object or feature. Such a signature may be useful for navigation relative to a sparse map including the non-semantic feature or object, as a vehicle traversing the roadway may apply an algorithm similar to the algorithm used to generate the image hash in order to confirm/verify the presence in a captured image of the mapped non-semantic feature or object. Using this technique, non-semantic features may add to the richness of the sparse maps (e.g., to enhance their usefulness in navigation) without adding significant data overhead.

As noted, target trajectories may be stored in the sparse map. These target trajectories (e.g., 3D splines) may represent the preferred or recommended paths for each available lane of a roadway, each valid pathway through a junction, for merges and exits, etc. In addition to target trajectories, other road feature may also be detected, harvested, and incorporated in the sparse maps in the form of representative splines. Such features may include, for example, road edges, lane markings, curbs, guardrails, or any other objects or features that extend along a roadway or road segment.

### Generating a Sparse Map

In some embodiments, a sparse map may include at least one line representation of a road surface feature extending along a road segment and a plurality of landmarks associated with the road segment. In certain aspects, the sparse map may be generated via “crowdsourcing,” for example, through image analysis of a plurality of images acquired as one or more vehicles traverse the road segment.

FIG. 8 shows a sparse map 800 that one or more vehicles, e.g., vehicle 200 (which may be an autonomous vehicle), may access for providing autonomous vehicle navigation. Sparse map 800 may be stored in a memory, such as memory 140 or 150. Such memory devices may include any types of non-transitory storage devices or computer-readable media. For example, in some embodiments, memory 140 or 150 may include hard drives, compact discs, flash memory, magnetic based memory devices, optical based memory devices, etc. In some embodiments, sparse map 800 may be stored in a database (e.g., map database 160) that may be stored in memory 140 or 150, or other types of storage devices.

In some embodiments, sparse map 800 may be stored on a storage device or a non-transitory computer-readable medium provided onboard vehicle 200 (e.g., a storage device included in a navigation system onboard vehicle 200). A processor (e.g., processing unit 110) provided on vehicle 200 may access sparse map 800 stored in the storage device or computer-readable medium provided onboard vehicle 200 in order to generate navigational instructions for guiding the autonomous vehicle 200 as the vehicle traverses a road segment.

Sparse map 800 need not be stored locally with respect to a vehicle, however. In some embodiments, sparse map 800 may be stored on a storage device or computer-readable medium provided on a remote server that communicates with vehicle 200 or a device associated with vehicle 200. A processor (e.g., processing unit 110) provided on vehicle 200 may receive data included in sparse map 800 from the remote server and may execute the data for guiding the autonomous driving of vehicle 200. In such embodiments, the remote server may store all of sparse map 800 or only a portion thereof. Accordingly, the storage device or computer-readable medium provided onboard vehicle 200 and/or onboard one or more additional vehicles may store the remaining portion(s) of sparse map 800.

Furthermore, in such embodiments, sparse map 800 may be made accessible to a plurality of vehicles traversing various road segments (e.g., tens, hundreds, thousands, or millions of vehicles, etc.). It should be noted also that sparse map 800 may include multiple sub-maps. For example, in some embodiments, sparse map 800 may include hundreds, thousands, millions, or more, of sub-maps (e.g., map tiles) that may be used in navigating a vehicle. Such sub-maps may be referred to as local maps or map tiles, and a vehicle traveling along a roadway may access any number of local maps relevant to a location in which the vehicle is traveling. The local map sections of sparse map 800 may be stored with a Global Navigation Satellite System (GNSS) key as an index to the database of sparse map 800. Thus, while computation of steering angles for navigating a host vehicle in the present system may be performed without reliance upon a GNSS position of the host vehicle, road features, or landmarks, such GNSS information may be used for retrieval of relevant local maps.

In general, sparse map 800 may be generated based on data (e.g., drive information) collected from one or more vehicles as they travel along roadways. For example, using sensors aboard the one or more vehicles (e.g., cameras, speedometers, GPS, accelerometers, etc.), the trajectories that the one or more vehicles travel along a roadway may be recorded, and the polynomial representation of a preferred trajectory for vehicles making subsequent trips along the roadway may be determined based on the collected trajectories travelled by the one or more vehicles. Similarly, data collected by the one or more vehicles may aid in identifying potential landmarks along a particular roadway. Data collected from traversing vehicles may also be used to identify road profile information, such as road width profiles, road roughness profiles, traffic line spacing profiles, road conditions, etc. Using the collected information, sparse map 800 may be generated and distributed (e.g., for local storage or via on-the-fly data transmission) for use in navigating one or more autonomous vehicles. However, in some embodiments, map generation may not end upon initial generation of the map. As will be discussed in greater detail below, sparse map 800 may be continuously or periodically updated based on data collected from vehicles as those vehicles continue to traverse roadways included in sparse map 800.

Data recorded in sparse map 800 may include position information based on Global Positioning System (GPS) data. For example, location information may be included in sparse map 800 for various map elements, including, for example, landmark locations, road profile locations, etc. Locations for map elements included in sparse map 800 may be obtained using GPS data collected from vehicles traversing a roadway. For example, a vehicle passing an identified landmark may determine a location of the identified landmark using GPS position information associated with the vehicle and a determination of a location of the identified landmark relative to the vehicle (e.g., based on image analysis of data collected from one or more cameras on board the vehicle). Such location determinations of an identified landmark (or any other feature included in sparse map 800) may be repeated as additional vehicles pass the location of the identified landmark. Some or all of the additional location determinations may be used to refine the location information stored in sparse map 800 relative to the identified landmark. For example, in some embodiments, multiple position measurements relative to a particular feature stored in sparse map 800 may be averaged together. Any other mathematical operations, however, may also be used to refine a stored location of a map element based on a plurality of determined locations for the map element.

In a particular example, harvesting vehicles may traverse a particular road segment. Each harvesting vehicle captures images of their respective environments. The images may be collected at any suitable frame capture rate (e.g., 9 Hz, etc.). Image analysis processor(s) aboard each harvesting vehicle analyze the captured images to detect the presence of semantic and/or non-semantic features/objects. At a high level, the harvesting vehicles transmit to a mapping-server indications of detections of the semantic and/or non-semantic objects/features along with positions associated with those objects/features. In more detail, type indicators, dimension indicators, etc. may be transmitted together with the position information. The position information may include any suitable information for enabling the mapping server to aggregate the detected objects/features into a sparse map useful in navigation. In some cases, the position information may include one or more 2D image positions (e.g., X-Y pixel locations) in a captured image where the semantic or non-semantic features/objects were detected. Such image positions may correspond to a center of the feature/object, a corner, etc. In this scenario, to aid the mapping server in reconstructing the drive information and aligning the drive information from multiple harvesting vehicles, each harvesting vehicle may also provide the server with a location (e.g., a GPS location) where each image was captured.

In other cases, the harvesting vehicle may provide to the server one or more 3D real world points associated with the detected objects/features. Such 3D points may be relative to a predetermined origin (such as an origin of a drive segment) and may be determined through any suitable technique. In some cases, a structure in motion technique may be used to determine the 3D real world position of a detected object/feature. For example, a certain object such as a particular speed limit sign may be detected in two or more captured images. Using information such as the known ego motion (speed, trajectory, GPS position, etc.) of the harvesting vehicle between the captured images, along with observed changes of the speed limit sign in the captured images (change in X-Y pixel location, change in size, etc.), the real-world position of one or more points associated with the speed limit sign may be determined and passed along to the mapping server. Such an approach is optional, as it requires more computation on the part of the harvesting vehicle systems. The sparse map of the disclosed embodiments may enable autonomous navigation of a vehicle using relatively small amounts of stored data. In some embodiments, sparse map 800 may have a data density (e.g., including data representing the target trajectories, landmarks, and any other stored road features) of less than 2 MB per kilometer of roads, less than 1 MB per kilometer of roads, less than 500 kB per kilometer of roads, or less than 100 kB per kilometer of roads. In some embodiments, the data density of sparse map 800 may be less than 10 kB per kilometer of roads or even less than 2 kB per kilometer of roads (e.g., 1.6 kB per kilometer), or no more than 10 kB per kilometer of roads, or no more than 20 kB per kilometer of roads. In some embodiments, most, if not all, of the roadways of the United States may be navigated autonomously using a sparse map having a total of 4 GB or less of data. These data density values may represent an average over an entire sparse map 800, over a local map within sparse map 800, and/or over a particular road segment within sparse map 800.

As noted, sparse map 800 may include representations of a plurality of target trajectories 810 for guiding autonomous driving or navigation along a road segment. Such target trajectories may be stored as three-dimensional splines. The target trajectories stored in sparse map 800 may be determined based on two or more reconstructed trajectories of prior traversals of vehicles along a particular road segment, for example. A road segment may be associated with a single target trajectory or multiple target trajectories. For example, on a two lane road, a first target trajectory may be stored to represent an intended path of travel along the road in a first direction, and a second target trajectory may be stored to represent an intended path of travel along the road in another direction (e.g., opposite to the first direction). Additional target trajectories may be stored with respect to a particular road segment. For example, on a multi-lane road one or more target trajectories may be stored representing intended paths of travel for vehicles in one or more lanes associated with the multi-lane road. In some embodiments, each lane of a multi-lane road may be associated with its own target trajectory. In other embodiments, there may be fewer target trajectories stored than lanes present on a multi-lane road. In such cases, a vehicle navigating the multi-lane road may use any of the stored target trajectories to guides its navigation by taking into account an amount of lane offset from a lane for which a target trajectory is stored (e.g., if a vehicle is traveling in the left most lane of a three lane highway, and a target trajectory is stored only for the middle lane of the highway, the vehicle may navigate using the target trajectory of the middle lane by accounting for the amount of lane offset between the middle lane and the left-most lane when generating navigational instructions).

In some embodiments, the target trajectory may represent an ideal path that a vehicle should take as the vehicle travels. The target trajectory may be located, for example, at an approximate center of a lane of travel. In other cases, the target trajectory may be located elsewhere relative to a road segment. For example, a target trajectory may approximately coincide with a center of a road, an edge of a road, or an edge of a lane, etc. In such cases, navigation based on the target trajectory may include a determined amount of offset to be maintained relative to the location of the target trajectory. Moreover, in some embodiments, the determined amount of offset to be maintained relative to the location of the target trajectory may differ based on a type of vehicle (e.g., a passenger vehicle including two axles may have a different offset from a truck including more than two axles along at least a portion of the target trajectory).

Sparse map 800 may also include data relating to a plurality of predetermined landmarks 820 associated with particular road segments, local maps, etc. As discussed in greater detail below, these landmarks may be used in navigation of the autonomous vehicle. For example, in some embodiments, the landmarks may be used to determine a current position of the vehicle relative to a stored target trajectory. With this position information, the autonomous vehicle may be able to adjust a heading direction to match a direction of the target trajectory at the determined location.

The plurality of landmarks 820 may be identified and stored in sparse map 800 at any suitable spacing. In some embodiments, landmarks may be stored at relatively high densities (e.g., every few meters or more). In some embodiments, however, significantly larger landmark spacing values may be employed. For example, in sparse map 800, identified (or recognized) landmarks may be spaced apart by 10 meters, 20 meters, 50 meters, 100 meters, 1 kilometer, or 2 kilometers. In some cases, the identified landmarks may be located at distances of even more than 2 kilometers apart.

Between landmarks, and therefore between determinations of vehicle position relative to a target trajectory, the vehicle may navigate based on dead reckoning in which the vehicle uses sensors to determine its ego motion and estimate its position relative to the target trajectory. Because errors may accumulate during navigation by dead reckoning, over time the position determinations relative to the target trajectory may become increasingly less accurate. The vehicle may use landmarks occurring in sparse map 800 (and their known locations) to remove the dead reckoning-induced errors in position determination. In this way, the identified landmarks included in sparse map 800 may serve as navigational anchors from which an accurate position of the vehicle relative to a target trajectory may be determined. Because a certain amount of error may be acceptable in position location, an identified landmark need not always be available to an autonomous vehicle. Rather, suitable navigation may be possible even based on landmark spacings, as noted above, of 10 meters, 20 meters, 50 meters, 100 meters, 500 meters, 1 kilometer, 2 kilometers, or more. In some embodiments, a density of 1 identified landmark every 1 km of road may be sufficient to maintain a longitudinal position determination accuracy within 1 m. Thus, not every potential landmark appearing along a road segment need be stored in sparse map 800.

Moreover, in some embodiments, lane markings may be used for localization of the vehicle during landmark spacings. By using lane markings during landmark spacings, the accumulation of errors during navigation by dead reckoning may be minimized.

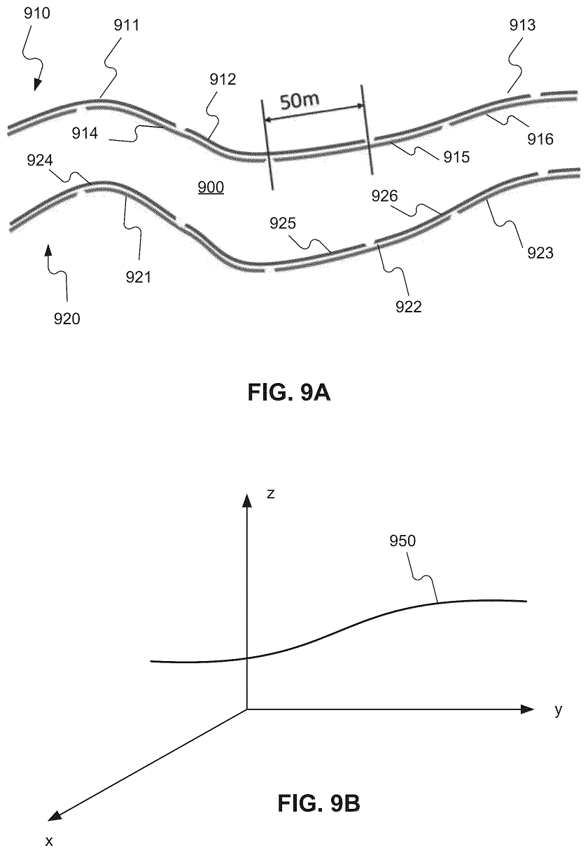

In addition to target trajectories and identified landmarks, sparse map 800 may include information relating to various other road features. For example, FIG. 9A illustrates a representation of curves along a particular road segment that may be stored in sparse map 800. In some embodiments, a single lane of a road may be modeled by a three-dimensional polynomial description of left and right sides of the road. Such polynomials representing left and right sides of a single lane are shown in FIG. 9A. Regardless of how many lanes a road may have, the road may be represented using polynomials in a way similar to that illustrated in FIG. 9A. For example, left and right sides of a multi-lane road may be represented by polynomials similar to those shown in FIG. 9A, and intermediate lane markings included on a multi-lane road (e.g., dashed markings representing lane boundaries, solid yellow lines representing boundaries between lanes traveling in different directions, etc.) may also be represented using polynomials such as those shown in FIG. 9A.

As shown in FIG. 9A, a lane 900 may be represented using polynomials (e.g., a first order, second order, third order, or any suitable order polynomials). For illustration, lane 900 is shown as a two-dimensional lane and the polynomials are shown as two-dimensional polynomials. As depicted in FIG. 9A, lane 900 includes a left side 910 and a right side 920. In some embodiments, more than one polynomial may be used to represent a location of each side of the road or lane boundary. For example, each of left side 910 and right side 920 may be represented by a plurality of polynomials of any suitable length. In some cases, the polynomials may have a length of about 100 m, although other lengths greater than or less than 100 m may also be used. Additionally, the polynomials can overlap with one another in order to facilitate seamless transitions in navigating based on subsequently encountered polynomials as a host vehicle travels along a roadway. For example, each of left side 910 and right side 920 may be represented by a plurality of third order polynomials separated into segments of about 100 meters in length (an example of the first predetermined range), and overlapping each other by about 50 meters. The polynomials representing the left side 910 and the right side 920 may or may not have the same order. For example, in some embodiments, some polynomials may be second order polynomials, some may be third order polynomials, and some may be fourth order polynomials.

In the example shown in FIG. 9A, left side 910 of lane 900 is represented by two groups of third order polynomials. The first group includes polynomial segments 911, 912, and 913. The second group includes polynomial segments 914, 915, and 916. The two groups, while substantially parallel to each other, follow the locations of their respective sides of the road. Polynomial segments 911, 912, 913, 914, 915, and 916 have a length of about 100 meters and overlap adjacent segments in the series by about 50 meters. As noted previously, however, polynomials of different lengths and different overlap amounts may also be used. For example, the polynomials may have lengths of 500 m, 1 km, or more, and the overlap amount may vary from 0 to 50 m, 50 m to 100 m, or greater than 100 m. Additionally, while FIG. 9A is shown as representing polynomials extending in 2D space (e.g., on the surface of the paper), it is to be understood that these polynomials may represent curves extending in three dimensions (e.g., including a height component) to represent elevation changes in a road segment in addition to X-Y curvature. In the example shown in FIG. 9A, right side 920 of lane 900 is further represented by a first group having polynomial segments 921, 922, and 923 and a second group having polynomial segments 924, 925, and 926.

Returning to the target trajectories of sparse map 800, FIG. 9B shows a three-dimensional polynomial representing a target trajectory for a vehicle traveling along a particular road segment. The target trajectory represents not only the X-Y path that a host vehicle should travel along a particular road segment, but also the elevation change that the host vehicle will experience when traveling along the road segment. Thus, each target trajectory in sparse map 800 may be represented by one or more three-dimensional polynomials, like the three-dimensional polynomial 950 shown in FIG. 9B. Sparse map 800 may include a plurality of trajectories (e.g., millions or billions or more to represent trajectories of vehicles along various road segments along roadways throughout the world). In some embodiments, each target trajectory may correspond to a spline connecting three-dimensional polynomial segments.

Regarding the data footprint of polynomial curves stored in sparse map 800, in some embodiments, each third degree polynomial may be represented by four parameters, each requiring four bytes of data. Suitable representations may be obtained with third degree polynomials requiring about 192 bytes of data for every 100 m. This may translate to approximately 200 kB per hour in data usage/transfer requirements for a host vehicle traveling approximately 100 km/hr.

Sparse map 800 may describe the lanes network using a combination of geometry descriptors and meta-data. The geometry may be described by polynomials or splines as described above. The meta-data may describe the number of lanes, special characteristics (such as a car pool lane), and possibly other sparse labels. The total footprint of such indicators may be negligible.

Accordingly, a sparse map according to embodiments of the present disclosure may include at least one line representation of a road surface feature extending along the road segment, each line representation representing a path along the road segment substantially corresponding with the road surface feature. In some embodiments, as discussed above, the at least one line representation of the road surface feature may include a spline, a polynomial representation, or a curve. Furthermore, in some embodiments, the road surface feature may include at least one of a road edge or a lane marking. Moreover, as discussed below with respect to “crowdsourcing,” the road surface feature may be identified through image analysis of a plurality of images acquired as one or more vehicles traverse the road segment.

As previously noted, sparse map 800 may include a plurality of predetermined landmarks associated with a road segment. Rather than storing actual images of the landmarks and relying, for example, on image recognition analysis based on captured images and stored images, each landmark in sparse map 800 may be represented and recognized using less data than a stored, actual image would require. Data representing landmarks may still include sufficient information for describing or identifying the landmarks along a road. Storing data describing characteristics of landmarks, rather than the actual images of landmarks, may reduce the size of sparse map 800.

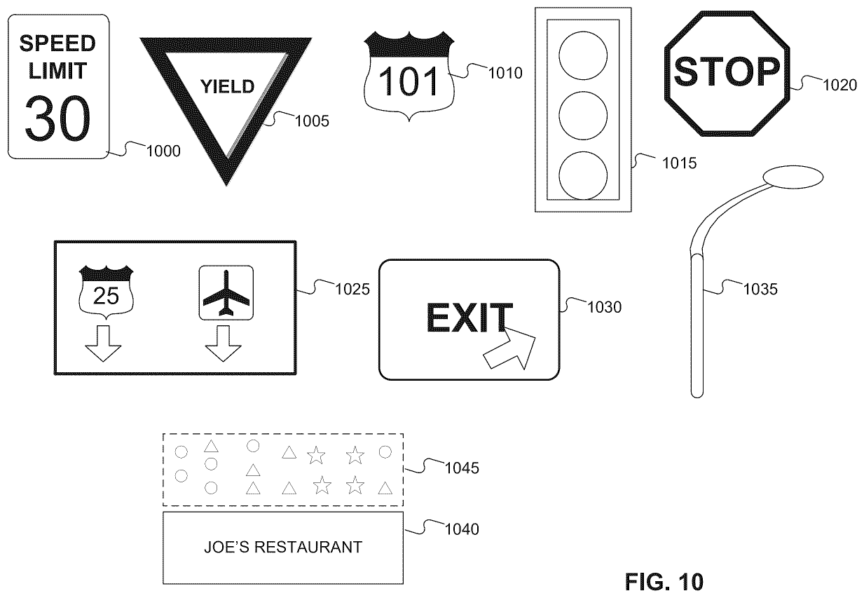

FIG. 10 illustrates examples of types of landmarks that may be represented in sparse map 800. The landmarks may include any visible and identifiable objects along a road segment. The landmarks may be selected such that they are fixed and do not change often with respect to their locations and/or content. The landmarks included in sparse map 800 may be useful in determining a location of vehicle 200 with respect to a target trajectory as the vehicle traverses a particular road segment. Examples of landmarks may include traffic signs, directional signs, general signs (e.g., rectangular signs), roadside fixtures (e.g., lampposts, reflectors, etc.), and any other suitable category. In some embodiments, lane marks on the road, may also be included as landmarks in sparse map 800.

Examples of landmarks shown in FIG. 10 include traffic signs, directional signs, roadside fixtures, and general signs. Traffic signs may include, for example, speed limit signs (e.g., speed limit sign 1000), yield signs (e.g., yield sign 1005), route number signs (e.g., route number sign 1010), traffic light signs (e.g., traffic light sign 1015), stop signs (e.g., stop sign 1020). Directional signs may include a sign that includes one or more arrows indicating one or more directions to different places. For example, directional signs may include a highway sign 1025 having arrows for directing vehicles to different roads or places, an exit sign 1030 having an arrow directing vehicles off a road, etc. Accordingly, at least one of the plurality of landmarks may include a road sign.

General signs may be unrelated to traffic. For example, general signs may include billboards used for advertisement, or a welcome board adjacent a border between two countries, states, counties, cities, or towns. FIG. 10 shows a general sign 1040 (“Joe's Restaurant”). Although general sign 1040 may have a rectangular shape, as shown in FIG. 10, general sign 1040 may have other shapes, such as square, circle, triangle, etc.

Landmarks may also include roadside fixtures. Roadside fixtures may be objects that are not signs, and may not be related to traffic or directions. For example, roadside fixtures may include lampposts (e.g., lamppost 1035), power line posts, traffic light posts, etc.

Landmarks may also include beacons that may be specifically designed for usage in an autonomous vehicle navigation system. For example, such beacons may include stand-alone structures placed at predetermined intervals to aid in navigating a host vehicle. Such beacons may also include visual/graphical information added to existing road signs (e.g., icons, emblems, bar codes, etc.) that may be identified or recognized by a vehicle traveling along a road segment. Such beacons may also include electronic components. In such embodiments, electronic beacons (e.g., RFID tags, etc.) may be used to transmit non-visual information to a host vehicle. Such information may include, for example, landmark identification and/or landmark location information that a host vehicle may use in determining its position along a target trajectory.

In some embodiments, the landmarks included in sparse map 800 may be represented by a data object of a predetermined size. The data representing a landmark may include any suitable parameters for identifying a particular landmark. For example, in some embodiments, landmarks stored in sparse map 800 may include parameters such as a physical size of the landmark (e.g., to support estimation of distance to the landmark based on a known size/scale), a distance to a previous landmark, lateral offset, height, a type code (e.g., a landmark type—what type of directional sign, traffic sign, etc.), a GPS coordinate (e.g., to support global localization), and any other suitable parameters. Each parameter may be associated with a data size. For example, a landmark size may be stored using 8 bytes of data. A distance to a previous landmark, a lateral offset, and height may be specified using 12 bytes of data. A type code associated with a landmark such as a directional sign or a traffic sign may require about 2 bytes of data. For general signs, an image signature enabling identification of the general sign may be stored using 50 bytes of data storage. The landmark GPS position may be associated with 16 bytes of data storage. These data sizes for each parameter are examples only, and other data sizes may also be used. Representing landmarks in sparse map 800 in this manner may offer a lean solution for efficiently representing landmarks in the database. In some embodiments, objects may be referred to as standard semantic objects or non-standard semantic objects. A standard semantic object may include any class of object for which there's a standardized set of characteristics (e.g., speed limit signs, warning signs, directional signs, traffic lights, etc. having known dimensions or other characteristics). A non-standard semantic object may include any object that is not associated with a standardized set of characteristics (e.g., general advertising signs, signs identifying business establishments, potholes, trees, etc. that may have variable dimensions). Each non-standard semantic object may be represented with 38 bytes of data (e.g., 8 bytes for size; 12 bytes for distance to previous landmark, lateral offset, and height; 2 bytes for a type code; and 16 bytes for position coordinates). Standard semantic objects may be represented using even less data, as size information may not be needed by the mapping server to fully represent the object in the sparse map.

Sparse map 800 may use a tag system to represent landmark types. In some cases, each traffic sign or directional sign may be associated with its own tag, which may be stored in the database as part of the landmark identification. For example, the database may include on the order of 1000 different tags to represent various traffic signs and on the order of about 10000 different tags to represent directional signs. Of course, any suitable number of tags may be used, and additional tags may be created as needed. General purpose signs may be represented in some embodiments using less than about 100 bytes (e.g., about 86 bytes including 8 bytes for size; 12 bytes for distance to previous landmark, lateral offset, and height; 50 bytes for an image signature; and 16 bytes for GPS coordinates).

Thus, for semantic road signs not requiring an image signature, the data density impact to sparse map 800, even at relatively high landmark densities of about 1 per 50 m, may be on the order of about 760 bytes per kilometer (e.g., 20 landmarks per km×38 bytes per landmark=760 bytes). Even for general purpose signs including an image signature component, the data density impact is about 1.72 kB per km (e.g., 20 landmarks per km×86 bytes per landmark=1,720 bytes). For semantic road signs, this equates to about 76 kB per hour of data usage for a vehicle traveling 100 km/hr. For general purpose signs, this equates to about 170 kB per hour for a vehicle traveling 100 km/hr. It should be noted that in some environments (e.g., urban environments) there may be a much higher density of detected objects available for inclusion in the sparse map (perhaps more than one per meter). In some embodiments, a generally rectangular object, such as a rectangular sign, may be represented in sparse map 800 by no more than 100 bytes of data. The representation of the generally rectangular object (e.g., general sign 1040) in sparse map 800 may include a condensed image signature or image hash (e.g., condensed image signature 1045) associated with the generally rectangular object. This condensed image signature/image hash may be determined using any suitable image hashing algorithm and may be used, for example, to aid in identification of a general purpose sign, for example, as a recognized landmark. Such a condensed image signature (e.g., image information derived from actual image data representing an object) may avoid a need for storage of an actual image of an object or a need for comparative image analysis performed on actual images in order to recognize landmarks.

Referring to FIG. 10, sparse map 800 may include or store a condensed image signature 1045 associated with a general sign 1040, rather than an actual image of general sign 1040. For example, after an image capture device (e.g., image capture device 122, 124, or 126) captures an image of general sign 1040, a processor (e.g., image processor 190 or any other processor that can process images either aboard or remotely located relative to a host vehicle) may perform an image analysis to extract/create condensed image signature 1045 that includes a unique signature or pattern associated with general sign 1040. In one embodiment, condensed image signature 1045 may include a shape, color pattern, a brightness pattern, or any other feature that may be extracted from the image of general sign 1040 for describing general sign 1040.

For example, in FIG. 10, the circles, triangles, and stars shown in condensed image signature 1045 may represent areas of different colors. The pattern represented by the circles, triangles, and stars may be stored in sparse map 800, e.g., within the 50 bytes designated to include an image signature. Notably, the circles, triangles, and stars are not necessarily meant to indicate that such shapes are stored as part of the image signature. Rather, these shapes are meant to conceptually represent recognizable areas having discernible color differences, textual areas, graphical shapes, or other variations in characteristics that may be associated with a general purpose sign. Such condensed image signatures can be used to identify a landmark in the form of a general sign. For example, the condensed image signature can be used to perform a same-not-same analysis based on a comparison of a stored condensed image signature with image data captured, for example, using a camera onboard an autonomous vehicle.

Accordingly, the plurality of landmarks may be identified through image analysis of the plurality of images acquired as one or more vehicles traverse the road segment. As explained below with respect to “crowdsourcing,” in some embodiments, the image analysis to identify the plurality of landmarks may include accepting potential landmarks when a ratio of images in which the landmark does appear to images in which the landmark does not appear exceeds a threshold. Furthermore, in some embodiments, the image analysis to identify the plurality of landmarks may include rejecting potential landmarks when a ratio of images in which the landmark does not appear to images in which the landmark does appear exceeds a threshold.

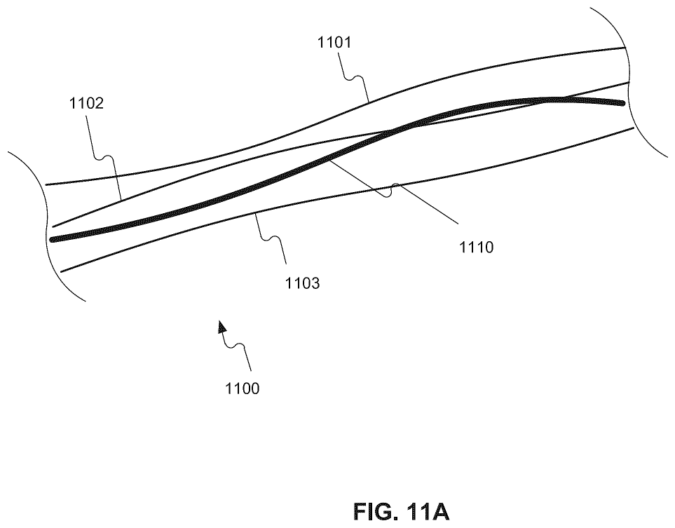

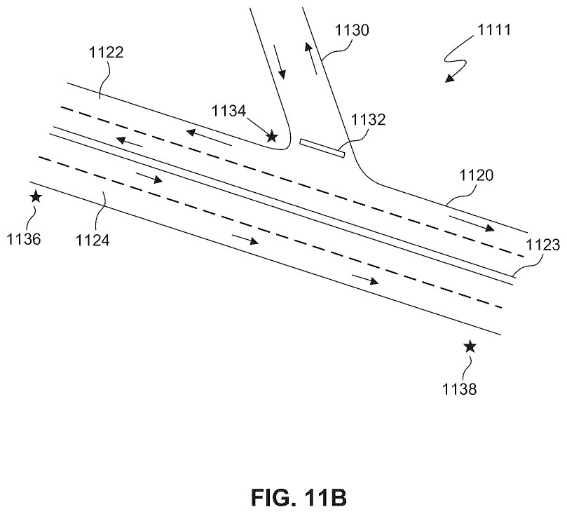

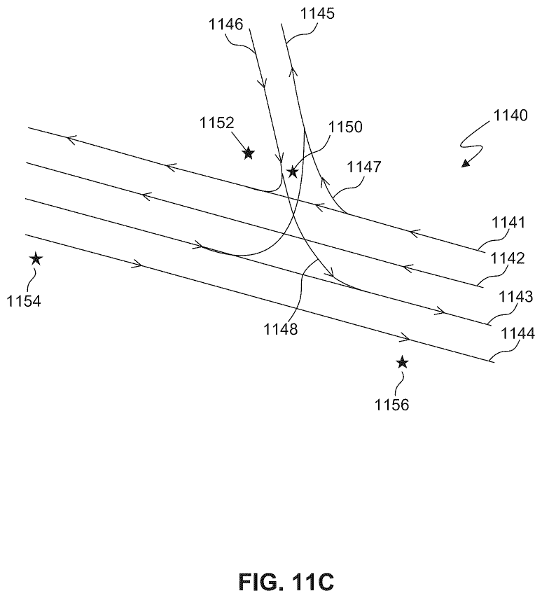

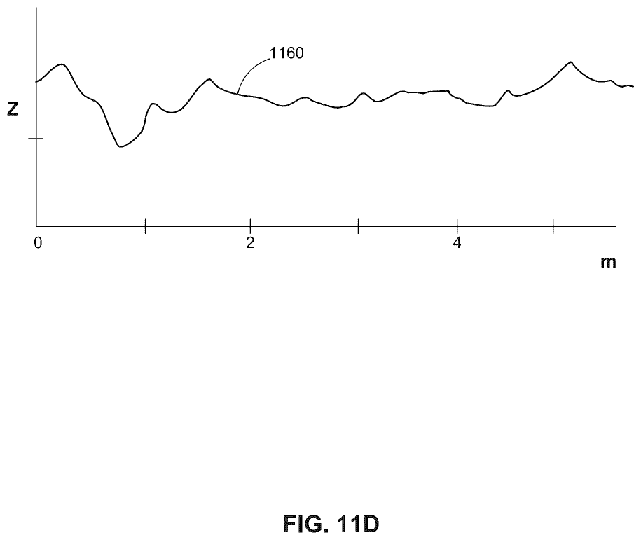

Returning to the target trajectories a host vehicle may use to navigate a particular road segment, FIG. 11A shows polynomial representations trajectories capturing during a process of building or maintaining sparse map 800. A polynomial representation of a target trajectory included in sparse map 800 may be determined based on two or more reconstructed trajectories of prior traversals of vehicles along the same road segment. In some embodiments, the polynomial representation of the target trajectory included in sparse map 800 may be an aggregation of two or more reconstructed trajectories of prior traversals of vehicles along the same road segment. In some embodiments, the polynomial representation of the target trajectory included in sparse map 800 may be an average of the two or more reconstructed trajectories of prior traversals of vehicles along the same road segment. Other mathematical operations may also be used to construct a target trajectory along a road path based on reconstructed trajectories collected from vehicles traversing along a road segment.

As shown in FIG. 11A, a road segment 1100 may be travelled by a number of vehicles 200 at different times. Each vehicle 200 may collect data relating to a path that the vehicle took along the road segment. The path traveled by a particular vehicle may be determined based on camera data, accelerometer information, speed sensor information, and/or GPS information, among other potential sources. Such data may be used to reconstruct trajectories of vehicles traveling along the road segment, and based on these reconstructed trajectories, a target trajectory (or multiple target trajectories) may be determined for the particular road segment. Such target trajectories may represent a preferred path of a host vehicle (e.g., guided by an autonomous navigation system) as the vehicle travels along the road segment.

In the example shown in FIG. 11A, a first reconstructed trajectory 1101 may be determined based on data received from a first vehicle traversing road segment 1100 at a first time period (e.g., day 1), a second reconstructed trajectory 1102 may be obtained from a second vehicle traversing road segment 1100 at a second time period (e.g., day 2), and a third reconstructed trajectory 1103 may be obtained from a third vehicle traversing road segment 1100 at a third time period (e.g., day 3). Each trajectory 1101, 1102, and 1103 may be represented by a polynomial, such as a three-dimensional polynomial. It should be noted that in some embodiments, any of the reconstructed trajectories may be assembled onboard the vehicles traversing road segment 1100.

Additionally, or alternatively, such reconstructed trajectories may be determined on a server side based on information received from vehicles traversing road segment 1100. For example, in some embodiments, vehicles 200 may transmit data to one or more servers relating to their motion along road segment 1100 (e.g., steering angle, heading, time, position, speed, sensed road geometry, and/or sensed landmarks, among things). The server may reconstruct trajectories for vehicles 200 based on the received data. The server may also generate a target trajectory for guiding navigation of autonomous vehicle that will travel along the same road segment 1100 at a later time based on the first, second, and third trajectories 1101, 1102, and 1103. While a target trajectory may be associated with a single prior traversal of a road segment, in some embodiments, each target trajectory included in sparse map 800 may be determined based on two or more reconstructed trajectories of vehicles traversing the same road segment. In FIG. 11A, the target trajectory is represented by 1110. In some embodiments, the target trajectory 1110 may be generated based on an average of the first, second, and third trajectories 1101, 1102, and 1103. In some embodiments, the target trajectory 1110 included in sparse map 800 may be an aggregation (e.g., a weighted combination) of two or more reconstructed trajectories.

At the mapping server, the server may receive actual trajectories for a particular road segment from multiple harvesting vehicles traversing the road segment. To generate a target trajectory for each valid path along the road segment (e.g., each lane, each drive direction, each path through a junction, etc.), the received actual trajectories may be aligned. The alignment process may include using detected objects/features identified along the road segment along with harvested positions of those detected objects/features to correlate the actual, harvested trajectories with one another. Once aligned, an average or “best fit” target trajectory for each available lane, etc. may be determined based on the aggregated, correlated/aligned actual trajectories.

FIGS. 11B and 11C further illustrate the concept of target trajectories associated with road segments present within a geographic region 1111. As shown in FIG. 11B, a first road segment 1120 within geographic region 1111 may include a multilane road, which includes two lanes 1122 designated for vehicle travel in a first direction and two additional lanes 1124 designated for vehicle travel in a second direction opposite to the first direction. Lanes 1122 and lanes 1124 may be separated by a double yellow line 1123. Geographic region 1111 may also include a branching road segment 1130 that intersects with road segment 1120. Road segment 1130 may include a two-lane road, each lane being designated for a different direction of travel. Geographic region 1111 may also include other road features, such as a stop line 1132, a stop sign 1134, a speed limit sign 1136, and a hazard sign 1138.

As shown in FIG. 11C, sparse map 800 may include a local map 1140 including a road model for assisting with autonomous navigation of vehicles within geographic region 1111. For example, local map 1140 may include target trajectories for one or more lanes associated with road segments 1120 and/or 1130 within geographic region 1111. For example, local map 1140 may include target trajectories 1141 and/or 1142 that an autonomous vehicle may access or rely upon when traversing lanes 1122. Similarly, local map 1140 may include target trajectories 1143 and/or 1144 that an autonomous vehicle may access or rely upon when traversing lanes 1124. Further, local map 1140 may include target trajectories 1145 and/or 1146 that an autonomous vehicle may access or rely upon when traversing road segment 1130. Target trajectory 1147 represents a preferred path an autonomous vehicle should follow when transitioning from lanes 1120 (and specifically, relative to target trajectory 1141 associated with a right-most lane of lanes 1120) to road segment 1130 (and specifically, relative to a target trajectory 1145 associated with a first side of road segment 1130. Similarly, target trajectory 1148 represents a preferred path an autonomous vehicle should follow when transitioning from road segment 1130 (and specifically, relative to target trajectory 1146) to a portion of road segment 1124 (and specifically, as shown, relative to a target trajectory 1143 associated with a left lane of lanes 1124.

Sparse map 800 may also include representations of other road-related features associated with geographic region 1111. For example, sparse map 800 may also include representations of one or more landmarks identified in geographic region 1111. Such landmarks may include a first landmark 1150 associated with stop line 1132, a second landmark 1152 associated with stop sign 1134, a third landmark associated with speed limit sign 1154, and a fourth landmark 1156 associated with hazard sign 1138. Such landmarks may be used, for example, to assist an autonomous vehicle in determining its current location relative to any of the shown target trajectories, such that the vehicle may adjust its heading to match a direction of the target trajectory at the determined location.

In some embodiments, sparse map 800 may also include road signature profiles. Such road signature profiles may be associated with any discernible/measurable variation in at least one parameter associated with a road. For example, in some cases, such profiles may be associated with variations in road surface information such as variations in surface roughness of a particular road segment, variations in road width over a particular road segment, variations in distances between dashed lines painted along a particular road segment, variations in road curvature along a particular road segment, etc. FIG. 11D shows an example of a road signature profile 1160. While profile 1160 may represent any of the parameters mentioned above, or others, in one example, profile 1160 may represent a measure of road surface roughness, as obtained, for example, by monitoring one or more sensors providing outputs indicative of an amount of suspension displacement as a vehicle travels a particular road segment.

Alternatively or concurrently, profile 1160 may represent variation in road width, as determined based on image data obtained via a camera onboard a vehicle traveling a particular road segment. Such profiles may be useful, for example, in determining a particular location of an autonomous vehicle relative to a particular target trajectory. That is, as it traverses a road segment, an autonomous vehicle may measure a profile associated with one or more parameters associated with the road segment. If the measured profile can be correlated/matched with a predetermined profile that plots the parameter variation with respect to position along the road segment, then the measured and predetermined profiles may be used (e.g., by overlaying corresponding sections of the measured and predetermined profiles) in order to determine a current position along the road segment and, therefore, a current position relative to a target trajectory for the road segment.

In some embodiments, sparse map 800 may include different trajectories based on different characteristics associated with a user of autonomous vehicles, environmental conditions, and/or other parameters relating to driving. For example, in some embodiments, different trajectories may be generated based on different user preferences and/or profiles. Sparse map 800 including such different trajectories may be provided to different autonomous vehicles of different users. For example, some users may prefer to avoid toll roads, while others may prefer to take the shortest or fastest routes, regardless of whether there is a toll road on the route. The disclosed systems may generate different sparse maps with different trajectories based on such different user preferences or profiles. As another example, some users may prefer to travel in a fast moving lane, while others may prefer to maintain a position in the central lane at all times.

Different trajectories may be generated and included in sparse map 800 based on different environmental conditions, such as day and night, snow, rain, fog, etc. Autonomous vehicles driving under different environmental conditions may be provided with sparse map 800 generated based on such different environmental conditions. In some embodiments, cameras provided on autonomous vehicles may detect the environmental conditions, and may provide such information back to a server that generates and provides sparse maps. For example, the server may generate or update an already generated sparse map 800 to include trajectories that may be more suitable or safer for autonomous driving under the detected environmental conditions. The update of sparse map 800 based on environmental conditions may be performed dynamically as the autonomous vehicles are traveling along roads.

Other different parameters relating to driving may also be used as a basis for generating and providing different sparse maps to different autonomous vehicles. For example, when an autonomous vehicle is traveling at a high speed, turns may be tighter. Trajectories associated with specific lanes, rather than roads, may be included in sparse map 800 such that the autonomous vehicle may maintain within a specific lane as the vehicle follows a specific trajectory. When an image captured by a camera onboard the autonomous vehicle indicates that the vehicle has drifted outside of the lane (e.g., crossed the lane mark), an action may be triggered within the vehicle to bring the vehicle back to the designated lane according to the specific trajectory.

### Crowdsourcing a Sparse Map

The disclosed sparse maps may be efficiently (and passively) generated through the power of crowdsourcing. For example, any private or commercial vehicle equipped with a camera (e.g., a simple, low resolution camera regularly included as OEM equipment on today's vehicles) and an appropriate image analysis processor can serve as a harvesting vehicle. No special equipment (e.g., high definition imaging and/or positioning systems) are required. As a result of the disclosed crowdsourcing technique, the generated sparse maps may be extremely accurate and may include extremely refined position information (enabling navigation error limits of 10 cm or less) without requiring any specialized imaging or sensing equipment as input to the map generation process. Crowdsourcing also enables much more rapid (and inexpensive) updates to the generated maps, as new drive information is continuously available to the mapping server system from any roads traversed by private or commercial vehicles minimally equipped to also serve as harvesting vehicles. There is no need for designated vehicles equipped with high-definition imaging and mapping sensors. Therefore, the expense associated with building such specialized vehicles can be avoided. Further, updates to the presently disclosed sparse maps may be made much more rapidly than systems that rely upon dedicated, specialized mapping vehicles (which by virtue of their expense and special equipment are typically limited to a fleet of specialized vehicles of far lower numbers than the number of private or commercial vehicles already available for performing the disclosed harvesting techniques).

The disclosed sparse maps generated through crowdsourcing may be extremely accurate because they may be generated based on many inputs from multiple (10s, hundreds, millions, etc.) of harvesting vehicles that have collected drive information along a particular road segment. For example, every harvesting vehicle that drives along a particular road segment may record its actual trajectory and may determine position information relative to detected objects/features along the road segment. This information is passed along from multiple harvesting vehicles to a server. The actual trajectories are aggregated to generate a refined, target trajectory for each valid drive path along the road segment. Additionally, the position information collected from the multiple harvesting vehicles for each of the detected objects/features along the road segment (semantic or non-semantic) can also be aggregated. As a result, the mapped position of each detected object/feature may constitute an average of hundreds, thousands, or millions of individually determined positions for each detected object/feature. Such a technique may yield extremely accurate mapped positions for the detected objects/features.

In some embodiments, the disclosed systems and methods may generate a sparse map for autonomous vehicle navigation. For example, disclosed systems and methods may use crowdsourced data for generation of a sparse map that one or more autonomous vehicles may use to navigate along a system of roads. As used herein, “crowdsourcing” means that data are received from various vehicles (e.g., autonomous vehicles) travelling on a road segment at different times, and such data are used to generate and/or update the road model, including sparse map tiles. The model or any of its sparse map tiles may, in turn, be transmitted to the vehicles or other vehicles later travelling along the road segment for assisting autonomous vehicle navigation. The road model may include a plurality of target trajectories representing preferred trajectories that autonomous vehicles should follow as they traverse a road segment. The target trajectories may be the same as a reconstructed actual trajectory collected from a vehicle traversing a road segment, which may be transmitted from the vehicle to a server. In some embodiments, the target trajectories may be different from actual trajectories that one or more vehicles previously took when traversing a road segment. The target trajectories may be generated based on actual trajectories (e.g., through averaging or any other suitable operation).

The vehicle trajectory data that a vehicle may upload to a server may correspond with the actual reconstructed trajectory for the vehicle or may correspond to a recommended trajectory, which may be based on or related to the actual reconstructed trajectory of the vehicle, but may differ from the actual reconstructed trajectory. For example, vehicles may modify their actual, reconstructed trajectories and submit (e.g., recommend) to the server the modified actual trajectories. The road model may use the recommended, modified trajectories as target trajectories for autonomous navigation of other vehicles.

In addition to trajectory information, other information for potential use in building a sparse data map 800 may include information relating to potential landmark candidates. For example, through crowd sourcing of information, the disclosed systems and methods may identify potential landmarks in an environment and refine landmark positions. The landmarks may be used by a navigation system of autonomous vehicles to determine and/or adjust the position of the vehicle along the target trajectories.

The reconstructed trajectories that a vehicle may generate as the vehicle travels along a road may be obtained by any suitable method. In some embodiments, the reconstructed trajectories may be developed by stitching together segments of motion for the vehicle, using, e.g., ego motion estimation (e.g., three dimensional translation and three dimensional rotation of the camera, and hence the body of the vehicle). The rotation and translation estimation may be determined based on analysis of images captured by one or more image capture devices along with information from other sensors or devices, such as inertial sensors and speed sensors. For example, the inertial sensors may include an accelerometer or other suitable sensors configured to measure changes in translation and/or rotation of the vehicle body. The vehicle may include a speed sensor that measures a speed of the vehicle.

In some embodiments, the ego motion of the camera (and hence the vehicle body) may be estimated based on an optical flow analysis of the captured images. An optical flow analysis of a sequence of images identifies movement of pixels from the sequence of images, and based on the identified movement, determines motions of the vehicle. The ego motion may be integrated over time and along the road segment to reconstruct a trajectory associated with the road segment that the vehicle has followed.

Data (e.g., reconstructed trajectories) collected by multiple vehicles in multiple drives along a road segment at different times may be used to construct the road model (e.g., including the target trajectories, etc.) included in sparse data map 800. Data collected by multiple vehicles in multiple drives along a road segment at different times may also be averaged to increase an accuracy of the model. In some embodiments, data regarding the road geometry and/or landmarks may be received from multiple vehicles that travel through the common road segment at different times. Such data received from different vehicles may be combined to generate the road model and/or to update the road model.

The geometry of a reconstructed trajectory (and also a target trajectory) along a road segment may be represented by a curve in three dimensional space, which may be a spline connecting three dimensional polynomials. The reconstructed trajectory curve may be determined from analysis of a video stream or a plurality of images captured by a camera installed on the vehicle. In some embodiments, a location is identified in each frame or image that is a few meters ahead of the current position of the vehicle. This location is where the vehicle is expected to travel to in a predetermined time period. This operation may be repeated frame by frame, and at the same time, the vehicle may compute the camera's ego motion (rotation and translation). At each frame or image, a short range model for the desired path is generated by the vehicle in a reference frame that is attached to the camera. The short range models may be stitched together to obtain a three dimensional model of the road in some coordinate frame, which may be an arbitrary or predetermined coordinate frame. The three dimensional model of the road may then be fitted by a spline, which may include or connect one or more polynomials of suitable orders.

To conclude the short range road model at each frame, one or more detection modules may be used. For example, a bottom-up lane detection module may be used. The bottom-up lane detection module may be useful when lane marks are drawn on the road. This module may look for edges in the image and assembles them together to form the lane marks. A second module may be used together with the bottom-up lane detection module. The second module is an end-to-end deep neural network, which may be trained to predict the correct short range path from an input image. In both modules, the road model may be detected in the image coordinate frame and transformed to a three dimensional space that may be virtually attached to the camera.

Although the reconstructed trajectory modeling method may introduce an accumulation of errors due to the integration of ego motion over a long period of time, which may include a noise component, such errors may be inconsequential as the generated model may provide sufficient accuracy for navigation over a local scale. In addition, it is possible to cancel the integrated error by using external sources of information, such as satellite images or geodetic measurements. For example, the disclosed systems and methods may use a GNSS receiver to cancel accumulated errors. However, the GNSS positioning signals may not be always available and accurate. The disclosed systems and methods may enable a steering application that depends weakly on the availability and accuracy of GNSS positioning. In such systems, the usage of the GNSS signals may be limited. For example, in some embodiments, the disclosed systems may use the GNSS signals for database indexing purposes only.

In some embodiments, the range scale (e.g., local scale) that may be relevant for an autonomous vehicle navigation steering application may be on the order of 50 meters, 100 meters, 200 meters, 300 meters, etc. Such distances may be used, as the geometrical road model is mainly used for two purposes: planning the trajectory ahead and localizing the vehicle on the road model. In some embodiments, the planning task may use the model over a typical range of 40 meters ahead (or any other suitable distance ahead, such as 20 meters, 30 meters, 50 meters), when the control algorithm steers the vehicle according to a target point located 1.3 seconds ahead (or any other time such as 1.5 seconds, 1.7 seconds, 2 seconds, etc.). The localization task uses the road model over a typical range of 60 meters behind the car (or any other suitable distances, such as 50 meters, 100 meters, 150 meters, etc.), according to a method called “tail alignment” described in more detail in another section. The disclosed systems and methods may generate a geometrical model that has sufficient accuracy over particular range, such as 100 meters, such that a planned trajectory will not deviate by more than, for example, 30 cm from the lane center.

As explained above, a three dimensional road model may be constructed from detecting short range sections and stitching them together. The stitching may be enabled by computing a six degree ego motion model, using the videos and/or images captured by the camera, data from the inertial sensors that reflect the motions of the vehicle, and the host vehicle velocity signal. The accumulated error may be small enough over some local range scale, such as of the order of 100 meters. All this may be completed in a single drive over a particular road segment.

In some embodiments, multiple drives may be used to average the resulted model, and to increase its accuracy further. The same car may travel the same route multiple times, or multiple cars may send their collected model data to a central server. In any case, a matching procedure may be performed to identify overlapping models and to enable averaging in order to generate target trajectories. The constructed model (e.g., including the target trajectories) may be used for steering once a convergence criterion is met. Subsequent drives may be used for further model improvements and in order to accommodate infrastructure changes.

Sharing of driving experience (such as sensed data) between multiple cars becomes feasible if they are connected to a central server. Each vehicle client may store a partial copy of a universal road model, which may be relevant for its current position. A bidirectional update procedure between the vehicles and the server may be performed by the vehicles and the server. The small footprint concept discussed above enables the disclosed systems and methods to perform the bidirectional updates using a very small bandwidth.

Information relating to potential landmarks may also be determined and forwarded to a central server. For example, the disclosed systems and methods may determine one or more physical properties of a potential landmark based on one or more images that include the landmark. The physical properties may include a physical size (e.g., height, width) of the landmark, a distance from a vehicle to a landmark, a distance between the landmark to a previous landmark, the lateral position of the landmark (e.g., the position of the landmark relative to the lane of travel), the GPS coordinates of the landmark, a type of landmark, identification of text on the landmark, etc. For example, a vehicle may analyze one or more images captured by a camera to detect a potential landmark, such as a speed limit sign.

The vehicle may determine a distance from the vehicle to the landmark or a position associated with the landmark (e.g., any semantic or non-semantic object or feature along a road segment) based on the analysis of the one or more images. In some embodiments, the distance may be determined based on analysis of images of the landmark using a suitable image analysis method, such as a scaling method and/or an optical flow method. As previously noted, a position of the object/feature may include a 2D image position (e.g., an X-Y pixel position in one or more captured images) of one or more points associated with the object/feature or may include a 3D real-world position of one or more points (e.g., determined through structure in motion/optical flow techniques, LIDAR or RADAR information, etc.). In some embodiments, the disclosed systems and methods may be configured to determine a type or classification of a potential landmark. In case the vehicle determines that a certain potential landmark corresponds to a predetermined type or classification stored in a sparse map, it may be sufficient for the vehicle to communicate to the server an indication of the type or classification of the landmark, along with its location. The server may store such indications. At a later time, during navigation, a navigating vehicle may capture an image that includes a representation of the landmark, process the image (e.g., using a classifier), and compare the result landmark in order to confirm detection of the mapped landmark and to use the mapped landmark in localizing the navigating vehicle relative to the sparse map.

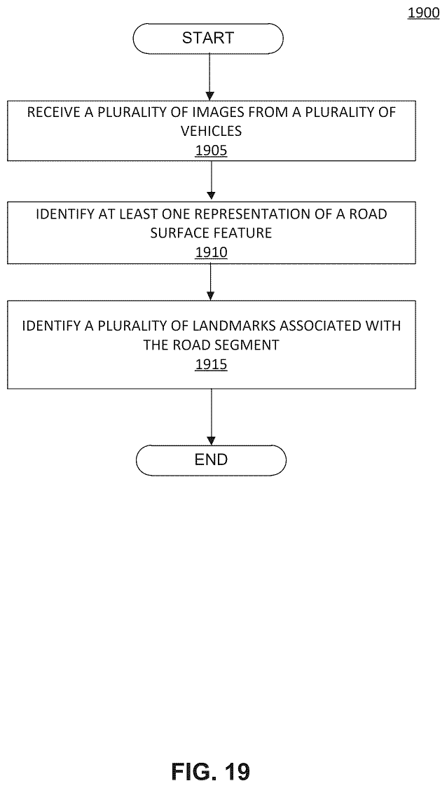

In some embodiments, multiple autonomous vehicles travelling on a road segment may communicate with a server. The vehicles (or clients) may generate a curve describing its drive (e.g., through ego motion integration) in an arbitrary coordinate frame. The vehicles may detect landmarks and locate them in the same frame. The vehicles may upload the curve and the landmarks to the server. The server may collect data from vehicles over multiple drives, and generate a unified road model. For example, as discussed below with respect to FIG. 19, the server may generate a sparse map having the unified road model using the uploaded curves and landmarks.

The server may also distribute the model to clients (e.g., vehicles). For example, the server may distribute the sparse map to one or more vehicles. The server may continuously or periodically update the model when receiving new data from the vehicles. For example, the server may process the new data to evaluate whether the data includes information that should trigger an updated, or creation of new data on the server. The server may distribute the updated model or the updates to the vehicles for providing autonomous vehicle navigation.

The server may use one or more criteria for determining whether new data received from the vehicles should trigger an update to the model or trigger creation of new data. For example, when the new data indicates that a previously recognized landmark at a specific location no longer exists, or is replaced by another landmark, the server may determine that the new data should trigger an update to the model. As another example, when the new data indicates that a road segment has been closed, and when this has been corroborated by data received from other vehicles, the server may determine that the new data should trigger an update to the model.

The server may distribute the updated model (or the updated portion of the model) to one or more vehicles that are traveling on the road segment, with which the updates to the model are associated. The server may also distribute the updated model to vehicles that are about to travel on the road segment, or vehicles whose planned trip includes the road segment, with which the updates to the model are associated. For example, while an autonomous vehicle is traveling along another road segment before reaching the road segment with which an update is associated, the server may distribute the updates or updated model to the autonomous vehicle before the vehicle reaches the road segment.

In some embodiments, the remote server may collect trajectories and landmarks from multiple clients (e.g., vehicles that travel along a common road segment). The server may match curves using landmarks and create an average road model based on the trajectories collected from the multiple vehicles. The server may also compute a graph of roads and the most probable path at each node or conjunction of the road segment. For example, the remote server may align the trajectories to generate a crowdsourced sparse map from the collected trajectories.

The server may average landmark properties received from multiple vehicles that travelled along the common road segment, such as the distances between one landmark to another (e.g., a previous one along the road segment) as measured by multiple vehicles, to determine an arc-length parameter and support localization along the path and speed calibration for each client vehicle. The server may average the physical dimensions of a landmark measured by multiple vehicles travelled along the common road segment and recognized the same landmark. The averaged physical dimensions may be used to support distance estimation, such as the distance from the vehicle to the landmark. The server may average lateral positions of a landmark (e.g., position from the lane in which vehicles are travelling in to the landmark) measured by multiple vehicles travelled along the common road segment and recognized the same landmark. The averaged lateral potion may be used to support lane assignment. The server may average the GPS coordinates of the landmark measured by multiple vehicles travelled along the same road segment and recognized the same landmark. The averaged GPS coordinates of the landmark may be used to support global localization or positioning of the landmark in the road model.

In some embodiments, the server may identify model changes, such as constructions, detours, new signs, removal of signs, etc., based on data received from the vehicles. The server may continuously or periodically or instantaneously update the model upon receiving new data from the vehicles. The server may distribute updates to the model or the updated model to vehicles for providing autonomous navigation. For example, as discussed further below, the server may use crowdsourced data to filter out “ghost” landmarks detected by vehicles.

In some embodiments, the server may analyze driver interventions during the autonomous driving. The server may analyze data received from the vehicle at the time and location where intervention occurs, and/or data received prior to the time the intervention occurred. The server may identify certain portions of the data that caused or are closely related to the intervention, for example, data indicating a temporary lane closure setup, data indicating a pedestrian in the road. The server may update the model based on the identified data. For example, the server may modify one or more trajectories stored in the model.

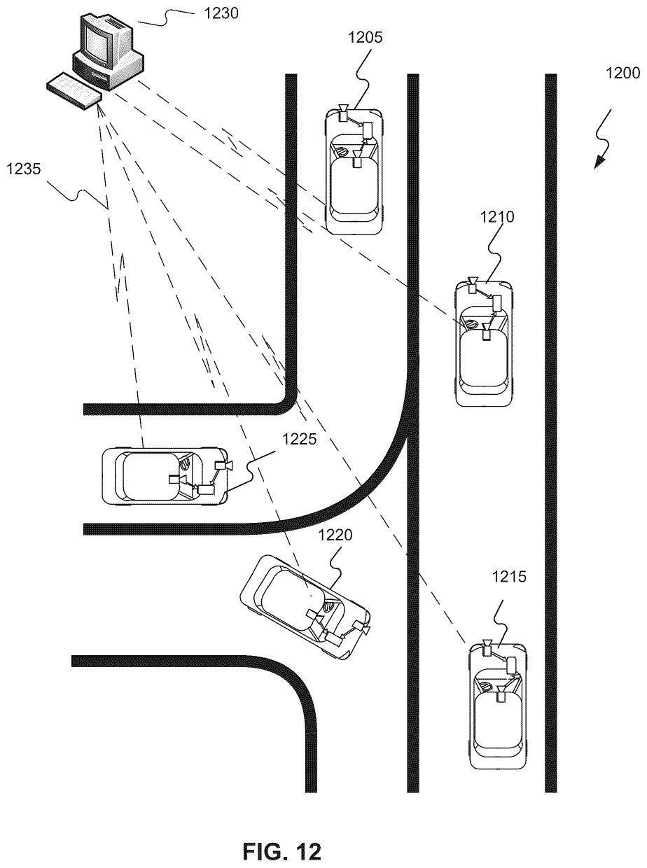

FIG. 12 is a schematic illustration of a system that uses crowdsourcing to generate a sparse map (as well as distribute and navigate using a crowdsourced sparse map). FIG. 12 shows a road segment 1200 that includes one or more lanes. A plurality of vehicles 1205, 1210, 1215, 1220, and 1225 may travel on road segment 1200 at the same time or at different times (although shown as appearing on road segment 1200 at the same time in FIG. 12). At least one of vehicles 1205, 1210, 1215, 1220, and 1225 may be an autonomous vehicle. For simplicity of the present example, all of the vehicles 1205, 1210, 1215, 1220, and 1225 are presumed to be autonomous vehicles.

Each vehicle may be similar to vehicles disclosed in other embodiments (e.g., vehicle 200), and may include components or devices included in or associated with vehicles disclosed in other embodiments. Each vehicle may be equipped with an image capture device or camera (e.g., image capture device 122 or camera 122). Each vehicle may communicate with a remote server 1230 via one or more networks (e.g., over a cellular network and/or the Internet, etc.) through wireless communication paths 1235, as indicated by the dashed lines. Each vehicle may transmit data to server 1230 and receive data from server 1230. For example, server 1230 may collect data from multiple vehicles travelling on the road segment 1200 at different times, and may process the collected data to generate an autonomous vehicle road navigation model, or an update to the model. Server 1230 may transmit the autonomous vehicle road navigation model or the update to the model to the vehicles that transmitted data to server 1230. Server 1230 may transmit the autonomous vehicle road navigation model or the update to the model to other vehicles that travel on road segment 1200 at later times.

As vehicles 1205, 1210, 1215, 1220, and 1225 travel on road segment 1200, navigation information collected (e.g., detected, sensed, or measured) by vehicles 1205, 1210, 1215, 1220, and 1225 may be transmitted to server 1230. In some embodiments, the navigation information may be associated with the common road segment 1200. The navigation information may include a trajectory associated with each of the vehicles 1205, 1210, 1215, 1220, and 1225 as each vehicle travels over road segment 1200. In some embodiments, the trajectory may be reconstructed based on data sensed by various sensors and devices provided on vehicle 1205. For example, the trajectory may be reconstructed based on at least one of accelerometer data, speed data, landmarks data, road geometry or profile data, vehicle positioning data, and ego motion data. In some embodiments, the trajectory may be reconstructed based on data from inertial sensors, such as accelerometer, and the velocity of vehicle 1205 sensed by a speed sensor. In addition, in some embodiments, the trajectory may be determined (e.g., by a processor onboard each of vehicles 1205, 1210, 1215, 1220, and 1225) based on sensed ego motion of the camera, which may indicate three dimensional translation and/or three dimensional rotations (or rotational motions). The ego motion of the camera (and hence the vehicle body) may be determined from analysis of one or more images captured by the camera.

In some embodiments, the trajectory of vehicle 1205 may be determined by a processor provided aboard vehicle 1205 and transmitted to server 1230. In other embodiments, server 1230 may receive data sensed by the various sensors and devices provided in vehicle 1205, and determine the trajectory based on the data received from vehicle 1205.

In some embodiments, the navigation information transmitted from vehicles 1205, 1210, 1215, 1220, and 1225 to server 1230 may include data regarding the road surface, the road geometry, or the road profile. The geometry of road segment 1200 may include lane structure and/or landmarks. The lane structure may include the total number of lanes of road segment 1200, the type of lanes (e.g., one-way lane, two-way lane, driving lane, passing lane, etc.), markings on lanes, width of lanes, etc. In some embodiments, the navigation information may include a lane assignment, e.g., which lane of a plurality of lanes a vehicle is traveling in. For example, the lane assignment may be associated with a numerical value “3” indicating that the vehicle is traveling on the third lane from the left or right. As another example, the lane assignment may be associated with a text value “center lane” indicating the vehicle is traveling on the center lane.

Server 1230 may store the navigation information on a non-transitory computer-readable medium, such as a hard drive, a compact disc, a tape, a memory, etc. Server 1230 may generate (e.g., through a processor included in server 1230) at least a portion of an autonomous vehicle road navigation model for the common road segment 1200 based on the navigation information received from the plurality of vehicles 1205, 1210, 1215, 1220, and 1225 and may store the model as a portion of a sparse map. Server 1230 may determine a trajectory associated with each lane based on crowdsourced data (e.g., navigation information) received from multiple vehicles (e.g., 1205, 1210, 1215, 1220, and 1225) that travel on a lane of road segment at different times. Server 1230 may generate the autonomous vehicle road navigation model or a portion of the model (e.g., an updated portion) based on a plurality of trajectories determined based on the crowd sourced navigation data. Server 1230 may transmit the model or the updated portion of the model to one or more of autonomous vehicles 1205, 1210, 1215, 1220, and 1225 traveling on road segment 1200 or any other autonomous vehicles that travel on road segment at a later time for updating an existing autonomous vehicle road navigation model provided in a navigation system of the vehicles. The autonomous vehicle road navigation model may be used by the autonomous vehicles in autonomously navigating along the common road segment 1200.

As explained above, the autonomous vehicle road navigation model may be included in a sparse map (e.g., sparse map 800 depicted in FIG. 8). Sparse map 800 may include sparse recording of data related to road geometry and/or landmarks along a road, which may provide sufficient information for guiding autonomous navigation of an autonomous vehicle, yet does not require excessive data storage. In some embodiments, the autonomous vehicle road navigation model may be stored separately from sparse map 800, and may use map data from sparse map 800 when the model is executed for navigation. In some embodiments, the autonomous vehicle road navigation model may use map data included in sparse map 800 for determining target trajectories along road segment 1200 for guiding autonomous navigation of autonomous vehicles 1205, 1210, 1215, 1220, and 1225 or other vehicles that later travel along road segment 1200. For example, when the autonomous vehicle road navigation model is executed by a processor included in a navigation system of vehicle 1205, the model may cause the processor to compare the trajectories determined based on the navigation information received from vehicle 1205 with predetermined trajectories included in sparse map 800 to validate and/or correct the current traveling course of vehicle 1205.

In the autonomous vehicle road navigation model, the geometry of a road feature or target trajectory may be encoded by a curve in a three-dimensional space. In one embodiment, the curve may be a three dimensional spline including one or more connecting three dimensional polynomials. As one of skill in the art would understand, a spline may be a numerical function that is piece-wise defined by a series of polynomials for fitting data. A spline for fitting the three dimensional geometry data of the road may include a linear spline (first order), a quadratic spline (second order), a cubic spline (third order), or any other splines (other orders), or a combination thereof. The spline may include one or more three dimensional polynomials of different orders connecting (e.g., fitting) data points of the three dimensional geometry data of the road. In some embodiments, the autonomous vehicle road navigation model may include a three dimensional spline corresponding to a target trajectory along a common road segment (e.g., road segment 1200) or a lane of the road segment 1200.

As explained above, the autonomous vehicle road navigation model included in the sparse map may include other information, such as identification of at least one landmark along road segment 1200. The landmark may be visible within a field of view of a camera (e.g., camera 122) installed on each of vehicles 1205, 1210, 1215, 1220, and 1225. In some embodiments, camera 122 may capture an image of a landmark. A processor (e.g., processor 180, 190, or processing unit 110) provided on vehicle 1205 may process the image of the landmark to extract identification information for the landmark. The landmark identification information, rather than an actual image of the landmark, may be stored in sparse map 800. The landmark identification information may require much less storage space than an actual image. Other sensors or systems (e.g., GPS system) may also provide certain identification information of the landmark (e.g., position of landmark). The landmark may include at least one of a traffic sign, an arrow marking, a lane marking, a dashed lane marking, a traffic light, a stop line, a directional sign (e.g., a highway exit sign with an arrow indicating a direction, a highway sign with arrows pointing to different directions or places), a landmark beacon, or a lamppost. A landmark beacon refers to a device (e.g., an RFID device) installed along a road segment that transmits or reflects a signal to a receiver installed on a vehicle, such that when the vehicle passes by the device, the beacon received by the vehicle and the location of the device (e.g., determined from GPS location of the device) may be used as a landmark to be included in the autonomous vehicle road navigation model and/or the sparse map 800.

The identification of at least one landmark may include a position of the at least one landmark. The position of the landmark may be determined based on position measurements performed using sensor systems (e.g., Global Positioning Systems, inertial based positioning systems, landmark beacon, etc.) associated with the plurality of vehicles 1205, 1210, 1215, 1220, and 1225. In some embodiments, the position of the landmark may be determined by averaging the position measurements detected, collected, or received by sensor systems on different vehicles 1205, 1210, 1215, 1220, and 1225 through multiple drives. For example, vehicles 1205, 1210, 1215, 1220, and 1225 may transmit position measurements data to server 1230, which may average the position measurements and use the averaged position measurement as the position of the landmark. The position of the landmark may be continuously refined by measurements received from vehicles in subsequent drives.

The identification of the landmark may include a size of the landmark. The processor provided on a vehicle (e.g., 1205) may estimate the physical size of the landmark based on the analysis of the images. Server 1230 may receive multiple estimates of the physical size of the same landmark from different vehicles over different drives. Server 1230 may average the different estimates to arrive at a physical size for the landmark, and store that landmark size in the road model. The physical size estimate may be used to further determine or estimate a distance from the vehicle to the landmark. The distance to the landmark may be estimated based on the current speed of the vehicle and a scale of expansion based on the position of the landmark appearing in the images relative to the focus of expansion of the camera. For example, the distance to landmark may be estimated by Z=V*dt*R/D, where V is the speed of vehicle, R is the distance in the image from the landmark at time t1 to the focus of expansion, and D is the change in distance for the landmark in the image from t1 to t2. dt represents the (t2−t1). For example, the distance to landmark may be estimated by Z=V*dt*R/D, where V is the speed of vehicle, R is the distance in the image between the landmark and the focus of expansion, dt is a time interval, and D is the image displacement of the landmark along the epipolar line. Other equations equivalent to the above equation, such as Z=V*ω/Δω, may be used for estimating the distance to the landmark. Here, V is the vehicle speed, ω is an image length (like the object width), and Δω is the change of that image length in a unit of time.

When the physical size of the landmark is known, the distance to the landmark may also be determined based on the following equation: Z=f * W/ω, where f is the focal length, W is the size of the landmark (e.g., height or width), ω is the number of pixels when the landmark leaves the image. From the above equation, a change in distance Z may be calculated using ΔZ=f*W*Δω/ω2+f*ΔW/ω, where ΔW decays to zero by averaging, and where Δω is the number of pixels representing a bounding box accuracy in the image. A value estimating the physical size of the landmark may be calculated by averaging multiple observations at the server side. The resulting error in distance estimation may be very small. There are two sources of error that may occur when using the formula above, namely ΔW and Δω. Their contribution to the distance error is given by ΔZ=f*W*Δω/ω2+f*ΔW/ω. However, ΔW decays to zero by averaging; hence ΔZ is determined by Δω (e.g., the inaccuracy of the bounding box in the image).

For landmarks of unknown dimensions, the distance to the landmark may be estimated by tracking feature points on the landmark between successive frames. For example, certain features appearing on a speed limit sign may be tracked between two or more image frames. Based on these tracked features, a distance distribution per feature point may be generated. The distance estimate may be extracted from the distance distribution. For example, the most frequent distance appearing in the distance distribution may be used as the distance estimate. As another example, the average of the distance distribution may be used as the distance estimate.

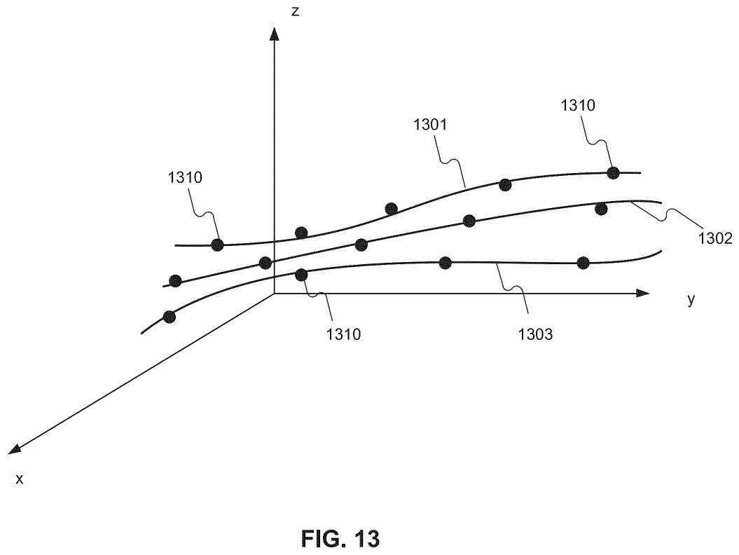

FIG. 13 illustrates an example autonomous vehicle road navigation model represented by a plurality of three dimensional splines 1301, 1302, and 1303. The curves 1301, 1302, and 1303 shown in FIG. 13 are for illustration purpose only. Each spline may include one or more three dimensional polynomials connecting a plurality of data points 1310. Each polynomial may be a first order polynomial, a second order polynomial, a third order polynomial, or a combination of any suitable polynomials having different orders. Each data point 1310 may be associated with the navigation information received from vehicles 1205, 1210, 1215, 1220, and 1225. In some embodiments, each data point 1310 may be associated with data related to landmarks (e.g., size, location, and identification information of landmarks) and/or road signature profiles (e.g., road geometry, road roughness profile, road curvature profile, road width profile). In some embodiments, some data points 1310 may be associated with data related to landmarks, and others may be associated with data related to road signature profiles.

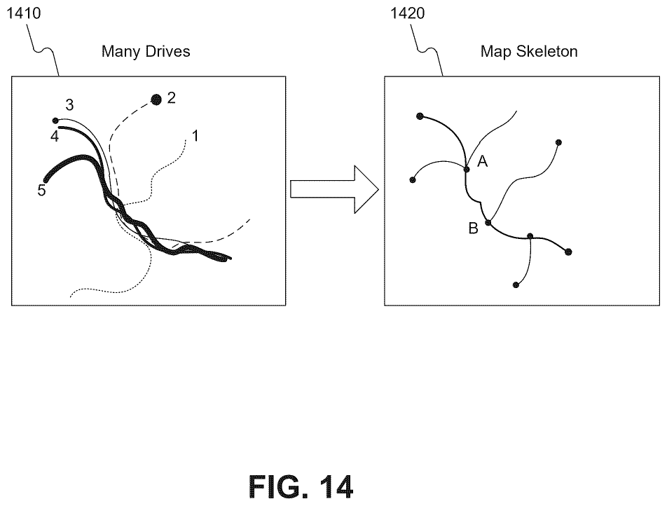

FIG. 14 illustrates raw location data 1410 (e.g., GPS data) received from five separate drives. One drive may be separate from another drive if it was traversed by separate vehicles at the same time, by the same vehicle at separate times, or by separate vehicles at separate times. To account for errors in the location data 1410 and for differing locations of vehicles within the same lane (e.g., one vehicle may drive closer to the left of a lane than another), server 1230 may generate a map skeleton 1420 using one or more statistical techniques to determine whether variations in the raw location data 1410 represent actual divergences or statistical errors. Each path within skeleton 1420 may be linked back to the raw data 1410 that formed the path. For example, the path between A and B within skeleton 1420 is linked to raw data 1410 from drives 2, 3, 4, and 5 but not from drive 1. Skeleton 1420 may not be detailed enough to be used to navigate a vehicle (e.g., because it combines drives from multiple lanes on the same road unlike the splines described above) but may provide useful topological information and may be used to define intersections.

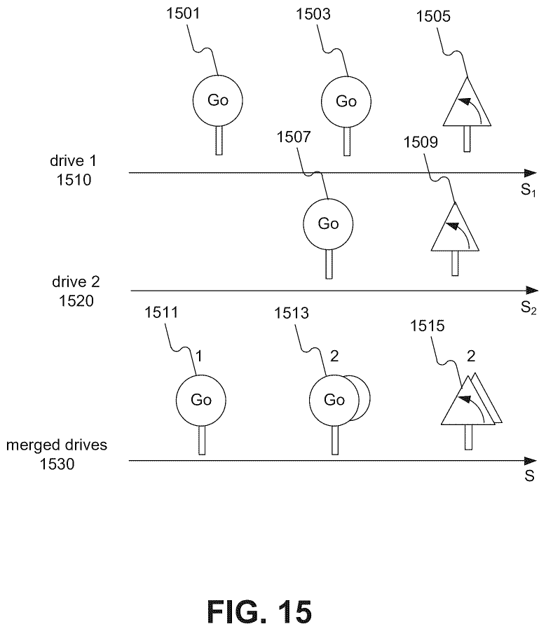

FIG. 15 illustrates an example by which additional detail may be generated for a sparse map within a segment of a map skeleton (e.g., segment A to B within skeleton 1420). As depicted in FIG. 15, the data (e.g., ego-motion data, road markings data, and the like) may be shown as a function of position S (or S1 or S2) along the drive. Server 1230 may identify landmarks for the sparse map by identifying unique matches between landmarks 1501, 1503, and 1505 of drive 1510 and landmarks 1507 and 1509 of drive 1520. Such a matching algorithm may result in identification of landmarks 1511, 1513, and 1515. One skilled in the art would recognize, however, that other matching algorithms may be used. For example, probability optimization may be used in lieu of or in combination with unique matching. Server 1230 may longitudinally align the drives to align the matched landmarks. For example, server 1230 may select one drive (e.g., drive 1520) as a reference drive and then shift and/or elastically stretch the other drive(s) (e.g., drive 1510) for alignment.

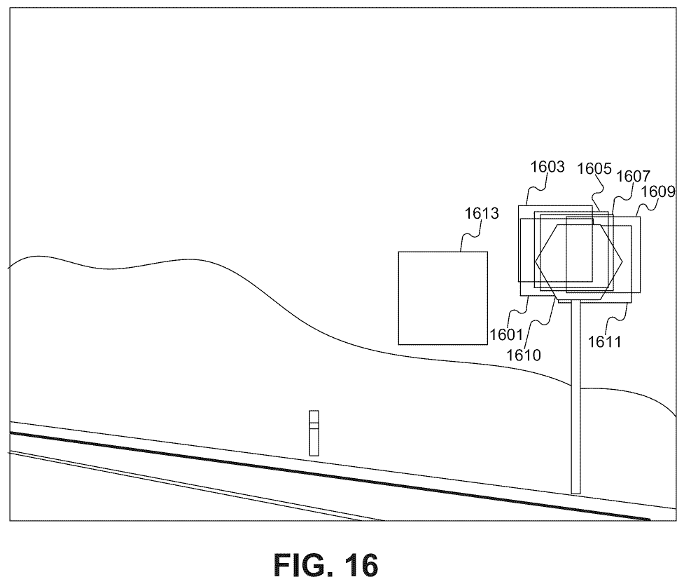

FIG. 16 shows an example of aligned landmark data for use in a sparse map. In the example of FIG. 16, landmark 1610 comprises a road sign. The example of FIG. 16 further depicts data from a plurality of drives 1601, 1603, 1605, 1607, 1609, 1611, and 1613. In the example of FIG. 16, the data from drive 1613 consists of a “ghost” landmark, and the server 1230 may identify it as such because none of drives 1601, 1603, 1605, 1607, 1609, and 1611 include an identification of a landmark in the vicinity of the identified landmark in drive 1613. Accordingly, server 1230 may accept potential landmarks when a ratio of images in which the landmark does appear to images in which the landmark does not appear exceeds a threshold and/or may reject potential landmarks when a ratio of images in which the landmark does not appear to images in which the landmark does appear exceeds a threshold.

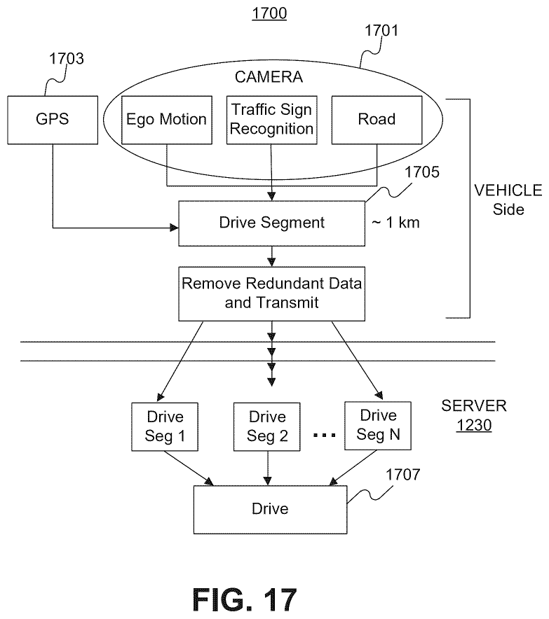

FIG. 17 depicts a system 1700 for generating drive data, which may be used to crowdsource a sparse map. As depicted in FIG. 17, system 1700 may include a camera 1701 and a locating device 1703 (e.g., a GPS locator). Camera 1701 and locating device 1703 may be mounted on a vehicle (e.g., one of vehicles 1205, 1210, 1215, 1220, and 1225). Camera 1701 may produce a plurality of data of multiple types, e.g., ego motion data, traffic sign data, road data, or the like. The camera data and location data may be segmented into drive segments 1705. For example, drive segments 1705 may each have camera data and location data from less than 1 km of driving.

In some embodiments, system 1700 may remove redundancies in drive segments 1705. For example, if a landmark appears in multiple images from camera 1701, system 1700 may strip the redundant data such that the drive segments 1705 only contain one copy of the location of and any metadata relating to the landmark. By way of further example, if a lane marking appears in multiple images from camera 1701, system 1700 may strip the redundant data such that the drive segments 1705 only contain one copy of the location of and any metadata relating to the lane marking.

System 1700 also includes a server (e.g., server 1230). Server 1230 may receive drive segments 1705 from the vehicle and recombine the drive segments 1705 into a single drive 1707. Such an arrangement may allow for reduced bandwidth requirements when transferring data between the vehicle and the server while also allowing for the server to store data relating to an entire drive.

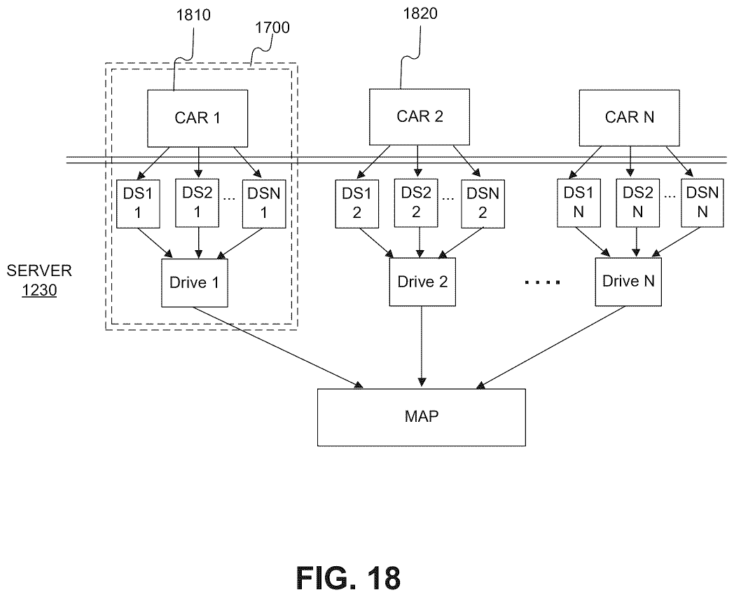

FIG. 18 depicts system 1700 of FIG. 17 further configured for crowdsourcing a sparse map. As in FIG. 17, system 1700 includes vehicle 1810, which captures drive data using, for example, a camera (which produces, e.g., ego motion data, traffic sign data, road data, or the like) and a locating device (e.g., a GPS locator). As in FIG. 17, vehicle 1810 segments the collected data into drive segments (depicted as “DS1 1,” “DS2 1,” “DSN 1” in FIG. 18). Server 1230 then receives the drive segments and reconstructs a drive (depicted as “Drive 1” in FIG. 18) from the received segments.

As further depicted in FIG. 18, system 1700 also receives data from additional vehicles. For example, vehicle 1820 also captures drive data using, for example, a camera (which produces, e.g., ego motion data, traffic sign data, road data, or the like) and a locating device (e.g., a GPS locator). Similar to vehicle 1810, vehicle 1820 segments the collected data into drive segments (depicted as “DS1 2,” “DS2 2,” “DSN 2” in FIG. 18). Server 1230 then receives the drive segments and reconstructs a drive (depicted as “Drive 2” in FIG. 18) from the received segments. Any number of additional vehicles may be used. For example, FIG. 18 also includes “CAR N” that captures drive data, segments it into drive segments (depicted as “DS1 N,” “DS2N,” “DSN N” in FIG. 18), and sends it to server 1230 for reconstruction into a drive (depicted as “Drive N” in FIG. 18).

As depicted in FIG. 18, server 1230 may construct a sparse map (depicted as “MAP”) using the reconstructed drives (e.g., “Drive 1,” “Drive 2,” and “Drive N”) collected from a plurality of vehicles (e.g., “CAR 1” (also labeled vehicle 1810), “CAR 2” (also labeled vehicle 1820), and “CAR N”).

FIG. 19 is a flowchart showing an example process 1900 for generating a sparse map for autonomous vehicle navigation along a road segment. Process 1900 may be performed by one or more processing devices included in server 1230.

Process 1900 may include receiving a plurality of images acquired as one or more vehicles traverse the road segment (step 1905). Server 1230 may receive images from cameras included within one or more of vehicles 1205, 1210, 1215, 1220, and 1225. For example, camera 122 may capture one or more images of the environment surrounding vehicle 1205 as vehicle 1205 travels along road segment 1200. In some embodiments, server 1230 may also receive stripped down image data that has had redundancies removed by a processor on vehicle 1205, as discussed above with respect to FIG. 17.

Process 1900 may further include identifying, based on the plurality of images, at least one line representation of a road surface feature extending along the road segment (step 1910). Each line representation may represent a path along the road segment substantially corresponding with the road surface feature. For example, server 1230 may analyze the environmental images received from camera 122 to identify a road edge or a lane marking and determine a trajectory of travel along road segment 1200 associated with the road edge or lane marking. In some embodiments, the trajectory (or line representation) may include a spline, a polynomial representation, or a curve. Server 1230 may determine the trajectory of travel of vehicle 1205 based on camera ego motions (e.g., three dimensional translation and/or three dimensional rotational motions) received at step 1905.

Process 1900 may also include identifying, based on the plurality of images, a plurality of landmarks associated with the road segment (step 1910). For example, server 1230 may analyze the environmental images received from camera 122 to identify one or more landmarks, such as road sign along road segment 1200. Server 1230 may identify the landmarks using analysis of the plurality of images acquired as one or more vehicles traverse the road segment. To enable crowdsourcing, the analysis may include rules regarding accepting and rejecting possible landmarks associated with the road segment. For example, the analysis may include accepting potential landmarks when a ratio of images in which the landmark does appear to images in which the landmark does not appear exceeds a threshold and/or rejecting potential landmarks when a ratio of images in which the landmark does not appear to images in which the landmark does appear exceeds a threshold.

Process 1900 may include other operations or steps performed by server 1230. For example, the navigation information may include a target trajectory for vehicles to travel along a road segment, and process 1900 may include clustering, by server 1230, vehicle trajectories related to multiple vehicles travelling on the road segment and determining the target trajectory based on the clustered vehicle trajectories, as discussed in further detail below. Clustering vehicle trajectories may include clustering, by server 1230, the multiple trajectories related to the vehicles travelling on the road segment into a plurality of clusters based on at least one of the absolute heading of vehicles or lane assignment of the vehicles. Generating the target trajectory may include averaging, by server 1230, the clustered trajectories. By way of further example, process 1900 may include aligning data received in step 1905. Other processes or steps performed by server 1230, as described above, may also be included in process 1900.

The disclosed systems and methods may include other features. For example, the disclosed systems may use local coordinates, rather than global coordinates. For autonomous driving, some systems may present data in world coordinates. For example, longitude and latitude coordinates on the earth surface may be used. In order to use the map for steering, the host vehicle may determine its position and orientation relative to the map. It seems natural to use a GPS device on board, in order to position the vehicle on the map and in order to find the rotation transformation between the body reference frame and the world reference frame (e.g., North, East and Down). Once the body reference frame is aligned with the map reference frame, then the desired route may be expressed in the body reference frame and the steering commands may be computed or generated.

The disclosed systems and methods may enable autonomous vehicle navigation (e.g., steering control) with low footprint models, which may be collected by the autonomous vehicles themselves without the aid of expensive surveying equipment. To support the autonomous navigation (e.g., steering applications), the road model may include a sparse map having the geometry of the road, its lane structure, and landmarks that may be used to determine the location or position of vehicles along a trajectory included in the model. As discussed above, generation of the sparse map may be performed by a remote server that communicates with vehicles travelling on the road and that receives data from the vehicles. The data may include sensed data, trajectories reconstructed based on the sensed data, and/or recommended trajectories that may represent modified reconstructed trajectories. As discussed below, the server may transmit the model back to the vehicles or other vehicles that later travel on the road to aid in autonomous navigation.

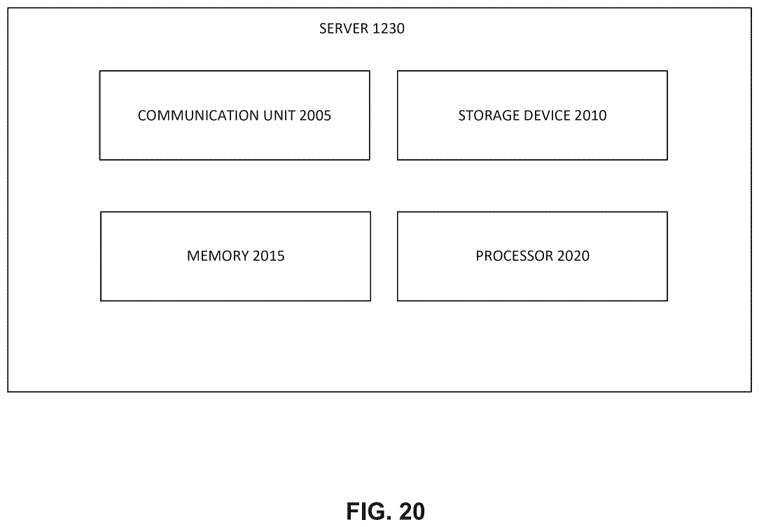

FIG. 20 illustrates a block diagram of server 1230. Server 1230 may include a communication unit 2005, which may include both hardware components (e.g., communication control circuits, switches, and antenna), and software components (e.g., communication protocols, computer codes). For example, communication unit 2005 may include at least one network interface. Server 1230 may communicate with vehicles 1205, 1210, 1215, 1220, and 1225 through communication unit 2005. For example, server 1230 may receive, through communication unit 2005, navigation information transmitted from vehicles 1205, 1210, 1215, 1220, and 1225. Server 1230 may distribute, through communication unit 2005, the autonomous vehicle road navigation model to one or more autonomous vehicles.

Server 1230 may include at least one non-transitory storage medium 2010, such as a hard drive, a compact disc, a tape, etc. Storage device 1410 may be configured to store data, such as navigation information received from vehicles 1205, 1210, 1215, 1220, and 1225 and/or the autonomous vehicle road navigation model that server 1230 generates based on the navigation information. Storage device 2010 may be configured to store any other information, such as a sparse map (e.g., sparse map 800 discussed above with respect to FIG. 8).

In addition to or in place of storage device 2010, server 1230 may include a memory 2015. Memory 2015 may be similar to or different from memory 140 or 150. Memory 2015 may be a non-transitory memory, such as a flash memory, a random access memory, etc. Memory 2015 may be configured to store data, such as computer codes or instructions executable by a processor (e.g., processor 2020), map data (e.g., data of sparse map 800), the autonomous vehicle road navigation model, and/or navigation information received from vehicles 1205, 1210, 1215, 1220, and 1225.

Server 1230 may include at least one processing device 2020 configured to execute computer codes or instructions stored in memory 2015 to perform various functions. For example, processing device 2020 may analyze the navigation information received from vehicles 1205, 1210, 1215, 1220, and 1225, and generate the autonomous vehicle road navigation model based on the analysis. Processing device 2020 may control communication unit 1405 to distribute the autonomous vehicle road navigation model to one or more autonomous vehicles (e.g., one or more of vehicles 1205, 1210, 1215, 1220, and 1225 or any vehicle that travels on road segment 1200 at a later time). Processing device 2020 may be similar to or different from processor 180, 190, or processing unit 110.

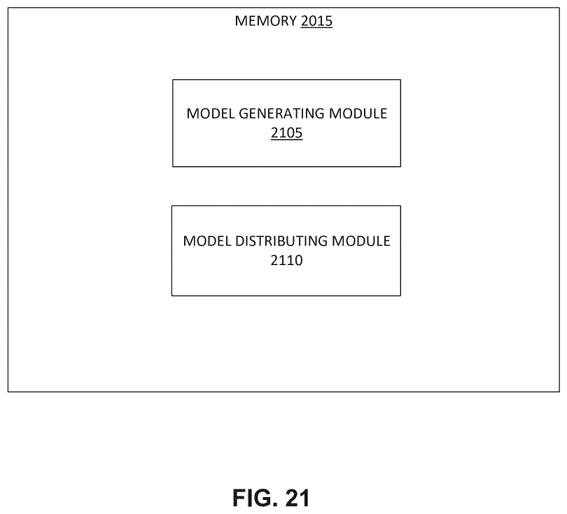

FIG. 21 illustrates a block diagram of memory 2015, which may store computer code or instructions for performing one or more operations for generating a road navigation model for use in autonomous vehicle navigation. As shown in FIG. 21, memory 2015 may store one or more modules for performing the operations for processing vehicle navigation information. For example, memory 2015 may include a model generating module 2105 and a model distributing module 2110. Processor 2020 may execute the instructions stored in any of modules 2105 and 2110 included in memory 2015.

Model generating module 2105 may store instructions which, when executed by processor 2020, may generate at least a portion of an autonomous vehicle road navigation model for a common road segment (e.g., road segment 1200) based on navigation information received from vehicles 1205, 1210, 1215, 1220, and 1225. For example, in generating the autonomous vehicle road navigation model, processor 2020 may cluster vehicle trajectories along the common road segment 1200 into different clusters. Processor 2020 may determine a target trajectory along the common road segment 1200 based on the clustered vehicle trajectories for each of the different clusters. Such an operation may include finding a mean or average trajectory of the clustered vehicle trajectories (e.g., by averaging data representing the clustered vehicle trajectories) in each cluster. In some embodiments, the target trajectory may be associated with a single lane of the common road segment 1200.

The road model and/or sparse map may store trajectories associated with a road segment. These trajectories may be referred to as target trajectories, which are provided to autonomous vehicles for autonomous navigation. The target trajectories may be received from multiple vehicles, or may be generated based on actual trajectories or recommended trajectories (actual trajectories with some modifications) received from multiple vehicles. The target trajectories included in the road model or sparse map may be continuously updated (e.g., averaged) with new trajectories received from other vehicles.

Vehicles travelling on a road segment may collect data by various sensors. The data may include landmarks, road signature profile, vehicle motion (e.g., accelerometer data, speed data), vehicle position (e.g., GPS data), and may either reconstruct the actual trajectories themselves, or transmit the data to a server, which will reconstruct the actual trajectories for the vehicles. In some embodiments, the vehicles may transmit data relating to a trajectory (e.g., a curve in an arbitrary reference frame), landmarks data, and lane assignment along traveling path to server 1230. Various vehicles travelling along the same road segment at multiple drives may have different trajectories. Server 1230 may identify routes or trajectories associated with each lane from the trajectories received from vehicles through a clustering process.

FIG. 22 illustrates a process of clustering vehicle trajectories associated with vehicles 1205, 1210, 1215, 1220, and 1225 for determining a target trajectory for the common road segment (e.g., road segment 1200). The target trajectory or a plurality of target trajectories determined from the clustering process may be included in the autonomous vehicle road navigation model or sparse map 800. In some embodiments, vehicles 1205, 1210, 1215, 1220, and 1225 traveling along road segment 1200 may transmit a plurality of trajectories 2200 to server 1230. In some embodiments, server 1230 may generate trajectories based on landmark, road geometry, and vehicle motion information received from vehicles 1205, 1210, 1215, 1220, and 1225. To generate the autonomous vehicle road navigation model, server 1230 may cluster vehicle trajectories 1600 into a plurality of clusters 2205, 2210, 2215, 2220, 2225, and 2230, as shown in FIG. 22.

Clustering may be performed using various criteria. In some embodiments, all drives in a cluster may be similar with respect to the absolute heading along the road segment 1200. The absolute heading may be obtained from GPS signals received by vehicles 1205, 1210, 1215, 1220, and 1225. In some embodiments, the absolute heading may be obtained using dead reckoning. Dead reckoning, as one of skill in the art would understand, may be used to determine the current position and hence heading of vehicles 1205, 1210, 1215, 1220, and 1225 by using previously determined position, estimated speed, etc. Trajectories clustered by absolute heading may be useful for identifying routes along the roadways.

In some embodiments, all the drives in a cluster may be similar with respect to the lane assignment (e.g., in the same lane before and after a junction) along the drive on road segment 1200. Trajectories clustered by lane assignment may be useful for identifying lanes along the roadways. In some embodiments, both criteria (e.g., absolute heading and lane assignment) may be used for clustering.

In each cluster 2205, 2210, 2215, 2220, 2225, and 2230, trajectories may be averaged to obtain a target trajectory associated with the specific cluster. For example, the trajectories from multiple drives associated with the same lane cluster may be averaged. The averaged trajectory may be a target trajectory associate with a specific lane. To average a cluster of trajectories, server 1230 may select a reference frame of an arbitrary trajectory C0. For all other trajectories (C1, . . . , Cn), server 1230 may find a rigid transformation that maps Ci to C0, where i=1, 2, . . . , n, where n is a positive integer number, corresponding to the total number of trajectories included in the cluster. Server 1230 may compute a mean curve or trajectory in the C0 reference frame.

In some embodiments, the landmarks may define an arc length matching between different drives, which may be used for alignment of trajectories with lanes. In some embodiments, lane marks before and after a junction may be used for alignment of trajectories with lanes.

To assemble lanes from the trajectories, server 1230 may select a reference frame of an arbitrary lane. Server 1230 may map partially overlapping lanes to the selected reference frame. Server 1230 may continue mapping until all lanes are in the same reference frame. Lanes that are next to each other may be aligned as if they were the same lane, and later they may be shifted laterally.

Landmarks recognized along the road segment may be mapped to the common reference frame, first at the lane level, then at the junction level. For example, the same landmarks may be recognized multiple times by multiple vehicles in multiple drives. The data regarding the same landmarks received in different drives may be slightly different. Such data may be averaged and mapped to the same reference frame, such as the C0 reference frame. Additionally or alternatively, the variance of the data of the same landmark received in multiple drives may be calculated.

In some embodiments, each lane of road segment 120 may be associated with a target trajectory and certain landmarks. The target trajectory or a plurality of such target trajectories may be included in the autonomous vehicle road navigation model, which may be used later by other autonomous vehicles travelling along the same road segment 1200. Landmarks identified by vehicles 1205, 1210, 1215, 1220, and 1225 while the vehicles travel along road segment 1200 may be recorded in association with the target trajectory. The data of the target trajectories and landmarks may be continuously or periodically updated with new data received from other vehicles in subsequent drives.

For localization of an autonomous vehicle, the disclosed systems and methods may use an Extended Kalman Filter. The location of the vehicle may be determined based on three dimensional position data and/or three dimensional orientation data, prediction of future location ahead of vehicle's current location by integration of ego motion. The localization of vehicle may be corrected or adjusted by image observations of landmarks. For example, when vehicle detects a landmark within an image captured by the camera, the landmark may be compared to a known landmark stored within the road model or sparse map 800. The known landmark may have a known location (e.g., GPS data) along a target trajectory stored in the road model and/or sparse map 800. Based on the current speed and images of the landmark, the distance from the vehicle to the landmark may be estimated. The location of the vehicle along a target trajectory may be adjusted based on the distance to the landmark and the landmark's known location (stored in the road model or sparse map 800). The landmark's position/location data (e.g., mean values from multiple drives) stored in the road model and/or sparse map 800 may be presumed to be accurate.

In some embodiments, the disclosed system may form a closed loop subsystem, in which estimation of the vehicle six degrees of freedom location (e.g., three dimensional position data plus three dimensional orientation data) may be used for navigating (e.g., steering the wheel of) the autonomous vehicle to reach a desired point (e.g., 1.3 second ahead in the stored). In turn, data measured from the steering and actual navigation may be used to estimate the six degrees of freedom location.

In some embodiments, poles along a road, such as lampposts and power or cable line poles may be used as landmarks for localizing the vehicles. Other landmarks such as traffic signs, traffic lights, arrows on the road, stop lines, as well as static features or signatures of an object along the road segment may also be used as landmarks for localizing the vehicle. When poles are used for localization, the x observation of the poles (i.e., the viewing angle from the vehicle) may be used, rather than the y observation (i.e., the distance to the pole) since the bottoms of the poles may be occluded and sometimes they are not on the road plane.

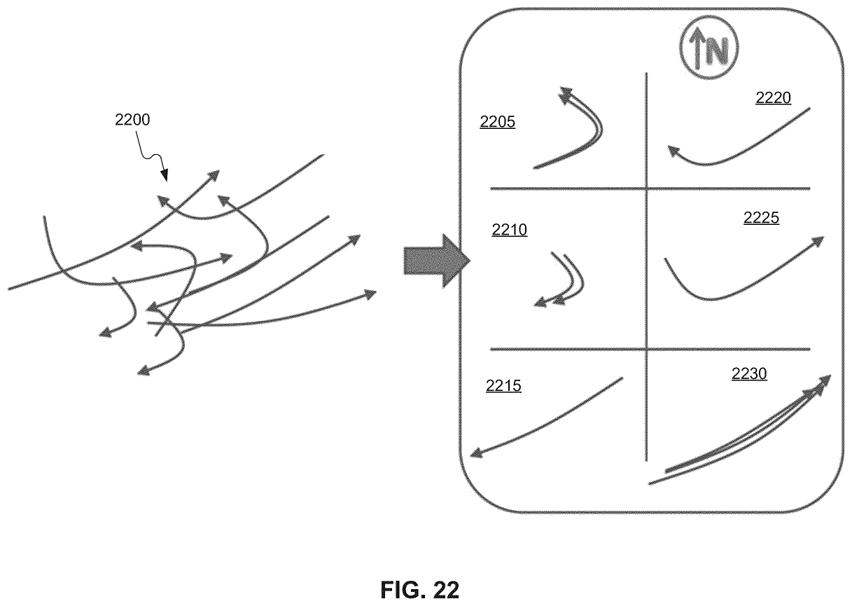

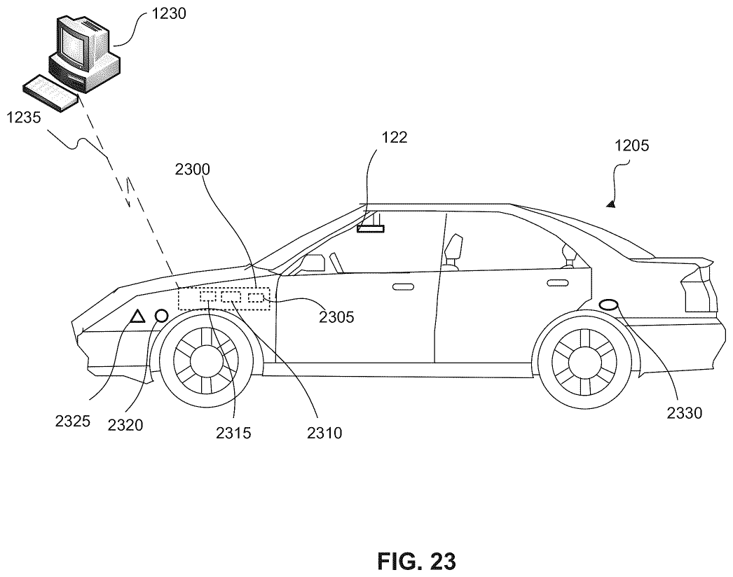

FIG. 23 illustrates a navigation system for a vehicle, which may be used for autonomous navigation using a crowdsourced sparse map. For illustration, the vehicle is referenced as vehicle 1205. The vehicle shown in FIG. 23 may be any other vehicle disclosed herein, including, for example, vehicles 1210, 1215, 1220, and 1225, as well as vehicle 200 shown in other embodiments. As shown in FIG. 12, vehicle 1205 may communicate with server 1230. Vehicle 1205 may include an image capture device 122 (e.g., camera 122). Vehicle 1205 may include a navigation system 2300 configured for providing navigation guidance for vehicle 1205 to travel on a road (e.g., road segment 1200). Vehicle 1205 may also include other sensors, such as a speed sensor 2320 and an accelerometer 2325. Speed sensor 2320 may be configured to detect the speed of vehicle 1205. Accelerometer 2325 may be configured to detect an acceleration or deceleration of vehicle 1205. Vehicle 1205 shown in FIG. 23 may be an autonomous vehicle, and the navigation system 2300 may be used for providing navigation guidance for autonomous driving. Alternatively, vehicle 1205 may also be a non-autonomous, human-controlled vehicle, and navigation system 2300 may still be used for providing navigation guidance.

Navigation system 2300 may include a communication unit 2305 configured to communicate with server 1230 through communication path 1235. Navigation system 2300 may also include a GPS unit 2310 configured to receive and process GPS signals. Navigation system 2300 may further include at least one processor 2315 configured to process data, such as GPS signals, map data from sparse map 800 (which may be stored on a storage device provided onboard vehicle 1205 and/or received from server 1230), road geometry sensed by a road profile sensor 2330, images captured by camera 122, and/or autonomous vehicle road navigation model received from server 1230. The road profile sensor 2330 may include different types of devices for measuring different types of road profile, such as road surface roughness, road width, road elevation, road curvature, etc. For example, the road profile sensor 2330 may include a device that measures the motion of a suspension of vehicle 2305 to derive the road roughness profile. In some embodiments, the road profile sensor 2330 may include radar sensors to measure the distance from vehicle 1205 to road sides (e.g., barrier on the road sides), thereby measuring the width of the road. In some embodiments, the road profile sensor 2330 may include a device configured for measuring the up and down elevation of the road. In some embodiment, the road profile sensor 2330 may include a device configured to measure the road curvature. For example, a camera (e.g., camera 122 or another camera) may be used to capture images of the road showing road curvatures. Vehicle 1205 may use such images to detect road curvatures.

The at least one processor 2315 may be programmed to receive, from camera 122, at least one environmental image associated with vehicle 1205. The at least one processor 2315 may analyze the at least one environmental image to determine navigation information related to the vehicle 1205. The navigation information may include a trajectory related to the travel of vehicle 1205 along road segment 1200. The at least one processor 2315 may determine the trajectory based on motions of camera 122 (and hence the vehicle), such as three dimensional translation and three dimensional rotational motions. In some embodiments, the at least one processor 2315 may determine the translation and rotational motions of camera 122 based on analysis of a plurality of images acquired by camera 122. In some embodiments, the navigation information may include lane assignment information (e.g., in which lane vehicle 1205 is travelling along road segment 1200). The navigation information transmitted from vehicle 1205 to server 1230 may be used by server 1230 to generate and/or update an autonomous vehicle road navigation model, which may be transmitted back from server 1230 to vehicle 1205 for providing autonomous navigation guidance for vehicle 1205.

The at least one processor 2315 may also be programmed to transmit the navigation information from vehicle 1205 to server 1230. In some embodiments, the navigation information may be transmitted to server 1230 along with road information. The road location information may include at least one of the GPS signal received by the GPS unit 2310, landmark information, road geometry, lane information, etc. The at least one processor 2315 may receive, from server 1230, the autonomous vehicle road navigation model or a portion of the model. The autonomous vehicle road navigation model received from server 1230 may include at least one update based on the navigation information transmitted from vehicle 1205 to server 1230. The portion of the model transmitted from server 1230 to vehicle 1205 may include an updated portion of the model. The at least one processor 2315 may cause at least one navigational maneuver (e.g., steering such as making a turn, braking, accelerating, passing another vehicle, etc.) by vehicle 1205 based on the received autonomous vehicle road navigation model or the updated portion of the model.

The at least one processor 2315 may be configured to communicate with various sensors and components included in vehicle 1205, including communication unit 2305, GPS unit 2310, camera 122, speed sensor 2320, accelerometer 2325, and road profile sensor 2330. The at least one processor 2315 may collect information or data from various sensors and components and transmit the information or data to server 1230 through communication unit 2305. Alternatively or additionally, various sensors or components of vehicle 1205 may also communicate with server 1230 and transmit data or information collected by the sensors or components to server 1230.

In some embodiments, vehicles 1205, 1210, 1215, 1220, and 1225 may communicate with each other, and may share navigation information with each other, such that at least one of the vehicles 1205, 1210, 1215, 1220, and 1225 may generate the autonomous vehicle road navigation model using crowdsourcing, e.g., based on information shared by other vehicles. In some embodiments, vehicles 1205, 1210, 1215, 1220, and 1225 may share navigation information with each other and each vehicle may update its own the autonomous vehicle road navigation model provided in the vehicle. In some embodiments, at least one of the vehicles 1205, 1210, 1215, 1220, and 1225 (e.g., vehicle 1205) may function as a hub vehicle. The at least one processor 2315 of the hub vehicle (e.g., vehicle 1205) may perform some or all of the functions performed by server 1230. For example, the at least one processor 2315 of the hub vehicle may communicate with other vehicles and receive navigation information from other vehicles. The at least one processor 2315 of the hub vehicle may generate the autonomous vehicle road navigation model or an update to the model based on the shared information received from other vehicles. The at least one processor 2315 of the hub vehicle may transmit the autonomous vehicle road navigation model or the update to the model to other vehicles for providing autonomous navigation guidance.

### Navigation Based on Sparse Maps

As previously discussed, the autonomous vehicle road navigation model including sparse map 800 may include a plurality of mapped lane marks and a plurality of mapped objects/features associated with a road segment. As discussed in greater detail below, these mapped lane marks, objects, and features may be used when the autonomous vehicle navigates. For example, in some embodiments, the mapped objects and features may be used to localized a host vehicle relative to the map (e.g., relative to a mapped target trajectory). The mapped lane marks may be used (e.g., as a check) to determine a lateral position and/or orientation relative to a planned or target trajectory. With this position information, the autonomous vehicle may be able to adjust a heading direction to match a direction of a target trajectory at the determined position.

Vehicle 200 may be configured to detect lane marks in a given road segment. The road segment may include any markings on a road for guiding vehicle traffic on a roadway. For example, the lane marks may be continuous or dashed lines demarking the edge of a lane of travel. The lane marks may also include double lines, such as a double continuous lines, double dashed lines or a combination of continuous and dashed lines indicating, for example, whether passing is permitted in an adjacent lane. The lane marks may also include freeway entrance and exit markings indicating, for example, a deceleration lane for an exit ramp or dotted lines indicating that a lane is turn-only or that the lane is ending. The markings may further indicate a work zone, a temporary lane shift, a path of travel through an intersection, a median, a special purpose lane (e.g., a bike lane, HOV lane, etc.), or other miscellaneous markings (e.g., crosswalk, a speed hump, a railway crossing, a stop line, etc.).

Vehicle 200 may use cameras, such as image capture devices 122 and 124 included in image acquisition unit 120, to capture images of the surrounding lane marks. Vehicle 200 may analyze the images to detect point locations associated with the lane marks based on features identified within one or more of the captured images. These point locations may be uploaded to a server to represent the lane marks in sparse map 800. Depending on the position and field of view of the camera, lane marks may be detected for both sides of the vehicle simultaneously from a single image. In other embodiments, different cameras may be used to capture images on multiple sides of the vehicle. Rather than uploading actual images of the lane marks, the marks may be stored in sparse map 800 as a spline or a series of points, thus reducing the size of sparse map 800 and/or the data that must be uploaded remotely by the vehicle.

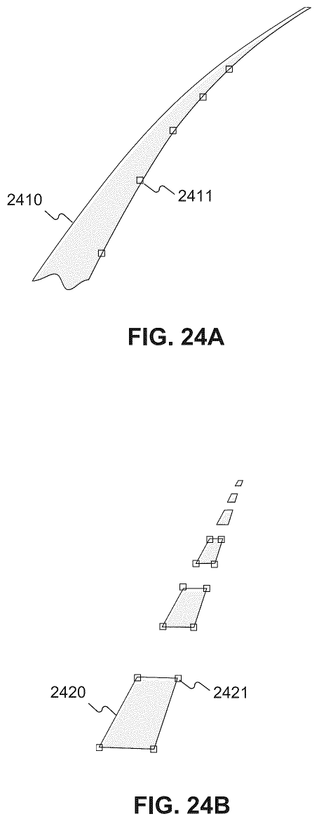

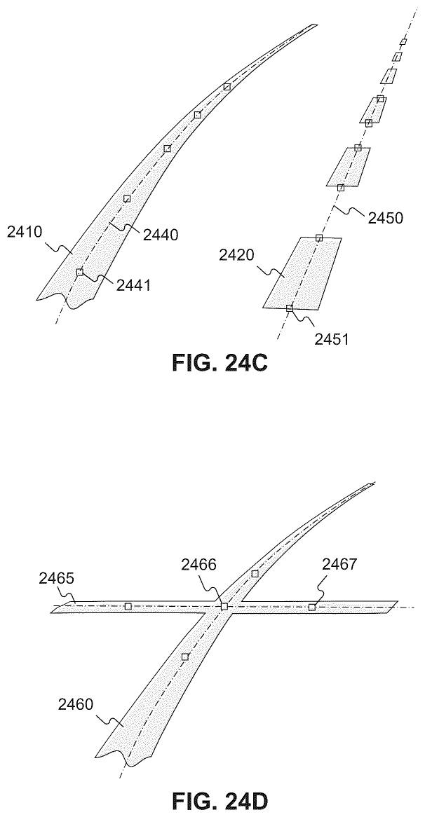

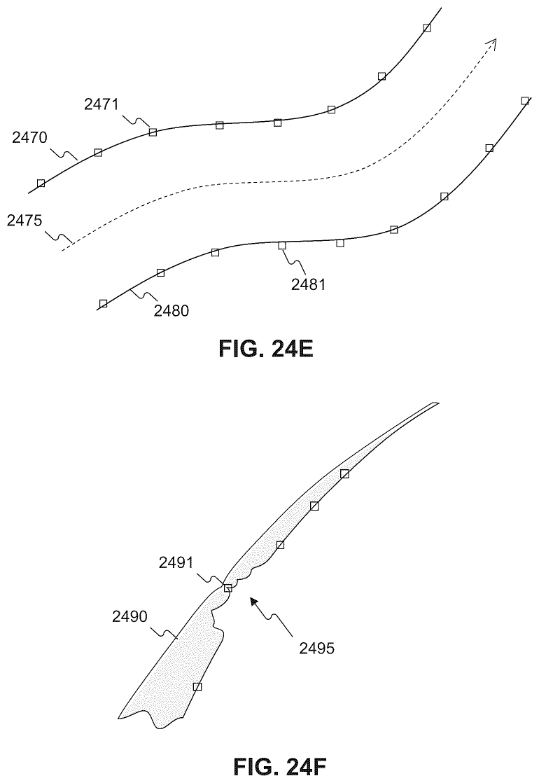

FIGS. 24A-24D illustrate exemplary point locations that may be detected by vehicle 200 to represent particular lane marks. Similar to the landmarks described above, vehicle 200 may use various image recognition algorithms or software to identify point locations within a captured image. For example, vehicle 200 may recognize a series of edge points, corner points or various other point locations associated with a particular lane mark. FIG. 24A shows a continuous lane mark 2410 that may be detected by vehicle 200. Lane mark 2410 may represent the outside edge of a roadway, represented by a continuous white line. As shown in FIG. 24A, vehicle 200 may be configured to detect a plurality of edge location points 2411 along the lane mark. Location points 2411 may be collected to represent the lane mark at any intervals sufficient to create a mapped lane mark in the sparse map. For example, the lane mark may be represented by one point per meter of the detected edge, one point per every five meters of the detected edge, or at other suitable spacings. In some embodiments, the spacing may be determined by other factors, rather than at set intervals such as, for example, based on points where vehicle 200 has a highest confidence ranking of the location of the detected points. Although FIG. 24A shows edge location points on an interior edge of lane mark 2410, points may be collected on the outside edge of the line or along both edges. Further, while a single line is shown in FIG. 24A, similar edge points may be detected for a double continuous line. For example, points 2411 may be detected along an edge of one or both of the continuous lines.

Vehicle 200 may also represent lane marks differently depending on the type or shape of lane mark. FIG. 24B shows an exemplary dashed lane mark 2420 that may be detected by vehicle 200. Rather than identifying edge points, as in FIG. 24A, vehicle may detect a series of corner points 2421 representing corners of the lane dashes to define the full boundary of the dash. While FIG. 24B shows each corner of a given dash marking being located, vehicle 200 may detect or upload a subset of the points shown in the figure. For example, vehicle 200 may detect the leading edge or leading corner of a given dash mark, or may detect the two corner points nearest the interior of the lane. Further, not every dash mark may be captured, for example, vehicle 200 may capture and/or record points representing a sample of dash marks (e.g., every other, every third, every fifth, etc.) or dash marks at a predefined spacing (e.g., every meter, every five meters, every 10 meters, etc.) Corner points may also be detected for similar lane marks, such as markings showing a lane is for an exit ramp, that a particular lane is ending, or other various lane marks that may have detectable corner points. Corner points may also be detected for lane marks consisting of double dashed lines or a combination of continuous and dashed lines.

In some embodiments, the points uploaded to the server to generate the mapped lane marks may represent other points besides the detected edge points or corner points. FIG. 24C illustrates a series of points that may represent a centerline of a given lane mark. For example, continuous lane 2410 may be represented by centerline points 2441 along a centerline 2440 of the lane mark. In some embodiments, vehicle 200 may be configured to detect these center points using various image recognition techniques, such as convolutional neural networks (CNN), scale-invariant feature transform (SIFT), histogram of oriented gradients (HOG) features, or other techniques. Alternatively, vehicle 200 may detect other points, such as edge points 2411 shown in FIG. 24A, and may calculate centerline points 2441, for example, by detecting points along each edge and determining a midpoint between the edge points. Similarly, dashed lane mark 2420 may be represented by centerline points 2451 along a centerline 2450 of the lane mark. The centerline points may be located at the edge of a dash, as shown in FIG. 24C, or at various other locations along the centerline. For example, each dash may be represented by a single point in the geometric center of the dash. The points may also be spaced at a predetermined interval along the centerline (e.g., every meter, 5 meters, 10 meters, etc.). The centerline points 2451 may be detected directly by vehicle 200, or may be calculated based on other detected reference points, such as corner points 2421, as shown in FIG. 24B. A centerline may also be used to represent other lane mark types, such as a double line, using similar techniques as above.

In some embodiments, vehicle 200 may identify points representing other features, such as a vertex between two intersecting lane marks. FIG. 24D shows exemplary points representing an intersection between two lane marks 2460 and 2465. Vehicle 200 may calculate a vertex point 2466 representing an intersection between the two lane marks. For example, one of lane marks 2460 or 2465 may represent a train crossing area or other crossing area in the road segment. While lane marks 2460 and 2465 are shown as crossing each other perpendicularly, various other configurations may be detected. For example, the lane marks 2460 and 2465 may cross at other angles, or one or both of the lane marks may terminate at the vertex point 2466. Similar techniques may also be applied for intersections between dashed or other lane mark types. In addition to vertex point 2466, various other points 2467 may also be detected, providing further information about the orientation of lane marks 2460 and 2465.

Vehicle 200 may associate real-world coordinates with each detected point of the lane mark. For example, location identifiers may be generated, including coordinate for each point, to upload to a server for mapping the lane mark. The location identifiers may further include other identifying information about the points, including whether the point represents a corner point, an edge point, center point, etc. Vehicle 200 may therefore be configured to determine a real-world position of each point based on analysis of the images. For example, vehicle 200 may detect other features in the image, such as the various landmarks described above, to locate the real-world position of the lane marks. This may involve determining the location of the lane marks in the image relative to the detected landmark or determining the position of the vehicle based on the detected landmark and then determining a distance from the vehicle (or target trajectory of the vehicle) to the lane mark. When a landmark is not available, the location of the lane mark points may be determined relative to a position of the vehicle determined based on dead reckoning. The real-world coordinates included in the location identifiers may be represented as absolute coordinates (e.g., latitude/longitude coordinates), or may be relative to other features, such as based on a longitudinal position along a target trajectory and a lateral distance from the target trajectory. The location identifiers may then be uploaded to a server for generation of the mapped lane marks in the navigation model (such as sparse map 800). In some embodiments, the server may construct a spline representing the lane marks of a road segment. Alternatively, vehicle 200 may generate the spline and upload it to the server to be recorded in the navigational model.

FIG. 24E shows an exemplary navigation model or sparse map for a corresponding road segment that includes mapped lane marks. The sparse map may include a target trajectory 2475 for a vehicle to follow along a road segment. As described above, target trajectory 2475 may represent an ideal path for a vehicle to take as it travels the corresponding road segment, or may be located elsewhere on the road (e.g., a centerline of the road, etc.). Target trajectory 2475 may be calculated in the various methods described above, for example, based on an aggregation (e.g., a weighted combination) of two or more reconstructed trajectories of vehicles traversing the same road segment.

In some embodiments, the target trajectory may be generated equally for all vehicle types and for all road, vehicle, and/or environment conditions. In other embodiments, however, various other factors or variables may also be considered in generating the target trajectory. A different target trajectory may be generated for different types of vehicles (e.g., a private car, a light truck, and a full trailer). For example, a target trajectory with relatively tighter turning radii may be generated for a small private car than a larger semi-trailer truck. In some embodiments, road, vehicle and environmental conditions may be considered as well. For example, a different target trajectory may be generated for different road conditions (e.g., wet, snowy, icy, dry, etc.), vehicle conditions (e.g., tire condition or estimated tire condition, brake condition or estimated brake condition, amount of fuel remaining, etc.) or environmental factors (e.g., time of day, visibility, weather, etc.). The target trajectory may also depend on one or more aspects or features of a particular road segment (e.g., speed limit, frequency and size of turns, grade, etc.). In some embodiments, various user settings may also be used to determine the target trajectory, such as a set driving mode (e.g., desired driving aggressiveness, economy mode, etc.).

The sparse map may also include mapped lane marks 2470 and 2480 representing lane marks along the road segment. The mapped lane marks may be represented by a plurality of location identifiers 2471 and 2481. As described above, the location identifiers may include locations in real world coordinates of points associated with a detected lane mark. Similar to the target trajectory in the model, the lane marks may also include elevation data and may be represented as a curve in three-dimensional space. For example, the curve may be a spline connecting three dimensional polynomials of suitable order the curve may be calculated based on the location identifiers. The mapped lane marks may also include other information or metadata about the lane mark, such as an identifier of the type of lane mark (e.g., between two lanes with the same direction of travel, between two lanes of opposite direction of travel, edge of a roadway, etc.) and/or other characteristics of the lane mark (e.g., continuous, dashed, single line, double line, yellow, white, etc.). In some embodiments, the mapped lane marks may be continuously updated within the model, for example, using crowdsourcing techniques. The same vehicle may upload location identifiers during multiple occasions of travelling the same road segment or data may be selected from a plurality of vehicles (such as 1205, 1210, 1215, 1220, and 1225) travelling the road segment at different times. Sparse map 800 may then be updated or refined based on subsequent location identifiers received from the vehicles and stored in the system. As the mapped lane marks are updated and refined, the updated road navigation model and/or sparse map may be distributed to a plurality of autonomous vehicles.

Generating the mapped lane marks in the sparse map may also include detecting and/or mitigating errors based on anomalies in the images or in the actual lane marks themselves. FIG. 24F shows an exemplary anomaly 2495 associated with detecting a lane mark 2490. Anomaly 2495 may appear in the image captured by vehicle 200, for example, from an object obstructing the camera's view of the lane mark, debris on the lens, etc. In some instances, the anomaly may be due to the lane mark itself, which may be damaged or worn away, or partially covered, for example, by dirt, debris, water, snow or other materials on the road. Anomaly 2495 may result in an erroneous point 2491 being detected by vehicle 200. Sparse map 800 may provide the correct the mapped lane mark and exclude the error. In some embodiments, vehicle 200 may detect erroneous point 2491 for example, by detecting anomaly 2495 in the image, or by identifying the error based on detected lane mark points before and after the anomaly. Based on detecting the anomaly, the vehicle may omit point 2491 or may adjust it to be in line with other detected points. In other embodiments, the error may be corrected after the point has been uploaded, for example, by determining the point is outside of an expected threshold based on other points uploaded during the same trip, or based on an aggregation of data from previous trips along the same road segment.

The mapped lane marks in the navigation model and/or sparse map may also be used for navigation by an autonomous vehicle traversing the corresponding roadway. For example, a vehicle navigating along a target trajectory may periodically use the mapped lane marks in the sparse map to align itself with the target trajectory. As mentioned above, between landmarks the vehicle may navigate based on dead reckoning in which the vehicle uses sensors to determine its ego motion and estimate its position relative to the target trajectory. Errors may accumulate over time and vehicle's position determinations relative to the target trajectory may become increasingly less accurate. Accordingly, the vehicle may use lane marks occurring in sparse map 800 (and their known locations) to reduce the dead reckoning-induced errors in position determination. In this way, the identified lane marks included in sparse map 800 may serve as navigational anchors from which an accurate position of the vehicle relative to a target trajectory may be determined.

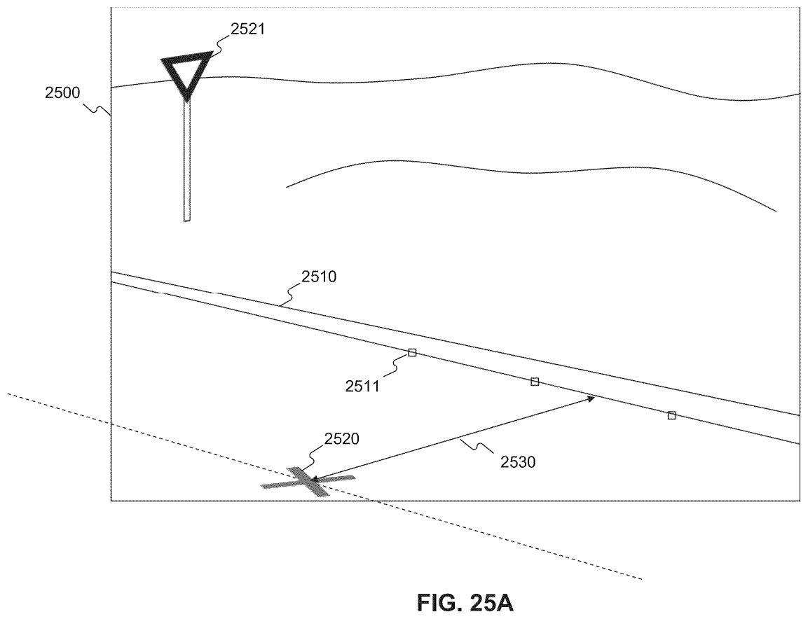

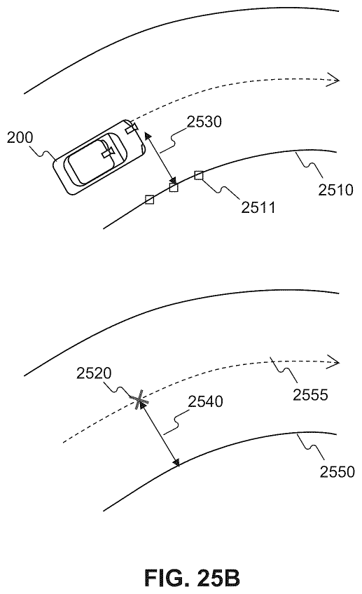

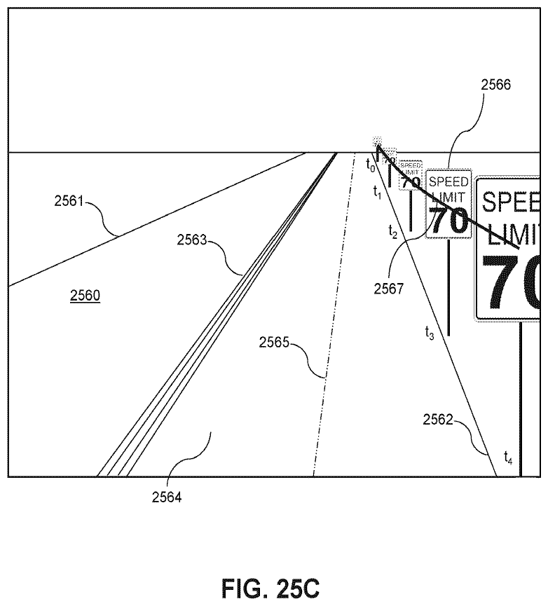

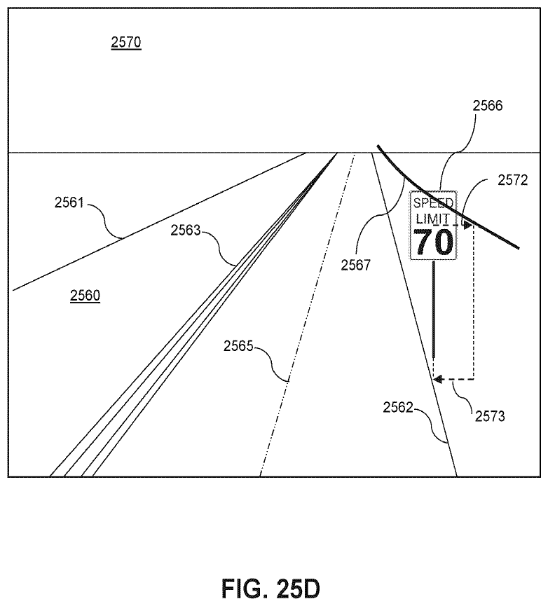

FIG. 25A shows an exemplary image 2500 of a vehicle's surrounding environment that may be used for navigation based on the mapped lane marks. Image 2500 may be captured, for example, by vehicle 200 through image capture devices 122 and 124 included in image acquisition unit 120. Image 2500 may include an image of at least one lane mark 2510, as shown in FIG. 25A. Image 2500 may also include one or more landmarks 2521, such as road sign, used for navigation as described above. Some elements shown in FIG. 25A, such as elements 2511, 2530, and 2520 which do not appear in the captured image 2500 but are detected and/or determined by vehicle 200 are also shown for reference.

Using the various techniques described above with respect to FIGS. 24A-D and 24F, a vehicle may analyze image 2500 to identify lane mark 2510. Various points 2511 may be detected corresponding to features of the lane mark in the image. Points 2511, for example, may correspond to an edge of the lane mark, a corner of the lane mark, a midpoint of the lane mark, a vertex between two intersecting lane marks, or various other features or locations. Points 2511 may be detected to correspond to a location of points stored in a navigation model received from a server. For example, if a sparse map is received containing points that represent a centerline of a mapped lane mark, points 2511 may also be detected based on a centerline of lane mark 2510.

The vehicle may also determine a longitudinal position represented by element 2520 and located along a target trajectory. Longitudinal position 2520 may be determined from image 2500, for example, by detecting landmark 2521 within image 2500 and comparing a measured location to a known landmark location stored in the road model or sparse map 800. The location of the vehicle along a target trajectory may then be determined based on the distance to the landmark and the landmark's known location. The longitudinal position 2520 may also be determined from images other than those used to determine the position of a lane mark. For example, longitudinal position 2520 may be determined by detecting landmarks in images from other cameras within image acquisition unit 120 taken simultaneously or near simultaneously to image 2500. In some instances, the vehicle may not be near any landmarks or other reference points for determining longitudinal position 2520. In such instances, the vehicle may be navigating based on dead reckoning and thus may use sensors to determine its ego motion and estimate a longitudinal position 2520 relative to the target trajectory. The vehicle may also determine a distance 2530 representing the actual distance between the vehicle and lane mark 2510 observed in the captured image(s). The camera angle, the speed of the vehicle, the width of the vehicle, or various other factors may be accounted for in determining distance 2530.

FIG. 25B illustrates a lateral localization correction of the vehicle based on the mapped lane marks in a road navigation model. As described above, vehicle 200 may determine a distance 2530 between vehicle 200 and a lane mark 2510 using one or more images captured by vehicle 200. Vehicle 200 may also have access to a road navigation model, such as sparse map 800, which may include a mapped lane mark 2550 and a target trajectory 2555. Mapped lane mark 2550 may be modeled using the techniques described above, for example using crowdsourced location identifiers captured by a plurality of vehicles. Target trajectory 2555 may also be generated using the various techniques described previously. Vehicle 200 may also determine or estimate a longitudinal position 2520 along target trajectory 2555 as described above with respect to FIG. 25A. Vehicle 200 may then determine an expected distance 2540 based on a lateral distance between target trajectory 2555 and mapped lane mark 2550 corresponding to longitudinal position 2520. The lateral localization of vehicle 200 may be corrected or adjusted by comparing the actual distance 2530, measured using the captured image(s), with the expected distance 2540 from the model.

FIGS. 25C and 25D provide illustrations associated with another example for localizing a host vehicle during navigation based on mapped landmarks/objects/features in a sparse map. FIG. 25C conceptually represents a series of images captured from a vehicle navigating along a road segment 2560. In this example, road segment 2560 includes a straight section of a two-lane divided highway delineated by road edges 2561 and 2562 and center lane marking 2563. As shown, the host vehicle is navigating along a lane 2564, which is associated with a mapped target trajectory 2565. Thus, in an ideal situation (and without influencers such as the presence of target vehicles or objects in the roadway, etc.) the host vehicle should closely track the mapped target trajectory 2565 as it navigates along lane 2564 of road segment 2560. In reality, the host vehicle may experience drift as it navigates along mapped target trajectory 2565. For effective and safe navigation, this drift should be maintained within acceptable limits (e.g., +/−10 cm of lateral displacement from target trajectory 2565 or any other suitable threshold). To periodically account for drift and to make any needed course corrections to ensure that the host vehicle follows target trajectory 2565, the disclosed navigation systems may be able to localize the host vehicle along the target trajectory 2565 (e.g., determine a lateral and longitudinal position of the host vehicle relative to the target trajectory 2565) using one or more mapped features/objects included in the sparse map.

As a simple example, FIG. 25C shows a speed limit sign 2566 as it may appear in five different, sequentially captured images as the host vehicle navigates along road segment 2560. For example, at a first time, t0, sign 2566 may appear in a captured image near the horizon. As the host vehicle approaches sign 2566, in subsequentially captured images at times t1, t2, t3, and t4, sign 2566 will appear at different 2D X-Y pixel locations of the captured images. For example, in the captured image space, sign 2566 will move downward and to the right along curve 2567 (e.g., a curve extending through the center of the sign in each of the five captured image frames). Sign 2566 will also appear to increase in size as it is approached by the host vehicle (i.e., it will occupy a great number of pixels in subsequently captured images).

These changes in the image space representations of an object, such as sign 2566, may be exploited to determine a localized position of the host vehicle along a target trajectory. For example, as described in the present disclosure, any detectable object or feature, such as a semantic feature like sign 2566 or a detectable non-semantic feature, may be identified by one or more harvesting vehicles that previously traversed a road segment (e.g., road segment 2560). A mapping server may collect the harvested drive information from a plurality of vehicles, aggregate and correlate that information, and generate a sparse map including, for example, a target trajectory 2565 for lane 2564 of road segment 2560. The sparse map may also store a location of sign 2566 (along with type information, etc.). During navigation (e.g., prior to entering road segment 2560), a host vehicle may be supplied with a map tile including a sparse map for road segment 2560. To navigate in lane 2564 of road segment 2560, the host vehicle may follow mapped target trajectory 2565.

The mapped representation of sign 2566 may be used by the host vehicle to localize itself relative to the target trajectory. For example, a camera on the host vehicle will capture an image 2570 of the environment of the host vehicle, and that captured image 2570 may include an image representation of sign 2566 having a certain size and a certain X-Y image location, as shown in FIG. 25D. This size and X-Y image location can be used to determine the host vehicle's position relative to target trajectory 2565. For example, based on the sparse map including a representation of sign 2566, a navigation processor of the host vehicle can determine that in response to the host vehicle traveling along target trajectory 2565, a representation of sign 2566 should appear in captured images such that a center of sign 2566 will move (in image space) along line 2567. If a captured image, such as image 2570, shows the center (or other reference point) displaced from line 2567 (e.g., the expected image space trajectory), then the host vehicle navigation system can determine that at the time of the captured image it was not located on target trajectory 2565. From the image, however, the navigation processor can determine an appropriate navigational correction to return the host vehicle to the target trajectory 2565. For example, if analysis shows an image location of sign 2566 that is displaced in the image by a distance 2572 to the left of the expected image space location on line 2567, then the navigation processor may cause a heading change by the host vehicle (e.g., change the steering angle of the wheels) to move the host vehicle leftward by a distance 2573. In this way, each captured image can be used as part of a feedback loop process such that a difference between an observed image position of sign 2566 and expected image trajectory 2567 may be minimized to ensure that the host vehicle continues along target trajectory 2565 with little to no deviation. Of course, the more mapped objects that are available, the more often the described localization technique may be employed, which can reduce or eliminate drift-induced deviations from target trajectory 2565.

The process described above may be useful for detecting a lateral orientation or displacement of the host vehicle relative to a target trajectory. Localization of the host vehicle relative to target trajectory 2565 may also include a determination of a longitudinal location of the target vehicle along the target trajectory. For example, captured image 2570 includes a representation of sign 2566 as having a certain image size (e.g., 2D X-Y pixel area). This size can be compared to an expected image size of mapped sign 2566 as it travels through image space along line 2567 (e.g., as the size of the sign progressively increases, as shown in FIG. 25C). Based on the image size of sign 2566 in image 2570, and based on the expected size progression in image space relative to mapped target trajectory 2565, the host vehicle can determine its longitudinal position (at the time when image 2570 was captured) relative to target trajectory 2565. This longitudinal position coupled with any lateral displacement relative to target trajectory 2565, as described above, allows for full localization of the host vehicle relative to target trajectory 2565, as the host vehicle navigates along road 2560.

FIGS. 25C and 25D provide just one example of the disclosed localization technique using a single mapped object and a single target trajectory. In other examples, there may be many more target trajectories (e.g., one target trajectory for each viable lane of a multi-lane highway, urban street, complex junction, etc.) and there may be many more mapped available for localization. For example, a sparse map representative of an urban environment may include many objects per meter available for localization.

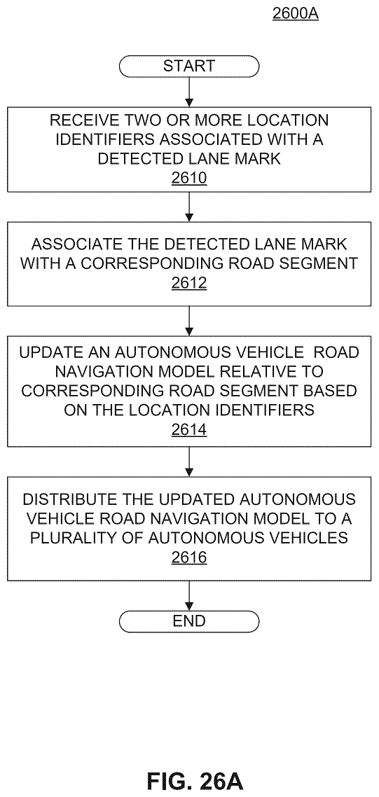

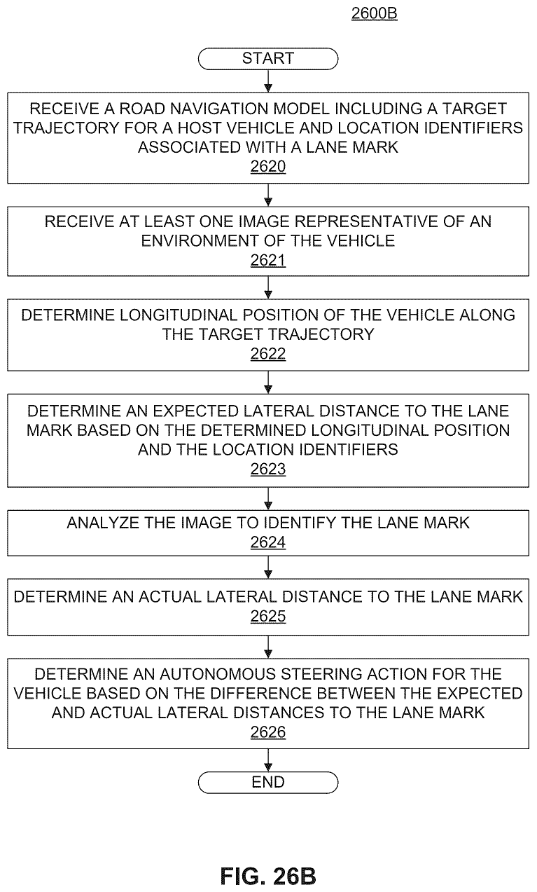

FIG. 26A is a flowchart showing an exemplary process 2600A for mapping a lane mark for use in autonomous vehicle navigation, consistent with disclosed embodiments. At step 2610, process 2600A may include receiving two or more location identifiers associated with a detected lane mark. For example, step 2610 may be performed by server 1230 or one or more processors associated with the server. The location identifiers may include locations in real-world coordinates of points associated with the detected lane mark, as described above with respect to FIG. 24E. In some embodiments, the location identifiers may also contain other data, such as additional information about the road segment or the lane mark. Additional data may also be received during step 2610, such as accelerometer data, speed data, landmarks data, road geometry or profile data, vehicle positioning data, ego motion data, or various other forms of data described above. The location identifiers may be generated by a vehicle, such as vehicles 1205, 1210, 1215, 1220, and 1225, based on images captured by the vehicle. For example, the identifiers may be determined based on acquisition, from a camera associated with a host vehicle, of at least one image representative of an environment of the host vehicle, analysis of the at least one image to detect the lane mark in the environment of the host vehicle, and analysis of the at least one image to determine a position of the detected lane mark relative to a location associated with the host vehicle. As described above, the lane mark may include a variety of different marking types, and the location identifiers may correspond to a variety of points relative to the lane mark. For example, where the detected lane mark is part of a dashed line marking a lane boundary, the points may correspond to detected corners of the lane mark. Where the detected lane mark is part of a continuous line marking a lane boundary, the points may correspond to a detected edge of the lane mark, with various spacings as described above. In some embodiments, the points may correspond to the centerline of the detected lane mark, as shown in FIG. 24C, or may correspond to a vertex between two intersecting lane marks and at least one two other points associated with the intersecting lane marks, as shown in FIG. 24D.

At step 2612, process 2600A may include associating the detected lane mark with a corresponding road segment. For example, server 1230 may analyze the real-world coordinates, or other information received during step 2610, and compare the coordinates or other information to location information stored in an autonomous vehicle road navigation model. Server 1230 may determine a road segment in the model that corresponds to the real-world road segment where the lane mark was detected.

At step 2614, process 2600A may include updating an autonomous vehicle road navigation model relative to the corresponding road segment based on the two or more location identifiers associated with the detected lane mark. For example, the autonomous road navigation model may be sparse map 800, and server 1230 may update the sparse map to include or adjust a mapped lane mark in the model. Server 1230 may update the model based on the various methods or processes described above with respect to FIG. 24E. In some embodiments, updating the autonomous vehicle road navigation model may include storing one or more indicators of position in real world coordinates of the detected lane mark. The autonomous vehicle road navigation model may also include a at least one target trajectory for a vehicle to follow along the corresponding road segment, as shown in FIG. 24E.

At step 2616, process 2600A may include distributing the updated autonomous vehicle road navigation model to a plurality of autonomous vehicles. For example, server 1230 may distribute the updated autonomous vehicle road navigation model to vehicles 1205, 1210, 1215, 1220, and 1225, which may use the model for navigation. The autonomous vehicle road navigation model may be distributed via one or more networks (e.g., over a cellular network and/or the Internet, etc.), through wireless communication paths 1235, as shown in FIG. 12.

In some embodiments, the lane marks may be mapped using data received from a plurality of vehicles, such as through a crowdsourcing technique, as described above with respect to FIG. 24E. For example, process 2600A may include receiving a first communication from a first host vehicle, including location identifiers associated with a detected lane mark, and receiving a second communication from a second host vehicle, including additional location identifiers associated with the detected lane mark. For example, the second communication may be received from a subsequent vehicle travelling on the same road segment, or from the same vehicle on a subsequent trip along the same road segment. Process 2600A may further include refining a determination of at least one position associated with the detected lane mark based on the location identifiers received in the first communication and based on the additional location identifiers received in the second communication. This may include using an average of the multiple location identifiers and/or filtering out “ghost” identifiers that may not reflect the real-world position of the lane mark.

FIG. 26B is a flowchart showing an exemplary process 2600B for autonomously navigating a host vehicle along a road segment using mapped lane marks. Process 2600B may be performed, for example, by processing unit 110 of autonomous vehicle 200. At step 2620, process 2600B may include receiving from a server-based system an autonomous vehicle road navigation model. In some embodiments, the autonomous vehicle road navigation model may include a target trajectory for the host vehicle along the road segment and location identifiers associated with one or more lane marks associated with the road segment. For example, vehicle 200 may receive sparse map 800 or another road navigation model developed using process 2600A. In some embodiments, the target trajectory may be represented as a three-dimensional spline, for example, as shown in FIG. 9B. As described above with respect to FIGS. 24A-F, the location identifiers may include locations in real world coordinates of points associated with the lane mark (e.g., corner points of a dashed lane mark, edge points of a continuous lane mark, a vertex between two intersecting lane marks and other points associated with the intersecting lane marks, a centerline associated with the lane mark, etc.).

At step 2621, process 2600B may include receiving at least one image representative of an environment of the vehicle. The image may be received from an image capture device of the vehicle, such as through image capture devices 122 and 124 included in image acquisition unit 120. The image may include an image of one or more lane marks, similar to image 2500 described above.

At step 2622, process 2600B may include determining a longitudinal position of the host vehicle along the target trajectory. As described above with respect to FIG. 25A, this may be based on other information in the captured image (e.g., landmarks, etc.) or by dead reckoning of the vehicle between detected landmarks.

At step 2623, process 2600B may include determining an expected lateral distance to the lane mark based on the determined longitudinal position of the host vehicle along the target trajectory and based on the two or more location identifiers associated with the at least one lane mark. For example, vehicle 200 may use sparse map 800 to determine an expected lateral distance to the lane mark. As shown in FIG. 25B, longitudinal position 2520 along a target trajectory 2555 may be determined in step 2622. Using spare map 800, vehicle 200 may determine an expected distance 2540 to mapped lane mark 2550 corresponding to longitudinal position 2520.

At step 2624, process 2600B may include analyzing the at least one image to identify the at least one lane mark. Vehicle 200, for example, may use various image recognition techniques or algorithms to identify the lane mark within the image, as described above. For example, lane mark 2510 may be detected through image analysis of image 2500, as shown in FIG. 25A.

At step 2625, process 2600B may include determining an actual lateral distance to the at least one lane mark based on analysis of the at least one image. For example, the vehicle may determine a distance 2530, as shown in FIG. 25A, representing the actual distance between the vehicle and lane mark 2510. The camera angle, the speed of the vehicle, the width of the vehicle, the position of the camera relative to the vehicle, or various other factors may be accounted for in determining distance 2530.

At step 2626, process 2600B may include determining an autonomous steering action for the host vehicle based on a difference between the expected lateral distance to the at least one lane mark and the determined actual lateral distance to the at least one lane mark. For example, as described above with respect to FIG. 25B, vehicle 200 may compare actual distance 2530 with an expected distance 2540. The difference between the actual and expected distance may indicate an error (and its magnitude) between the vehicle's actual position and the target trajectory to be followed by the vehicle. Accordingly, the vehicle may determine an autonomous steering action or other autonomous action based on the difference. For example, if actual distance 2530 is less than expected distance 2540, as shown in FIG. 25B, the vehicle may determine an autonomous steering action to direct the vehicle left, away from lane mark 2510. Thus, the vehicle's position relative to the target trajectory may be corrected. Process 2600B may be used, for example, to improve navigation of the vehicle between landmarks.

Processes 2600A and 2600B provide examples only of techniques that may be used for navigating a host vehicle using the disclosed sparse maps. In other examples, processes consistent with those described relative to FIGS. 25C and 25D may also be employed.

In some embodiments, the disclosed systems, methods, and non-transitory computer-readable media may use one or more AV maps. An autonomous vehicle (AV) map (or AV map) may include information to support and/or implement one or more autonomous vehicle (AV) functions of a vehicle in manner such that the vehicle operates in a safe manner and/or navigates in an accurate manner. The AV functions supported and/or implemented by an autonomous vehicle (or a semi-autonomous vehicle) may include one or more autonomously controlled functions (e.g., functions determined, selected, and/or implemented based on instructions executed by at least one processor) such as steering, accelerating, and/or braking the vehicle. The AV functions may be part of a driving policy, such as RSS, for example, which was developed and is implemented by Mobileye, of Jerusalem, Israel. The information for operating the vehicle in a safe manner may include, but is not limited to, information pertaining to one or more regulations applicable to a location of the vehicle or a jurisdiction (e.g., a right-hand traffic or left-hand traffic jurisdiction), information related to an environment in which the vehicle is located (e.g., information related to a drivable path, stop sign, traffic light, speed limit, lane markings, landmarks, free space, virtual or physical stop lines, traffic light relevancy information, etc.), and/or information related to adjusting and/or adapting navigation of the vehicle to account for one or more objects (e.g., other vehicles, pedestrians, objects, obstacles, occlusions, hazards, road work zones, traffic cones, etc.) in an environment of the vehicle. The vehicle may sense objects in the environment of the vehicle using one or more sensors (e.g., cameras, radar, lidar), as discussed herein. The AV map may serve as a redundant source of information for the sensed information and, in some cases, may also supplement the sensed information (e.g., provide a location of a virtual stop line, where no stop line is marked on the road). In some embodiments, operating the vehicle in a safe manner may further include operating the vehicle to maintain a comfort level for one or more passengers in the vehicle. The comfort level may include one or more predetermined criteria (e.g., related to speed, acceleration, and/or turning) selected to cause the vehicle to operate in a manner that meets or exceeds a designated or selected level of passenger comfort. The level of comfort may be formalized and expressed in appropriate mathematical formulae. For example, mathematical formulae that limit the extent of jerk or acceleration in different directions that is applied to a passenger may be used. The information for operating the vehicle in an accurate manner may include, but is not limited to, information pertaining to a planned or designated navigational path (e.g., a trajectory, as discussed herein) or a route (e.g., from a particular location, such as a starting location, to a destination). In some embodiments, the information included in an AV map may further include information that supports and/or implements one or more AV functions in an efficient manner. The information for operating the vehicle in an efficient manner may include information pertaining to speed, acceleration, lane changes, and/or lane positioning, and/or traveling and/or selecting a path or route based on traffic conditions (e.g., traveling a route that is a greater distance than a shorter route experiencing traffic conditions) and/or other factors or attributes related to potential routes (e.g., weather conditions, road conditions, or other characteristics of routes, such as traveling a highway without traffic lights instead of a road with traffic lights). In some embodiments, the AV map may further include at least some information from a high-definition (HD) map. In some embodiments, the AV map may be a sparse map, as described above. In some embodiments, the AV map may be crowdsourced, as discussed herein. In this disclosure, the terms “AV map” and “sparse map” are used interchangeably.

### Systems and Methods for Parking a Vehicle

The following embodiments relate to systems and methods for parking a vehicle. Each of the embodiments described in the sections below may include and operate with or based on any of the features, systems, and methods described in the sections above.

### Initial Position Selection to Establish Depth Independent Parking Corridor

Parking of AVs is a challenging task, and many AVs vehicles are limited with respect to the types of parking spaces they can successfully navigate. For instance, typical AVs are selective as to which kind of parking spaces they can autonomously park in, and typically, only parking spaces which meet a specific criterion, e.g., relating to size, orientation, location, nearby obstacles, can be autonomously navigated by, and parked in by, an AV. Thus, there is scope and a need for AV navigation systems with expanded capabilities for improving the flexibility as to which kinds of parking spaces an AV can autonomously park in. There is also a need for AV navigation systems capable of performing an array of different parking space entry maneuvers and for performing complex parking space entry maneuvers to broaden the scope of parking spaces available for use by AVs.

The present system is aimed at enhancing the abilities of AVs to safely enter a wider range of parking spaces from a wider range of initial navigation positions relative to an available parking space. One solution is to select an initial position for the parking space approach maneuver that allows a host vehicle to enter the parking space substantially aligned with the parking space such that an envelope of the host vehicle does not intersect with or cross either the left or the right parking space boundaries (optionally, with a buffer applied). With this technique, a host vehicle can enter the parking space to whatever depth the parking space allows (thus, depth independent). Details of such a system and approach are included in the sections below.

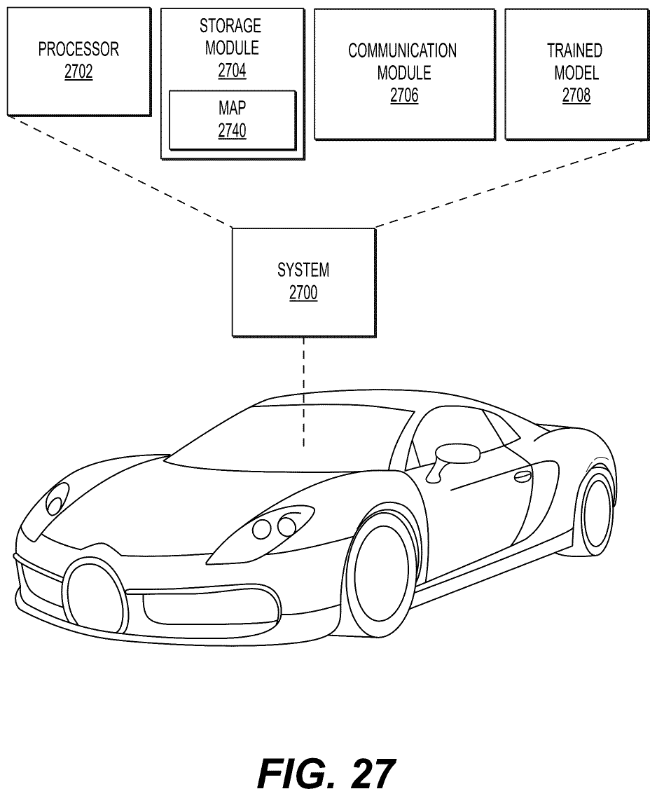

FIG. 27 illustrates a host vehicle navigation system 2700, consistent with disclosed embodiments. Host vehicle navigation system 2700 may, in embodiments, be used by the host vehicle to enable and/or implement features associated with the presently disclosed embodiments. Additionally, or alternatively, various features of the presently disclosed embodiments may be fully or partially implemented and/or enabled by one or systems external to the host vehicle, such as a server in communication with the host vehicle.

System 2700 may include at least one processor 2702, as shown. In addition to processor 2702, system 2700 may include a storage module 2704 and a communication module 2706, which may communicate with processor 2702, one or more sensors, one or more actuators, and/or one or more remotely located servers. Image data, for example, captured by a camera onboard a host vehicle 2720, and any other type of sensor information or driving state information may be received via communication module 2706.

Processor 2702 may include various types of processing devices. For example, processor 2702 may include one or more microprocessors, preprocessors, a central processing unit (CPU), support circuits, digital signal processors, integrated circuits, memory, or any other types of devices suitable for running applications. Communication module 2706 may include one or more devices configured to receive one or more instructions from processor 2702 and/or exchange transmissions over an air interface to one or more networks (e.g., cellular, the Internet, etc.) by use of a radio frequency, infrared frequency, magnetic field, or an electric field. Storage module 2704 may receive data and/or instructions from processor 2702. Storage module 2704 may include one or more of random-access memory (RAM), read-only memory (ROM), flash memory, disk drives, optical storage, tape storage, removable storage and/or any other types of storage. Communication module 2706 may use any known standard to transmit and/or receive data (e.g., Wi-Fi, Bluetooth®, Bluetooth Smart, 3102.15.4, ZigBee, etc.). Such transmissions may include communications from system 2700 to at least one remotely located vehicle.

In some cases, storage module 2704 may store a map 2740 of one or more road segments or geographic regions. In some examples, map 2740 includes a certain number of map tiles (e.g., 1-8 map tiles) that may be downloaded from a mapping server on demand and based on the needs, current location, planned route, etc. of a host vehicle navigation system. In some embodiments, map 2740 is a sparse map (e.g., a REM map), as discussed above.

Additionally, in some embodiments, system 2700 may be capable of communicating with or implementing at least one trained model 2708. Communicating with at least one trained model may include providing one or more different data inputs to the trained model as well as reading or extracting one or more outputs from the trained model. In some embodiments, the at least one trained model may be local to the system. For example, as shown in FIG. 27, system 2700 may implement trained model 2708. Alternatively, in some embodiments, the at least one trained model may be external to the system, and the at least one processor may communicate with the at least one trained model using any suitable means for sending and/or receiving data. For example, the at least one processor 2702 may use communication module 2706 to interact and communicate with a trained model implemented by one or more remotely located processor-based systems.

In the presently disclosed systems, host vehicle navigation system 2700 may rely upon various types of sensor-based information to assist in identifying available parking spaces suitable for the host vehicle. Such sensor-based information may also be relied upon by system 2700 to assist in navigating the host vehicle relative to an available parking space. In some cases, such sensor-based information may include image data provided by one or more cameras (as described in sections above) onboard the host vehicle, one or more LIDAR systems, and/or one or more RADAR systems onboard the host vehicle.

The presently described host vehicle navigation systems may be configured to implement various different navigation maneuvers, e.g., from among a suite of maneuver types, to enable navigation of a host vehicle relative to many different types of parking spaces. Such parking space types may be found in various parking environments (e.g., parking garages, outdoor lots, marked lots, unmarked lots, paved surfaces, unpaved surfaces, etc.) and may include parking spaces of varying geometry (e.g., various widths and depths, rectangularly arranged, fishbone pattern spaces, etc.). Additionally, the presently disclosed host vehicle navigation systems may be configured to cause a host vehicle to successfully navigate into an available parking space from parking lot navigation alleys of varying geometry (e.g., various widths of free space between rows of parking spaces) and starting from various different directions of travel relative rows of parking spaces (e.g., orthogonal to a longitudinal parking space axis, parallel to a longitudinal parking space axis, angled relative to a longitudinal parking space axis, etc.).

Navigating a host vehicle relative to a parking space may be accomplished in various different ways, as described herein. In one embodiment, sensed image data (e.g., an image captured by a camera onboard a host vehicle, a point cloud generated by LIDAR or RADAR system, etc.), wherein the sensed image data includes a representation of a parking space. Here and throughout the disclosure, references to captured images, as a particular example of sensed image data, may be used to simplify the discussion. Such references, however, should be understood to apply equally to other types of sensed image data, such as LIDAR or RADAR generated data. Based at least in part on analysis of the sensed image data, a first indicator of a left boundary and a second indicator of a right boundary associated with the parking space are determined. Optionally, based at least in part on analysis of the sensed image data, an indicator of an entrance to the parking space may be determined. In some cases, the indicator of the entrance to the parking space may include a parking space threshold (e.g., a representation such as a virtual line associated with an entrance to a parking space). Based on the determined first and second indicators of the left and right boundaries and optionally also based on a determined indicator of the entrance to the parking space, such as a parking space threshold, a parking space approach maneuver initial position is determined. The entrance to the parking space may, however, be indicated in any suitable manner (e.g., a detected opening to free space associated with an unoccupied parking space; an edge or face of a virtual bounding box determined for the parking space; one or more corners (and optionally one or more associated 3D real world points) detected relative to a barrier, parked vehicle, painted parking space line, etc.).

The parking space approach maneuver initial position is an initial position for the host vehicle relative to a parking space and from which the host vehicle is able to navigate toward the parking space entrance and enter the parking space with an envelope of the host vehicle between the left boundary and the right boundary, and wherein further entry of the host vehicle into the parking space can be performed without requiring the vehicle envelope to intersect with or cross over the left boundary or the right boundary inside the parking space.

As noted, a parking space entrance may be designated with any suitable indicator. In some cases, such an entrance may be indicated by the presence of free space between parking space boundaries. Such boundaries may be associated with or determined based on one or more parked cars, parking space lines painted on a parking lot surface, barriers, objects, curbs, etc. Left and right parking space boundaries may be associated with any parking corridor determined to have sufficient width to fit the host vehicle. The entrance to the parking space may be associated with a relevant portion of the parking space corridor, including, e.g., a threshold of the parking space beyond which the envelope of the host vehicle should not cross left and/or right boundaries of the parking space or parking corridor. For example, left and right boundaries of a parking space or parking corridor associated with the parking space may extend outside of a region or area of the parking space (e.g., into a parking space alley between rows of parking spaces). Outside of the parking space, however, a host vehicle navigation system may be free to allow the envelope of the host vehicle to cross boundaries of the parking corridor, as outside of the parking space area, there may be not obstacles for the host vehicle to contact. Within the parking space area, however, allowing the host vehicle envelope to cross left and/or right boundaries of the parking space corridor may result in collision or contact with objects such as parked vehicles, barriers, etc.

The entrance to the parking space, or parking space threshold, may be determined in various ways. In some cases, the parking space threshold may be indicated by a virtual line between any two points associated with an entrance to a parking space. Such a virtual line may extend between the ends of two parking space lines painted on the surface of a parking lot, between the nearest corners of two parked cars, between the nearest corners of two barriers, any combination of such parking space delimiters, or between any two points associated with objects on opposing sides of a parking space/parking space corridor. The entrance to the parking space may also be determined as associated with a plane or face of a determined bounding box, a plane between points associated with obstacles (e.g., barriers, parked vehicles, curbs, painted lines, etc.) delineating a parking space (e.g., corners or points of closest approach between the host vehicle and parking space obstacles).

To safely navigate a host vehicle into a parking space, the host vehicle navigation system may determine the initial position of the parking space approach maneuver such that upon reaching the entrance to the parking space, the host vehicle may enter the parking space (e.g., by crossing an indicator associated with parking space entrance, such as a determined parking space threshold) such that the envelope of the host vehicle is between the left boundary and the right boundary of the parking space, and wherein further entry of the host vehicle into the parking space can be performed without requiring the vehicle envelope to intersect with or cross over the left boundary or the right boundary. Activation of one or more actuator systems associated with the host vehicle causes the host vehicle to navigate to the parking space approach maneuver initial position and subsequently into the parking space from the parking space approach maneuver initial position.

The disclosed embodiments are aimed at overcoming one or more challenges or limitations exhibited by traditional autonomous vehicle navigation systems. For example, as noted, traditional AV systems, if configured to navigate relative to a parking space, have limited available parking maneuver options. As a result, such navigation systems are unable to successfully and accurately navigate relative to a wide range of parking space configurations and initial conditions. Rather, such systems are often limited to parking only where a selected parking space satisfies certain rigid configuration requirements and/or initial starting position requirements.

The presently disclosed embodiments seek to overcome such challenges at least in part by analyzing geometry and/or other information relative to a parking space candidate and determining an initial position from which a parking space approach maneuver (e.g., a single, forward-direction or reverse-direction maneuver) may be executed to allow the host vehicle to enter a parking space with an envelope of the host vehicle remaining between a left boundary and a right boundary associated with the parking space. In a particular example, further entry of the host vehicle into the parking space can be performed without requiring the vehicle envelope to intersect with or cross over the left boundary or the right boundary. Such a feature may allow for navigation of the host vehicle into a parking space irrespective of a depth of the parking space. As a result, using the disclosed technique, a host vehicle navigation system may automatically cause a host vehicle to initiate a parking space entry maneuver without first assessing or otherwise determining a depth of a parking space as a precondition for entering the parking space.

The disclosed host vehicle navigation systems may be capable of navigating a host vehicle into various types of parking spaces with various geometries or configurations. For example, parking spaces may be quadrilateral, e.g., rectangular (or otherwise), and may be defined by left and right hand sides (e.g., left and right hand side parking space limiters, whether those limiters correspond to parking space lines or whether such limiters correspond to virtual lines or boundaries of a parking space (e.g., between parked cars, next to one or more objects, etc. with or without a buffer relative to the parked cars or objects). Parking spaces may also be delineated by depth limiters (e.g., any barrier, boundary, line, curb, virtual line, etc.) indicating a depth of a parking space along a longitudinal axis of the parking space between left and right parking space limiters and opposite to a parking space threshold associated with an entrance to the parking space.

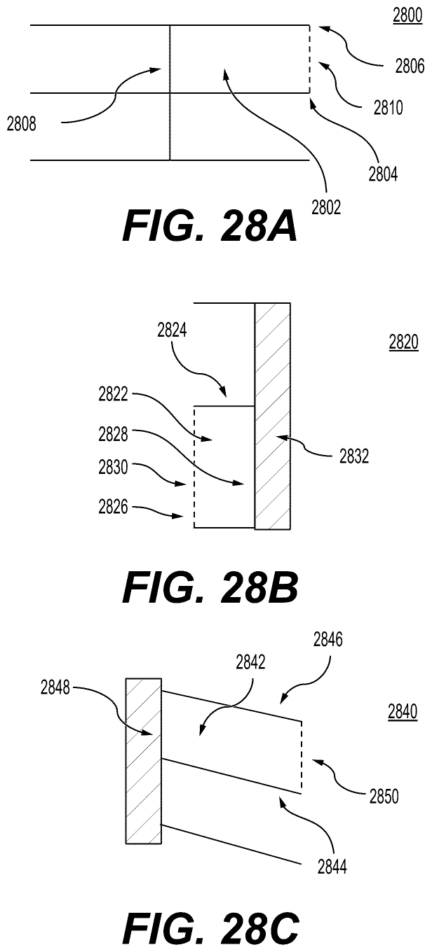

FIGS. 28A, 28B, and 28C show various examples of parking space geometries and configurations relative to which the disclosed host vehicle navigation system may be used to navigate the host vehicle. FIG. 28A shows an orthogonal (or bay) parking space configuration 2800, which includes a parking space 2802. Parking space 2802, in this example, is delineated by a left parking space marker 2804, a right parking space marker 2806, and a parking space depth marker 2808. A parking space threshold 2810 in this example corresponds to a virtual line at the entrance of parking space 2802 between left parking space marker 2804 and right parking space marker 2806.

FIG. 28B shows a parallel parking space configuration 2820, which includes a parking space 2822. Parking space 2822, in this example, is delineated by a forward parking space limiter 2824, an aft parking space limiter 2826, and a right side parking space limiter 2828. A parking space threshold 2830 in this example corresponds to a virtual line at the entrance of parking space 2822 between forward parking space limiter 2824 and aft parking space limiter 2826.

FIG. 28C shows a fishbone parking space configuration 2840, which includes a parking space 2842. Parking space 2842, in this example, is delineated by a left parking space marker 2844, a right parking space marker 2846, and a parking space depth marker 2848. A parking space threshold 2840 in this example corresponds to a virtual line at the entrance of parking space 2842 between left parking space marker 2844 and right parking space marker 2846.

It should be noted that the various examples of parking spaces represented by FIGS. 28A-C may be delineated by various types of parking space limiters. For example, as shown in FIGS. 28A-C, the parking space delimiters correspond to parking space markings (e.g., painted lines on asphalt, etc.). In some cases, however, a parking space may be associated with or at least partially defined by one or more curbs, poles, barriers, objects, parked cars, etc. that establish at least one border of the parking space or limit or define an area associated with the parking space. Any object having a height greater than a predetermined threshold (e.g., 3 cm, 5 cm, 10 cm, etc.) relative to parking lot surface may define or partially define a parking space or parking space area. For example, in FIG. 28B, a curb 2832 (and sidewalk, for example) at least partially forms right side parking space limiter 2828. In this example, parking space limiter 2828 may or may not also include a painted line (e.g., on or just inside curb 2832).

The presently disclosed embodiments may be useful for autonomously navigating a host vehicle relative to any type of parking space configuration, including those represented by FIGS. 28A-C. In the disclosed embodiments, a parking space may be included within a corridor of parking spaces. That is, in embodiments, the parking space is a part of an arrangement of parking spaces, arranged in one or more rows/columns of parking spaces. In such embodiments, a row/column of parking spaces is adjacent to a free space in which vehicles can navigate about the parking spaces (e.g., parking lot navigation alleys).

According to the disclosed embodiments, a parking space includes a parking space threshold corresponding to an entrance to the parking space. The disclosed host vehicle navigation systems may be configured to autonomously navigate a host vehicle such that the host vehicle enters a parking space by crossing the parking space threshold. In the examples shown in FIGS. 28A-C, the parking space thresholds correspond to virtual lines 2810, 2830, and 2850 (although such thresholds may also be designated with any suitable line marking). For example, to enter parking space 2802, a host vehicle may be caused to cross parking space threshold 2810 between left marker 2804 and right marker 2806. To enter parking space 2842, a host vehicle may be caused to cross an entrance to parking space 2842, such as a parking space threshold 2850 between left marker 2844 and right marker 2846 or any other suitable indicator of an entrance to parking space 2842 (e.g., a bounding box face, a free space region boundary, etc.). In the parallel parking configuration example of FIG. 28B, to enter parking space 2822, a host vehicle may be caused to cross parking space threshold 2830 at an angle to approach parking space limiter 2828 (e.g., a curb or line) before turning toward forward limiter 2824 (which may include a painted line, may be unmarked, may correspond to a barrier or parked vehicle, etc.) and coming to rest between forward limiter 2824 and aft limiter 2826. In some cases, such entry into a parallel parking space may constitute a single maneuver (e.g., a single forward or reverse motion arc) from an initial position outside of parking space 2822. In other cases, such entry into a parallel parking space may constitute a more complex maneuver (e.g., an S-shaped maneuver, an S-shaped maneuver or arc maneuver followed by a linear, curved, or S-shaped forward or reverse maneuver) from an initial position outside of parking space 2822.

As noted, various sensor types may be employed to support navigation of a host vehicle relative to an available parking space. Such sensors, for example, may include one or more onboard cameras, LIDAR systems, and/or RADAR systems. In many cases, combinations of such sensor systems may be included on a host vehicle and used in combination to support navigation of a host vehicle relative to a parking space. Such sensor systems may be used to assess various geometric characteristics of observable regions of a parking space, but may also be used in identifying an initial position for a host vehicle from which the host vehicle can enter a parking space using a single parking maneuver (e.g., a single forward motion or reverse motion arced maneuver).

In disclosed embodiments, a captured image may be received from a camera onboard a host vehicle. Such a camera may be any suitable camera (e.g., a side-facing camera, a forward-facing camera, etc.), such as any of the cameras described in the sections above. The captured image may constitute sensed image data including a representation of a parking space or portion of a parking space. As previously noted, sensed image data including a representation of a parking space or portion of a parking space may also be acquired from LIDAR or RADAR systems, etc.

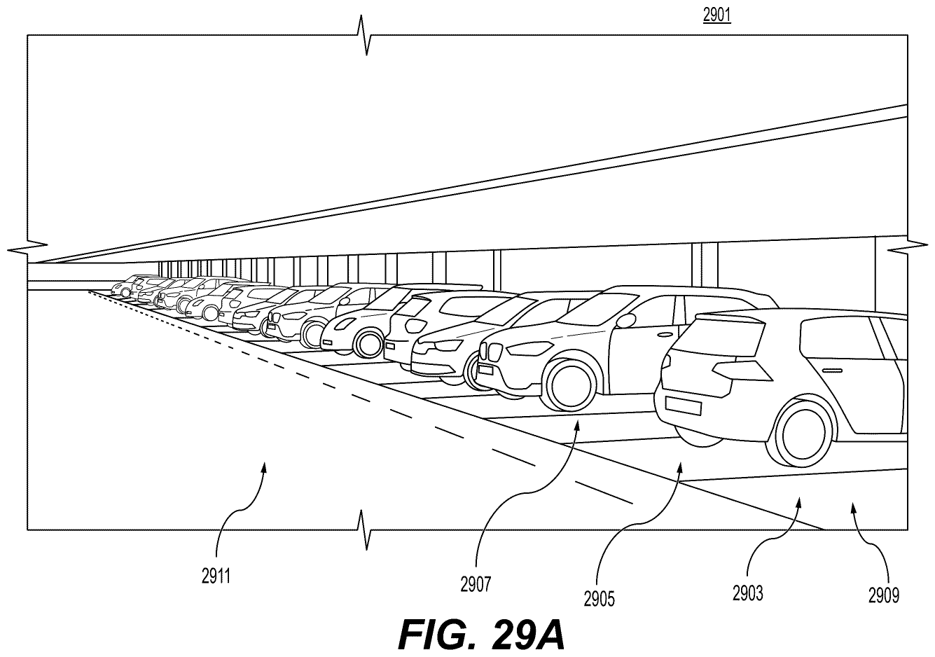

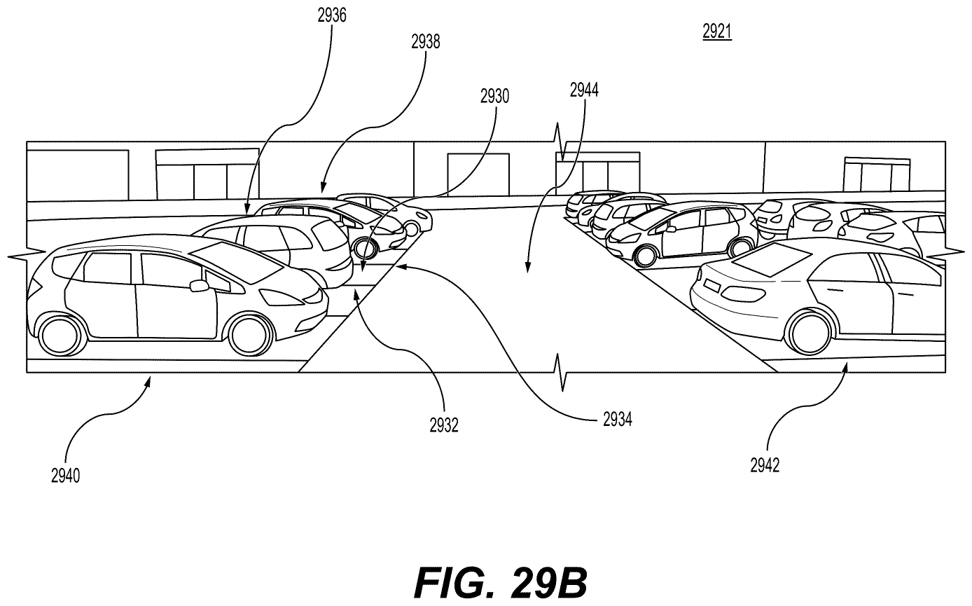

An example of an image 2901 captured by a camera onboard a host vehicle is shown in FIG. 29A. Image 2901 may represent a full or partial field of view of a forward-facing camera, a full or partial field of view of a side-facing camera, a full or partial field of a corner camera mounted on a host vehicle to provide a field of view at partially covering a region forward of the host vehicle and a region to the side of the host vehicle. Image 2901 includes a representation of a parking space 2903, a parking space 2905, and a parking space 2907 (among other parking space representations). As represented by image 2901, parking space 2903 and parking space 2907 are free (unoccupied) and may qualify as available parking space candidates for a host vehicle being navigated according to the disclosed embodiments. In contrast, parking space 2905 is represented in image 2901 as being occupied by another vehicle. In this example, image 2901 represents a parking garage environment that includes a row (or column or corridor) of parking spaces 2909 adjacent to and accessible from a parking lot navigation alley (e.g., a free space) 2911 in which a vehicle can navigate about the parking spaces and from which a vehicle can access an available parking space.

Any suitable technique may be employed for determining whether a parking space candidate is occupied. For example, one or more trained models may be configured to analyze a captured image, or a portion of a captured image, and identify occupied and/or unoccupied parking spaces in a parking environment. Such a determination, whether using a trained model or an algorithmic approach, may be made based on whether an object is represented in a captured image in a region of the image associated with a parking space candidate. If an object representation is present in the region of the parking space candidate, that parking space may be deemed as occupied. A complete view of a parking space candidate need not be available, however, to determine (at least an initial determination suitable for initiating a parking maneuver) that a parking space is unoccupied. For example, in some cases, where no object representation appears in a parking space region of an image within a predetermined distance of the parking space threshold (e.g., 1 m, 2 m, etc.), the parking space may be identified as unoccupied.

FIG. 29B shows another example of an image 2921 that may be captured by a camera (e.g., forward-facing camera) onboard a host vehicle. In this example, image 2921 includes a representation of a parking space 2930 defined by a left side lane marking 2932 and a right side lane marking 2934. Parking space 2930 is adjacent to two other car parking spaces—a parking space on the left side of parking space 2930 that is occupied by a vehicle 2936 and a parking space on the right side of parking space 2930 that is occupied by a vehicle 2938. Further, as shown in FIG. 29B, parking space 2930 is an example of a bay parking space, and is a part of a row of parking spaces 2940. Further, the parking environment represented by image 2921 also includes a representation of a second row of parking spaces 2942 separated from row 2940 by a parking lot navigation alley (e.g., a free space) 2944 in which a vehicle can navigate about the parking spaces and from which a vehicle can access an available parking space.

Captured image 2921 may be received by system 2700, e.g. via communication module 2706, from a camera onboard the host vehicle, and may be analyzed by processor 2702. Any suitable image analysis technique may be employed by processor 2702 depending on the requirements of a particular application. In some cases, the image analysis techniques may include image segmentation and/or an algorithmic analysis relative to one or more regions of interest included in image 2921. In some cases, such image analysis techniques may include providing image data or representations of image data associated with image 2921 to one or more trained models. For example, such trained models (e.g., convolutional neural networks, graph neural networks, transformer based neural networks, etc.) may be configured to receive image data or representations of image data (e.g., feature vectors, encoded image data, embedding vectors, etc.) associated with image 2921. In some cases, such as applications employing graph neural network based trained models, image data input may be represented by a plurality of nodes and a plurality of edge connections between various subsets of the plurality of nodes. In applications employing a large language model approach and/or transformer based trained neural networks, image data input may be represented by a plurality of tokens or vector descriptions associated with image features and/or image segments associated with image 2921.

Exemplary disclosed trained models may also be configured to provide an output indicative of whether any of various predetermined conditions are represented by image 2921. Such conditions may include, among many other things, whether captured image 2921 includes representations of one or more parking spaces, an identification of one or more unoccupied parking spaces represented in image 2921, left and/or right boundaries associated with one or more unoccupied parking spaces (e.g., identification of line markings and/or parked vehicle edges adjacent to an unoccupied parking space), a planned drivable path/trajectory for the host vehicle to navigate prior to initiating a parking maneuver to enter an unoccupied parking space, a location (e.g., an image location or a real world 3D point location) associated with an initial position from which the host vehicle should begin a parking maneuver to enter an unoccupied parking space, an observed or estimated depth of an unoccupied parking space, an observed or estimated width of an unoccupied parking space, etc. Such trained models may analyze a captured image and provide as output a predicted depth value per pixel of a region of interest or an entirety of the captured image. Such depth information may be used to determine 3D point locations in the real world for one or more features represented in the captured image (e.g., parking space lines, parked car edges, etc.). This predicted depth information may be further confirmed by or augmented with (fused with) depth information provided by a sensor such as a LIDAR that may be mounted onboard a host vehicle.

According to an exemplary embodiment, processor 2702, for example, is configured to receive a captured image acquired by a camera onboard the host vehicle, wherein the captured image includes a representation of a parking space; determine, based at least in part on analysis of the captured image, a first indicator of a left boundary and a second indicator of a right boundary associated with the parking space; determine, based at least in part on analysis of the captured image, a parking space threshold associated with the parking space; determine a parking space approach maneuver initial position, wherein the parking space approach maneuver initial position is determined based on the determined first and second indicators of the left and right boundaries and also based on the determined parking space threshold; wherein the parking space approach maneuver initial position is one from which the host vehicle is able to navigate toward the parking space threshold and cross the threshold with an envelope of the host vehicle between the left boundary and the right boundary, and wherein further entry of the host vehicle into the parking space can be performed without requiring the vehicle envelope to intersect with or cross over the left boundary or the right boundary; and cause activation of one or more actuator systems associated with the host vehicle to cause the host vehicle to navigate into the parking space from the parking space approach maneuver initial position.

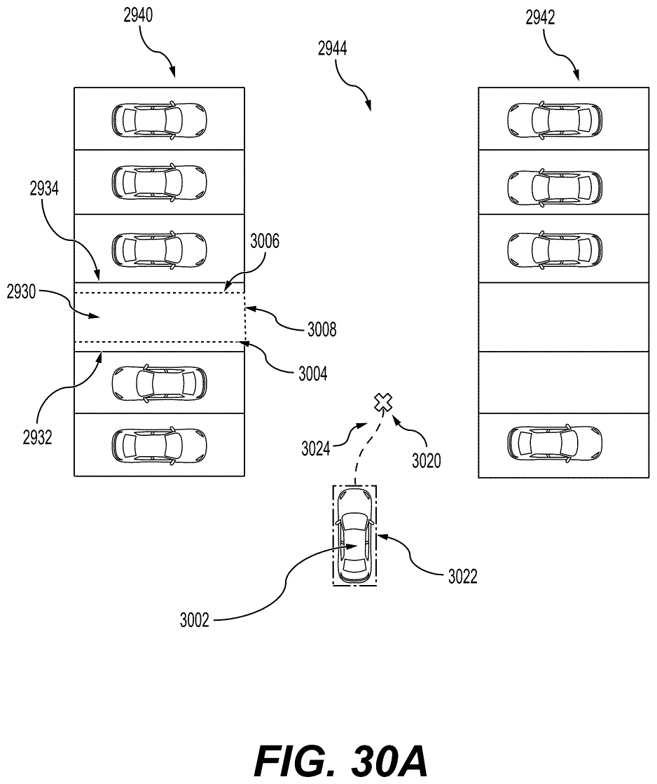

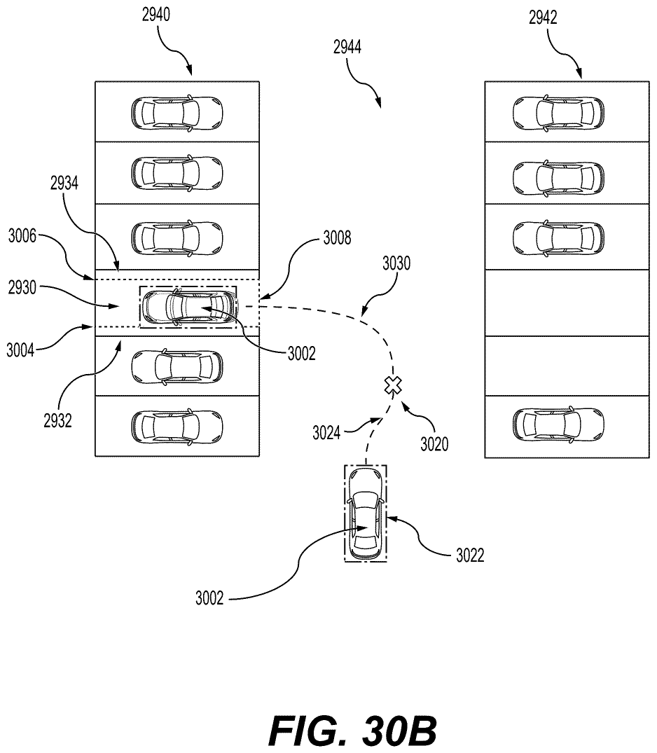

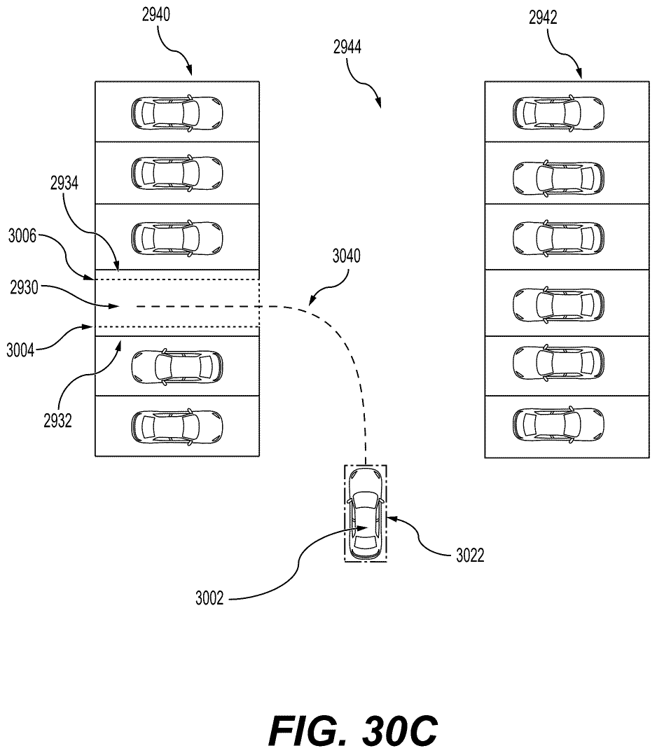

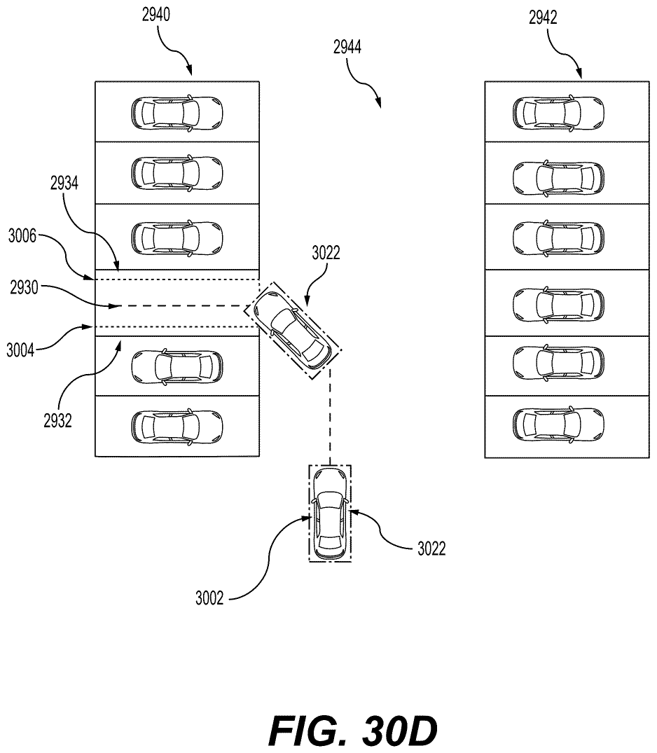

FIG. 30A provides a diagrammatic top-down representation of the parking environment represented by image 2921 of FIG. 29B. For example, in this example, image 2921 is captured by a camera onboard a host vehicle 3002, as host vehicle 3002 navigates along free space 2944 between rows of parking spaces 2940 and 2942. Based at least in part on analysis of the captured image 2921 (e.g., by image segmentation and/or the use of one or more trained models as described above), processor 2702, for example, may determine a first indicator 3004 of a left boundary and a second indicator 3006 of a right boundary associated with parking space 2930.

The first and second indicators can be represented using any suitable technique. In some cases, indicators 3004 and 3006 may be represented as lines or points or a combination (e.g., a line equation, a series of determined 3D points in space, at least two 3D points, two or more 2D image points, etc.). Indicators 3004 and 3006, in other cases, may be represented by bounding boxes, planes, or by any other spatial indicator or other type of indicator. In the example of FIG. 30A, indicators 3004 and 3006 may be represented as lines. Such lines may be coplanar with a surface of the parking lot or may be elevated relative to the surface of the parking lot. In some cases, indicators 3004 and 3006 may include lines that correspond to the left and right parking space lines 2932 and 2934 (e.g., painted lines identifying left and right boundaries of parking space 2930). In some cases, indicators 3004 and 3006 may correspond to other types of parking space designators or boundaries, such as a side of a parked vehicle (e.g., represented by a vertical plane intersecting a distal point of a widest feature) on one or more sides of a parking space, a barrier (e.g., wall, fence, concrete barrier, curb, row of bollards or columns, etc.). Thus, in embodiments, the first and second indicators 3004 and 3006 of the parking space define determined left and right bounds, respectively, of the parking space.

Left and right indicators 3004 and 3006 may be determined in any suitable way. For example, such indicators may be determined algorithmically based on image segmentation techniques (e.g., to identify a parking space line or boundary, a parked vehicle, etc.) and identification of an appropriate boundary identifier for a detected unoccupied parking space (e.g., vertical plane, bounding box, line, etc.). Alternatively, or additionally, any such parking space boundaries and associated indicators 3004 and 3006 may be determined using one or more trained models, such as any of the examples described above. Such models may be configured to receive image data or image data representations (e.g., vectors, tokens, nodes and edges, etc.) as input and, in turn, automatically output representations of left and right indicators 3004 and 3006 (e.g., lines, bounding boxes, planes, etc.).

In some embodiments, left and right indicators 3004 and 3006 may be offset from features represented in image 2921. For example, rather than determining locations of left and right indicators 3004 and 3006 as coinciding with an edge of a parked car, a surface or point of a barrier or obstacle along one or more sides of a parking space, or as collocated with left and right parking lines 2932 or 2934 marking a parking space, left and right indicators 3004 and 3006 may be determined to include a buffer relative to such features. For example, left and right indicators 3004 and 3006 may be located to include a buffer relative to a parked vehicle or a parking line on respective sides of the parking space. Such a buffer may help ensure that there is sufficient space between the host vehicle and a relevant obstacle, such as a barrier or parked car, to provide a safety margin as the host vehicle navigates into a parking space. Such buffers may also assist in ensuring sufficient space remains between the host vehicle and adjacent vehicles or obstacles to allow passengers to exit the host vehicle on one or both sides of the host vehicle. In the example of FIG. 30A, left and right indicators 3004 and 3006 are spaced apart from left and right parking space lines (e.g., lines painted on a surface of the parking lot) by the disclosed buffer.

Such a buffer may be selected to include any suitable amount. In some cases, the buffer can be selected between 0-50 cm, for example. Or more specifically, the disclosed buffer may be at least 5 cm, 10 cm, 15 cm, 20 cm, 30 cm, etc. The buffer may be predetermined and stored in a memory associated with the host vehicle navigation system (e.g., as a parameter value associated with navigation code, etc.). In other cases, one or more parking space buffers determined by the host vehicle navigation system may be controlled by a user (e.g., one or more user-selected buffer values).

In some cases, a captured image, such as image 2941, may not include full representations of one or more features (e.g., lines, parked vehicles, barriers, fences, etc.) corresponding to or designating free space associated with a parking space. For example, such features may be fully or partially obscured by obstacles such as other parked vehicles, walls, etc. In image 2921 of FIG. 29B, for example, lines 2932 and 2934 are partially obscured by parked vehicle 2936. Similarly, a representation of parked vehicle 2938 is partially obscured by the representation of vehicle 2936 in the foreground relative to vehicle 2938. In such embodiments, the first and second indicators may be determined based on the visible portions of relevant features or objects represented in the captured image or other types of sensed image data (e.g., from LIDAR or RADAR systems). Additionally, left and right indicators 3004 and 3006 may be determined based on visible features represented in the captured image, but optionally may also be extrapolated to indicate (with or without a buffer) both the visible and non-visible portions of boundary features associated with a parking space (e.g., lines, parked cars, barriers, etc.).

In some embodiments, left and right parking space boundary indicators 3004 and 3006 may be determined based on image analysis alone (e.g., algorithmically, using one or more trained models, etc.). For example, using a trained model, 3D real world locations associated with boundary indicators 3004 and 3006 may be predicted based on image locations of various features (e.g., lines, parked vehicles, barriers, etc.) represented in a captured image. Alternatively, or additionally, various other sensor information may also be used to determine or augment location determinations associated with boundary indicators 3004 and 3006. For example, LIDAR and/or RADAR point cloud data may be available to assist the host vehicle navigation system (e.g., including processor 2702) in determining representations of the left and right boundary indicators 3004 and 3006.

Additionally, or alternatively, the boundaries of a parking space and associated left and right boundary indicators 3004 and 3006 can be determined from a map. For instance, as described above, in embodiments, a host vehicle may have access to, e.g. comprise (have stored thereon), a (sparse) map, which can e.g., and in embodiments, be generated from crowdsourced data, and which may comprise data relating to landmarks associated with a road or navigable area (e.g., a parking lot, parking garage, etc.). Such landmarks may include lines designating parking space boundaries. Thus, as a host vehicle navigates a free space of a parking lot (e.g., free space 2944), stored parking space line representations and predicted image locations in a captured image 2921 for those parking space line representations may be used to locate the host vehicle relative to the map. Such stored parking space line representations may also be used to navigate the host vehicle relative to real world locations associated with the mapped parking space line representations (e.g., as the host vehicle enters a parking space). When the host vehicle is located relative to a parking space, data from the sparse map associated with the parking space, such as the locations of its boundaries, width, depth, etc., can be obtained (e.g., from the sparse map), and used to determine the locations of the bounds of the parking space, and thus the left and right boundaries of the parking space.

Processor 2702 is also configured to determine, based at least in part on analysis of captured image 2921, a parking space threshold 3008 associated with parking space 2930. Parking space threshold 3008 can be represented in any suitable way. For example, threshold 3008 may be represented as a line (e.g., collocated on a surface of the parking lot, elevated relative to the surface, etc.), a plane (e.g., a vertical plane at an entrance to parking space 2930), etc. In some cases, threshold 3008 corresponds to an entrance of a parking space, such as parking space 2930. Such an entrance may be referenced relative to physical boundaries or constraints associated with a parking space, such as painted lines, parked vehicles, barriers, etc. In other cases, for example, where left and right parking space boundary indicators 3004 and 3006 include offset buffers (as in the example shown in FIG. 30A) the parking space threshold may be referenced relative to left and right parking space boundary indicators 3004 and 3006. In the example of FIG. 30A, parking space threshold 3008 corresponds to (or may be designated by) a line between the closest points of the left boundary and the right boundary of the parking space. Thus, in some embodiments, parking space threshold 3008 may correspond to closest points of the left and right parking space indicators (with or without buffer offsets) 3004 and 3006 at a determined entrance to the parking space.

Parking space threshold 3008 may be determined using any suitable technique. In some cases, a trained model may receive as input some or all of a captured image or data representations of the captured image (e.g., vector descriptions, nodes/edges, etc.) and may output a location or representation of threshold 3008 (e.g., as a line, 3D real world points, etc.). Such lines and/or 3D points may be determined using depth information predicted by a trained model (as described above) and/or may be determined based on LIDAR point cloud data, etc.

As will be appreciated, in embodiments, the parking space threshold can be determined from a sparse map stored on storage module 2704. For example, as set out above, a host vehicle can be localized relative to a parking space using the sparse map, and once it is localized, the parking space threshold can be determined from data in the sparse map relating to the parking space, e.g. the sparse map may indicate the parking space threshold size of the parking space, or other data which allows the parking space threshold size to be determined, such as, but not limited to, the location of the parking space bounds of the parking space (from which the shortest line distance between the two bounds can be determined).

In the disclosed embodiments, processor 2702 is also configured to determine a parking space approach maneuver initial position. The parking space approach maneuver initial position is determined based on the determined first and second indicators of the left and right boundaries and also based on the determined parking space threshold. In the disclosed embodiments, the parking space approach maneuver initial position is one from which a host vehicle is able to navigate toward the parking space threshold and cross the threshold with an envelope of the host vehicle between the left boundary and the right boundary, and wherein further entry of the host vehicle into the parking space can be performed without requiring the vehicle envelope to intersect with or cross over the left boundary or the right boundary.

The parking space approach maneuver initial position can be determined based on the first and second indicators, and the parking space threshold, in any suitable and desired manner. In some embodiments, the parking space approach maneuver initial position is determined using a trained system or model. The trained system or model can be any suitable and desired system or model. The trained model/system may be configured to receive captured image input (e.g., image data or data representations of the captured image data such as vectors, nodes/edges, etc.) and output a predicted location relative to a parking space from which the host vehicle is to initiate a parking space entry maneuver.

In some embodiments, a trained model may be configured to receive as input representations of the indicators of left and right parking space boundaries and a representation of the parking space threshold. Alternatively, the trained model may be configured to infer locations for the indicators of left and right parking space boundaries and the parking space threshold and use those inferences in predicting and providing an output indicating a position of the determined parking space approach maneuver initial position. In the disclosed embodiments, and relative to the example of FIG. 30A, a parking space approach maneuver initial position 3020 is one from which host vehicle 3002 is able to navigate toward parking space threshold 3008 and cross the threshold with an envelope 3022 of the host vehicle between left boundary indicator 3004 and right boundary indicator 3006, and wherein further entry of host vehicle 3002 into parking space 2930 can be performed without requiring vehicle envelope 3022 to intersect with or cross over left boundary indicator 3004 or right boundary indicator 3006. Although in this example, envelope 3022 is represented as a bounding box around the host vehicle 3002, the envelope is not limited to such a form, and can take any suitable form (e.g., one that follows contours of the host vehicle or is defined by one or more point locations associated with features of the host vehicle).

With left and right boundary indicators and the parking space threshold determined, the parking space approach maneuver initial position 3020 may be determined in any suitable manner. In some cases, position 3020 may be determined algorithmically. For example, using predetermined parameter values, such as dimensions of the host vehicle, dimensions of features of the host vehicle relative to various onboard camera positions (e.g., maximum extension of a host vehicle feature (e.g., forward or rear bumper, side panel, etc.), minimum turn radius of the host vehicle, minimum available turn radius for the host vehicle (e.g., where turn radius varies based on parking lot surface conditions or other factors), host vehicle envelope indicators (e.g., relative to one or more onboard camera positions), etc. a position on a surface of the parking lot may be calculated from which the parking space approach maneuver may be initiated. Such a position may correspond to a location from which the host vehicle may enter an available parking space by following a planned trajectory corresponding to a minimum turn radius for the host vehicle. Where more space is available, however, such a position may correspond to a location from which the host vehicle may enter an available parking space by following a planned trajectory corresponding to a turn radius greater than a minimum turn radius for the host vehicle.

One or more trained models may also be used to determine a location of parking space approach maneuver initial position 3020. Such a location may correspond to or may be represented as a 3D real world point location. Such a 3D point location may be collocated with a surface of the parking lot or may be elevated relative to a surface of the parking lot. In some cases, the 3D real world point location may be determined as within a horizontal plane that also includes a location of one or more cameras onboard the host vehicle. In such cases, the trained model may receive one or more captured images (or data representations of one or more captured images (e.g., vector descriptions, nodes/edges, etc.)) and output a location of position 3020. The trained model may also receive as input or may otherwise have access to data (e.g., from a database stored in memory) representative of various parameter values for the host vehicle (e.g., minimum turn radius, kinematic model, center of mass, wheel rotation parameters (e.g. minimum turn radius), etc.), envelope dimensions, camera position information relative to the host vehicle, relative dimensions of various features of the host vehicle with respect to onboard camera positions, one or more other types of dimensions, etc.). Position 3020 may be determined by the trained model based on such parameter values. In addition to accessing such parameter values from a memory, database, etc., one or more of these types of parameters may also be inferred by the trained model based on one or more captured images that include representations of host vehicle structures or features. In such cases, the trained model may infer a host vehicle envelope and corresponding dimensions or constraints associated with the envelope based on known relative locations of cameras and image locations of host vehicle features in images captured by such cameras.

It should be noted that any number of trained models may be used to perform the task of determining a parking space approach maneuver initial position 3020. In some cases, one or more trained models are used to determine left and right parking space boundary indicators 3004 and 3006 and parking space threshold 3008. Indicators or representations of such features may be provided as input to one or more additional trained models configured to output position 3020 based on left and right parking space boundary indicators 3004 and 3006, parking space threshold 3008, parameter values associated with a host vehicle, and/or one or more captured images. In other cases, however, a trained model may generate an output of position 3020 directly upon receiving a captured image (such as image 2921) as input. In such cases, the trained model may be trained to predict position 3020 based on inferences made relative to known parameter values associated with a host vehicle (e.g., provided as input or otherwise accessible by the trained model) along with locations of left and right parking space boundary indicators 3004 and 3006 and parking space threshold 3008 that the trained model can infer based on analysis of one or more captured images (or data representations of those images).

Parking space approach maneuver initial position 3020 may be represented in any suitable way. In some cases, position 3020 is represented as a 3D real world point location. Such a 3D point location may be included on a plane associated with a surface of the parking lot or included in a plane that includes a position of one or more cameras onboard the host vehicle.

With parking space approach maneuver initial position 3020 determined, the host vehicle navigation system may plan a trajectory for navigating the host vehicle to initial position 3020. The planned trajectory from a current location associated with the host vehicle to the initial position 3020 may be represented in any suitable manner, such as a series of 3D real world point locations, a 3D spline, a 2D curve along a plane determined as representative of the parking lot surface, etc. One or more trained models may be used to generate the planned trajectory to initial position 3020. It should be noted that the same trained model(s) used to determine initial position 3020, as described above, may be used to generate the planned trajectory for navigating the host vehicle to initial position 3020. In other cases, however, the planned trajectory may be determined by one or more trained models that receive initial position 3020 as input, for example.

It should also be noted that the initial position 3020 determination and determination of the planned trajectory for navigating the host vehicle to initial position 3020 may be performed relative to any newly captured image representative of the parking lot environment. In some cases, for example, image frames from a camera onboard a host vehicle may be received at a periodic rate (e.g., 9 Hz, or greater or less). A initial position 3020 and planned trajectory determination may be determined based on any or all of the newly acquired images. Thus, in some cases, an initial position 3020 and a planned trajectory may be determined at a rate of 9 Hz as the host vehicle is navigated toward the planned trajectories determined for each received image. In some examples, techniques may be used to smooth the planned trajectory determination (e.g., limiting a newly planned trajectory to one or more point locations of a newly planned trajectory to the same or similar points determined for a prior planned trajectory). Such techniques can help stabilize the planned trajectory determinations.

Navigation of the host vehicle to parking space approach maneuver initial position 3020, therefore, may proceed by determination of a new parking space approach maneuver initial position 3020 with each image frame received. Similarly, as noted above, a new (or partially new) planned trajectory for navigating the host vehicle to position 3020 may also be determined with each newly captured image. Navigation ends when host vehicle 3002 (e.g., a predetermined location relative to host vehicle 3002, such as a center of a front bumper, a location of a forward facing camera onboard host vehicle 3002, etc.) reaches position 3020 before receiving a newly captured image.

Navigation along a planned trajectory may be performed with the assistance of one or more sensors. For example, wheel rotation sensors, accelerometers, etc. may be used to determine a host vehicle position relative to a planned trajectory. Additionally or alternatively, the host vehicle may be localized relative to the planned trajectory using mapped landmark locations stored in a sparse map (e.g., REM map), as described above. In some cases, GPS sensor information may also be used to assist in locating the host vehicle relative to a planned trajectory.

Navigating host vehicle 3002 to initial position 3020 may also include positioning host vehicle 3002 upon reaching initial position 3020 to have a desired heading direction. For example, in some cases, it may be desired for host vehicle 3002 to be oriented such that a longitudinal axis of host vehicle 3002 is generally parallel to parking space threshold 3008. From the initial position 3020 and with such an orientation, host vehicle 3002 may be navigated into parking space 2930 using an approximately 90 degree arc maneuver. It is also possible for host vehicle 3002 to be maneuvered into parking space 2930 from an initial orientation where the longitudinal axis of host vehicle is less than parallel with threshold 3008 (e.g., a heading direction of host vehicle 3002 is angled toward threshold 3008) or where the longitudinal axis of host vehicle is greater than parallel with threshold 3008 (e.g., a heading direction of host vehicle 3002 is angled away from threshold 3008). In such cases, a less than 90 degree arc maneuver or a greater than 90 degree arc maneuver may be employed for navigating the host vehicle toward and into the parking space 2930.

Each planned trajectory (e.g., determined by processor 2702 using one or more trained models, as described above) may be determined and generated to include an approach toward initial position 3020 that orients host vehicle 3002 at a desired orientation relative to the parking space (e.g., parking space threshold 3008). Depending on a location of the host vehicle relative to a determined initial position 3020, various types of planned trajectories may be to provide desired heading direction at initial location. For example, in the scenario represented by FIG. 30A, an S-shaped planned trajectory 3024 may be generated to orient host vehicle 3002 generally parallel to threshold 3008 upon reaching initial position 3020.

The disclosed host vehicle navigation systems continue to generate planned trajectories for the host vehicle after reaching the determined initial position 3020 from which to initiate one or more parking space entry maneuvers. The planned trajectories may be determined using any of the techniques discussed above (e.g., algorithmically generated, determined using one or more trained models, etc.). Further, such planned trajectories from initial position 3020 toward and into parking space 2930 may be determined/generated for each image frame received from a camera onboard host vehicle 3002. The planned trajectories from initial position 3020 into parking space 2930 may be represented as a series of 3D real world point locations, a series of 2D points relative to a road surface model or plane representative of a parking lot surface, a 3D spline, or any other suitable path representation.

As described above, initial position 3020 is determined as a location from which host vehicle 3002 is able to navigate toward parking space threshold 3008 and cross the threshold with an envelope 3022 of the host vehicle between a determined left boundary 3004 of parking space 2930 and a determined right boundary 3006 of parking space 2930. Further, initial position 3020 is determined or selected such that host vehicle 3002 is able to maneuver into parking space 2930 without requiring vehicle envelope 3022 to intersect with or cross over the left boundary 3004 or the right boundary 3006. Selection of initial position 3020 based on such criteria helps ensure that planned trajectories for host vehicle 3002 generated at initial position 3020 and as the host vehicle navigates into parking space 2930 are not likely to result in envelope 3022 intersecting with either left boundary 3004 or the right boundary 3006. Not only does such an approach reduce or eliminate a risk that host vehicle 3002 contacts parked cars (or barriers, objects, etc.) on either side of parking space 2930, but such an approach also assists in centering host vehicle 3002 within parking space 2930.

As host vehicle 3002 navigates into parking space 2930 along a planned trajectory generated by the host vehicle navigation system, one or more sensors may be relied upon to confirm that host vehicle 3002 does not contact objects, barriers, parked vehicles, etc. adjacent to parking space 2930. Such sensors may include LIDAR units, RADAR units, sonic units, cameras, etc. As host vehicle 3002 navigates relative to parking space 2930, if one or more sensor outputs indicate that host vehicle 3002 is at risk of contacting an object, barrier, or parked vehicle, etc. adjacent to parking space 2930 or if host vehicle envelope 3022 is on course to intersect with left boundary 3004 or right boundary 3006, the host vehicle navigation system may cause host vehicle 3002 to change course relative to a planned trajectory. In some cases, such a sensor output may cause the host vehicle navigation system to generate an updated planned trajectory that allows host vehicle 3002 to navigate into parking space 2930 without vehicle 3002 contacting an adjacent object or envelope 3022 crossing a parking space boundary. In other cases, the host vehicle navigation system may cause host vehicle 3002 to abort the parking space entry maneuver (e.g., by reversing out of parking space 2930 and navigating to a new parking space candidate).

It should be noted that in some cases, a host vehicle navigation system may initiate a parking space entry maneuver and/or a parking maneuver initial position based on criteria different from those discussed above. For example, in some cases, the host vehicle navigation system may determine a parking maneuver initial position 3020 based on an indicator of a left parking space boundary, without also determining a right parking space boundary. Similarly, in some cases, the host vehicle navigation system may determine a parking maneuver initial position 3020 based on an indicator of a right parking space boundary, without also determining a left parking space boundary. And, in some cases, it need not be necessary to determine a parking space threshold or indicator of such a threshold in order to initiate a parking space entry maneuver.

FIGS. 30B to 30D provide diagrammatic representations of various parking space entry scenarios. As shown in FIG. 30B, implementing the parking space entry procedure outlined above, the navigation system of host vehicle 3002 selects parking space entry maneuver initial position 3020 and plans trajectory 3024 (an S-shaped trajectory in this example) to follow in order to navigate vehicle 3002 to initial position 3020. From position 3020, the navigation system plans a trajectory 3030 to enable vehicle 3002 to turn toward parking space 2930, cross parking space threshold 3008 without host vehicle envelope 3022 crossing over left parking space boundary 3004 or right parking space boundary 3006. Trajectory 3030 may or may not include an arced section having a radius corresponding to a minimum turn radius for vehicle 3002. For example, in some cases (where sufficient space exists in free space region 2944, for example), trajectory 3030 may include an arced section (or other type of curved section) having a radius greater than a minimum turn radius of host vehicle 3002.

Notably, host vehicle 3002 may be navigated toward initial position 3020 such that any desired orientation of host vehicle 3002 is achieved upon reaching initial position 3020. In some cases, as in the example of FIG. 30B, host vehicle 3002 may arrive at location 3020 with an orientation substantially parallel to parking space threshold 3008. In other embodiments, however, host vehicle 3002 may be caused to navigate toward location 3020 such that upon arrival at location 3020, host vehicle 3002 is not parallel to threshold 3008. For example, in some cases host vehicle 3002 may be oriented at location 3020 such that a longitudinal axis of host vehicle 3002 is rotated toward parking space 2930 relative to a line parallel with threshold 3008.

As noted, initial position 3020 may be determined or designated in any suitable manner. For example, in some cases, initial position 3020 may be designated as a 2D X-Y location on a plane associated with a road surface (e.g., parking lot surface) or an X-Y position relative to a road surface model representing a road/parking lot surface. In other cases, initial position 3020 may be designated as a 3D real world point. Initial position 3020 may also be designated not as a single point, but as a region or area on a road/parking lot surface (e.g., a bounding box of a desired shape, dimension, and optionally orientation). Initial position 3020 may also be associated with a desired or planned orientation vector or directional indicator to aid in orienting host vehicle 3002 with a target orientation upon reaching initial position 3020.

It should be noted that the disclosed system may determine that host vehicle 3002 is located at initial position 3020 using various techniques. For example, in some cases, the disclosed navigation system may determine that host vehicle 3002 is located at initial position 3020 when a predetermined point or location associated with host vehicle 3002 (e.g., an X-Y onboard camera location, a position of a point on envelope/bounding box 3022, or any other point or location associated with host vehicle 3002) is collocated with initial position 3022 or offset from initial position 3022 by predetermined X, Y, and/or Z translations.

FIG. 30C provides a diagrammatic representation of a scenario in which a parking space entry maneuver initial position 3020 is not determined or where insufficient spaces exists in free space region 2944 to navigate to an initial position that would allow host vehicle to enter space 2930 without envelope 3022 crossing boundary 3004 or boundary 3006. For example, as shown in FIG. 30D, where host vehicle 3002 is navigated to follow a planned trajectory 3040 (e.g., an arced trajectory having a radius corresponding to a minimum turn radius of vehicle 3002 but not initiated from an initial position 3020 due to space constraints of region 2944), envelope 3022 of host vehicle 3002 intersects with both left boundary 3004 and right boundary 3006. Such an approach to parking space 2930 may increase the possibility of contact between host vehicle 3002 and parked vehicles adjacent to parking space 2930 (or any other objects or barriers that may be present adjacent to parking space 2930).

As illustrated by FIGS. 30C and 30D, there may exist certain parking spaces for which no parking space entry maneuver initial position exists from which a host vehicle may enter a target parking space without its envelope crossing a parking space boundary. Such a scenario may occur, for example as shown in FIGS. 30C and 30D where there is limited space between rows of parking spaces. Such a scenario may also occur, for example, where a host vehicle is large or oversized, especially relative to available parking spaces. For example, as host vehicle width and/or length increase, so too does its envelope. And, as the size of the envelope increases, it may become less likely to identify a suitable parking space entry maneuver initial position from which the host vehicle can enter a parking space without crossing the left or right boundary associated with the parking space. In an additional example, it may be determined that a particular host vehicle is not suitable for an identified available parking space. For example, based on one or more captured images, such as image 2921, upon determining left and right boundaries 3004 and 3006, processor 2702 may also determine that there is insufficient width between left and right boundaries 3004 and 3006 to accommodate a width of the host vehicle without an envelope associated with the host vehicle crossing left and/or right boundaries 3004 and 3006. In such cases, the host vehicle navigation system may forego an attempt to navigate toward the identified, available parking space.

To navigate host vehicle 3002 relative to parking space 2930, the host vehicle navigation system including one or more processors, such as processor 2702, may cause activation of one or more actuator systems associated with the host vehicle. Such actuator systems may include a throttle system, a gear selection system, a braking system, and/or a steering system. As discussed above with regard to FIG. 2F, activation of such actuator systems may include sending control signals (e.g., from a processor such as processor 2702) to the various actuator systems to cause the host vehicle to move along a planned trajectory and toward a desired or target position.

Using such actuator systems, the host vehicle navigation system may cause host vehicle 3002 to navigate relative to planned trajectory 3024 (FIG. 30A) toward parking space approach maneuver initial position 3020. Similarly, the host vehicle navigation system may cause host vehicle 3002 to navigate relative trajectory 3030 to enter parking space 2930 without crossing the determined left or right boundary associated with the parking space.

The host vehicle navigation system is configured to cause continued actuation of the actuator systems as the host vehicle navigates along planned trajectory 3030 in order to move host vehicle 3002 deeper into parking space 2930. When the host vehicle navigation system determines that the host vehicle has reached a parking maneuver termination location, the host vehicle navigation system activates the braking system to bring the host vehicle to a stop. Such a parking maneuver termination location may be determined based on one or more images captured as the host vehicle enters or navigates within parking space 2930. The termination location may also be determined as corresponding to a location within parking space 2930 where host vehicle 3002 has fully crossed threshold 3008 such that host vehicle 3002 resides fully within parking space 2930. In some cases, the termination location may also be determined as corresponding to a location within parking space 2930 where host vehicle 3002 has not fully crossed threshold 3008, but that host vehicle 3002 resides within parking space 2930 to a degree that envelope 3022 of host vehicle 3002 does not extend into region 2944 to an extent that would cause interference with vehicle movement within region 2944 (e.g., less than 1.5 meters protrusion into region 2944, less than 1.0 meters, less than 0.5 meters, etc.).

In some cases, the parking maneuver termination location may also be determined based on a determined location of a depth limiter associated with parking space 2930. Such a depth limiter (e.g., a painted line, curb, parked vehicle, pole, barrier, etc. positioned along a longitudinal axis of parking space 2930 opposite to threshold 3008 may be determined, e.g., based on analysis of one or more captured images and/or based on LIDAR depth information.

As host vehicle 3002 navigates into parking space 2930 along a planned trajectory generated by the host vehicle navigation system, one or more sensors may be relied upon to confirm that host vehicle 3002 does not contact objects, barriers, parked vehicles, etc. adjacent to parking space 2930. Such sensors may include LIDAR units, RADAR units, sonic units, cameras, etc. As host vehicle 3002 navigates relative to parking space 2930, if one or more sensor outputs indicate that host vehicle 3002 is at risk of contacting an object, barrier, or parked vehicle, etc. adjacent to parking space 2930 or if host vehicle envelope 3022 is on course to intersect with left boundary 3004 or right boundary 3006, the host vehicle navigation system may cause host vehicle 3002 to change course relative to a planned trajectory. In some cases, such a sensor output may cause the host vehicle navigation system to generate an updated planned trajectory that allows host vehicle 3002 to navigate into parking space 2930 without vehicle 3002 contacting an adjacent object or envelope 3022 crossing a parking space boundary. In other cases, the host vehicle navigation system may cause host vehicle 3002 to abort the parking space entry maneuver (e.g., by reversing out of parking space 2930 and navigating to a new parking space candidate).

One potential advantage offered by the presently disclosed embodiments is that the host vehicle navigation system may initiate a series of parking space entry maneuvers in cases where information relating to the depth of the parking space is not available. For example, captured image 2921 (FIG. 29B) includes a representation of parking space 2930. The representation of parking space 2930 in image 2921 may be sufficient to suggest to the host vehicle navigation system that parking space 2930 is available/unoccupied. As shown in FIG. 29B, however, only a partial representation of parking space 2930 is available. Thus, based on captured image 2921, it may not yet be possible for the host vehicle navigation system to determine an available depth of parking space 2930. It may be possible that there is a small car, a motorcycle, or an object that is not represented in image 2921, but nevertheless blocks access to a full depth of parking space 2930 (or sufficient depth to fit host vehicle 3002). In other cases, a depth limiter, such as a curb, pole, or other obstacle may be present at a distal end of parking space 2930. A representation of such a feature may be absent from captured image 2921 and, in some cases, such a feature may result in a depth of parking space 2930 that is insufficient to fit host vehicle 3002. Nevertheless, according to the disclosed embodiments, the host vehicle navigation system may initiate a parking space entry maneuver without complete information regarding an available depth associated with parking space 2930.

In such cases, the host vehicle navigation system may determine parking space characteristics, such as parking space boundaries 3004, 3006 and parking space threshold 3008 as described above and determine a parking space maneuver initial position 3020 without information associated with a depth limiter for the parking space. Not requiring full parking space depth information as a prerequisite for initiating a parking space entry maneuver may make autonomous vehicle parking maneuvers more efficient and pleasant from a user experience viewpoint. For example, in some cases, such as the scenarios represented by images 2901 and 2921, a host vehicle navigation system may identify candidate parking spaces as potentially available and/or deep enough to accommodate the host vehicle. However, in some cases, without passing by the parking space, it may be difficult or impossible to determine (e.g., based on captured images, LIDAR information, RADAR information, etc.) whether the candidate space can properly accommodate the host vehicle (e.g., has sufficient depth, is not occupied by a small vehicle not represented in a captured image, etc.). Thus, in such cases, a host vehicle navigation system may have limited options relative to parking spaces that are at least partially obscured from view: forgo a parking space candidate altogether in favor of a parking space candidate more visible to onboard sensors; pass by a candidate space, acquire sensor information relative to the candidate space, reverse into the space, or reverse to a position from which a forward parking space entry maneuver may be initiated; etc. Such options may result in increases in time required to autonomously park a host vehicle and/or reduced parking space options and passed parking spaces (especially in crowded lots). Such inefficiencies may result in negative experiences for users of autonomous vehicles. In contrast to these limitations, the disclosed systems may offer reduced times for parking an autonomous vehicle, reduced complexity in parking entry maneuvers, and/or increased flexibility in selecting a parking space candidate for parking an autonomous vehicle. In the disclosed systems, selection of the parking space entry maneuver initial position (based on threshold determinations dependent not on parking space depth, but dependent on determined boundaries of the parking space candidate) may enable the host vehicle navigation system to initiate a parking space entry maneuver even where information relating to the depth of the parking space is not available. If it is later determined during entry of a parking space that the parking space lacks sufficient depth to accommodate the host vehicle, the host vehicle can be navigated to a new candidate space. In many (or most) cases, however, a host vehicle navigation system will determine during entry of a parking space that the parking space has sufficient depth to accommodate the host vehicle. In such cases, the parking space entry maneuver can simply progress to completion without expending any additional effort or time for sensing depth information as a prerequisite to initiating a parking space entry maneuver.

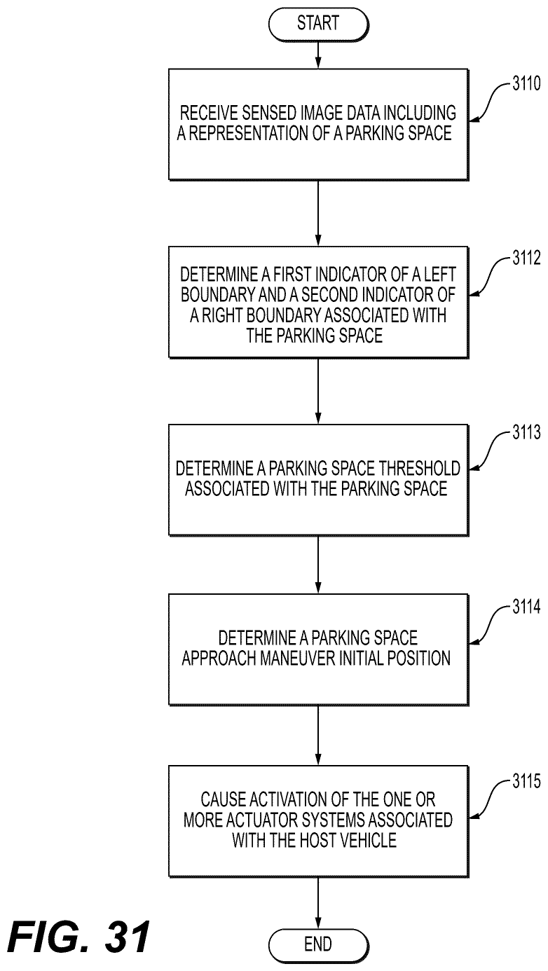

FIG. 31 is a flowchart showing a process for navigating a host vehicle relative to a parking space according to the present embodiments. As shown in FIG. 31, the process begins with receiving a sensed image data acquired by a camera on the host vehicle (step 3110). The image includes a representation of a parking space and can be processed and obtained in any suitable and desired manner, as discussed above. The process continues by determining a first indicator of a left boundary and a second indicator of a right boundary associated with the parking space (3112). This can be done as described above. A parking space threshold is determined (step 3113). Based on the first and second indicators of the left and right boundaries, and also based on the determined parking space threshold, a parking space approach maneuver initial position is then determined (step 3114). Once the parking space approach maneuver initial position is determined, one or more actuator systems associated with the host vehicle are then activated to cause the host vehicle to navigate into the parking space from the parking space approach maneuver initial position (step 3115), e.g. by navigating the host vehicle into the parking space approach maneuver initial position and then into parking space.

It should be noted that while the described embodiments include determination of a parking space threshold in order to identify the parking space approach maneuver initial position, such a step is not required in every situation. Rather, in some cases, determination of the parking space approach maneuver initial position may be based solely on the determined left and right parking space boundaries. In general, however, determination of a parking space threshold is consistent with determining an entrance to an available parking space. Such an entrance may be bounded by the determined left and right parking space boundaries.

As will be appreciated from the above, the present embodiment allows for more flexible parking by allowing the host vehicle to determine and navigate into a parking space approach maneuver initial position which allows the host vehicle to navigate into the parking space without intersecting and crossing over the left and right side boundaries of the parking space.

### S Maneuver on Third Leg or Serpentine Maneuver

As noted above, AVs equipped with traditional navigation systems may have limited options for navigating relative to parking spaces. For example, in many cases, AVs may be limited to a small number of predetermined parking maneuvers that may be incompatible with certain types of parking spaces and parking configurations. As a result, AV parking can be an inefficient and sometimes ineffective process that can leave users frustrated. The presently disclosed systems and techniques are aimed at making AV parking more efficient and effective such that an AV may successfully navigate relative to a wide range of parking environments including various parking space types and configurations.

In some embodiments, the presently disclosed embodiments may include a host vehicle navigation system configured to perform certain types of maneuvers at different stages of the parking process with an aim to make AV parking more flexible and efficient. Such maneuvers may include a reverse motion leg (e.g., to locate the host vehicle at a parking space approach maneuver initial position), an S-shaped maneuver, (e.g., for parallel parking) or both a reverse motion leg and an S-shaped maneuver incorporated into a series of parking maneuvers to navigate a host vehicle relative to an available parking space. With such capabilities, the disclosed host vehicle navigation systems may be capable of successfully parking the host vehicle in a wide range of parking environments. Additionally, the disclosed host vehicle navigation systems may be capable of making navigation corrections at various stages of a series of parking maneuvers in order to successfully park a host vehicle (e.g., rather than having to abort a parking attempt) where it is determined during a parking maneuver that at least one aspect of the planned maneuver would violate a predetermined parking constraint (e.g., crossing a parking space boundary, contacting a barrier or parked vehicle adjacent to a parking space, etc.). These capabilities may enhance a user experience by increasing the number of parking space types and conditions available to an AV, by decreasing time required to park and AV, and/or by increasing the likelihood that a host vehicle can be successfully parked once a parking maneuver sequence is initiated (e.g., without having to abort a parking sequence and retry).

For example, for a typical reverse perpendicular parking maneuver (as a double arc) into a space on the right of a host vehicle, the x-axis may represent a path along the travel lane, and the y-axis may represent a perpendicular to the travel lane (e.g., toward one or more parking spaces). The initial heading θ₀=0° (e.g., aligned with X-axis) and the goal is a final heading θf≈−90° and a final position translated into the parking space. Accordingly, unlike parallel parking, the final heading does not equal the initial heading. The process may include a first arc (e.g., entry rotation), where the host vehicle, begins reversing and turn the wheel fully toward the space to create constant curvature κ=+1/R, rotation around an instantaneous center on one side, and the ending angle θ decreases from 0° toward −90°. Geometrically, the rear axle may trace part of a circle of radius R. During this arc, X decreases (moving backward); Y increases (entering the space); and θ rotates steadily. The process may further include a second arc (e.g., alignment and/or straightening) at which some angle (e.g., 40-60°), the host vehicle reverses steering lock. As part of this step, curvature flips sign→κ=−1/R, the instantaneous center jumps to the opposite side, and rotation slows and stabilizes. The different between this process and parallel parking is that. in perpendicular parking, the host vehicle doe not cancel the full rotation. Rather, the first arc generates most of the 90° rotation and the second arc 2 fine-tunes position and aligns the car within the boundaries. The two arcs are not symmetric. That is, Δθ₁=rotation from arc 1 and Δθ₂=rotation from arc 2. For parallel parking, Δθ₁+Δθ₂≈0. For perpendicular parking, Δθ₁+Δθ₂≈−90°. Thus, the maneuver is still a double curvature change, but not curvature cancellation. Between arcs:, steering crosses zero, curvature=0 momentarily, and the path has an inflection point. This is still an S-like curve, but it may be truncated and it may not be a symmetric S. Rather, it may be an S that ends in rotation. Accordingly, arc 1 creates angular momentum (e.g., a heading change) and arc 2 refines the translation while stabilizing a heading direction. The double arc may allow a large heading rotation, controlled lateral displacement, and precise alignment inside a narrow rectangular constraint. A single circular arc would overshoot depth, hit the boundary, or leave an incorrect orientation. Thus, the second arc may act as a correction phase.

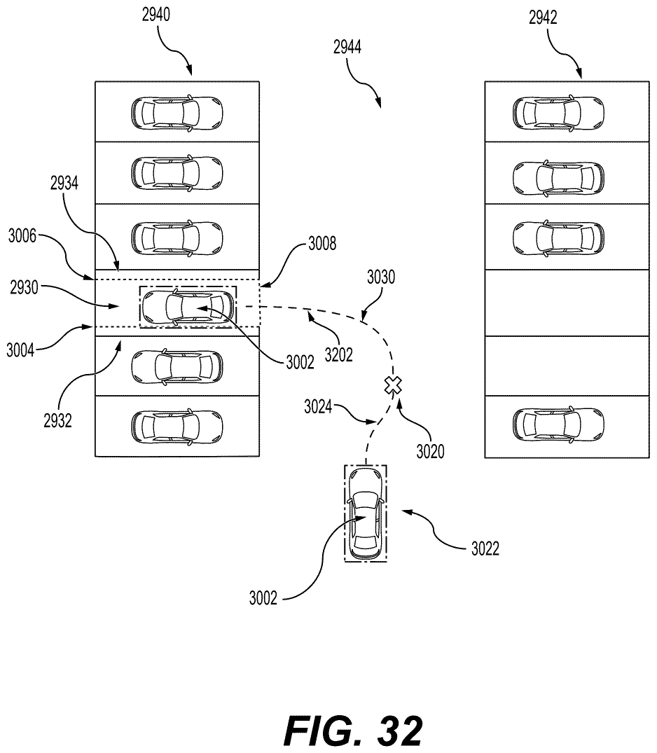

As noted, the presently disclosed host vehicle navigation systems may be configured to perform an S-shaped maneuver during a parking sequence. Such an S-shaped maneuver may be incorporated into any desired leg in a sequence of parking maneuvers. For example, as shown in FIG. 32, a planned trajectory for a host vehicle may include an S-shaped trajectory 3024. Such an S-shaped trajectory, as described above, may be useful for navigating host vehicle 3002 to parking space entry maneuver initial position 3020. In other cases, a planned trajectory 3030 for navigating host vehicle 3002 toward parking space 2930 may include an S-shaped trajectory segment 3202, as shown in FIG. 32. Trajectory segment 3202 may be useful, for example, for correcting alignment of host vehicle 3002 relative to parking space 2930, as host vehicle travels toward parking space 2930. For example, in the example represented by FIG. 32, as host vehicle 3002 travels away from initial position 3020 along the initial arced segment of planned trajectory 3030, the host vehicle navigation system may determine (e.g., based on analysis of one or more images captured by one or more cameras onboard host vehicle 3002) that the planned trajectory is likely to result in envelope 3022 not being centered relative to parking space 2930 (e.g., relative to left and right boundaries 3004 and 3006). And, if envelope 3022 is not centered relative to parking space 2930 and/or left and right boundaries 3004 and 3006, there may be an increased risk that envelope 3022 intersects with one of left boundary 3004 or right boundary 3006. To correct a misalignment of host vehicle 3002, the host vehicle navigation system can determine and generate (e.g., as host vehicle 3002 approaches parking space 2930) a planned trajectory that includes S-shaped trajectory segment 3202. Such an S-shaped trajectory segment may be useful for re-aligning host vehicle 3002 relative to parking space 2930 as host vehicle 3002 approaches parking space 2930 (e.g., rather than requiring an aborted parking space maneuver and another parking attempt).

As described above, images may be acquired by cameras onboard host vehicle 3002 at any suitable rate (e.g., 9 Hz). And, in response to one or more acquired images, a new planned trajectory may be determined for host vehicle 3002. In this way, as new information becomes available (e.g., based on analysis of captured image frames, from LIDAR or RADAR sensors, etc.), new planned trajectories may be generated that account for the new information. In some cases, the new information may include an indication (based on analysis of a captured image frame, etc.) that envelope 3022 of vehicle 3002 is not aligned as desired relative to parking space 2930 and/or left or right boundaries 3004 and 3006. In response to such information, a new planned trajectory may include S-shaped segment 3202 in order to re-align or to correct alignment of host vehicle 3002 relative parking space 2930 and/or left or right boundaries 3004 and 3006.

As described herein, an S-shaped planned trajectory may include any type of curved trajectory that includes at least one inflection point where, for example, there is a sign change (e.g., positive slope to negative slope; negative slope to positive slope; zero slope to positive slope; zero slope to negative slope) in the slope of a heading direction of the host vehicle.

It should be noted that initial position 3020 may be determined as described in the sections above. In some cases, determination of initial position 3020 may also be selected to allow for sufficient space for host vehicle 3002 to complete an S-shaped maneuver while navigating toward parking space 2930 and before envelope 3022 crosses threshold 3008. It is not required, however, that a planned S-shaped trajectory fall entirely outside the boundaries of parking space 2930. For example, in some cases, at least a portion of S-shaped trajectory 3202 may be included within parking space 2930 (e.g., including threshold 3008 and left and right boundaries 3004 and 3006). In these cases, correction of alignment of host vehicle 3002 may be achieved partially or fully within parking space 2930 (e.g., where space and vehicle characteristics allow and/or where desired constraints associated with left and right boundaries 3004 and 3006 are maintained).

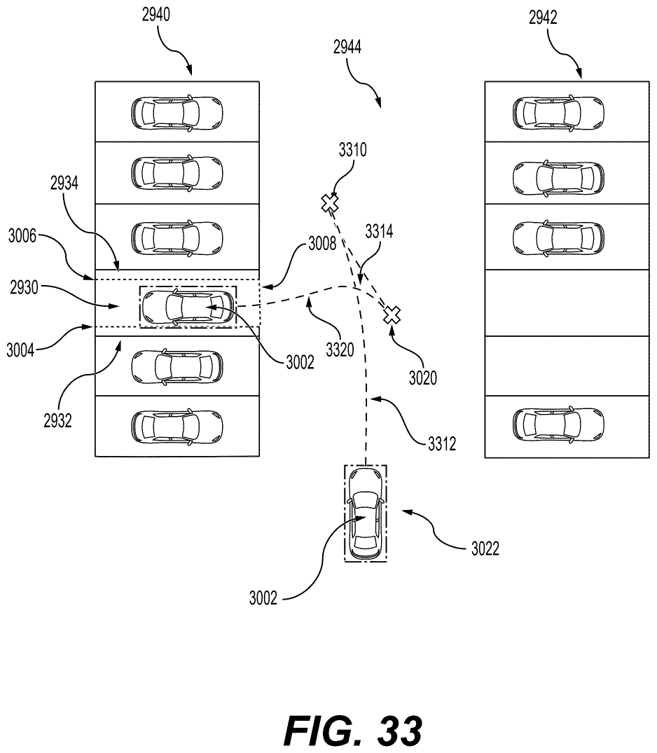

The presently disclosed host vehicle navigation systems may also be configured to perform a reverse motion maneuver during a parking sequence. For example, as shown in FIG. 33, host vehicle 3002 may be navigated to a reverse motion initiation point 3310. At point 3310, the disclosed host vehicle navigation system reverses the navigation direction of host vehicle 3002 to locate host vehicle 3002 at initial position 3020 (similar to the process outlined above). In this case, host vehicle 3002 may be oriented such that a longitudinal axis of envelope 3022 is substantially parallel with or anti-parallel with parking space threshold 3008. For example, host vehicle 3002 may be oriented at initial position 3020 such that the longitudinal axis of envelope 3022 is rotated away from parallel with threshold 3008 and toward a center of parking space 2930. Such an orientation may be useful in allowing the host vehicle to proceed more directly toward parking space 2930. In such cases and depending on the location of initial position 3020 relative to parking space 2930, the available turn radius of host vehicle 3002, the size of the envelope 3022 of host vehicle 3002, the orientation of host vehicle 3002 at initial position 3020, among other factors, a planned trajectory 3320 may or may not require an S-shape in order to navigate host vehicle 3002 into parking space 2930.

The reverse parking maneuver coupled with planned trajectory 3320 with an optional S-shape may be useful in a variety of parking situations. For example, in some cases, such as the example situation represented by FIG. 30D, free space (such as free space 2944) between rows of parking spaces may have insufficient width to allow the host vehicle to complete a parking space approach maneuver and turn into the parking space along a single arced trajectory. In such cases, the limited free space width, the size of vehicle envelope 3022, and/or the available minimum turn radius of the host vehicle may preclude the host vehicle from entering the parking space along a single arced trajectory. In such cases, the three-point maneuver represented in FIG. 33 may be useful. Such a three-point maneuver may include a first leg 3312 that includes navigating the host vehicle to reverse motion initiation point 3310. Next, the host vehicle navigation system navigates host vehicle 3002 from reverse motion initiation point 3310 to parking space approach maneuver initial position 3020 along trajectory 3314. From initial position 3020, host vehicle 3002 is navigated into parking space 2930 along trajectory 3320. In the example shown in FIG. 33, host vehicle 3002 is represented as moving in a forward motion direction along trajectory 3312, a reverse motion direction along trajectory 3314, and a forward motion direction along trajectory 3320. It should be noted that using the disclosed techniques, host vehicle 3002 may be navigated into parking space 2930 using a three-point maneuver that includes a reverse motion direction along trajectory 3312, a forward motion direction along trajectory 3314, and a reverse motion direction along trajectory 3320. Any or all of trajectories 3312, 3314, or 3320 may include an S-shaped trajectory, a single arced trajectory, one or more straight trajectory segments, or combinations thereof.

In the example of FIG. 33, initial position 3020 may be determined (similar to the process outlined above) as an initial position from which the host vehicle may be navigated toward parking space threshold 3008 and cross the threshold with an envelope 3022 of the host vehicle passing between the left boundary 3004 and the right boundary 3006, and wherein further entry of the host vehicle into the parking space can be performed without requiring the vehicle envelope 3022 to intersect with or cross over the left boundary 3004 or the right boundary 3006. Further, in some examples, parking space approach maneuver initial position 3020 is also one from which the host vehicle has sufficient space to complete an S maneuver along trajectory 3320 prior to crossing the parking space threshold 3008.

The three-point parking maneuver represented by FIG. 33 may allow for increased parking flexibility in a variety of situations. For example, inclusion of a middle leg along trajectory 3314 may enhance flexibility by allowing for a wide range of potential heading directions for host vehicle 3002 upon reaching a determined parking space approach maneuver initial position 3020. In some cases, where space allows, for example, a host vehicle 3002 may be navigated to an initial position 3020 where its heading direction is fully parallel to or nearly parallel to a parking corridor designated by left boundary 3004 and/or right boundary 3006. In other cases (e.g., where less space is available), the middle leg along trajectory 3314 may assist in achieving a heading direction pointed away from parallel with threshold 3008 by at least some non-zero angle such that host vehicle 3002 has a heading direction at determined location 3020 that points at least some amount toward parking space 2930. Even a small degree of shift in the heading direction of host vehicle 3002 toward parking space 2930 at initial position 3020 may significantly increase the success rate of safely navigating host vehicle 3002 into parking space 2930, significantly increase the number of parking spaces and different parking space scenarios available to the host vehicle, etc.

As noted, any or all of trajectories 3312, 3314, or 3320 may include a S-shaped trajectory as part of or all of the trajectory. Such an S-shaped trajectory may assist the host vehicle navigation system in making corrections to the positioning of the host vehicle or refining the position of host vehicle 3002 as host vehicle 3002 approaches location 3310, location 3020, and/or as host vehicle 3002 approaches parking space 2930. For example, from position 3020, the host vehicle navigation system may cause host vehicle 3002 to proceed along a planned trajectory to approach parking space 2930. As the host vehicle approaches parking space 2930, the host vehicle navigation system may determine that a refinement or correction to the position of host vehicle 3002 relative to parking space 2930 (e.g., relative to left boundary 3004 and/or right boundary 3006) may be desirable to better center host vehicle 3002 within a parking corridor indicated by left boundary 3004 and/or right boundary 3006. Such a determination by the host vehicle navigation system may be based on analysis of incoming sensor data, including, for example, captured images from one or more cameras onboard host vehicle 3002, point cloud information received from a LIDAR or RADAR system onboard host vehicle 3003, acoustic sensor information, etc. Where such a refinement is determined to be useful, for example, in correcting or refining an alignment of host vehicle 3002 relative to a parking space corridor between left boundary 3004 and right boundary 3006, the host vehicle navigation system may control one or more steering actuators associated with host vehicle 3002 to cause the host vehicle to execute an S-shaped maneuver to correct or adjust alignment relative to parking space 2930. The S-shaped trajectory may include any type of curved trajectory that includes at least one inflection point where, for example, there is a sign change in the slope of a heading direction of the host vehicle (e.g., positive slope to negative slope; negative slope to positive slope; zero slope to positive slope; zero slope to negative slope).

In some embodiments, the host vehicle navigation system may select location 3020 such that there is sufficient space between location 3020 and parking space 2930 (e.g., between location 3020 and parking space threshold 3008) to allow for an S-shaped maneuver prior to the host vehicle envelope 3022 entering the parking space. In some cases (e.g., where an S-shaped maneuver can be completed without envelope 3022 extending beyond a parking corridor established by left boundary 3004 and right boundary 3006), the S-shaped maneuver may be completed or partially completed as host vehicle 3002 is entering parking space 2930. The capability to perform such a maneuver and correct or refine alignment of the host vehicle during the parking space approach maneuver may increase parking success and may avoid the need for one or more corrective maneuvers involving changes in vehicle motion direction (e.g., forward to reverse or reverse to forward) to change or correct vehicle alignment. Selection of location 3020 to enable a corrective S-shaped maneuver as host vehicle 3002 approaches and/or enters parking space 2930 may be based on factors such as a predetermined kinematic model for the host vehicle, known turn radius capabilities of the host vehicle, size of the host vehicle, etc.

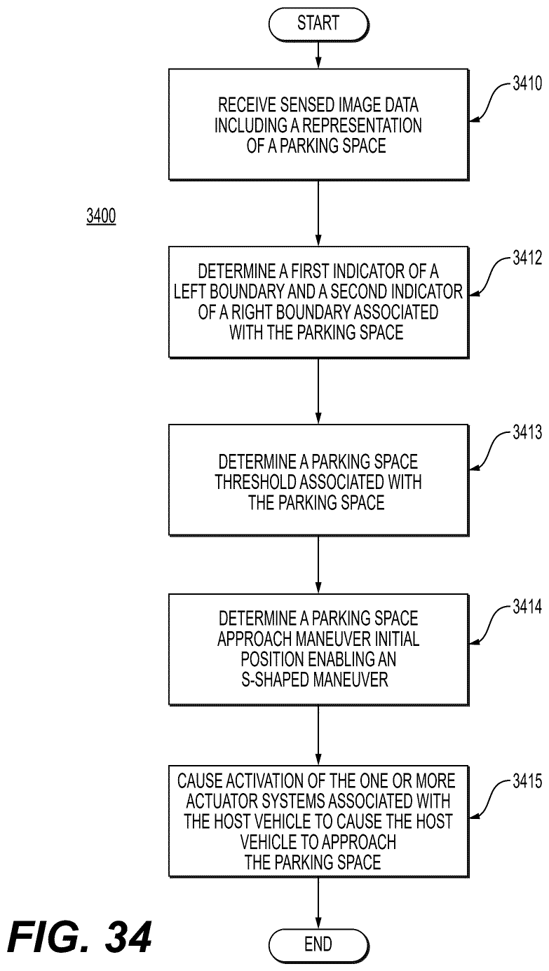

FIG. 34 includes a flowchart representative of a method 3400 for navigating a host vehicle relative to a parking space. In this example, method 3400 includes receiving sensed image data acquired by an image sensing system, wherein the sensed image data includes a representation of a parking space (step 3410); determining, based at least in part on analysis of the sensed image data, a first indicator of a left boundary and a second indicator of a right boundary associated with the parking space (step 3412); determining, based at least in part on analysis of the sensed image data, a parking space threshold associated with the parking space (step 3413); and determining a parking space approach maneuver initial position (step 3414) from which the host vehicle can be caused to perform an S-shaped maneuver as the host vehicle approaches (and in some cases, enters) the parking space. The parking space approach maneuver initial position is determined based on the determined first and second indicators of the left and right boundaries and also based on the determined parking space threshold; wherein the parking space approach maneuver initial position is one from which the host vehicle is able to navigate toward the parking space threshold and cross the threshold with an envelope of the host vehicle passing between the left boundary and the right boundary, and wherein further entry of the host vehicle into the parking space can be performed without requiring the vehicle envelope to intersect with or cross over the left boundary or the right boundary; and wherein the parking space approach maneuver initial position is also one from which the host vehicle has sufficient space to complete an S maneuver prior to crossing the parking space threshold. Method 3400 also includes causing activation of one or more actuator systems associated with the host vehicle to cause the host vehicle to navigate into the parking space from the parking space approach maneuver initial position and, in some examples, to complete the S maneuver prior to crossing the parking space threshold (step 3415).

As previously noted, the sensed image data may include one or more images captured by a camera onboard the host vehicle, point cloud information from a LIDAR and/or RADAR system, etc. Further, referring to the example of FIG. 33, causing the activation of the one or more actuator systems associated with the host vehicle also causes navigation of the host vehicle relative to the parking space approach maneuver initial position 3020, and wherein the navigation of the host vehicle relative to the parking space approach maneuver initial position includes a forward motion leg 3312 and a reverse motion leg 3314.

In some examples, the left boundary of parking space 2930 is associated with a parking line 2932 or an edge of a parked vehicle on a left side of the parking space. Similarly, the right boundary may be associated with a parking line 2934 or edge of a parked vehicle on a right side of the parking space. The parking space threshold 3008 may be determined, where applicable, using any of the techniques described above. In one example, threshold 3008 may be indicated by a line between closest points associated with the left boundary and the right boundary associated with the parking space. In some cases, the left boundary of parking space 2930 may include a buffer (e.g., a buffer relative to a parked vehicle or a parking line on a left of the parking space). Similarly, the right boundary may also include a buffer relative to a parked vehicle or a parking line on a right side of the parking space.

As noted, the parking space approach maneuver initial position 3020 may be determined based on a variety of factors. In some cases, such factors include a turn radius associated with the host vehicle and/or a width of the host vehicle. And, a trained system or a model may be used to determine the parking space approach maneuver initial position 3020. The trained system or model may be trained based on historical vehicle drive data, a predetermined vehicle kinematic model, or crowdsourced data.

### Depthless Parking Maneuver Initiation (Partial Spot Visible)

As noted above, a host vehicle navigation system may control one or more actuator systems on a host vehicle in order to navigate the host vehicle within a parking zone (e.g., a parking lot, garage, etc.). This navigation may be based on analysis by the host vehicle navigation system of sensor data available from one or more sensors onboard the host vehicle. In some examples, the sensor data may include sensed image data acquired from one or more cameras, one or more LIDAR or RADAR systems, etc. onboard the host vehicle. In some cases, the sensed image data may include full representations of one or more parking spaces available to the host vehicle. In such cases, the host vehicle navigation may have sufficient information to fully characterize an available parking space to determine whether the parking space is suitable for accommodating the host vehicle (e.g., whether the parking space is unoccupied by a parked vehicle or other object, whether the parking space is wide enough, deep enough, etc.).

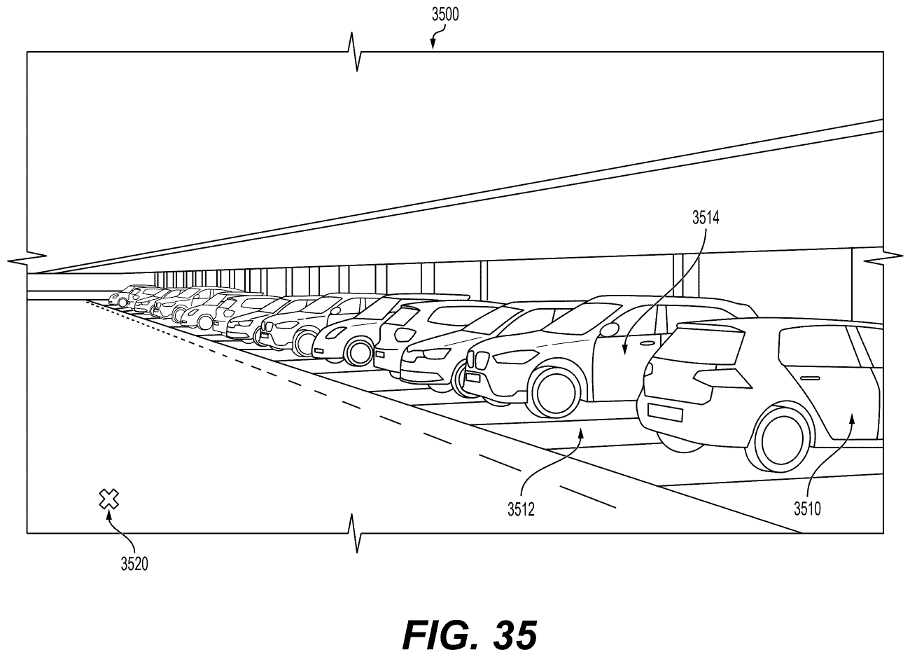

In other cases, however, the available sensor data (e.g., sensed image data) may include less than a full representation of a parking space candidate. For example, a captured image (or LIDAR or RADAR point cloud) may include a representation of only a portion of a parking space candidate. FIG. 35 provides an example of such a scenario. In the example of FIG. 35, a captured image 3500 includes representations of several parked vehicles, such as parked vehicle 3510. Image 3500 also includes a representation of a parking space 3512 that resides between parked vehicles 3510 and 3514. Only a partial representation of parking space 3512 appears in captured image 3500 because vehicle 3510 is occluding part of parking space 3512. As a result of such occlusions, captured image 3500 may include insufficient information for the host vehicle system to conclusively determine whether parking space 3512 is suitable for accommodating the host vehicle. For example, an object such as a cone, pylon, motorcycle, scooter, debris, etc. may be present in parking space 3512, but fully occluded in image 3500 by the representation of vehicle 3510. Similarly, it may be possible that parking space 3500 includes a depth limiter, such as a concrete curb, pylon, column protector, or any other type of parking structure or fixture that may limit the depth of parking space 3500. In some cases, such a depth limiter (while allowing enough free space in parking space 3500 to accommodate certain types of vehicles) may result in insufficient free space in space 3500 to fully or suitably accommodate the host vehicle.

As described above, once a parking space candidate is identified, the host vehicle navigation system may determine a parking space approach maneuver initial position, such as position 3520 shown in FIG. 35, from which the host vehicle can be navigated toward parking space 3512 with an envelope of the host vehicle safely entering parking space 3512 without the envelope crossing or intersecting with boundaries of a determined parking corridor. To navigate the host vehicle to position 3520, the host vehicle navigation system may plan a trajectory to location 3520, and control the heading direction (e.g., by controlling actuation of one or more systems including a steering system) to follow the planned trajectory to location 3520 from which the parking space approach maneuver may be initiated.

As noted above, in some examples, a host vehicle navigation system receives sensed image data at a periodic rate. For example, in some examples, one or more onboard cameras may capture images at a predetermined frame capture rate (e.g., 9 Hz or other) such that the host vehicle navigation system has regularly updated image captures from points along the trajectory toward location 3520. Such navigation to location 3520 may occur, however, without receiving sensed image data including a full representation of parking space 3512. In some cases, even once the host vehicle reaches location 3520, captured image data from that location may still only include a partial representation of parking space 3512 (depending on the location 3520 relative to objects that occlude parking space 3512). Thus, in situations similar to the example of FIG. 35, it may be possible that the host vehicle is navigated to location 3520 and perhaps navigated partially along a planned trajectory from location 3520 toward an entrance of parking space 3512 never having received sensed image data including a full representation of parking space 3512.

In such cases, it may be possible that image data acquired during a parking maneuver (either while navigating to initial position 3520 or while navigating into the entrance of parking space 3512) may include a representation of one or more conditions that make parking space 3512 unsuitable for accommodating the host vehicle. For example, parking space 3512 may include one or more objects occupying or blocking a portion of the parking space. Or, parking space 3512 may include a depth limiter that would prevent the host vehicle from fully or suitably entering the parking space. Any of these conditions (among others) may make parking space 3512 an unsuitable candidate for accommodating a host vehicle. Because sensed image data including representations of one or more aspects of such conditions may not be available to the host vehicle navigation system until after a parking space entry maneuver needs to be initiated. But, initiating a parking space entry maneuver without a full characterization of a parking space candidate (e.g., whether the parking space candidate is occupied, blocked, too small, etc.) can result in the need to abort a parking space entry maneuver.

One way to overcome such a challenge is to require that full characterization of a parking space is achieved prior to initiating a parking space entry maneuver. For example, host vehicles equipped with onboard cameras, LIDAR, or RADAR systems may be navigated relative to a partially occluded parking space in such a manner to enable available sensors to capture sensed image data sufficient to assess the depth of the parking space and whether any blockages are present. For example, the host vehicle navigation system may cause the host vehicle to navigate past a parking space to allow the fields of view of available sensors to access the full area of the parking space. Once image data representative of the full area of the parking space is acquired, a host vehicle navigation system may initiate one or more parking space entry maneuvers (e.g., determining an approach position 3520, causing the host vehicle to navigate to position 3520, and navigating the host vehicle into the parking space 3512) without risk of having to later abort a parking space entry process due to blockages or insufficient depth.

Such an approach, however, may be undesirable. For example, having to perform reconnaissance maneuvers separate from parking entry maneuvers in order to acquire image data including a full representation of a parking space may be cumbersome and inefficient. Extra time may be required to accomplish the reconnaissance maneuvers prior to even beginning parking space entry maneuvers. The extra time required and the extra maneuvers may detract from the user experience and may also block the flow of traffic within a parking lot or garage.

The presently disclosed system is aimed at overcoming one or more of these challenges by combining parking space reconnaissance with performance of parking space maneuvers. Using this approach, the presently disclosed systems may identify a parking space candidate, such as parking space 3512 in FIG. 35, and initiate one or maneuvers to cause a host vehicle to approach and enter the parking space without first image data available that includes a full representation of the parking space. In other words, the present system may initiate a parking space maneuver with only a partial representation of the parking space included in available sensed image data and, therefore, without information indicative of an available depth of the parking space or whether one or more objects blocks at least a portion of the parking space.

In the presently disclosed embodiments, a host vehicle navigation system receives image data (e.g., captured images, LIDAR or RADAR point clouds, etc.) at a predetermined rate (e.g., 9 Hz). Using the techniques described in the sections above, a parking space candidate may be identified (e.g., based on free space between parking lines, parked vehicles, barriers, or other objects detected through analysis of received image data). The host vehicle navigation system may then initiate one or more maneuvers to cause the host vehicle to approach and enter the parking space.

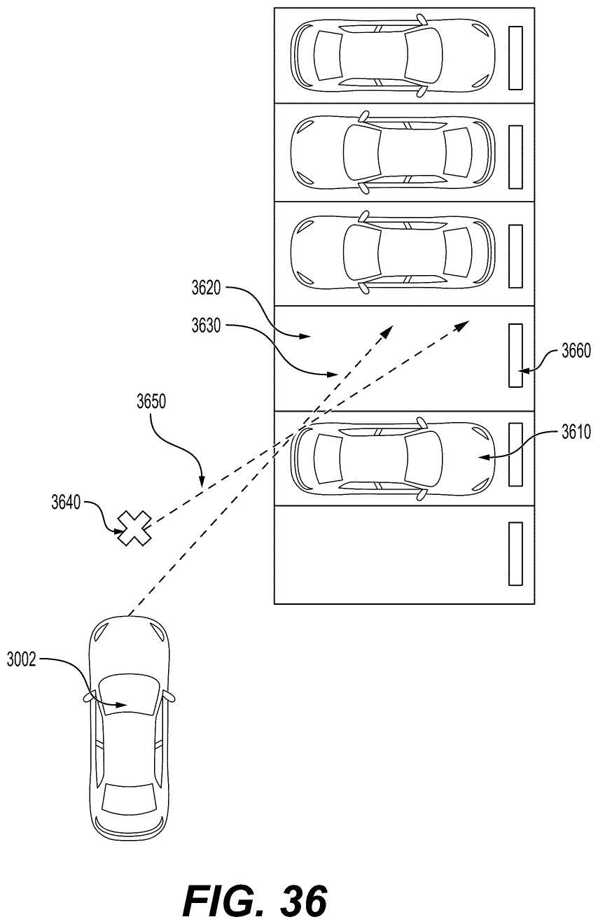

FIG. 36 provides a diagrammatic representation of the parking scenario represented by FIG. 35. At the current position of host vehicle 3002, a parked vehicle 3610 may occlude a portion of a parking space candidate 3620 from a field of view of one or more cameras onboard host vehicle 3002 (as represented by ray 3630). As part of implementing a parking space entry maneuver as described in the sections above, the host vehicle navigation system may identify a parking space approach maneuver initial position 3640 (as described above). The navigation system causes host vehicle 3002 to navigate to initial position 3640. During the navigation to initial position 3640, sensed image data continues to be acquired at the predetermined rate. Upon reaching initial position 3640, sensed image date captured from that location may still lack a full representation of parking space 3620, as indicated by ray 3650. For example, in this example, from initial location 3640, a camera onboard host vehicle 3002 may capture an image (such as image 3500 of FIG. 35) that includes only a partial representation of parking space 3620. Such a partial representation may, therefore, lack information relating to the available depth of parking space 3620 or whether an object resides in an occluded region of parking space 3620. For example, an image captured from a vantage point at location 3640 may lack a representation of a depth limiter, such as curb 3660, present at a distal region of parking space 3620 (e.g., an area generally opposite to an entrance to the parking space).

In this example, the host vehicle navigation system would cause the host vehicle 3002 to navigate from initial position 3640 toward an entrance of parking space 3620 (using any of the techniques described in the sections above) without conclusive information confirming that parking space 3640 has sufficient depth to accommodate host vehicle 3002. As the host vehicle is navigated toward and perhaps into parking space 3620, newly received sensed image data may become available that includes a representation of one or more regions of parking space 3620 formerly occluded by parked vehicle 3610. For example, a representation of a distal region of parking space 3620 including curb 3660 may be included within one or more images acquired as the host vehicle is caused to navigate toward and into parking space 3620. With image data including a representation of the distal region of parking space 3620 and any depth limiters (e.g., curb 3660, a painted line, a parked vehicle, a pylon, etc.), the host vehicle navigation system can determine whether sufficient depth exists in parking space 3620 to fully or suitably accommodate host vehicle 3002. If the host vehicle navigation system determines that parking space 3620 includes sufficient depth for host vehicle 3002 and is free of blockages, the host vehicle navigation system may cause host vehicle 3002 to continue fully into parking space 3620. On the other hand, if the host vehicle navigation system determines that parking space 3620 does not include sufficient depth to suitably accommodate host vehicle 3002 or that parking space 3620 includes one or more object blockages that would restrict access to parking space 3620, the navigation system may cause host vehicle 3002 to abort the parking maneuver, reverse out of the parking space, and proceed to navigate relative to the parking environment as the host vehicle navigation system searches for a new parking space candidate.

The disclosed embodiments may offer certain benefits. For example, the host vehicle navigation system may initiate a parking space entry maneuver with less than full information about the suitability of a parking space candidate. Most parking spaces where early captured image data suggests no blockages or occupation will ultimately prove suitable for parking. The presently disclosed embodiments take advantage of this fact by initiating parking space entry maneuvers based on a partial characterization of the parking space and potentially without depth information relative to the parking space. In doing so, the present embodiments may increase parking efficiency, reduce time required to identify a parking space candidate and enter an identified candidate, and avoid traffic blockages associated with reconnaissance maneuvers. As a result, the user experience may be improved.

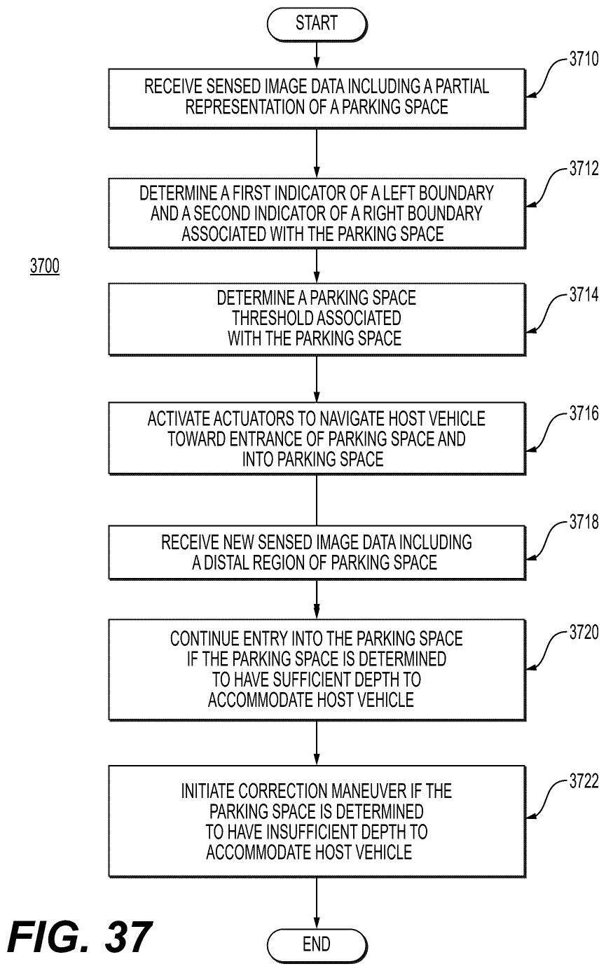

FIG. 37 provides a flowchart representing a method 3700 for navigating a host vehicle relative to a parking space, according to exemplary disclosed embodiments. For example, method 3700 may include receiving sensed image data acquired by an image sensing system, wherein the sensed image data includes a partial representation of a parking space, such that less than a full area of the parking space is represented in the sensed image data, and a distal region of the parking space and an associated parking space depth limiter are not represented in the captured image (step 3710); determining, based at least in part on analysis of the sensed image data, a first indicator of a left boundary and a second indicator of a right boundary associated with the parking space (step 3712); determining, based at least in part on analysis of the sensed image data, a parking space threshold associated with the parking space (step 3714); causing activation of one or more actuator systems associated with the host vehicle to cause the host vehicle to navigate toward the parking space threshold along a curved trajectory to enter the parking space (step 3716); receiving new sensed image data, as the host vehicle approaches the parking space, wherein the new sensed image data includes a representation of a distal region of the parking space and an associated parking space depth limiter (step 3718); and based on a determination of whether the parking space depth limiter allows for sufficient depth for the host vehicle to reach a position where the host vehicle is substantially parallel to the left boundary or the right boundary, causing the host vehicle to continue onward along the curved trajectory to complete entry into the parking space if there is sufficient depth (step 3720), or causing activation of the one or more actuator systems associated with the host vehicle to cause the host vehicle to initiate a correction maneuver during entry into the parking space (step 3722).

As in the sections above, the left boundary and right boundary of parking space 3620 (or any determined indicator of a parking space corridor) may be associated with a parking line or an edge of a parked vehicle. The parking space threshold may be indicated by a line between closest points associated with the left boundary and the right boundary associated with the parking space. In this example, a parking space depth limiter may include at least one of a curb, a parking space boundary line, a parked vehicle, a wall, a barrier, a pylon, or any object having a height of at least a predetermined amount relative a parking lot surface.

The described correction maneuver may include any suitable maneuver associated with navigating relative to a parking space. In some cases, the correction maneuver includes decreasing or increasing a turn radius of an approach trajectory. In other cases, the correction maneuver includes initiating a reverse maneuver. In such cases, the correction maneuver may further include reversing the host vehicle to a new approach point and resuming entry into the parking space from the new approach point, wherein the new approach point is determined based on the parking space depth limiter represented in the newly received sensed image data.

As in the sections above, the sensed image data may include an image captured by a camera onboard the host vehicle. The sensed image data may also include output from a RADAR or LIDAR system onboard the host vehicle.

### Automatic Parking Assist With Both Single Turn in and Three-Point Turn in Capability

Traditional vehicle navigation systems have limited capabilities, especially when navigating relative to a parking lot and/or parking spaces. For example, traditional navigation systems require full characterization of a parking space, including parking space depth and confirmation that the parking space is not occupied or blocked by objects or other vehicles, for example, in order to initiate a navigation sequence for causing a vehicle to enter a parking space. Further, traditional navigation systems have limited capabilities for causing a vehicle to enter a parking space, often being limited to a single maneuver type or a single series of maneuvers available for navigating a vehicle relative to a parking space. As a result, traditional host navigation systems lack flexibility with respect to parking lot navigation and navigation relative to parking spaces. Typically, valid parking space candidates for traditional navigation systems are limited to a subset of available parking spaces that meet stringent criteria imposed by the navigation system (e.g., known depth and occupation status, sufficient space to accomplish a single parking space entry maneuver or single series of parking space maneuvers available to the navigation system, etc.). As a result, traditional vehicle navigation systems may experience difficulty in locating parking spaces that meet such stringent criteria. In some cases, it may not be possible for a host vehicle navigation system to successfully identify a suitable parking space candidate, despite the presence of a plurality of unoccupied parking spaces in a parking lot or parking garage. Such performance restrictions may significantly limit the capabilities and ability of an autonomous vehicle to adequately perform and may detract from the user experience.

The presently disclosed embodiments are aimed at providing more flexibility relative to parking space navigation. One aim of the presently disclosed embodiments is providing the host vehicle navigation system with multiple different parking maneuver options or different series of parking maneuvers available to the navigation system. Such options may enable a host vehicle navigation system to successfully cause a host vehicle to enter a wide array of different types of parking spaces, under a wide array of parking lot conditions, etc. For example, in some cases, where it is determined that space allows, the host vehicle may use a single turn in approach to the parking space, and in some other cases where parking space boundaries (and potentially available approach positions for the host vehicle) do not allow for a single turn in approach (e.g., a single forward direction or reverse direction arced maneuver, S-shaped maneuver, arc with straight section maneuver, etc.), the host vehicle may opt for another available parking space navigation strategy. For example, in some embodiments, the host vehicle navigation system may execute a three-point turn maneuver (e.g., a reverse motion leg between two forward motion legs or a forward motion leg between two reverse motion legs), among other types of available maneuvers to enter the parking space. In this way, the host vehicle can be caused to directly enter into a parking space where space allows, or the host vehicle can be caused to implement one of a plurality of other available parking maneuvers or series of parking maneuvers (such as a three-point maneuver, etc.) to enter into a parking space. With this approach, the present embodiments may significantly increase the parking success rate of a host vehicle and the flexibility of the host vehicle navigation system in identifying suitable parking space candidates for entry.

FIGS. 32 and 33 provide examples of the type of flexibility in navigating a host vehicle relative to parking space candidates that the presently disclosed systems are aimed at providing. For example, where the host vehicle navigation system determined (e.g., based on analysis of received sensed image data) that conditions exist for allowing the host vehicle to safely enter a parking space candidate, such as parking space 2930, using a single direction motion, the host vehicle navigation system may identify a parking space approach maneuver initial position 3020, as described above, and plan a single motion trajectory such as trajectory 3030 for navigating the host vehicle 3002 into parking space 2930, according to the techniques and conditions described above. Trajectory 3030 planned and followed by the host vehicle navigation system may include a single arced section, multiple arced sections (such as the S-shaped trajectory shown in FIG. 32), one or more straight sections, etc.

FIG. 33 provides an example where the host vehicle navigation system identifies parking space 2930 as a suitable parking candidate, but where conditions do not allow for a single direction parking maneuver, as shown in FIG. 32. In this example, the host vehicle navigation system plans a three-point parking maneuver trajectory including a single reverse direction leg between two forward direction legs. One difference between the scenario of FIG. 32 and FIG. 33, is that in the scenario represented by FIG. 33, the host vehicle navigation system causes the host vehicle to reverse to the parking space approach maneuver initial position 3020 rather than navigating in a forward direction to position 3020. The addition of the reverse motion trajectory/leg 3314 allows the host vehicle more flexibility in navigating to initial position 3020 while simultaneously having the ability to more significantly alter a heading direction orientation of the host vehicle. Such flexibility and the ability to provide the host vehicle with heading directions at position 3020 aimed away from parallel with threshold 3008 and closer toward a center of parking space 2930 may enable the host vehicle to proceed more directly from position 3020 into parking space 2930 using a more direct, less arced trajectory. A S-shaped maneuver may or may not be employed as the host vehicle approaches and enters parking space 2930 depending on whether the host vehicle navigation system determines that an alignment correction is needed. The three-point maneuver of FIG. 33 may also significantly reduce the width of the parking space alley 2944 required by the host vehicle to safely enter parking space 2930 using the techniques and complying with the conditions described above. Thus, the availability of multiple different types of parking space navigation maneuvers may significantly increase the number of suitable parking space candidates open to the host vehicle under a wide range of parking lot conditions and can significantly increase the rate of success in safely navigating a host vehicle into an available parking space candidate.

Various parking conditions may affect which available parking approach maneuver or series of maneuvers a host vehicle selects for navigating a particular host vehicle relative to a parking space candidate. For example, as noted above, the width of a parking lot alley 2944 may affect which parking maneuver is selected. Other factors may include, a predetermined kinematic model for a particular host vehicle (including, for example, a known minimum available turn radius, a length of the host vehicle, a host vehicle envelope size, a host vehicle envelope orientation relative to one or more references points associated with the host vehicle, etc.). Still other factors may include the width of a parking space candidate, a width of a determined parking corridor (e.g., between determined left and right boundaries) for a parking space, an available depth of a parking space (if known), an orientation of the parking space (e.g., orthogonal, parallel, angled fishbone, etc.), whether one or more parked vehicles or barriers resides on one or more sides of the parking space, etc.

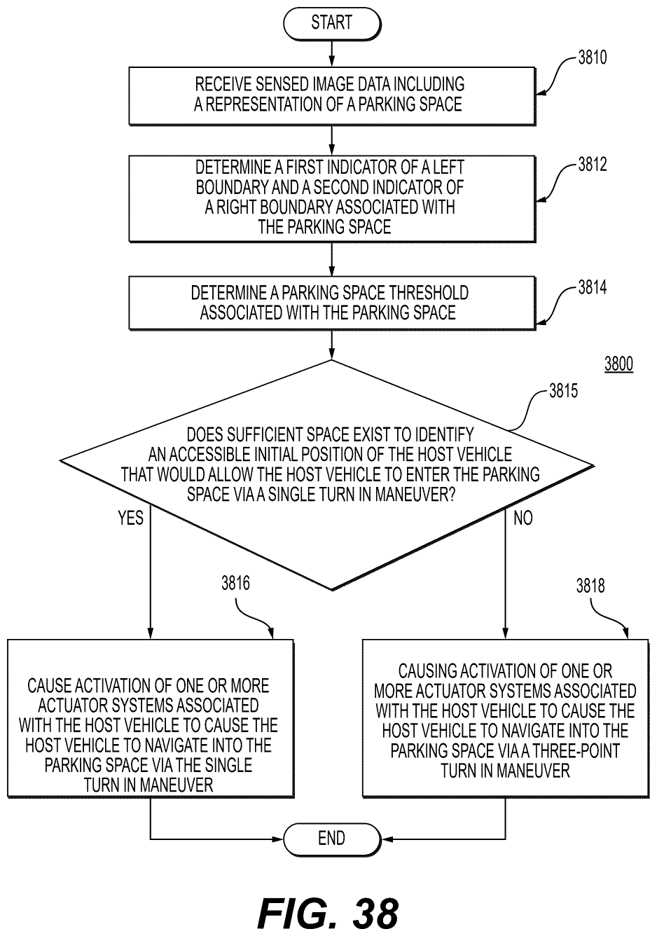

FIG. 38 provides a flowchart representing a method 3800 for navigating a host vehicle relative to a parking space, according to exemplary disclosed embodiments. For example, in the example of FIG. 38, method 3800 includes receiving sensed image data acquired by an image sensing system, wherein the sensed image data includes a representation of a parking space (step 3810); determining, based at least in part on analysis of the sensed image data, a first indicator of a left boundary and a second indicator of a right boundary associated with the parking space (step 3812); determining, based at least in part on analysis of the sensed image data, a parking space threshold associated with the parking space (step 3814).

At step 3815, a determination is made regarding whether sufficient space exists to identify an accessible initial position of the host vehicle that allows the host vehicle to enter the parking space via a single turn in maneuver. Where, based on an initial position of the host vehicle, a predetermined minimum vehicle turn radius for the host vehicle, and a predetermined envelope associated with the host vehicle, sufficient space is determined to exist from the initial position of the host vehicle to allow the host vehicle to enter the parking space via a single turn in maneuver, method 3800 includes causing activation of one or more actuator systems associated with the host vehicle to cause the host vehicle to navigate into the parking space via the single turn in maneuver (e.g., a single forward direction turn in maneuver) (step 3816). On the other hand, where, based on the initial position of the host vehicle, the predetermined minimum vehicle turn radius for the host vehicle, and the predetermined envelope associated with the host vehicle, sufficient space is determined to not exist from the initial position of the host vehicle to allow the host vehicle to enter the parking space via the single turn in maneuver, method 3800 includes causing activation of one or more actuator systems associated with the host vehicle to cause the host vehicle to navigate into the parking space via a three-point turn in maneuver (step 3818).

As noted in the sections above, the sensed image data may include captured images, such as one or more images captured by a camera onboard the host vehicle. The image data may also include output (e.g., one or more point clouds) from a RADAR or LIDAR system onboard the host vehicle.

The three-point turn in maneuver may include a reverse motion leg between two forward motion legs or may include a forward motion leg between two reverse motion legs. In some cases, the three-point turn in maneuver is performed without causing the predetermined envelope associated with the host vehicle to intersect with or cross the determined left and right boundaries associated with the parking space. Similarly, the single turn in maneuver may be performed without causing the predetermined envelope associated with the host vehicle to intersect with or cross the determined left and right boundaries associated with the parking space. As described above, the left boundary and/or the right boundary may be associated with a parking line or an edge of a parked vehicle on a left/right side of the parking space. The left boundary may include a buffer relative to a parked vehicle or a parking line on a left of the parking space, and/or the right boundary may include a buffer relative to a parked vehicle or a parking line on a right side of the parking space.

Further, as described above, the parking space threshold may be indicated in different ways, such as any feature (real or virtual) indicative of an entrance to a parking space. In some cases, the parking space threshold may be indicated by a line between closest points associated with the left boundary and the right boundary associated with the parking space.

The determination of whether sufficient space exists from the initial position of the host vehicle to allow the host vehicle to enter the parking space via a single turn in maneuver may be based on factors such as an initial position of the host vehicle, the predetermined minimum vehicle turn radius for the host vehicle, and the predetermined envelope associated with the host vehicle. This determination may involve determining a single turn in maneuver trajectory of the host vehicle into the parking space. This determination may further involve determining whether the single turn in maneuver trajectory when followed would cause the host vehicle to navigate toward the parking space threshold and cross the threshold with an envelope of the host vehicle between the left boundary and the right boundary and whether further entry of the host vehicle into the parking space can be performed without requiring the vehicle envelope to intersect with or cross over the left boundary or the right boundary.

In situations where it is determined that the single turn in maneuver trajectory when followed would cause the host vehicle to navigate toward the parking space threshold and cross the threshold with an envelope of the host vehicle between the left boundary and the right boundary and that further entry of the host vehicle into the parking space can be performed without requiring the vehicle envelope to intersect with or cross over the left boundary or the right boundary, then it is determined that sufficient space exists for the single turn in maneuver. In such cases, the host vehicle navigation system may proceed by actuating one or more systems associated with the host vehicle to cause the host vehicle to navigate toward and enter a parking space using the single turn in maneuver.

In other cases, where it is determined that the single turn in maneuver trajectory when followed would cause the host vehicle to either navigate toward the parking space threshold and cross the threshold with an envelope of the host vehicle intersecting one of the left boundary and the right boundary or whether that further entry of the host vehicle into the parking space cannot be performed without requiring the vehicle envelope to intersect with or cross over the left boundary or the right boundary, then it is determined that sufficient space does not exist for the single turn in maneuver. In such cases, an alternative parking maneuver or series of maneuvers (e.g., a three-point parking maneuver as represented in FIG. 33) may be employed.

### Fishbone Parking Maneuver

Autonomous vehicles, when performing parking maneuvers, may have to navigate relative to parking spaces oriented as a row of non-orthogonal, angled spaces (e.g., fishbone, herringbone, angled spaces, etc.). Parking in such fishbone parking spaces may present a challenge for autonomous vehicles. For example, existing systems that rely upon accurate depth determinations as a prerequisite to initiating a parking maneuver may have difficulty in determining parking space depth of a non-orthogonally oriented parking space. Thus, there remains a need for increasing the capabilities and flexibility of a host vehicle navigation system to enable successful navigation relative to various parking space orientations, including those oriented in a fishbone or angled pattern.

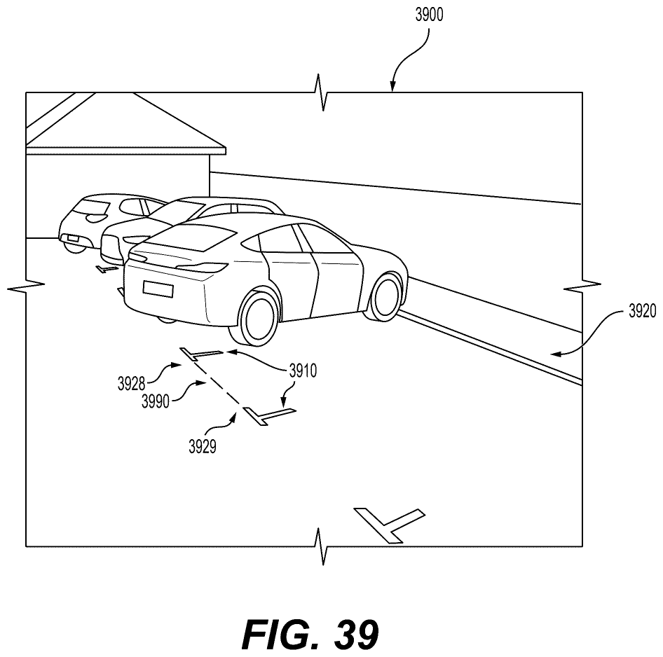

A fishbone parking space refers to any type of non-orthogonal parking space configuration (e.g., parking spaces arranged in a series of angled spaces, parking spaces arranged in a herringbone pattern, etc.). FIG. 39 includes a captured image (e.g., sensed image data) 3900 showing a series of angled parking spaces arranged in a fishbone or herringbone pattern. In this example, each parking space is identified by a pair of parking space identifiers 3910 that establish the location, width, angle, and entrance of each parking space. As discussed in further detail below, an entrance to the parking space may be indicated by a variety of features. In the example of FIG. 39, an entrance to the angled parking space may be indicated by a threshold 3990 extending between points 3928 and 3929 associated with respective parking space identifiers. The longitudinal depth of each parking space is established by curb 3920, which serves as an example depth limiter. It should be noted that in cases, such as a curb or another low profile structure, a parking space depth limiter may allow for the envelope of the host vehicle to extend beyond the depth limiter. In such cases, the depth limiter may operate by inhibiting further motion of the host vehicle when at least one wheel/tire contacts curb 3920 or other similar depth limiter structures. In other cases, such as those involving parked vehicles, pylons, poles, barriers, walls, etc. such depth limiters may operate by establishing a boundary for the parking space that the envelope of the host vehicle cannot (or at least should not) cross.

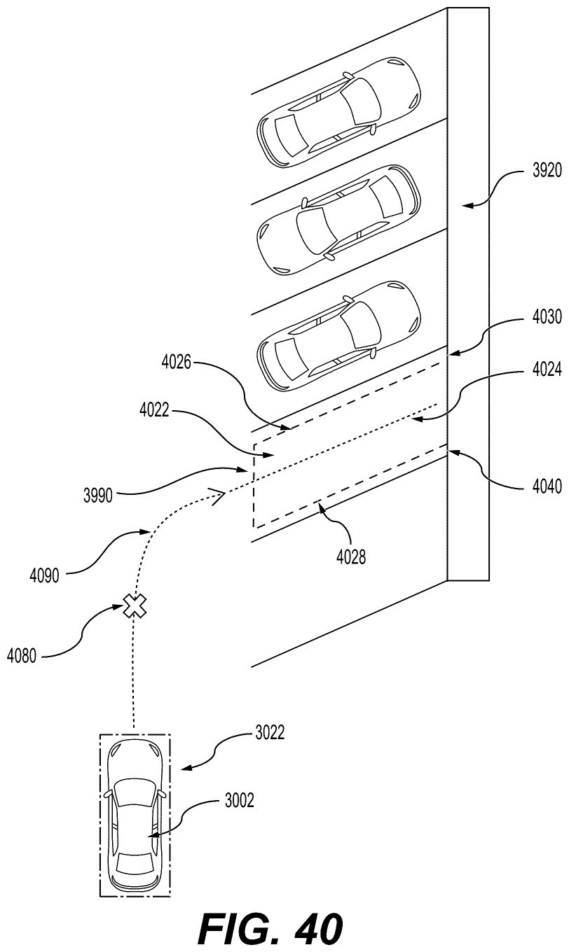

FIG. 40 provides a diagrammatic top view representation of the fishbone arrangement of parking spaces represented in FIG. 39. As noted, one challenge for a host vehicle navigation system in navigating a host vehicle relative to an angled/fishbone parking space is accurately determining the usable depth of the parking space. For example, in the case of orthogonally arranged parking spaces (FIG. 28A), upon entering a parking space, the host vehicle navigates generally orthogonally toward a depth limiter (e.g., painted line, curb, pylon, barrier, pole, parked vehicle, etc.). In such cases, a depth range determined relative to a point on the depth limiter may be applicable across the full width of the parking space. As an example, turning to FIG. 36, as host vehicle 3002 enters parking space 3620 and travels toward depth limiter 3660, a determination of the range (or depth) to any point on depth limiter 3660 (e.g., a curb) establishes the depth limit applicable across the full width of the parking space. The single point depth measurement in an orthogonally arranged parking space may function as the depth limit regardless of the position along the depth limiter that the measurement was taken or from which the depth was otherwise determined.

On the other hand, in the case of an angled parking space arrangement, as shown in FIG. 40, a single point depth determination made relative to the depth limiter may not apply across a full width of the parking space. For example, as host vehicle 3002 enters parking 4022 and travels toward depth limiter 3920 in a direction along a trajectory 4024 that is substantially centered in a parking corridor established by a left parking space boundary 4026 and a right parking space boundary 4028. In this orientation and with this direction of travel, the host vehicle will approach the depth limiter at a non-orthogonal angle. As a result, a depth determination (e.g., using LIDAR, RADAR, structure in motion calculations, a trained model configured to output depth per image pixel, etc.) made relative to a point 4030 of depth limiter 3920 will have a different value than a similar depth determination made relative to a point 4040 associated with the depth limiter. In this example, a range to point 4040 will be less than a range to point 4030 and, indeed, depth determinations made relative to any two points along the depth limiter within parking space 4022 should yield different values. Thus, a single depth value may not represent the practical depth limit across a full width of the parking space, and determining a depth relative to a single point along the depth limiter may not be sufficient for a host vehicle navigation system to determine a safe stopping location relative to a particular depth limiter.

The disclosed embodiments are aimed at safely navigating relative to depth limiters of angled parking spaces, especially wherein an approach direction of a host vehicle is non-orthogonal relative to a longitudinal axis associated with a parking space depth limiter. In such cases, effective depth determinations in angle parking space situations may be made in different ways. For example, in some cases, corners of the parking space (such as points 3930 and 3940) may be determined based on image analysis. Depth determinations may be made for each of these corner points, and the host vehicle navigation system may adopt the lesser of the two depth values as the useable depth of the angled parking space. In other cases, a trained model may be configured to receive an image including an angled parking space depth limiter as input and output a usable depth value for the angled parking space. Using this information, the host vehicle navigation system may determine an appropriate stopping location for the host vehicle relative to the type of depth limiter associated with the angled parking space.

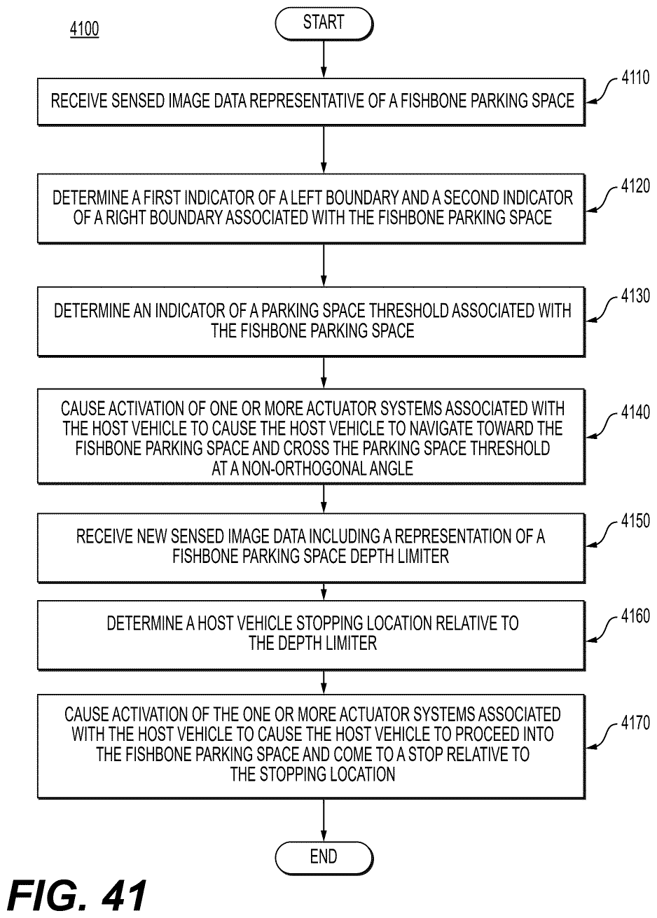

FIG. 41 includes a flowchart representative of a method 4100 for navigating a host vehicle relative to an angled (fishbone) parking space. In the example of FIG. 41, method 4100 includes receiving sensed image data acquired by an image sensing system, wherein the sensed image data includes a representation (e.g., at least a partial representation) of a fishbone parking space (step 4110); determining, based at least in part on analysis of the sensed image data, a first indicator of a left boundary and a second indicator of a right boundary associated with the fishbone parking space (step 4120); determining, based at least in part on analysis of the sensed image data, an indicator of a parking space threshold associated with the fishbone parking space (step 4130); causing activation of one or more actuator systems associated with the host vehicle to cause the host vehicle to navigate toward the fishbone parking space and cross the parking space threshold at a non-orthogonal angle (step 4140). As depth determination is an important characteristic for use in navigating a host vehicle relative to a parking space, and in view of the challenges in acquiring accurate depth information for an angled or fishbone configured parking space, method 4100 may also include receiving new sensed image data, as the host vehicle approaches the fishbone parking space, wherein the new sensed image data includes a representation of a fishbone parking space depth limiter non-orthogonally oriented relative to a direction of travel of the host vehicle into the fishbone parking space (step 4150). Based on the new sensed image data, and the representation of the fishbone parking space depth limiter, method 4100 may include determining a host vehicle stopping location based on the fishbone parking space depth limiter (step 4160); and causing activation of one or more actuator systems associated with the host vehicle to cause the host vehicle to proceed into the fishbone parking space and come to a stop in response to the determined host vehicle stopping location (step 4170).

As previously noted, the sensed image data may include one or more images captured by a camera onboard the host vehicle. The sensed image data may also include point cloud information from a LIDAR and/or RADAR system, etc. In some cases, the sensed image data may include a representation of only a partial area of the fishbone parking space, especially where the sensed image data includes representations of objects that occlude all or part of the angled/fishbone parking space. Similarly, in some cases, the sensed image data does not include a representation of the fishbone parking space depth limiter. As the host navigation system navigates the host vehicle relative to the angled parking space, however, newly acquired sensed image data may include representations of added regions associated with the parking space. In some cases, as the vehicle is navigated relative to the parking space (e.g., as the vehicle approaches threshold 3990 or navigates within parking space 4022) one or more sensors onboard host vehicle 3002 may acquire more complete or complete representations of at least a distal region of parking space 4022 including a representation of a portion of depth limiter 3920 relative to parking space 4022.

As noted in the sections above, various types of features, structures, objects, etc. may serve as a parking space depth limiter. For example, a fishbone parking space depth limiter (such as depth limiter 3920, which includes a curb and a sidewalk segment) may include at least one of a curb, a parking space boundary line, a parked vehicle, a wall, or a barrier, among other structures, features, or objects.

It should also be noted that the techniques described above for navigating a host vehicle relative to parking space are also applicable here. For example, navigating a host vehicle relative to angled parking space 4022 (FIG. 40) may include determining a parking space approach maneuver initial position 4080, determining a planned trajectory 4090 for approaching and/or entering parking space 4022, determining indicators of left and right boundaries 4026 and 4028, detecting and navigating relative to one or more depth limiters 3920, etc. Navigation relative to the angled or fishbone parking space 4022 may also include an S-shaped trajectory, S-shaped alignment correction, single motion direction approach and entry maneuver (e.g., a single arced forward motion trajectory, a single arced forward motion trajectory with a substantially straight trajectory leg, a forward motion S-shaped trajectory, etc.), as described relative to any of the embodiments above. Further, navigation relative to the angled parking space 4022 may, in some cases, include a three-point maneuver, as described above, or may be accomplished with reverse motion navigation of the host vehicle (e.g., a single arced reverse motion trajectory, a single arced reverse motion trajectory with a substantially straight trajectory leg, a reverse motion S-shaped trajectory, etc.).

As in the embodiments above, left and right boundary indicators 4026 and 4028 can include any type of feature or object from which a parking corridor may be determined. In some cases, the left boundary is associated with a parking line or an edge of a parked vehicle on a left side of the parking space, and/or the right boundary is associated with a parking line or edge of a parked vehicles on a right side of the parking space. Either or both of the left boundary or the right boundary may include a buffer relative to a parking line, a parked vehicle, a barrier, curb, object etc. positioned along a left or right side of an angled parking space, in this case.

The techniques described above for determining an indicator of an entrance to a parking space (e.g., a parking space threshold 3990) may also apply to navigation relative to angled parking space 4022. As described above, parking space threshold 3990 may be indicated by various types of features, structures, objects, both real or virtual that may indicate an entrance to parking space 4022. In some cases, parking space threshold 3990 may be indicated by a line between closest points associated with the left boundary and the right boundary associated with the parking space. In some cases, the closest points may be associated with points (e.g., 3D real world points), such as points 3928 and 3929 (FIG. 39) determined relative to painted features on a surface of a parking lot. Such points may be located at ends of parking space lines, corners of adjoining lines, etc. Threshold 3990 may be indicated by corners (or other points) associated with parked vehicles, barriers, pylons, etc. on one or both sides of an entrance to parking space 4022.

Because of the angled orientation of parking space 4022, an entrance to the parking space may be indicated by a line that is non-orthogonal relative to a parking corridor established by left and right boundaries 4026 and 4028. As a result, a host vehicle navigating relative to the left or right boundaries 4026 or 4028 may enter the parking space by crossing the threshold at a non-orthogonal angle. In some cases, the host vehicle may be traveling parallel to or substantially parallel to the left and/or right boundaries 4026 and 4028. In other cases, the host vehicle may travel at an angle relative to the left and/or right boundaries 4026 and 4028. In either situation, the host vehicle navigation system may determine (e.g., based on analysis of received sensed image data) whether the host vehicle can continue to navigate into the fishbone parking space 4022 without the envelope 3022 of the host vehicle 3002 intersecting with or crossing over the left or right boundaries 4026 and 4028. Based on a determination that the host vehicle can continue to navigate into the fishbone parking space without the envelope of the host vehicle intersecting with or crossing over the left or right boundaries, the host vehicle navigation system may activate one or more actuation systems of the host vehicle to cause the host vehicle to navigate to the host vehicle stopping location determined based on depth limiter 3920 (e.g., based on the location, range to, height, etc. of depth limiter 3920). On the other hand, where it is determined that the host vehicle cannot continue to navigate into the fishbone parking space without the envelope of the host vehicle intersecting with or crossing over the left or right boundaries, then the host vehicle navigation system may activate one or more actuator systems of the host vehicle to cause the host vehicle to exit the fishbone parking space, perform one or more correction maneuvers, and navigate to the host vehicle stopping location without the envelope of the host vehicle crossing over or intersecting with the left or right boundary of the fishbone parking space.

### Parking Corridor Determination

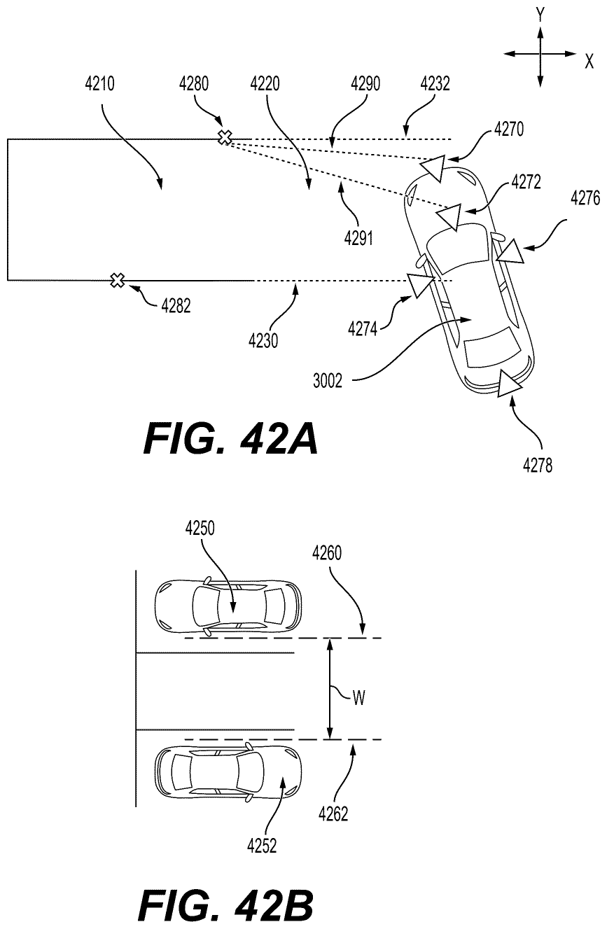

As previously described, one aspect of navigating a host vehicle relative to a parking space includes determining a parking corridor associated with a parking space and causing the host vehicle to navigate within the determined corridor to enter the parking space. FIG. 42A provides a diagrammatic representation of a parking space 4210 and a parking corridor 4220 associated with the parking space. In this example, parking corridor 4220 indicates a left boundary 4230 and a right boundary 4232 of navigable free space associated with parking space 4210. In some cases, left boundary 4230 and right boundary 4232 may correspond with or may be indicated by any of the left boundaries and right boundaries described in the sections above. For example, left boundary 4230 and right boundary 4232 may be associated with painted parking space lines, side edges of parked vehicles, curbs, walls, pylons, or any other type of object, structure, or feature associated with a left or right limit of a parking space. In some cases, the parking corridor includes a width corresponding to a width between parallel left and right boundaries determined based on points of closest approach between objects, features, structures, etc. on left and right sides of the parking space. In some examples, the left boundary 4230 and right boundary 4232 are associated with buffers relative to features, structures, or objects on a left or right side of a parking space.

Determining a parking corridor in which to navigate a host vehicle relative to a parking space may have certain advantages. For example, in some cases, a parking corridor indicated by parallel left and right boundaries 4230 and 4232 may have a width equal to or offset (e.g., with a buffer or safety margin) relative to a determined maximum width of unimpeded free space within the parking space. Determining a parking corridor in such a manner may minimize or eliminate the risk that the parking corridor includes structures, for example, that pose a collision hazard for a host vehicle. And, as the parking corridor may be indicated with parallel boundaries marking available free space (optionally, reduced by a safety margin/buffer) within a parking space, the full depth of the available parking corridor has a common width. This may greatly simplify the process for determining a suitable parking corridor, as the width of the parking corridor is constant and, therefore, depth independent. As a result, a host vehicle navigation system need not collect a plurality of points on the left side and right side of a parking space to generate a full profile of the available free space in a parking space. Rather, a suitable parking corridor may be determined based on as few as two location measurements—one associated with the left side of the parking space and one associated with the right side of the parking space where the two location measurements correspond to points of closest approach between left and right side parking space limiters.

For example, as shown in FIG. 42B if a parking space candidate resides between two parked vehicles 4250 and 4252, in some cases, the left and right side points of closest approach may correspond to outside edges of side view mirrors on respective parked vehicles. In such an example, an available parking corridor may be indicated by left and right boundaries 4260 and 4262 and may have a width, W, associated with a shortest line (e.g., an orthogonal line) between two parallels (e.g., boundaries 4260 and 4262) that extend through respective edges of side view mirrors on vehicles 4250 and 4252.

As noted, a potential advantage of determining a constant width (depth independent) parking corridor for use in navigating a host vehicle relative to a parking space is that the parking corridor may be determined based on as few as two points (e.g., 3D real world points). Such points may be determined, for example, using sensed image data acquired using one or more sensing systems onboard host vehicle 3002. Such sensing systems may include cameras, LIDAR systems, RADAR systems, etc. As shown in FIG. 42A, such sensing systems may be located in various locations relative to host vehicle 3002. In one example, host vehicle 3002 includes a forward facing camera or LIDAR/RADAR system 4270 mounted relative to a grill or front bumper of the vehicle, a forward facing camera or LIDAR/RADAR system 4272 mounted relative to a windscreen of the vehicle, a first side facing camera or LIDAR/RADAR system 4274, a second side facing camera or LIDAR/RADAR system 4276, and a rear facing camera or LIDAR/RADAR system 4278.

One or more of the available cameras or LIDAR/RADAR systems may be employed to determine a parking corridor (e.g., to detect indicators of left and right corridor boundaries 4230 and 4232). In this example, points 4280 and 4282 may correspond to the points of closest approach between features, structures, objects etc. based on which parking corridor 4220 may be determined. A point location (e.g., a 3D real world point) may be determined for both points 4280 and 4282 using any suitable technique (e.g., LIDAR or RADAR depth information alone or fused with images captured by one or more cameras; structure in motion calculations based on images captured by any of the onboard imaging systems; trained models configured to output per pixel depth/range information for acquired images, etc.).

Certain techniques may potentially enhance accuracy and or reduce errors associated with determination of point locations for points 4280 and 4282. For example, point locations determined based on sensor data collected from a vantage point closer to an edge/boundary of the parking corridor may be less error prone as compared to point locations determined based on sensor data collected from a vantage point closer to a center of the parking corridor. In the example, of FIG. 42A, a point location for point 4280 determined based on sensor information (e.g., from a camera, LIDAR, RADAR, etc.) collected from a vantage point associated with sensor system 4270 (along line 4290) may be more accurate than a point location for point 4280 determined based on sensor information collected from a vantage point associated with sensor system 4272 (along line 4291). Thus, one technique of potentially improving accuracy of parking corridor boundaries 4230 and 4232 would be to determine locations associated with boundaries 4230 and/or 4232 using an available sensor system having a y-coordinate location (in the example of FIG. 42A) closest to a y-coordinate of point 4282 to determine parking corridor boundary 4230 and an available sensor system having a y-coordinate location closest to a y-coordinate of point 4280 to determine parking corridor boundary 4232.

The embodiments may further be described using the following clauses:
Clause 1. A system for navigating a host vehicle relative to a parking space, the system comprising: at least one processor comprising circuitry and a memory, wherein the memory includes instructions that when executed by the circuitry cause the at least one processor to: receive sensed image data acquired by an image sensing system, wherein the sensed image data includes a representation of a parking space; determine, based at least in part on analysis of the sensed image data, a first indicator of a left boundary and a second indicator of a right boundary associated with the parking space; determine a parking space approach maneuver initial position, wherein the parking space approach maneuver initial position is determined based on the determined first and second indicators of the left and right boundaries and also based on a determined indicator of an entrance to the parking space; wherein the parking space approach maneuver initial position is one from which the host vehicle is able to navigate toward the entrance to the parking space and enter the parking space with an envelope of the host vehicle between the left boundary and the right boundary, and wherein further entry of the host vehicle into the parking space can be performed without requiring the vehicle envelope to intersect with or cross over the left boundary or the right boundary inside the parking space; and cause activation of one or more actuator systems associated with the host vehicle to cause the host vehicle to navigate into the parking space from the parking space approach maneuver initial position.
Clause 2. The system of clause 1, wherein the sensed image data includes an image captured by a camera onboard the host vehicle.
Clause 3. The system of clause 1, wherein the sensed image data includes output from a RADAR or LIDAR system onboard the host vehicle.
Clause 4. The system of clause 1, wherein the left boundary is associated with a parking line or an edge of a parked vehicle on a left side of the parking space, and/or the right boundary is associated with a parking line or edge of a parked vehicles on a right side of the parking space.
Clause 5. The system of clause 1, wherein the memory includes instructions that when executed by the circuitry cause the at least one processor to determine, based at least in part on analysis of the sensed image data, an indicator of an entrance to the parking space.
Clause 6. The system of clause 5, wherein the indicator of the entrance to the parking space is associated with a line, indicative of a parking space threshold, between closest points associated with the left boundary and the right boundary associated with the parking space.
Clause 7. The system of clause 1, wherein the left boundary includes a buffer relative to a parked vehicle or a parking line on a left side of the parking space, and/or the right boundary includes a buffer relative to a parked vehicle or a parking line on a right side of the parking space.
Clause 8. The system of clause 1, wherein the parking space approach maneuver initial position is further determined based on host vehicle turn radius and/or host vehicle width.
Clause 9. The system of clause 1, wherein the parking space approach maneuver initial position is further determined using a trained system or a model.
Clause 10. The system of clause 9, wherein the trained system or model is trained based on vehicle historical data or crowdsourced data.
Clause 11. The system of clause 1, wherein causing the activation of the one or more actuator systems associated with the host vehicle also causes navigation to the parking space approach maneuver initial position.
Clause 12. The system of clause 11, wherein the navigation to the parking space approach maneuver initial position includes activating one or more actuation systems of the host vehicle to cause the host vehicle to travel in a reverse direction.
Clause 13. The system of clause 11, wherein the navigation to the parking space approach maneuver initial position includes activating one or more actuation systems of the host vehicle to cause the host vehicle to perform a serpentine maneuver prior to reaching the parking space approach maneuver initial position.
Clause 14. The system of clause 1, wherein the parking space approach maneuver initial position corresponds to a point from which a heading direction of the host vehicle is controlled to turn the host vehicle toward the entrance to the parking space as the host vehicle approaches the entrance to the parking space.
Clause 15. The system of clause 1, wherein the parking space approach maneuver initial position is associated with a predetermined heading direction enabling the host vehicle to enter the parking space in a single maneuver.
Clause 16. A method for navigating a host vehicle relative to a parking space, the method comprising: receiving sensed image data acquired by an image sensing system, wherein the sensed image data includes a representation of a parking space; determining, based at least in part on analysis of the sensed image data, a first indicator of a left boundary and a second indicator of a right boundary associated with the parking space; determining, based at least in part on analysis of the sensed image data, an indicator of an entrance to the parking space; determining a parking space approach maneuver initial position, wherein the parking space approach maneuver initial position is determined based on the determined first and second indicators of the left and right boundaries and also based on the determined indicator of the entrance to the parking space; wherein the parking space approach maneuver initial position is one from which the host vehicle is able to navigate toward the entrance to the parking space and enter the parking space with an envelope of the host vehicle between the left boundary and the right boundary, and wherein further entry of the host vehicle into the parking space can be performed without requiring the vehicle envelope to intersect with or cross over the left boundary or the right boundary; and causing activation of one or more actuator systems associated with the host vehicle to cause the host vehicle to navigate into the parking space from the parking space approach maneuver initial position.
Clause 17. The method of clause 16, wherein the left boundary is associated with a parking line or an edge of a parked vehicle on a left side of the parking space, and the right boundary is associated with a parking line or edge of a parked vehicles on a right side of the parking space.
Clause 18. The method of clause 16, wherein the indicator of the entrance to the parking space is associated with a line, indicative of a parking space threshold, between closest points associated with the left boundary and the right boundary associated with the parking space.
Clause 19. The method of clause 16, wherein the left boundary includes a buffer relative to a parked vehicle or a parking line on a left side of the parking space, and/or the right boundary includes a buffer relative to a parked vehicle or a parking line on a right side of the parking space.
Clause 20. The method of clause 16, wherein the parking space approach maneuver initial position is further determined based on host vehicle turn radius and/or host vehicle width.
Clause 21. The method of clause 16, wherein the parking space approach maneuver initial position is further determined using a trained system or a model.
Clause 22. The method of clause 21, wherein the trained system or model is trained based on vehicle historical data or crowdsourced data.
Clause 23. The method of clause 16, wherein causing the activation of the one or more actuator systems associated with the host vehicle also causes navigation of the host vehicle to the parking space approach maneuver initial position.
Clause 24. The method of clause 23, wherein the navigation to the parking space approach maneuver initial position includes activating one or more actuation systems of the host vehicle to cause the host vehicle to travel in a reverse direction.
Clause 25. The method of clause 23, wherein the navigation to the parking space approach maneuver initial position includes activating one or more actuation systems of the host vehicle to cause the host vehicle to perform a serpentine maneuver prior to reaching the parking space approach maneuver initial position.
Clause 26. The method of clause 16, wherein the parking space approach maneuver initial position corresponds to a point from which a heading direction of the host vehicle is controlled to turn the host vehicle toward the entrance to the parking space as the host vehicle approaches the entrance to the parking space.
Clause 27. The method of clause 16, wherein the parking space approach maneuver initial position is associated with a predetermined heading direction enabling the host vehicle to enter the parking space via forward motion and without reversing.
Clause 28. A non-transitory computer-readable medium storing instructions for navigating a host vehicle relative to a parking space according to a method, the method comprising: receiving sensed image data acquired by an image sensing system, wherein the sensed image data includes a representation of a parking space; determining, based at least in part on analysis of the sensed image data, a first indicator of a left boundary and a second indicator of a right boundary associated with the parking space; determining, based at least in part on analysis of the sensed image data, an indicator of an entrance to the parking space; determining a parking space approach maneuver initial position, wherein the parking space approach maneuver initial position is determined based on the determined first and second indicators of the left and right boundaries and also based on the determined indicator of the entrance to the parking space; wherein the parking space approach maneuver initial position is one from which the host vehicle is able to navigate toward the entrance to the parking space and enter the parking space with an envelope of the host vehicle between the left boundary and the right boundary, and wherein further entry of the host vehicle into the parking space can be performed without requiring the vehicle envelope to intersect with or cross over the left boundary or the right boundary; and causing activation of one or more actuator systems associated with the host vehicle to cause the host vehicle to navigate into the parking space from the parking space approach maneuver initial position.
Clause 29. A system for navigating a host vehicle relative to a parking space, the system comprising: at least one processor comprising circuitry and a memory, wherein the memory includes instructions that when executed by the circuitry cause the at least one processor to: receive sensed image data acquired by an image sensing system, wherein the sensed image data includes a representation of a parking space; determine, based at least in part on analysis of the sensed image data, a first indicator of a left boundary and a second indicator of a right boundary associated with the parking space; determine, based at least in part on analysis of the sensed image data, an indicator of a parking space threshold associated with the parking space; determine a parking space approach maneuver initial position, wherein the parking space approach maneuver initial position is determined based on the determined first and second indicators of the left and right boundaries and also based on the determined parking space threshold; wherein the parking space approach maneuver initial position is one from which the host vehicle is able to navigate toward the parking space threshold and cross the threshold with an envelope of the host vehicle passing between the left boundary and the right boundary, and wherein further entry of the host vehicle into the parking space can be performed without requiring the vehicle envelope to intersect with or cross over the left boundary or the right boundary; and wherein the parking space approach maneuver initial position is also one from which the host vehicle has sufficient space to complete an S maneuver prior to crossing the parking space threshold; and cause activation of one or more actuator systems associated with the host vehicle to cause the host vehicle to navigate into the parking space from the parking space approach maneuver initial position and to complete the S maneuver prior to crossing the parking space threshold.
Clause 30. The system of clause 29, wherein the sensed image data includes an image captured by a camera onboard the host vehicle.
Clause 31. The system of clause 29, wherein the sensed image data includes output from a RADAR or LIDAR system onboard the host vehicle.
Clause 32. The system of clause 29, wherein the left boundary is associated with a parking line or an edge of a parked vehicle on a left side of the parking space, and/or the right boundary is associated with a parking line or edge of a parked vehicles on a right side of the parking space.
Clause 33. The system of clause 29, wherein the parking space threshold is determined by a line between closest points associated with the left boundary and the right boundary associated with the parking space.
Clause 34. The system of clause 29, wherein the left boundary includes a buffer relative to a parked vehicle or a parking line on a left of the parking space, and/or the right boundary includes a buffer relative to a parked vehicle or a parking line on a right side of the parking space.
Clause 35. The system of clause 29, wherein the parking space approach maneuver initial position is further determined based on a turn radius associated with the host vehicle and/or a width of the host vehicle.
Clause 36. The system of clause 29, wherein the parking space approach maneuver initial position is further determined using a trained system or a model.
Clause 37. The system of clause 36, wherein the trained system or model is trained based on vehicle historical data or crowdsourced data.
Clause 38. The system of clause 29, wherein causing the activation of the one or more actuator systems associated with the host vehicle also causes navigation of the host vehicle relative to the parking space approach maneuver initial position, and wherein the navigation of the host vehicle relative to the parking space approach maneuver initial position includes a forward motion leg and a reverse motion leg.
Clause 39. A method for navigating a host vehicle relative to a parking space, the method comprising: receiving sensed image data acquired by an image sensing system, wherein the sensed image data includes a representation of a parking space; determining, based at least in part on analysis of the sensed image data, a first indicator of a left boundary and a second indicator of a right boundary associated with the parking space; determining, based at least in part on analysis of the sensed image data, a parking space threshold associated with the parking space; determining a parking space approach maneuver initial position, wherein the parking space approach maneuver initial position is determined based on the determined first and second indicators of the left and right boundaries and also based on the determined parking space threshold; wherein the parking space approach maneuver initial position is one from which the host vehicle is able to navigate toward the parking space threshold and cross the threshold with an envelope of the host vehicle passing between the left boundary and the right boundary, and wherein further entry of the host vehicle into the parking space can be performed without requiring the vehicle envelope to intersect with or cross over the left boundary or the right boundary; and wherein the parking space approach maneuver initial position is also one from which the host vehicle has sufficient space to complete an S maneuver prior to crossing the parking space threshold; and causing activation of one or more actuator systems associated with the host vehicle to cause the host vehicle to navigate into the parking space from the parking space approach maneuver initial position and to complete the S maneuver prior to crossing the parking space threshold.
Clause 40. The method of clause 39, wherein the left boundary is associated with a parking line or an edge of a parked vehicle on a left side of the parking space, and/or the right boundary is associated with a parking line or edge of a parked vehicles on a right side of the parking space.
Clause 41. The method of clause 39, wherein the parking space threshold is determined by a line between closest points associated with the left boundary and the right boundary associated with the parking space.
Clause 42. The method of clause 39, wherein the left boundary includes a buffer relative to a parked vehicle or a parking line on a left of the parking space, and/or the right boundary includes a buffer relative to a parked vehicle or a parking line on a right side of the parking space.
Clause 43. The method of clause 39, wherein the parking space approach maneuver initial position is further determined based on a turn radius of the host vehicle and/or a width of the host vehicle.
Clause 44. The method of clause 39, wherein the parking space approach maneuver initial position is further determined using a trained system or a model.
Clause 45. The method of clause 44, wherein the trained system or model is trained based on vehicle historical data or crowdsourced data.
Clause 46. The method of clause 39, wherein causing the activation of the one or more actuator systems associated with the host vehicle also causes navigation of the host vehicle relative to the parking space approach maneuver initial position, and wherein the navigation of the host vehicle relative to the parking space approach maneuver initial position includes a forward motion leg and a reverse motion leg.
Clause 47. A non-transitory computer-readable medium storing instructions for navigating a host vehicle relative to a parking space according to a method, the method comprising: receiving sensed image data acquired by an image sensing system, wherein the sensed image data includes a representation of a parking space; determining, based at least in part on analysis of the sensed image data, a first indicator of a left boundary and a second indicator of a right boundary associated with the parking space; determining, based at least in part on analysis of the sensed image data, a parking space threshold associated with the parking space; determining a parking space approach maneuver initial position, wherein the parking space approach maneuver initial position is determined based on the determined first and second indicators of the left and right boundaries and also based on the determined parking space threshold; wherein the parking space approach maneuver initial position is one from which the host vehicle is able to navigate toward the parking space threshold and cross the threshold with an envelope of the host vehicle passing between the left boundary and the right boundary, and wherein further entry of the host vehicle into the parking space can be performed without requiring the vehicle envelope to intersect with or cross over the left boundary or the right boundary; and wherein the parking space approach maneuver initial position is also one from which the host vehicle has sufficient space to complete an S maneuver prior to crossing the parking space threshold; and causing activation of one or more actuator systems associated with the host vehicle to cause the host vehicle to navigate into the parking space from the parking space approach maneuver initial position and to complete the S maneuver prior to crossing the parking space threshold.
Clause 48. A system for navigating a host vehicle relative to a parking space, the system comprising: at least one processor comprising circuitry and a memory, wherein the memory includes instructions that when executed by the circuitry cause the at least one processor to: receive sensed image data acquired by an image sensing system, wherein the sensed image data includes a partial representation of a parking space, such that less than a full area of the parking space is represented in the sensed image data, and a distal region of the parking space and an associated parking space depth limiter are not represented in the captured image; determine, based at least in part on analysis of the sensed image data, a first indicator of a left boundary and a second indicator of a right boundary associated with the parking space; determine, based at least in part on analysis of the sensed image data, a parking space threshold associated with the parking space; cause activation of one or more actuator systems associated with the host vehicle to cause the host vehicle to navigate toward the parking space threshold along a curved trajectory to enter the parking space; receive new sensed image data, as the host vehicle approaches the parking space, wherein the new sensed image data includes a representation of a distal region of the parking space and an associated parking space depth limiter; based on a determination of whether the parking space depth limiter allows for sufficient depth for the host vehicle to reach a position where the host vehicle is substantially parallel to the left boundary or the right boundary, cause the host vehicle to continue onward along the curved trajectory to complete entry into the parking space if there is sufficient depth, or cause activation of the one or more actuator systems associated with the host vehicle to cause the host vehicle to initiate a correction maneuver during entry into the parking space.
Clause 49. The system of clause 48, wherein the sensed image data includes an image captured by a camera onboard the host vehicle.
Clause 50. The system of clause 48, wherein the sensed image data includes output from a RADAR or LIDAR system onboard the host vehicle.
Clause 51. The system of clause 48, wherein the left boundary is associated with a parking line or an edge of a parked vehicle on a left side of the parking space, and/or the right boundary is associated with a parking line or edge of a parked vehicles on a right side of the parking space.
Clause 52. The system of clause 48, wherein the parking space threshold is determined by a line between closest points associated with the left boundary and the right boundary associated with the parking space.
Clause 53. The system of clause 48, wherein the parking space depth limiter includes at least one of a curb, a parking space boundary line, a parked vehicle, a wall, or a barrier.
Clause 54. The system of clause 48, wherein the parking space depth limiter includes at least one object having a height greater than predetermined threshold relative to a surface of a parking lot.
Clause 55. The system of clause 48, wherein the correction maneuver includes decreasing or increasing a turn radius of an approach trajectory or initiating a reverse maneuver.
Clause 56. The system of clause 48, wherein the correction maneuver includes reversing the host vehicle to a new approach point and resuming entry into the parking space from the new approach point, wherein the new approach point is determined based on the parking space depth limiter represented in the new captured image.
Clause 57. A method for navigating a host vehicle relative to a parking space, the method comprising: receiving sensed image data acquired by an image sensing system, wherein the sensed image data includes a partial representation of a parking space, such that less than a full area of the parking space is represented in the sensed image data, and a distal region of the parking space and an associated parking space depth limiter are not represented in the captured image; determining, based at least in part on analysis of the sensed image data, a first indicator of a left boundary and a second indicator of a right boundary associated with the parking space; determining, based at least in part on analysis of the sensed image data, a parking space threshold associated with the parking space; causing activation of one or more actuator systems associated with the host vehicle to cause the host vehicle to navigate toward the parking space threshold along a curved trajectory to enter the parking space; receiving new sensed image data, as the host vehicle approaches the parking space, wherein the new sensed image data includes a representation of a distal region of the parking space and an associated parking space depth limiter; based on a determination of whether the parking space depth limiter allows for sufficient depth for the host vehicle to reach a position where the host vehicle is substantially parallel to the left boundary or the right boundary, causing the host vehicle to continue onward along the curved trajectory to complete entry into the parking space if there is sufficient depth, or causing activation of the one or more actuator systems associated with the host vehicle to cause the host vehicle to initiate a correction maneuver during entry into the parking space.
Clause 58. The method of clause 57, wherein the left boundary is associated with a parking line or an edge of a parked vehicle on a left side of the parking space, and/or the right boundary is associated with a parking line or edge of a parked vehicles on a right side of the parking space
Clause 59. The method of clause 57, wherein the parking space threshold is determined by a line between closest points associated with the left boundary and the right boundary associated with the parking space.
Clause 60. The method of clause 57, wherein the parking space depth limiter includes at least one of a curb, a parking space boundary line, a parked vehicle, a wall, or a barrier.
Clause 61. The method of clause 57, wherein the correction maneuver includes decreasing or increasing a turn radius of an approach trajectory or initiating a reverse maneuver.
Clause 62. The method of clause 57, wherein the correction maneuver includes reversing the host vehicle to a new approach point and resuming entry into the parking space from the new approach point, wherein the new approach point is determined based on the parking space depth limiter represented in the new sensed image data.
Clause 63. A non-transitory computer-readable medium storing instructions for navigating a host vehicle relative to a parking space according to a method, the method comprising: receiving sensed image data acquired by an image sensing system, wherein the sensed image data includes a partial representation of a parking space, such that less than a full area of the parking space is represented in the sensed image data, and a distal region of the parking space and an associated parking space depth limiter are not represented in the captured image; determining, based at least in part on analysis of the sensed image data, a first indicator of a left boundary and a second indicator of a right boundary associated with the parking space; determining, based at least in part on analysis of the sensed image data, a parking space threshold associated with the parking space; causing activation of one or more actuator systems associated with the host vehicle to cause the host vehicle to navigate toward the parking space threshold along a curved trajectory to enter the parking space; receiving new sensed image data, as the host vehicle approaches the parking space, wherein the new sensed image data includes a representation of a distal region of the parking space and an associated parking space depth limiter; based on a determination of whether the parking space depth limiter allows for sufficient depth for the host vehicle to reach a position where the host vehicle is substantially parallel to the left boundary or the right boundary, causing the host vehicle to continue onward along the curved trajectory to complete entry into the parking space if there is sufficient depth, or causing activation of the one or more actuator systems associated with the host vehicle to cause the host vehicle to initiate a correction maneuver during entry into the parking space.
Clause 64. A system for navigating a host vehicle relative to a parking space, the system comprising: at least one processor comprising circuitry and a memory, wherein the memory includes instructions that when executed by the circuitry cause the at least one processor to: receive sensed image data acquired by an image sensing system, wherein the sensed image data includes a representation of a parking space; determine, based at least in part on analysis of the sensed image data, a first indicator of a left boundary and a second indicator of a right boundary associated with the parking space; determine, based at least in part on analysis of the sensed image data, a parking space threshold associated with the parking space; where, based on an initial position of the host vehicle, a predetermined minimum vehicle turn radius for the host vehicle, and a predetermined envelope associated with the host vehicle, sufficient space is determined to exist from the initial position of the host vehicle to allow the host vehicle to enter the parking space via a single turn in maneuver, cause activation of one or more actuator systems associated with the host vehicle to cause the host vehicle to navigate into the parking space via the single turn in maneuver; and where, based on the initial position of the host vehicle, the predetermined minimum vehicle turn radius for the host vehicle, and the predetermined envelope associated with the host vehicle, sufficient space is determined to not exist from the initial position of the host vehicle to allow the host vehicle to enter the parking space via the single turn in maneuver, cause activation of one or more actuator systems associated with the host vehicle to cause the host vehicle to navigate into the parking space via a three-point turn in maneuver.
Clause 65. The system of clause 64, wherein the sensed image data includes an image captured by a camera onboard the host vehicle.
Clause 66. The system of clause 64, wherein the sensed image data includes output from a RADAR or LIDAR system onboard the host vehicle.
Clause 67. The system of clause 64, wherein the three-point turn in maneuver includes a reverse motion leg between two forward motion legs.
Clause 68. The system of clause 64, wherein the three-point turn in maneuver includes a forward motion leg between two reverse motion legs.
Clause 69. The system of clause 64, wherein the three-point turn in maneuver includes a forward motion leg between two reverse motion legs.
Clause 70. The system of clause 64, wherein the three-point turn in maneuver is performed without causing the predetermined envelope associated with the host vehicle to intersect with or cross the determined left and right boundaries associated with the parking space.
Clause 71. The system of clause 64, wherein the single turn in maneuver is performed without causing the predetermined envelope associated with the host vehicle to intersect with or cross the determined left and right boundaries associated with the parking space.
Clause 72. The system of clause 64, wherein the left boundary is associated with a parking line or an edge of a parked vehicle on a left side of the parking space, and/or the right boundary is associated with a parking line or edge of a parked vehicles on a right side of the parking space.
Clause 73. The system of clause 64, wherein the parking space threshold is determined by a line between closest points associated with the left boundary and the right boundary associated with the parking space.
Clause 74. The system of clause 64, wherein the left boundary includes a buffer relative to a parked vehicle or a parking line on a left of the parking space, and/or the right boundary includes a buffer relative to a parked vehicle or a parking line on a right side of the parking space.
Clause 75. The system of clause 64, wherein the determination, based on the initial position of the host vehicle, the predetermined minimum vehicle turn radius for the host vehicle, and the predetermined envelope associated with the host vehicle, of whether sufficient space exists from the initial position of the host vehicle to allow the host vehicle to enter the parking space via a single turn in maneuver, is performed by: determining a single turn in maneuver trajectory of the host vehicle into the parking space; and determining whether the single turn in maneuver trajectory when followed would cause the host vehicle to navigate toward the parking space threshold and cross the threshold with an envelope of the host vehicle between the left boundary and the right boundary and whether further entry of the host vehicle into the parking space can be performed without requiring the vehicle envelope to intersect with or cross over the left boundary or the right boundary; wherein when it is determined that the single turn in maneuver trajectory when followed would cause the host vehicle to navigate toward the parking space threshold and cross the threshold with an envelope of the host vehicle between the left boundary and the right boundary and that further entry of the host vehicle into the parking space can be performed without requiring the vehicle envelope to intersect with or cross over the left boundary or the right boundary, then it is determined that sufficient space exists for the single turn in maneuver; and wherein when it is determined that the single turn in maneuver trajectory when followed would cause the host vehicle to either navigate toward the parking space threshold and cross the threshold with an envelope of the host vehicle intersecting one of the left boundary and the right boundary or whether that further entry of the host vehicle into the parking space cannot be performed without requiring the vehicle envelope to intersect with or cross over the left boundary or the right boundary, then it is determined that sufficient space does not exist for the single turn in maneuver.
Clause 76. A method for navigating a host vehicle relative to a parking space, the method comprising: receiving sensed image data acquired by an image sensing system, wherein the sensed image data includes a representation of a parking space; determining, based at least in part on analysis of the sensed image data, a first indicator of a left boundary and a second indicator of a right boundary associated with the parking space; determining, based at least in part on analysis of the sensed image data, a parking space threshold associated with the parking space; where, based on an initial position of the host vehicle, a predetermined minimum vehicle turn radius for the host vehicle, and a predetermined envelope associated with the host vehicle, sufficient space is determined to exist from the initial position of the host vehicle to allow the host vehicle to enter the parking space via a single turn in maneuver, causing activation of one or more actuator systems associated with the host vehicle to cause the host vehicle to navigate into the parking space via the single turn in maneuver; and where, based on the initial position of the host vehicle, the predetermined minimum vehicle turn radius for the host vehicle, and the predetermined envelope associated with the host vehicle, sufficient space is determined to not exist from the initial position of the host vehicle to allow the host vehicle to enter the parking space via the single turn in maneuver, causing activation of one or more actuator systems associated with the host vehicle to cause the host vehicle to navigate into the parking space via a three-point turn in maneuver.
Clause 77. The method of clause 76, wherein the sensed image data includes an image captured by a camera onboard the host vehicle.
Clause 78. The method of clause 76, wherein the sensed image data includes output from a RADAR or LIDAR system onboard the host vehicle.
Clause 79. The method of clause 76, wherein the three-point turn in maneuver includes a reverse motion leg between two forward motion legs.
Clause 80. The method of clause 76, wherein the three-point turn in maneuver includes a forward motion leg between two reverse motion legs.
Clause 81. The method of clause 76, wherein the three-point turn in maneuver is performed without intersecting with or crossing the determined left and right boundaries associated with the parking space.
Clause 82. The method of clause 76, wherein the single turn in maneuver is performed without intersecting with or crossing the determined left and right boundaries associated with the parking space.
Clause 83. The method of clause 76, wherein the left boundary is associated with a parking line or an edge of a parked vehicle on a left side of the parking space, and/or the right boundary is associated with a parking line or edge of a parked vehicles on a right side of the parking space.
Clause 84. The method of clause 76, wherein the parking space threshold is determined by a line between closest points associated with the left boundary and the right boundary associated with the parking space.
Clause 85. The method of clause 76, wherein the left boundary includes a buffer relative to a parked vehicle or a parking line on a left of the parking space, and/or the right boundary includes a buffer relative to a parked vehicle or a parking line on a right side of the parking space.
Clause 86. The method of clause 76, wherein the determination, based on the initial position of the host vehicle, the predetermined minimum vehicle turn radius for the host vehicle, and the predetermined envelope associated with the host vehicle, of whether sufficient space exists from the initial position of the host vehicle to allow the host vehicle to enter the parking space via a single turn in maneuver, is performed by: determining a single turn in maneuver trajectory of the host vehicle into the parking space; and determining whether the single turn in maneuver trajectory when followed would cause the host vehicle to navigate toward the parking space threshold and cross the threshold with an envelope of the host vehicle between the left boundary and the right boundary and whether further entry of the host vehicle into the parking space can be performed without requiring the vehicle envelope to intersect with or cross over the left boundary or the right boundary; wherein when it is determined that the single turn in maneuver trajectory when followed would cause the host vehicle to navigate toward the parking space threshold and cross the threshold with an envelope of the host vehicle between the left boundary and the right boundary and that further entry of the host vehicle into the parking space can be performed without requiring the vehicle envelope to intersect with or cross over the left boundary or the right boundary, then it is determined that sufficient space exists for the single turn in maneuver; and wherein when it is determined that the single turn in maneuver trajectory when followed would cause the host vehicle to either navigate toward the parking space threshold and cross the threshold with an envelope of the host vehicle intersecting one of the left boundary and the right boundary or whether that further entry of the host vehicle into the parking space cannot be performed without requiring the vehicle envelope to intersect with or cross over the left boundary or the right boundary, then it is determined that sufficient space does not exist for the single turn in maneuver.
Clause 87. The non-transitory computer-readable medium storing instructions for navigating a host vehicle relative to a parking space according to a method, the method comprising: receiving sensed image data acquired by an image sensing system, wherein the sensed image data includes a representation of a parking space; determining, based at least in part on analysis of the sensed image data, a first indicator of a left boundary and a second indicator of a right boundary associated with the parking space; determining, based at least in part on analysis of the sensed image data, a parking space threshold associated with the parking space; where, based on an initial position of the host vehicle, a predetermined minimum vehicle turn radius for the host vehicle, and a predetermined envelope associated with the host vehicle, sufficient space is determined to exist from the initial position of the host vehicle to allow the host vehicle to enter the parking space via a single turn in maneuver, causing activation of one or more actuator systems associated with the host vehicle to cause the host vehicle to navigate into the parking space via the single turn in maneuver; and where, based on the initial position of the host vehicle, the predetermined minimum vehicle turn radius for the host vehicle, and the predetermined envelope associated with the host vehicle, sufficient space is determined to not exist from the initial position of the host vehicle to allow the host vehicle to enter the parking space via the single turn in maneuver, causing activation of one or more actuator systems associated with the host vehicle to cause the host vehicle to navigate into the parking space via a three-point turn in maneuver.
Clause 88. A system for navigating a host vehicle relative to a parking space, the system comprising: at least one processor comprising circuitry and a memory, wherein the memory includes instructions that when executed by the circuitry cause the at least one processor to: receive sensed image data acquired by an image sensing system, wherein the sensed image data includes a representation of a fishbone parking space; determine, based at least in part on analysis of the sensed image data, a first indicator of a left boundary and a second indicator of a right boundary associated with the fishbone parking space; determine, based at least in part on analysis of the sensed image data, an indicator of a parking space threshold associated with the fishbone parking space; cause activation of one or more actuator systems associated with the host vehicle to cause the host vehicle to navigate toward the fishbone parking space and cross the parking space threshold at a non-orthogonal angle; receive a new sensed image data, as the host vehicle approaches the fishbone parking space, wherein the new sensed image data includes a representation of a fishbone parking space depth limiter non-orthogonally oriented relative to a direction of travel of the host vehicle into the fishbone parking space; determine a host vehicle stopping location based on the fishbone parking space depth limiter; and cause activation of the one or more actuator systems associated with the host vehicle to cause the host vehicle to proceed into the fishbone parking space and come to a stop in response to the determined host vehicle stopping location.
Clause 89. The system of clause 88, wherein the sensed image data includes an image captured by a camera onboard the host vehicle.
Clause 90. The system of clause 88, wherein the sensed image data includes output from a RADAR or LIDAR system onboard the host vehicle.
Clause 91. The system of clause 88, wherein the left boundary is associated with a parking line or an edge of a parked vehicle on a left side of the parking space, and/or the right boundary is associated with a parking line or edge of a parked vehicles on a right side of the parking space.
Clause 92. The system of clause 88, wherein the parking space threshold is determined by a line between closest points associated with the left boundary and the right boundary associated with the parking space.
Clause 93. The system of clause 88, wherein the left boundary includes a buffer relative to a parked vehicle or a parking line on a left of the parking space, and/or the right boundary includes a buffer relative to a parked vehicle or a parking line on a right side of the parking space.
Clause 94. The system of clause 88, wherein the fishbone parking space depth limiter includes at least one of a curb, a parking space boundary line, a parked vehicle, a wall, or a barrier.
Clause 95. The system of clause 88, wherein activation of the one or more actuator systems associated with the host vehicle is caused to cause the host vehicle to proceed into the fishbone parking space in reverse.
Clause 96. The system of clause 88, wherein the sensed image data includes a representation of only a partial area of the fishbone parking space and does not include a representation of the fishbone parking space depth limiter.
Clause 97. The system of clause 88, wherein after the host vehicle crosses the parking space threshold at a non-orthogonal angle it is determined whether the host vehicle can continue to navigate into the fishbone parking space without the envelope of the host vehicle intersecting with or crossing over the left or right boundaries; and wherein: when it is determined that the host vehicle can continue to navigate into the fishbone parking space without the envelope of the host vehicle intersecting with or crossing over the left or right boundaries, activation of one or more actuation systems of the host vehicle is caused to cause the host vehicle to navigate to the host vehicle stopping location; and when it is determined that the host vehicle cannot continue to navigate into the fishbone parking space without the envelope of the host vehicle intersecting with or crossing over the left or right boundaries, then activation of one or more actuator systems of the host vehicles is then caused to cause the host vehicle to exit the fishbone parking space, perform one or more correction maneuvers, and navigate to the host vehicle stopping location without the envelope of the host vehicle crossing over or intersecting with the left or right boundary of the fishbone parking space.
Clause 98. A method for navigating a host vehicle relative to a parking space, the method comprising: receiving sensed image data acquired by an image sensing system, wherein the sensed image data includes a representation of a fishbone parking space; determining, based at least in part on analysis of the sensed image data, a first indicator of a left boundary and a second indicator of a right boundary associated with the fishbone parking space; determining, based at least in part on analysis of the sensed image data, an indicator of a parking space threshold associated with the fishbone parking space; causing activation of one or more actuator systems associated with the host vehicle to cause the host vehicle to navigate toward the fishbone parking space and cross the parking space threshold at a non-orthogonal angle; receiving a new sensed image data, as the host vehicle approaches the fishbone parking space, wherein the new sensed image data includes a representation of a fishbone parking space depth limiter non-orthogonally oriented relative to a direction of travel of the host vehicle into the fishbone parking space; determining a host vehicle stopping location based on the fishbone parking space depth limiter; and causing activation of the one or more actuator systems associated with the host vehicle to cause the host vehicle to proceed into the fishbone parking space and come to a stop in response to the determined host vehicle stopping location.
Clause 99. The method of clause 98, wherein the left boundary is associated with a parking line or an edge of a parked vehicle on a left side of the parking space, and/or the right boundary is associated with a parking line or edge of a parked vehicles on a right side of the parking space.
Clause 100. The method of clause 98, wherein the parking space threshold is determined by a line between closest points associated with the left boundary and the right boundary associated with the parking space.
Clause 101. The method of clause 98, wherein the left boundary includes a buffer relative to a parked vehicle or a parking line on a left of the parking space, and/or the right boundary includes a buffer relative to a parked vehicle or a parking line on a right side of the parking space.
Clause 102. The method of clause 98, wherein the fishbone parking space depth limiter includes at least one of a curb, a parking space boundary line, a parked vehicle, a wall, or a barrier.
Clause 103. The method of clause 98, wherein activation of the one or more actuator systems associated with the host vehicle is caused to cause the host vehicle to proceed into the fishbone parking space in reverse.
Clause 104. The method of clause 98, wherein the sensed image data includes a representation of only a partial area of the fishbone parking space and does not include a representation of the fishbone parking space depth limiter.
Clause 105. The method of clause 98, wherein after the host vehicle crosses the parking space threshold at a non-orthogonal angle it is determined whether the host vehicle can continue to navigate into the fishbone parking space without the envelope of the host vehicle intersecting with or crossing over the left or right boundaries; and wherein: after it is determined that the host vehicle can continue to navigate into the fishbone parking space without the envelope of the host vehicle intersecting with or crossing over the left or right boundaries, activation of one or more actuation systems of the host vehicle is caused to cause the host vehicle to navigate to the host vehicle stopping location; and after it is determined that the host vehicle cannot continue to navigate into the fishbone parking space without the envelope of the host vehicle intersecting with or crossing over the left or right boundaries, then activation of one or more actuator systems of the host vehicle is then caused to cause the host vehicle to exit the fishbone parking space, perform one or more correction maneuvers, and navigate to the host vehicle stopping location without the envelope of the host vehicle crossing over or intersecting with the left or right boundary of the fishbone parking space.
Clause 106. A non-transitory computer-readable medium storing instructions for navigating a host vehicle relative to a parking space according to a method, the method comprising, the method comprising: receiving sensed image data acquired by an image sensing system, wherein the sensed image data includes a representation of a fishbone parking space; determining, based at least in part on analysis of the sensed image data, a first indicator of a left boundary and a second indicator of a right boundary associated with the fishbone parking space; determining, based at least in part on analysis of the sensed image data, an indicator of a parking space threshold associated with the fishbone parking space; causing activation of one or more actuator systems associated with the host vehicle to cause the host vehicle to navigate toward the fishbone parking space and cross the parking space threshold at a non-orthogonal angle; receiving a new sensed image data, as the host vehicle approaches the fishbone parking space, wherein the new sensed image data includes a representation of a fishbone parking space depth limiter non-orthogonally oriented relative to a direction of travel of the host vehicle into the fishbone parking space; determining a host vehicle stopping location based on the fishbone parking space depth limiter; and causing activation of the one or more actuator systems associated with the host vehicle to cause the host vehicle to proceed into the fishbone parking space and come to a stop in response to the determined host vehicle stopping location.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, 4K Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of . Net Framework, . Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A system for navigating a host vehicle relative to a parking space, the system comprising:
at least one processor comprising circuitry and a memory, wherein the memory includes instructions that when executed by the circuitry cause the at least one processor to:
receive sensed image data acquired by an image sensing system, wherein the sensed image data includes a representation of a parking space;
determine, based at least in part on analysis of the sensed image data, a first indicator of a left boundary and a second indicator of a right boundary associated with the parking space;
determine a parking space approach maneuver initial position, wherein the parking space approach maneuver initial position is determined based on the determined first and second indicators of the left and right boundaries and also based on a determined indicator of an entrance to the parking space; wherein the parking space approach maneuver initial position is one from which the host vehicle is able to navigate toward the entrance to the parking space and enter the parking space with an envelope of the host vehicle between the left boundary and the right boundary, and wherein further entry of the host vehicle into the parking space can be performed without requiring the vehicle envelope to intersect with or cross over the left boundary or the right boundary inside the parking space; and
cause activation of one or more actuator systems associated with the host vehicle to cause the host vehicle to navigate into the parking space from the parking space approach maneuver initial position.

2. The system of claim 1, wherein the sensed image data includes an image captured by a camera onboard the host vehicle.

3. The system of claim 1, wherein the sensed image data includes output from a RADAR or LIDAR system onboard the host vehicle.

4. The system of claim 1, wherein the left boundary is associated with a parking line or an edge of a parked vehicle on a left side of the parking space, and/or the right boundary is associated with a parking line or edge of a parked vehicles on a right side of the parking space.

5. The system of claim 1, wherein the memory includes instructions that when executed by the circuitry cause the at least one processor to determine, based at least in part on analysis of the sensed image data, an indicator of an entrance to the parking space.

6. The system of claim 5, wherein the indicator of the entrance to the parking space is associated with a line, indicative of a parking space threshold, between closest points associated with the left boundary and the right boundary associated with the parking space.

7. The system of claim 1, wherein the left boundary includes a buffer relative to a parked vehicle or a parking line on a left side of the parking space, and/or the right boundary includes a buffer relative to a parked vehicle or a parking line on a right side of the parking space.

8. The system of claim 1, wherein the parking space approach maneuver initial position is further determined based on host vehicle turn radius and/or host vehicle width.

9. The system of claim 1, wherein the parking space approach maneuver initial position is further determined using a trained system or a model.

10. The system of claim 9, wherein the trained system or model is trained based on vehicle historical data or crowdsourced data.

11. The system of claim 1, wherein causing the activation of the one or more actuator systems associated with the host vehicle also causes navigation to the parking space approach maneuver initial position.

12. The system of claim 11, wherein the navigation to the parking space approach maneuver initial position includes activating one or more actuation systems of the host vehicle to cause the host vehicle to travel in a reverse direction.

13. The system of claim 11, wherein the navigation to the parking space approach maneuver initial position includes activating one or more actuation systems of the host vehicle to cause the host vehicle to perform a serpentine maneuver prior to reaching the parking space approach maneuver initial position.

14. The system of claim 1, wherein the parking space approach maneuver initial position corresponds to a point from which a heading direction of the host vehicle is controlled to turn the host vehicle toward the entrance to the parking space as the host vehicle approaches the entrance to the parking space.

15. The system of claim 1, wherein the parking space approach maneuver initial position is associated with a predetermined heading direction enabling the host vehicle to enter the parking space in a single maneuver.

16. A method for navigating a host vehicle relative to a parking space, the method comprising:
receiving sensed image data acquired by an image sensing system, wherein the sensed image data includes a representation of a parking space;
determining, based at least in part on analysis of the sensed image data, a first indicator of a left boundary and a second indicator of a right boundary associated with the parking space;
determining, based at least in part on analysis of the sensed image data, an indicator of an entrance to the parking space;
determining a parking space approach maneuver initial position, wherein the parking space approach maneuver initial position is determined based on the determined first and second indicators of the left and right boundaries and also based on the determined indicator of the entrance to the parking space; wherein the parking space approach maneuver initial position is one from which the host vehicle is able to navigate toward the entrance to the parking space and enter the parking space with an envelope of the host vehicle between the left boundary and the right boundary, and wherein further entry of the host vehicle into the parking space can be performed without requiring the vehicle envelope to intersect with or cross over the left boundary or the right boundary; and
causing activation of one or more actuator systems associated with the host vehicle to cause the host vehicle to navigate into the parking space from the parking space approach maneuver initial position.

17. The method of claim 16, wherein the left boundary is associated with a parking line or an edge of a parked vehicle on a left side of the parking space, and the right boundary is associated with a parking line or edge of a parked vehicles on a right side of the parking space.

18. The method of claim 16, wherein the indicator of the entrance to the parking space is associated with a line, indicative of a parking space threshold, between closest points associated with the left boundary and the right boundary associated with the parking space.

19. The method of claim 16, wherein the left boundary includes a buffer relative to a parked vehicle or a parking line on a left side of the parking space, and/or the right boundary includes a buffer relative to a parked vehicle or a parking line on a right side of the parking space.

20. The method of claim 16, wherein the parking space approach maneuver initial position is further determined based on host vehicle turn radius and/or host vehicle width.

21. The method of claim 16, wherein the parking space approach maneuver initial position is further determined using a trained system or a model.

22. The method of claim 21, wherein the trained system or model is trained based on vehicle historical data or crowdsourced data.

23. The method of claim 16, wherein causing the activation of the one or more actuator systems associated with the host vehicle also causes navigation of the host vehicle to the parking space approach maneuver initial position.

24. The method of claim 23, wherein the navigation to the parking space approach maneuver initial position includes activating one or more actuation systems of the host vehicle to cause the host vehicle to travel in a reverse direction.

25. The method of claim 23, wherein the navigation to the parking space approach maneuver initial position includes activating one or more actuation systems of the host vehicle to cause the host vehicle to perform a serpentine maneuver prior to reaching the parking space approach maneuver initial position.

26. The method of claim 16, wherein the parking space approach maneuver initial position corresponds to a point from which a heading direction of the host vehicle is controlled to turn the host vehicle toward the entrance to the parking space as the host vehicle approaches the entrance to the parking space.

27. The method of claim 16, wherein the parking space approach maneuver initial position is associated with a predetermined heading direction enabling the host vehicle to enter the parking space via forward motion and without reversing.

28. A non-transitory computer-readable medium storing instructions for navigating a host vehicle relative to a parking space according to a method, the method comprising:
receiving sensed image data acquired by an image sensing system, wherein the sensed image data includes a representation of a parking space;
determining, based at least in part on analysis of the sensed image data, a first indicator of a left boundary and a second indicator of a right boundary associated with the parking space;
determining, based at least in part on analysis of the sensed image data, an indicator of an entrance to the parking space;
determining a parking space approach maneuver initial position, wherein the parking space approach maneuver initial position is determined based on the determined first and second indicators of the left and right boundaries and also based on the determined indicator of the entrance to the parking space; wherein the parking space approach maneuver initial position is one from which the host vehicle is able to navigate toward the entrance to the parking space and enter the parking space with an envelope of the host vehicle between the left boundary and the right boundary, and wherein further entry of the host vehicle into the parking space can be performed without requiring the vehicle envelope to intersect with or cross over the left boundary or the right boundary; and
causing activation of one or more actuator systems associated with the host vehicle to cause the host vehicle to navigate into the parking space from the parking space approach maneuver initial position.
